(19) United States
(12) Patent Application Publication
(10) Pub. No.: US 2020/0022873 A1
(43) Pub. Date: Jan. 23, 2020

(54) MODULAR DOSING ASSEMBLY OF MEDICAL SUBSTANCES

(71) Applicant: Mikael NAYGAUZ, Forrest Hills, NY (US)

(72) Inventor: Mikael NAYGAUZ, Forrest Hills, NY (US)

(21) Appl. No.: 16/550,545

(22) Filed: Aug. 26, 2019

Related U.S. Application Data
(63) Continuation-in-part of application No. 16/102,635, filed on Aug. 13, 2018.
(60) Provisional application No. 62/881,938, filed on Aug. 1, 2019.
(60) Provisional application No. 62/846,663, filed on May 12, 2019.
(60) Provisional application No. 62/690,260, filed on Jun. 26, 2018.
(60) Provisional application No. 62/681,884, filed on Jun. 7, 2018.
(60) Provisional application No. 62/680,974, filed on Jun. 5, 2018.
(60) Provisional application No. 62/679,817, filed on Jun. 3, 2018.
(60) Provisional application No. 62/670,833, filed on May 13, 2018.
(60) Provisional application No. 62/667,593, filed on May 6, 2018.
(60) Provisional application No. 62/666,866, filed on May 4, 2018.
(60) Provisional application No. 62/660,885, filed on Apr. 20, 2018.
(60) Provisional application No. 62/649,483, filed on Mar. 28, 2018.
(60) Provisional application No. 62/545,152, filed on Aug. 14, 2017.

(51) Int. Cl. A61J 1/20; A61J 1/14

(52) U.S. Cl. CPC A61J 1/2093; A61J 1/1412; A61J 1/1443; A61J 1/1468; A61J 1/1481; A61J 1/2006; A61J 1/2027; A61J 1/2037; A61J 1/2058; A61J 1/2065; A61J 2205/10; A61J 2205/20; A61J 2205/30; A61J 2205/40; A61J 1/1406

(57) ABSTRACT

Systems, devices and methods to establish fluid communication between vessels. Containers and devices having a unitary multiple entry port structure and a port unitary cover with buttons or levers for the assembly of customized final dosages of injectable beneficial substances. Containers and devices having a protective port with a cover configured to hermetically seal second container(s) within the protective port. A vessel having at least two entry ports and at least one exit port, and at least one container containing a dosing regimen, the at least one container configured to be received by one of the at least two entry ports of the vessel, whereby upon connection of the at least one container to the one of the at least two entry ports of the vessel, the dosing regimen in the at least one container is transferred into the vessel. Modular dosing system for adding at least one amount of a medicament to a preparation in a modular construction. System for displaying a dosing regimen or single amount of a medicament, so that the administrator of the amount is able to precisely ascertain the amount administered to a patient.

### CROSS REFERENCE TO RELATED APPLICATIONS

This application is a continuation-in-part of U.S. Ser. No. 16/102,635 filed on Aug. 13, 2018. This application claims the benefit of U.S. Provisional Patent Application No. 62/545,152 filed on Aug. 14, 2017; 62/649,483 filed on Mar. 28, 2018; 62/660,885 filed on Apr. 20, 2018; 62/666,866 filed on May 4, 2018; 62/667,593 filed on May 6, 2018; 62/670,833 filed on May 13, 2018; 62/679,817 filed on Jun. 3, 2018; 62/680,974 filed on Jun. 5, 2018; 62/681,884 filed on Jun. 7, 2018; 62/690,260 filed on Jun. 26, 2018; 62/846,663 filed on May 12, 2019; and 62/881,938 filed on Aug. 1, 2019.

The contents of the above applications are all incorporated by reference as if fully set forth herein in their entirety.

### FIELD OF THE INVENTION

The present invention relates, in some embodiments thereof, to systems, containers, devices and substance transfer methods to establish fluid communication between medical vessels and devices. In some embodiments of the invention, the systems and devices of the invention include a vessel comprising at least two entry ports and at least one exit port, and at least one container containing an amount of a beneficial substance, the at least one container configured to be received by one of the at least two entry ports of the vessel, whereby upon connection of the at least one container to the one of the at least two entry ports of the vessel, the dosing regimen in the at least one container is transferred into the vessel, thereby allowing the user to assemble virtually any customized final amount for an individual with maximum flexibility and without manual manipulation of the beneficial substance, wherein the vessel may be a container or a syringe. In other embodiments of the invention, the systems, containers, and devices of the invention involve a modular dosing system for assembling/adding a plurality of amounts of medicaments in a modular construction. In other embodiments of the invention, the systems and devices of the invention include a system for displaying a dosing regimen or single amount of a medicament, so that the administrator of the amount is able to precisely ascertain the amount administered to a patient.

### BACKGROUND OF THE INVENTION

The medicinal practice routinely involves administration of medical substances, such as, medicaments, fluids, nutritional substances and the alike, to patients or animals. The preparation and/or administration of such medicinal substances typically involves one or more transfers of those substances between pharmaceutical vessels or administration devices (such as, vials, syringes, infusion lines, connectors, etc.). Each such act of transferring substances between vessels or devices exposes the connection interfaces of the vessels and accordingly the medical substances themselves to contaminants present in ambient air or ambient air particles (e.g., bacteria, viruses, funguses, spores, pyrogens, dirt). In addition, connection interfaces are further prone to contaminations due to physical contact of the interfaces, for example, with nonsterile gloves, or devices.

Such contaminations are a major problem in the healthcare setting since contaminants, once invading within medicinal substances, may pose substantial danger if administered intracorporeally to patients.

Typical connection interfaces of pharmaceutical vessels or pharmaceutical administration devices include rubber bungs and/or stoppers covered by a cap and/or seal that can be flicked off and/or are removed prior to usage thereof. These rubber bungs/stoppers are used to allow penetration by a needle attached to a syringe or by other medical connectors and/or spikes/piercing members. When the cap and/or seal is flicked off and/or removed, the rubber bung and/or stopper is exposed to ambient air and to contaminants present therein. Accordingly, exposure of connection interfaces to ambient air may involve contamination of the interfaces and consequently contamination of a beneficial substance to be provided to a patient.

Existing systems include U.S. Pat. Nos. D720,067; D717,947; D703,812; D690,418; D639,939; D637,713; 9,790,011; 9,775,777; 9,561,326; 9,493,281; 9,492,353; 9,309,020 9,173,816; 9,168,203; 9,162,803; 9,039,672; 8,926,583; 8,827,978; 8,790,330; 8,662,985; 8,657,803; 8,622,985; 8,562,583; 8,545,475; 8,523,838; 8,491,563; 8,480,646; 8,449,521; 8,381,776; 8,336,587; 8,328,772; 8,287,513; 8,225,826; 8,075,550; 8,029,747; 7,998,134; 7,975,733; 7,942,860; 7,867,215; 7,744,581; 7,731,678; 7,387,216; 7,306,584; 6,875,203; 6,729,370 6,715,520; 6,602,239; 6,409,708; 6,343,629; 6,162,199; 6,113,583; 6,063,068; 5,893,397; 5,876,380; 5,832,971; 5,807,374; 5,746,733; 5,569,235; 5,462,535; 5,405,326; 5,292,318; 5,279,582; 4,944,723; 4,932,947; 4,932,937; 4,919,657; 4,915,701; 4,826,489; 4,673,404; 4,564,054; 3,610,241; 3,605,743; 3,587,575; 3,583,399; 3,578,037; 3,556,099; 3,552,387; 3,406,686; 3,380,450; 3,375,825; 3,342,180; 3,330,282; 3,330,281; 3,306,290; 3,255,752; 3,253,592; 3,076,456; 2,972,991; 2,922,419; US20160262982; US20160038373; US20150209568; US20140183196; US20140016570; US20140007973; US20140000754; US20130184672; US20130006200; US20120209238; US20120209218; US20120203194; US20110284561; US20110186177; US20110125128; US20110108158; US20110098647; US20100249745; US20100198182; US20100152669; US20100147402; US20100036319; US20100004602; US20090057258; US20080312634; US20080223484; US20080171981; US20060276759; US20050215976; US20030199847; US20030187420; US20020130100; US20020115981; US20020099354; ES2577377T3; EP2852367B1; EP2666513; EP2155141B1.

In order to overcome this obstacle, the current medical practice involves swabbing the surface of a connection interface with a disinfecting agent, such as 70% isopropyl alcohol, prior to accessing and/or piercing the connection interface. Other methods include i. v. (intravenous) rooms which are used for the sterile preparation of i. v. medications. Such rooms, to keep medicinal preparations as sterile as possible, are equipped with special instruments including, intravenous hoods with air filtration systems (e.g., HEPA filters), ventilation systems and air pressure systems. Additionally, those rooms necessitate that the medical staff working in these rooms are properly garmented, are properly trained, and require aseptic techniques, and employ quality control and validation processes. These systems require regular upkeep by certified personnel and require regular cleaning. These systems are therefore expensive, labor intensive, and require regular maintenance and testing to assure that they are operating effectively. The above described systems and methods are either cumbersome and expensive or inefficient in addressing the problem of reducing/eliminating contaminants on connection interfaces.

Taken together, the above described systems and methods are either cumbersome and expensive or inefficient in addressing the problem of reducing/eliminating contaminants on connection interfaces.

The other issue that was previously mentioned relates to standard commercially available amounts of beneficial substances and the disadvantage this poses for preparing tailored or customized final dosage amounts. The preparation of customized amounts of intracorporeally administered beneficial substances requires the manual manipulation of the beneficial substances typically by healthcare personnel. Manual manipulation involves drawing out by hand from vials using syringes and needles amounts of beneficial substances, measuring visually the amount of the beneficial substance that has been drawn into a syringe, and injecting the amount of the beneficial substance from a syringe into a second container, typically a bag or a bottle. The preparation of customized amounts of beneficial substances typically involves using less than the amount provided in one commercially available container or typically involves using more than the amount provided in one commercially available container. Customized dosages, particularly of chemotherapeutic agents, are typically based on a patient's weight, height, and/or age thus different patients require different final dosage amounts of chemotherapeutic agents (or other medicaments) since patients' weights, heights, ages, and body surface areas vary. Therefore, the preparation of customized final amounts of beneficial substances require the manual manipulation and measurement of beneficial substances by healthcare personnel to provide a customized/individualized final dose to a patient. This preparation of customized final amounts of beneficial substances is non-standardized since different healthcare personnel working different shifts perform the manual manipulations of the medicaments which introduces variability into medicament preparation processes. The accuracy of the final dosage amount dispensed to patients may vary depending on the individual measuring and mixing the medicaments/beneficial substances.

Another issue relates to leakage of fluids and/or vapors out of containers containing beneficial substance (such as injectable medicaments). When a user withdraws or injects a sterile fluid out of or into a container this process involves the use of a syringe with a needle, wherein the needle pierces a bung (e.g. rubber bung, stopper) of a container (e.g. vial containing a medicament). The bung of the container surrounds the exterior circumference and/or circumferential edge of the needle when the needle is pierced through the bung. Therefore, the bung firmly surrounding the needle's exterior circumference and/or circumferential edge and forms a hermetic/airtight seal between the needle and the bung thus not allowing any contents of the container/vial to escape while the beneficial substance contained in the container/vial is transferred into or from the container/vial and the syringe. However, this hermetic/airtight seal between the needle's circumferential edge and the bung is not foolproof since a user may move the needle in any direction (vertically, horizontally, laterally) while withdrawing/injecting the beneficial substance/medicament into or out of the container/vial. Movement of the needle is not uncommon during manual manipulation of the beneficial substance by a user and frequently leakage occurs in spaces formed between the needle's circumferential exterior edge and the bung. Such leakages may be very dangerous if the beneficial substance is a chemotherapeutic substance since chemotherapeutics are typically toxic, teratogenic, etc. Leakage of fluids and/or vapors in these spaces as described may expose a user such as a pharmacist, nurse, etc. to toxic substances. Additionally, currently when a vial containing an injectable medicament is attached to an intravenous bag the vial's bung is typically pierced by a spike/needle of the intravenous bag or of a connector that connects the vial to the bag. The spike/needle typically pierces the vial's bung (usually a rubber bung) before a secure airtight engagement is established between the intravenous bag or connector and the vial. Therefore, it common for vapors or fluids to escape from the fluidic passageway that is established between a vial and an intravenous bag or connector.

Another issue relates to breakage of containers (e.g. vials) when attached to a bag or a bottle. When pharmacy or nursing personnel attach a vial containing an injectable medicament to an intravenous bag or bottle, the bag/bottle with attached vial may fall and break during preparatory processes and/or during transport of the bag/bottle-vial from the pharmacy department of a hospital to the nursing units/stations. This is not uncommon. Breakage of the vial typically results in spillage of the powdered medication or liquid medicament contained in the vial that is attached to the intravenous bag or bottle. Additionally, if a toxic substance (such as a chemotherapeutic medicament) is contained inside the vial breakage of the vial will result in spillage of the toxic chemotherapeutic medicament thus exposing the environment, healthcare personnel, and possibly patients to the toxic substance.

Thus, there is a long felt and unmet need for systems, devices and/or methods that afford transfer of medical substances in a sterile manner. There is a need for reliable, user friendly and cost-effective solutions allowing contaminant-free engagement of vessels for drug preparation and administration processes. There is also a dire need for systems, devices and methods for the preparation of customized amounts of beneficial substances that obviate the need for manual manipulation of beneficial substances and that prevent leakage and/or spillage of beneficial substance into the environment.

### SUMMARY OF THE INVENTION

Objects of the invention are achieved by providing systems, devices and methods for administering medical substances in a decontaminated manner.

Objects of the invention are achieved by providing systems, devices and methods which are directed to the transfer of medical substances in an efficient, user-friendly and essentially sterile manner.

Objects of the invention are achieved by providing systems, devices and methods which afford the transfer of medical substances in an efficient, user-friendly and essentially sterile manner and in a modular construction.

Objects of the invention are achieved by providing systems, devices and methods which afford the transfer of medical substances in an efficient, user-friendly and modular construction.

Objects of the invention are achieved by providing systems, devices and methods which afford the transfer of medical substances in an efficient, user-friendly and essentially sterile manner so that dosing regimens are clearly shown and are able to be ascertained to a person administering an amount to a patient.

Objects of the invention are achieved by providing systems, devices and methods which afford the transfer of medical substances in a leak-free manner.

Objects of the invention are achieved by providing systems, devices and methods which afford the transfer of medical substances in a manner that prevents the escape of vapors and/or leaks into the environment.

Objects of the invention are achieved by providing systems, devices and methods which afford the assembly of a plurality of containers containing injectable medicaments and/or nutritional substances in a leak-free manner.

Objects of the invention are achieved by providing systems, devices and methods which afford the assembly of a plurality of containers inside a hermetically sealed port structure.

The present invention provides devices and systems that decontaminate connection surfaces of medical or pharmaceutical vessels and thereafter allow decontaminated fluid passageway between the vessels.

In a first aspect, the present invention provides a system for adding at least one amount of a medicament to a vessel, the system comprising: a vessel including at least two entry ports; and at least one container housing an amount of a medicament; wherein the at least one container is configured to be directly received and engaged by one of the at least two entry ports of the vessel, wherein upon connection of the at least one container to the one of the at least two entry ports of the vessel, the amount of the medicament housed in the at least one container is transferred into the vessel.

In a second aspect, the present invention provides a system for intermixing beneficial substances, comprising: a bag having at least one entry port and at least one exit ports, the at least one entry port configured to receive at least one container and allow to transfer a dose from the at least one container to the bag, the at least one entry port include a protective peripheral wall enclosing a cavity configured to receive the container and engulf thereof, thereby providing a protective entry port structure.

In certain embodiments, the at least one entry port includes a conduit fluidly connecting the bag to the at least one entry port.

In certain embodiments, the at least one entry port includes a cover for closing the entry port and providing a closed protective structure for the at least one container. In certain embodiments, the cover includes a cover closure mechanism for locking the cover to the entry port after the at least one container is received by the at least one entry port.

In certain embodiments, the system further comprising a mechanism for fluid transfer allowing to transfer the dose from the at least one container to the bag. In certain embodiments, the mechanism for fluid transfer includes a mechanism for moving a plunger of the container.

In certain embodiments, the system further comprising at least one negative air pressure compartment for exerting a lower pressure in the at least one entry port compared to ambient air pressure. In certain embodiments, the least one negative air pressure compartment is mounted to the at least one entry port and/or to the bag. In certain embodiments, the at least one negative air pressure compartment is mounted to the protective peripheral wall. In one or more embodiments, the at least one negative air pressure compartment is mounted to the cover. In one or more embodiments, the at least one negative air pressure compartment is mounted to the bag. In one or more embodiments, the at least one negative air pressure compartment is flush mounted to any of the bag, the cover, and/or the protective peripheral wall. In one or more embodiments, the at least one negative air pressure compartment is surface mounted to any of the bag, the cover, and/or the protective peripheral wall. In one or more embodiments, the negative air pressure compartment is made of a rigid material such as, but not limited to, a plastic, a metal, a glass, and combinations thereof. In one or more embodiments, the negative air pressure compartment has a pressure less than atmospheric pressure. In one or more embodiments, the protective peripheral wall is made of a rigid material. In one or more embodiments, the protective peripheral wall is made of a plastic material, a metal material, a glass material, a metal alloy, and/or combinations thereof.

In certain embodiments, the protective peripheral wall abuts the bag.

In certain embodiments, the protective peripheral wall is transparent.

In certain embodiments, the protective peripheral wall is translucent.

In certain embodiments, the protective peripheral wall is opaque.

In certain embodiments, the cover is transparent.

In certain embodiments, the cover is translucent.

In certain embodiments, the cover is opaque.

In certain embodiments, the at least one container abuts the vessel when the at least one container is engaged to the vessel. In certain embodiments, the at least one container is flush mounted to the vessel when the at least one container is engaged to the vessel. In certain embodiments, the at least one container is surface mounted to the vessel when the at least one container is engaged to the vessel.

In certain embodiments, the amount of the medicament is a non-standard amount.

In certain embodiments, the at least one container is configured to be directly received by at least one of the at least two entry ports.

In certain embodiments, the bag includes at least two entry ports, wherein the at least two entry ports are integrally connected to each other forming a unitary multiple entry port structure. In certain embodiments, the unitary multiple entry port structure includes at least two cavities for receiving at least two containers.

In certain embodiments, the vessel has a plurality of decontamination devices. In certain embodiments, the vessel is a bag or a bottle. In certain embodiments, the vessel is selected from a group consisting of a container, container with a flexible wall, container with a rigid wall, container with an expulsion member, a syringe, and container with a plunger.

In certain embodiments, the vessel is a cartridge or container based stacking system having a plurality of cartridges or containers. In certain embodiments, the amount of the medicament flows through the plurality of cartridges or containers.

In certain embodiments, the vessel includes at least two engagement mechanisms abutting a wall of the vessel. In certain embodiments, the at least two engagement mechanisms are surface mounted and/or flush mounted to a wall of the vessel. In certain embodiments, the at least two engagement mechanisms are configured to engage the at least two containers. In certain embodiments, the at least two engagement mechanisms are selected from a group consisting of a ratchet teeth mechanism, a snap-on mechanism, a slide-on mechanism, an adhesive mechanism, and combinations thereof. In certain embodiments, the at least two engagement mechanisms are a thread mechanism.

In certain embodiments, upon connection of the at least two containers to the vessel, the at least two containers abut a wall of the vessel. In certain embodiments, the upon connection of the at least two containers to the vessel, the at least two containers are surface mounted to a wall of the vessel. In certain embodiments, the upon connection of the at least two containers to the vessel, the at least two containers are flush mounted to a wall of the vessel. In certain embodiments, the at least two entry ports of the vessel abut the vessel. In certain embodiments, the at least two entry ports of the vessel abut a wall of the vessel. In embodiments, the at least two entry ports of the vessel are flush mounted the vessel. In certain embodiments, the at least two entry ports of the vessel are flush mounted to a wall of the vessel. In certain embodiments, the at least two entry ports of the vessel are surface mounted to the vessel. In certain embodiments, the at least two entry ports of the vessel are surface mounted to a wall of the vessel.

In certain embodiments, the vessel has at least three entry ports abutting the vessel. In certain embodiments, the vessel has at least four entry ports abutting a wall of the vessel. In certain embodiments, the vessel has at least three entry ports flush mounted to the vessel. In certain embodiments, the vessel has at least three entry ports flush mounted to a wall of the vessel. In certain embodiments, the vessel has at least four entry ports surface mounted to the vessel. In certain embodiments, the vessel has at least four entry ports surface mounted to a wall of the vessel.

In certain embodiments, the vessel is a container with a flexible wall. In certain embodiments, the vessel is a container is a bag. In certain embodiments, the vessel has a rigid wall. In certain embodiments, the vessel is a bottle. In certain embodiments, the vessel is a vial. In certain embodiments, the vessel is a cartridge. In certain embodiments, the vessel is a syringe.

In certain embodiments, the at least one container is at least two containers housing a medicament. In certain embodiments, the medicament is a beneficial substance.

In certain embodiments, the at least one container is at least three containers. In certain embodiments, the at least one container is four or more containers. In certain embodiments, at least two of the containers house a medicament. In certain embodiments, at least two of the containers house a beneficial substance. In certain embodiments, at least three of the containers house a medicament. In certain embodiments, at least three of the containers house a beneficial substance. In certain embodiments, at least four of the containers house a medicament. In certain embodiments, at least four of the containers house a beneficial substance.

In certain embodiments, at least two engagement mechanisms abut the vessel. In certain embodiments, at least two engagement mechanisms abut a wall of the vessel. In certain embodiments, at least three engagement mechanisms abut the vessel. In certain embodiments, at least three engagement mechanisms abut a wall of the vessel. In certain embodiments, a plurality of engagement mechanisms abut the vessel. In certain embodiments, a plurality of engagement mechanisms abut a wall of the vessel. In certain embodiments, at least two engagement mechanisms are surface mounted to the vessel. In certain embodiments, at least two engagement mechanisms are surface mounted to a wall of the vessel. In certain embodiments, at least three engagement mechanisms are surface mounted to the vessel. In certain embodiments, at least three engagement mechanisms are surface mounted to a wall of the vessel. In certain embodiments, a plurality of engagement mechanisms are surface mounted to the vessel. In certain embodiments, a plurality of engagement mechanisms are surface mounted to a wall of the vessel.

In certain embodiments, the at least two engagement mechanisms are configured to engage at least two containers. In certain embodiments, the at least three engagement mechanisms are configured to engage at least three of the containers.

In certain embodiments, the vessel further comprising an exit port. In certain embodiments, the exit port abuts the vessel. In certain embodiments, the exit port abuts a wall of the vessel. In certain embodiments, the exit port is flush mounted to the vessel. In certain embodiments, the exit port is flush mounted to the vessel. In certain embodiments, the exit port is flush mounted to a wall of the vessel. In certain embodiments, the exit port is surface mounted to the vessel. In certain embodiments, the exit port is surface mounted to a wall of the vessel. In certain embodiments, the at least two containers are selected from the group consisting of a bottle, a bag, a syringe, a vial, a pre-loaded vial, a ready-to-assemble vial, a cartridge, and combinations thereof.

In certain embodiments, the at least two containers are designed to allow a user to double-check the identity of the beneficial substance and/or medicament housed in the containers by comprising an element selected from a group consisting of enlarged fonts, color coding, raised bumps, or protuberant.

In certain embodiments, the at least three containers are designed to allow a user to double-check the amount of the beneficial substance housed in the containers by comprising an element selected from a group consisting of enlarged fonts, color coding, raised bumps, or protuberant.

In certain embodiments, the system provides for the customization of a final amount of the beneficial substance and/or medicament that is assembled without the need to visually measure amounts of beneficial substance.

In certain embodiments, the system provides for customization of the final amount of the beneficial substance and/or medicament that is assembled without the need to manually manipulate the beneficial substance housed in the containers.

In certain embodiments, the system is modular and wherein amounts of different medicaments and/or beneficial substances are provided to the user via similar and/or different containers. In certain embodiments, the system is modular and wherein different amounts of medicaments and/or beneficial substances are provided to the user via similar and/or different containers.

In certain embodiments, the containers have different shapes and sizes and are configured to attach to the at least two entry ports of the vessel.

In certain embodiments, the at least two containers house a beneficial substance and/or medicament selected from a group consisting of a drug from Table 1 and/or Table 2 or a therapeutically equivalent formulation thereof.

In certain embodiments, at least one of the at least two containers house a beneficial substance and/or medicament in a non-standard amount. In certain embodiments, at least one of the at least two containers house a beneficial substance and/or medicament in an amount less than a standard amount.

In certain embodiments, at least one of the containers houses a beneficial substance and/or medicament in a subtherapeutic amount. In certain embodiments, at least two of the containers houses a beneficial substance and/or medicament in a subtherapeutic amount. In certain embodiments, at least three containers houses a beneficial substance and/or medicament in a subtherapeutic amount.

In certain embodiments, at least one of the containers houses a beneficial substance and/or medicament in a subtherapeutic amount for a typical patient. In certain embodiments, at least two of the containers houses a beneficial substance and/or medicament in a subtherapeutic amount for a typical patient. In certain embodiments, at least three containers houses a beneficial substance and/or medicament in a subtherapeutic amount for a typical patient. In certain embodiments, at least one of the containers houses a beneficial substance and/or medicament in an ineffective amount for a typical patient. In certain embodiments, at least two of the containers houses a beneficial substance and/or medicament in an ineffective amount for a typical patient. In certain embodiments, at least three containers houses a beneficial substance and/or medicament in an ineffective amount for a typical patient.

In certain embodiments, the at least one container is selected from a group consisting of two containers, three containers, four containers and five containers. In certain embodiments, the at least one container is a plurality of containers.

In certain embodiments, the at least two entry ports is selected from a group consisting of three entry ports, four entry ports, five entry ports, and six entry ports. In certain embodiments, the at least two entry ports are a plurality of entry ports. In one or more embodiments, the vessel has at least two exit ports. In one or more embodiments, the vessel has at least three exit ports. In one or more embodiments, the vessel has a plurality of exit ports.

In one or more embodiments, the plurality of exit ports abut the vessel. In one or more embodiments, the plurality of exit ports abut a wall of the vessel. In one or more embodiments, the plurality of exit ports abut at least two walls of the vessel. In one or more embodiments, the plurality of exit ports are flush mounted to the vessel. In one or more embodiments, the plurality of exit ports are flush mounted to a wall of the vessel. In one or more embodiments, the plurality of exit ports are surface mounted to the vessel. In one or more embodiments, the plurality of exit ports are surface mounted to a wall of the vessel. In one or more embodiments, the at least one container has at least two exit ports. In one or more embodiments, the at least one container has at least three exit ports. In one or more embodiments, the at least one container has at least four exit ports. In one or more embodiments, the at least one container has a plurality of exit ports. In one or more embodiments, the at least one container has at least two exit ports on the same wall of the at least one container. In one or more embodiments, at least two containers each have at least two exit ports. In one or more embodiments, the at least two containers each have a plurality of exit ports. In one or more embodiments, at least two containers each have at least two entry ports and at least two exit ports. In one or more embodiments, at least three containers each have at least two entry ports and at least two exit ports. In one or more embodiments, at least two containers each have a plurality of entry ports and a plurality of exit ports. In one or more embodiments, at least three containers each have a plurality of entry ports and a plurality of exit ports.

In certain embodiments, the vessel is selected from a group consisting of a bag, a bottle, or a syringe. In certain embodiments, the vessel is a cartridge.

In certain embodiments, the vessel includes a rigid surface around the at least two entry ports of the vessel. In certain embodiments, the vessel includes a rigid surface around the at least two exit ports. In certain embodiments, a surface of the vessel that supports the at least two entry ports has a greater rigidity than another surface of the vessel. In certain embodiments, the rigid surface around the at least two entry ports is of a sufficient strength to provide for a plurality of containers to engage and remain engaged to a side wall of the vessel. In certain embodiments, the rigid surface around the at least two entry ports is of a sufficient strength to provide for a plurality of containers to engage and remain engaged to a top wall of the vessel. In certain embodiments, the rigid surface around the at least two entry ports is of a sufficient strength to provide for a plurality of containers to engage and remain engaged to a bottom wall of the vessel.

In certain embodiments, the at least one exit port of the vessel is connected to an infusion line, filter, or needle.

In certain embodiments, one of the at least two entry ports is located on a surface of the vessel and another one of the at least two entry ports is located on a different surface of the vessel. In certain embodiments, the at least two entry ports are oriented randomly on one or more surfaces of the vessel.

In certain embodiments, the at least one container is selected from a group consisting of a vial, an ampule, a capsule, a cartridge, a pre-loaded vial, a pre-loaded ampule, a pre-loaded capsule, or a pre-loaded ampule.

In certain embodiments, the at least one container has an expulsion member. In certain embodiments, the expulsion member is a plunger. In certain embodiments, the at least one container is a syringe. In certain embodiments, the at least one container is a plurality of containers, wherein the plurality of containers are syringes. In certain embodiments, the at least one container is a plurality of containers, wherein the plurality of containers have an expulsion member. In certain embodiments, the at least one container is a plurality of containers, wherein the plurality of containers each have an expulsion member.

In certain embodiments, the at least one container is designed to allow the user to double check the identity and/or at least one amount by comprising an element selected from a group consisting of enlarged font written doses, color coding, raised bumps or protuberant. In certain embodiments, the at least one container is designed to allow the user to double check the identity and/or at least one amount by comprising a scanning element. In certain embodiments, the scanning element is a bar code.

In certain embodiments, at least one of the two entry ports includes a decontamination interface and/or decontamination device. In one or more embodiments, the vessel further comprises an exit port. In one or more embodiments, the exit port includes a decontamination interface and/or decontamination device.

In certain embodiments, the decontamination interface comprises: a first connection interface attached to one of the at least two entry ports of the vessel; and a second connection interface attached to the at least one container, wherein said first connection interface and said second connection interface are configured to allow for an engagement between said one of the at least two entry ports of the vessel and the at least one container, and wherein said first and second connection interfaces are further configured to externally displace from said engagement between said one of the at least two entry ports and said at least one container while a hermetically sealed connection is maintained between said first vessel and said second vessel.

In certain embodiments, the decontamination interface comprises: a first connection interface configured to be coupled to one of the at least two entry ports of the vessel; and a second connection interface configured to be coupled to the at least one container; wherein the first and second connection interfaces are configured to engage with each other and entrap contaminants, and wherein the first connection interface and the second connection interface, following said engagement, are configured to internally displace within the at least two entry ports or said at least one container, while allowing for a contaminant-free fluid passageway and hermetically sealed engagement of the vessel and the at least one container.

In certain embodiments, the decontamination interface comprises: a sliding mechanism positioned on one of the at least two entry ports of the vessel or on the at least one container, the sliding mechanism configured to allow traveling there along of the at least one container, such that the at least one container may move from a first position to a second position; and a wiping member disposed on one of the at least two entry ports of the vessel or the at least one container, said wiping member is configured to remove contaminants from a surface of one of the at least two entry ports of the vessel or the at least one container at about the time of said movement of the at least one container from said first position to said second position. In one or more embodiment, or optionally, the at least one container moves between a plurality of positions on or within the decontamination interface or decontamination device. In one or more embodiments, the wiping member is disposed within a housing of the vessel and/or the at least one container.

In certain embodiments, the decontamination interface comprises: a housing; a wiping member disposed within the housing, wherein the wiping member is configured to move within the housing; and wherein the wiping member decontaminates a surface of at least one of the at least two entry ports of the vessel or a surface of the at least one container.

In certain embodiment, the vessel having a plurality of decontamination devices.

In certain embodiments, the container includes one or more decontamination interfaces.

In certain embodiments, the decontamination interface includes a displaceable plate having a first plate part and a second plate part, and wherein the system is configured to allow: sealing the first container or device with the first plate part; sealing the second container or device with the second plate part; purging air at the interface while moving the displaceable plate.

In certain embodiments, the decontamination interface and/or device is selected from a group consisting of external displacement, internal displacement, moveable wiper, static wiper.

In certain embodiments, the decontamination interface abuts a wall of the container. In certain embodiments, the decontamination interface is flush mounted to the container. In certain embodiments, the decontamination interface is surface mounted to the container. In certain embodiments, the decontamination device abuts a wall of the container. In certain embodiments, the decontamination device is flush mounted to a wall of the container. In certain embodiments, the decontamination device is surface mounted to a wall of the container.

In certain embodiments, the at least one amount is selected from a group consisting of a drug from Table 1 or a therapeutically equivalent formulation/salt thereof. In certain embodiments, the at least one amount is selected from a group consisting of a drug from Table 2 or a therapeutically equivalent formulation/salt thereof.

In certain embodiments, the amount is in a non-standard amount or an amount not typically provided in a commercially packaged container.

In certain embodiments, the at least one container includes an amount of a drug or a therapeutically equivalent formulation thereof in an amount less than 10% of a drug set forth in Table 1 Column A or Table 2 Column A, less than 20% of a drug set forth in Table 1 Column A or Table 2 Column A, less than 30% of a drug set forth in Table 1 Column A or Table 2 Column A, less than 40% of a drug set forth in Table 1 Column A or Table 2 Column A, or less than 50% of a drug set forth in Table 1 Column A or Table 2 Column A.

In certain embodiments, a second container includes an amount of a drug or a therapeutically equivalent formulation thereof in an amount less than 10% of a drug set forth in Table 1 Column A or Table 2 Column A, less than 20% of a drug set forth in Table 1 Column A or Table 2 Column A, less than 30% of a drug set forth in Table 1 Column A or Table 2. Column A, less than 40% of a drug set forth in Table 1 Column A or Table 2 Column A, or less than 50% of a drug set forth in Table 1 Column A or Table 2 Column A.

In certain embodiments, a third container includes an amount of a drug or a therapeutically equivalent formulation thereof in an amount less than 10% of a drug set forth in Table 1 Column A or Table 2 Column A, less than 20% of a drug set forth in Table 1 Column A or Table 2 Column A, less than 30% of a drug set forth in Table 1 Column A or Table 2 Column A, less than 40% of a drug set forth in Table 1 Column A or Table 2 Column A, or less than 50% of a drug set forth in Table 1 Column A or Table 2 Column A.

In certain embodiments, a fourth container includes an amount of a drug or a therapeutically equivalent formulation thereof in an amount less than 10% of a drug set forth in Table 1 Column A or Table 2 Column A, less than 20% of a drug set forth in Table 1 Column A or Table 2 Column A, less than 30% of a drug set forth in Table 1 Column A or Table 2 Column A, less than 40% of a drug set forth in Table 1 Column A or Table 2 Column A, or less than 50% of a drug set forth in Table 1 Column A or Table 2 Column A.

In certain embodiments, a fifth container includes an amount of the least one amount or a therapeutically equivalent formulation thereof in an amount less than 10% of a drug set forth in Table 1 Column A or Table 2 Column A, less than 20% of a drug set forth in Table 1 Column A or Table 2 Column A, less than 30% of a drug set forth in Table 1 Column A or Table 2 Column A, less than 40% of a drug set forth in Table 1 Column A or Table 2 Column A, or less than 50% of a drug set forth in Table 1 Column A or Table 2 Column A.

In certain embodiments, another container includes an amount of the at least one dose/amount or a therapeutically equivalent formulation thereof in an amount less than or greater than a standard prepackaged commercially available amount as set forth in Tables 1 and 2.

In certain embodiments, the system provides for customization of the amount within the vessel.

In certain embodiments, the system is modular and wherein amounts of different medicaments are provided to the user via different containers.

In certain embodiments, the containers have different shapes and sizes and are configured to attach to the at least two entry ports of the vessel.

In another aspect, the present invention provides a method for adding at least one amount of a medicament and/or a beneficial substance to a vessel, the method comprising: providing a vessel including at least two entry ports and at least one exit port; providing at least one container including at least one amount of a medicament; connecting the at least one container to one of the at least two entry ports of the vessel; wherein the at least one container is directly received and engaged by one of the at least two entry ports of the vessel; and transferring the at least one amount of a medicament in the at least one container to the vessel.

In certain embodiments, the at least one container is selected from a group consisting of two containers, three containers, four containers and five containers. In certain embodiments, the method further comprises connecting two of the containers to the vessel and transferring the contents of the two containers into the vessel. In certain embodiments, the method further comprises connecting three of the containers to the vessel and transferring the contents of the three containers into the vessel. In certain embodiments, the method further comprises connecting four containers to the vessel and transferring the contents of the four containers into the vessel. In certain embodiments, the method further comprises connecting five containers to the vessel and transferring the contents of the five containers into the vessel. In certain embodiments, the method further comprises connecting six or more containers to the vessel and transferring the contents of the six or more containers into the vessel.

In certain embodiments, the at least one amount is in a non-standard amount. In certain embodiments, the at least one container is a plurality of containers, wherein each of the plurality of containers houses a medicament and/or beneficial substance in a non-standard amount.

In certain embodiments, the at least one container is two containers, wherein each of the two containers houses a medicament and/or beneficial substance in a non-standard amount. In certain embodiments, the at least one container is three containers, wherein each of the three containers houses a medicament and/or beneficial substance in a non-standard amount. In certain embodiments, the at least one container is four containers, wherein each of the four containers houses a medicament and/or a beneficial substance in a non-standard amount. In certain embodiments, the at least one container is five containers, wherein each of the five containers houses a medicament and/or beneficial substance in a non-standard amount.

In certain embodiments, the at least one container is a plurality of containers, wherein at least one container houses a medicament and/or beneficial substance in a standard amount and wherein at least one container houses a medicament and/or a beneficial substance in a non-standard amount.

In certain embodiments, at least two of the containers may be stacked one upon the other. In certain embodiments, at least three of the containers may be stacked one upon the other. In certain embodiments, at least four of the containers may be stacked one upon the other. In certain embodiments, at least five of the containers may be stacked one upon the other. In certain embodiments, a plurality of the containers may be stacked one upon the other. In certain embodiments, the stacking of the containers is in a vertical configuration, wherein a force of gravity pulls the contents of the containers downward towards an exit port.

In certain embodiments, the stacking of the containers may be in a vertical and horizontal configuration. In certain embodiments, the connection of a plurality of containers to one another may be in a randomized configuration.

In certain embodiments, the vessel is selected from a group consisting of a bag, a bottle, or a syringe. In certain embodiments, the vessel may be a container. In certain embodiments, the vessel may be a container similar to the at least one container.

In certain embodiments, the at least one exit port of the vessel is connected to an infusion line, filter, connector, decontamination device or needle.

In certain embodiments, the at least one container is selected from a group consisting of a vial, an ampule, a capsule, a cartridge, a pre-loaded vial, a pre-loaded ampule, a pre-loaded capsule, or a pre-loaded ampule.

In certain embodiments, at least one of the two entry ports includes a decontamination interface. In one or more embodiments, at least two entry ports are coupled to a decontamination device or decontamination interface.

In certain embodiments, the connection between the vessel and the at least one container includes a decontamination interface, the decontamination interface comprises: a first connection interface attached to one of the at least two entry ports of the vessel; and a second connection interface attached to the at least one container, wherein said first connection interface and said second connection interface are directly received and engaged between said one of the at least two entry ports of the vessel and the at least one container, and wherein said first and second connection interfaces are externally displaced from said engagement between said one of the at least two entry ports and said at least one container while a hermetically sealed connection is maintained between said one of the at least two entry ports and said at least one container.

In certain embodiments, the decontamination interface comprises: a first connection interface is coupled to one of the at least two entry ports of the vessel; and a second connection interface is coupled to the at least one container; wherein the first and second connection interfaces are engaged with each other and entrap contaminants, and wherein the first connection interface and the second connection interface, following said engagement, are internally displaced within the at least two entry ports or said second at least one container, while providing for a contaminant-free fluid passageway and hermetically sealed engagement of the vessel and the at least one container.

In certain embodiments, the at least one container is selected from a group consisting of two containers, three containers, four containers and five containers.

In certain embodiments, the at least two entry ports is selected from a group consisting of three entry ports, four entry ports, five entry ports, and six entry ports.

In another aspect, the present invention is directed to a method of decontaminating a modular assembly system for beneficial substances, comprising: providing a vessel having a plurality of decontamination devices; providing a plurality of containers; and coupling the plurality of containers to the plurality of decontamination devices.

In certain embodiments, the method comprises decontaminating the surfaces of a plurality of containers. In certain embodiments, the plurality of containers are attached to the plurality of decontamination devices sequentially.

In certain embodiments, the plurality of containers are attached to the plurality of decontamination devices randomly.

In certain embodiments, the surfaces of the containers are decontaminated sequentially. In certain embodiments, the surfaces of the containers are decontaminated in a random order.

In certain embodiments, the method further comprises moving a wiping member across a plurality of housings of the decontamination devices. In certain embodiments, the method further comprises moving a plurality of the containers between a plurality of compartments of the decontamination devices.

In another aspect, the present invention is directed to a syringe comprising: at least two entry ports and at least one exit port, the syringe configured to receive at least one container including at least one amount of a medicament; wherein the at least one container is configured to be directly received and engaged by one of the at least two entry ports of the syringe, wherein upon connection of the at least one container to the one of the at least two entry ports of the syringe, the at least one amount in the at least one container is transferred into the syringe.

In another aspect, the present invention provides a system for assembling a beneficial substance, the system comprising: a vessel having at least two entry ports configured to directly receive and engage at least two containers; at least two containers configured to be directly received and engaged by the at least two entry ports of the vessel, wherein the at least two containers house a beneficial substance; wherein upon engagement of the at least two containers to the at least two entry ports of the vessel, the beneficial substance housed in the at least two containers is transferred into the vessel.

In certain embodiments, the at least two entry ports of the vessel abut a wall of the vessel. In certain embodiments, the at least two entry ports of the vessel are flush mounted or are surface mounted to a wall of the vessel. In certain embodiments, the vessel is a bag, bottle, syringe or combinations thereof.

In certain embodiments, the vessel has at least three entry ports. In certain embodiments, the engagement between the at least two entry ports of the vessel and the at least two containers is selected from a thread-luer mechanism, a ratchet teeth mechanism, an adhesive mechanism, a slide-on mechanism and a snap-on mechanism.

In certain embodiments, the vessel includes a rigid surface around the at least two entry ports of the vessel.

In certain embodiments, a surface of the vessel that supports the at least two entry ports has a greater rigidity than another surface of the vessel.

In certain embodiments, the at least two containers have a decontamination device. In certain embodiments, the decontamination device is selected from the group consisting of external displacement, internal displacement, static wiper, and moveable wiper decontamination device. In certain embodiments, the vessel has at least two decontamination devices configured to establish a contaminant-free engagement between the at least two entry ports of the vessel and the at least two containers. In certain embodiments, the at least two decontamination devices are attached to the at least two entry ports of the vessel. In certain embodiments, the at least two decontamination devices abut a wall of the vessel. In certain embodiments, the at least two decontamination devices are flush mounted or are surface mounted to a wall of the vessel.

In certain embodiments, the vessel further comprises an exit port. In certain embodiments, the exit port of the vessel is connected to an infusion line, a filter, or a needle. In certain embodiments, the exit port is connected to a decontamination device.

In certain embodiments, at least one container of the at least two containers houses an amount of a beneficial substance or a therapeutically equivalent formulation thereof in an amount less than about 5% of a drug set forth in Table 1 Column A or Table 2 Column A, less than about 10% of a drug set forth in Table 1 Column A or Table 2 Column A, less than about 15% of a drug set forth in Table 1 Column A or Table 2 Column A, less than about 20% of a drug set forth in Table 1 Column A or Table 2 Column A, or less than about 25% of a drug set forth in Table 1 Column A or Table 2 Column A.

In certain embodiments, at least one container of the at least two containers houses an amount of a beneficial substance or a therapeutically equivalent formulation thereof in an amount less than about 30% of a drug set forth in Table 1 Column A or Table 2 Column A, less than about 35% of a drug set forth in Table 1 Column A or Table 2 Column A, less than about 40% of a drug set forth in Table 1 Column A or Table 2 Column A, or less than about 50% of a drug set forth in Table 1 Column A or Table 2 Column A.

In certain embodiments, a second container of the at least two containers houses an amount of a beneficial substance or a therapeutically equivalent formulation thereof in an amount less than about 5% of a drug set forth in Table 1 Column A or Table 2 Column A, less than about 10% of a drug set forth in Table 1 Column A or Table 2 Column A, less than about 15% of a drug set forth in Table 1 Column A or Table 2 Column A, less than about 20% of a drug set forth in Table 1 Column A or Table 2 Column A, or less than about 25% of a drug set forth in Table 1 Column A or Table 2 Column A.

In certain embodiments, a second container of the at least two containers houses an amount of a beneficial substance or a therapeutically equivalent formulation thereof in an amount less than about 30% of a drug set forth in Table 1 Column A or Table 2 Column A, less than about 35% of a drug set forth in Table 1 Column A or Table 2 Column A, less than about 40% of a drug set forth in Table 1 Column A or Table 2 Column A, or less than about 50% of a drug set forth in Table 1 Column A or Table 2 Column A.

In another aspect, the present invention provides a system for the assembly of a beneficial substance, the system comprising: a vessel having at least two entry ports abutting the vessel, the at least two entry ports configured to receive at least two containers; at least two containers configured to be received by the at least two entry ports of the vessel, wherein the at least two containers are configured to be directly received by the at least two entry ports of the vessel.

In another aspect, the present invention provides a system for the assembly of a beneficial substance, the system comprising: a bag having at least two entry ports abutting the bag, the at least two entry ports configured to receive at least two containers; at least two containers configured to be received by the at least two entry ports of the bag, wherein the at least two containers are configured to be directly received by the at least two entry ports of the bag.

In another aspect, the present invention provides a first container for the assembly of a beneficial substance, the container having at least two entry ports abutting the first container, the at least two entry ports configured to receive at least two containers.

In another aspect, the present invention provides a system comprising a plurality of containers each having at least one entry port and at least one exit port, wherein the plurality of the containers are configured to engage one another in a sequential and/or randomized configuration, wherein upon and/or after engagement of the plurality of the containers, the plurality of the containers are in fluidic communication with one another.

In certain embodiments, the engagement between the plurality of the containers is an airtight engagement. In certain embodiments, the engagement between the plurality of the containers is a hermetic engagement. In certain embodiments, the engagement between the plurality of the containers is irreversible and/or permanent. In certain embodiments, the plurality of containers have a medicament, and/or a beneficial substance housed in the containers. In certain embodiments, the containers are configured to engage each other in a stacking configuration. In certain embodiments, the stacking configuration is a vertical or horizontal stacking configuration.

In certain embodiments, the engagement and fluidic communication between the plurality of the containers provides for the medicament and/or beneficial substance to flow through at least one of the containers. In certain embodiments, the engagement and fluidic communication between the plurality of the containers provides for the medicament and/or beneficial substance to flow through at least two of the containers. In certain embodiments, the engagement and fluidic communication between the plurality of the containers provides for the medicament and/or beneficial substance to flow through a plurality of the containers. In certain embodiments, a force of gravity pulls the medicament and/or beneficial substance downward through a plurality of the containers.

In certain embodiments, the system of the plurality of the containers provides for the preparation and/or administration of a customized and/or individualized amount of a medicament and/or beneficial substance.

In certain embodiments, the system of the plurality of the containers is modular. In certain embodiments, the system provides for the modular assembly of beneficial substances without manual manipulation of the beneficial substances.

In another aspect, the present invention provides a bag for the assembly of a beneficial substance, the bag having at least two entry ports abutting the bag, the at least two entry ports configured to receive at least two containers.

In certain embodiments, the bag has at least two entry ports flush mounted to the bag. In certain embodiments, the bag has at least two entry ports surface mounted to the bag. In certain embodiments, the at least two entry ports of the bag are made of a rigid material. In certain embodiments, the at least two entry ports of the bag are made of a material of sufficient strength to provide for the engagement of the at least two containers to a side wall of the bag. In certain embodiments, the at least two entry ports are a plurality of entry ports made of a material of sufficient strength to provide for the engagement and maintenance of the engagement of the plurality of containers to a side wall of the bag. In certain embodiments, the at least two entry ports of the bag are made of a glass material. In certain embodiments, the at least two entry ports of the bag are made of a metal material. In certain embodiments, the at least two entry ports of the bag are made of a plastic material. In certain embodiments, the at least two entry ports are made of a rigid plastic material.

In certain embodiments, the at least two entry ports have a thickness of at least one-eighth of an inch. In certain embodiments, the at least two entry ports have a thickness of at least one-quarter of an inch.

In certain embodiments, the at least two entry ports have a thickness of at least half an inch. In certain embodiments, the at least two entry ports of the bag have a compartment that has a pressure less than environmental or atmospheric pressure.

In certain embodiments, the at least two entry ports of the bag have a compartment that has a pressure less than the pressure of the at least two containers. In certain embodiments, the at least two entry ports of the bag have a compartment that houses a sterilizing and/or disinfecting substance. In certain embodiments, the at least two entry ports of the bag are sealed and/or covered. In certain embodiments, the seal and/or cover is a displaceable or a frangible seal and/or cover.

In another aspect, the present invention provides a system for the assembly of a beneficial substance, the system comprising:

a vessel having at least two entry ports flush mounted to the vessel, the at least two entry ports configured to receive at least two containers; at least two containers configured to be received by the at least two entry ports of the vessel, wherein the at least two containers are configured to be directly received by the at least two entry ports of the vessel.

In another aspect, the present invention provides a system for the assembly of a beneficial substance, the system comprising: a bag having at least two entry ports surface mounted to the bag, the at least two entry ports configured to receive at least two containers; at least two containers configured to be received by the at least two entry ports of the bag; wherein the at least two containers are configured to be directly received by the at least two entry ports of the bag.

In another aspect, the present invention provides a system for the assembly of a beneficial substance, the system comprising: a bag having at least two entry ports, the at least two entry ports configured to receive at least two connectors; at least two connectors configured to be received by the at least two entry ports of the bag; and at least two containers configured to be received by the at least two connectors; wherein the at least two connectors are received and engaged to the at least two entry ports of the bag and wherein the at least two containers are received and engaged to the at least two connectors a fluidic communication is established between the at least two containers and the at least two entry ports of the bag.

In certain embodiments, the at least two connectors have at least one decontamination device disposed on the connector. In certain embodiments, the at least two connectors have at least two decontamination devices disposed on the connector.

In certain embodiments, the at least two connectors have at least one displaceable interface or surface. In certain embodiments, the at least two connectors have at least two displaceable interfaces or surfaces. In certain embodiments, the at least two containers have a displaceable interface or surface. In certain embodiments, the at least two entry ports have a displaceable interface or surface. In certain embodiments, the at least two connectors have a decontamination device attached to the connectors. In certain embodiments, the at least two entry ports have a decontamination device attached to the entry ports. In certain embodiments, the at least two containers have a decontamination device attached to the entry ports. In certain embodiments, the at least two connectors each have a conduit disposed within the connector for providing a fluidic passageway between the at least two containers and the bag.

In another aspect, the present invention provides a vessel for the assembly of a beneficial substance, the vessel having at least two entry ports flush mounted to the vessel, the at least two entry ports configured to receive at least two containers and/or connectors.

In another aspect, the present invention provides a bag for the assembly of a beneficial substance, the bag having at least two entry ports flush mounted to the bag, the at least two entry ports configured to receive at least two containers and/or connectors. In another aspect the present invention provides a vessel for the assembly of a beneficial substance, the vessel having at least two entry ports surface mounted to the vessel, the at least two entry ports configured to receive at least two containers and/or at least two connectors. In another aspect the present invention provides a bag for the assembly of a beneficial substance, the bag having at least two entry ports surface mounted to the bag, the at least two entry ports configured to receive at least two containers and/or at least two connectors.

In another aspect, the present invention provides a system for the assembly of a beneficial substance, the system comprising: a syringe having at least two entry ports, the at least two entry ports configured to receive at least two containers; and at least two containers configured to be received by the at least two entry ports of the syringe.

In certain embodiments, the at least two entry ports abut the syringe. In certain embodiments, the at least two entry ports are flush mounted to the syringe. In certain embodiments, the at least two entry ports are surface mounted to the syringe. In certain embodiments, at least one of the at least two containers house a beneficial substance and/or medicament in a non-standard amount. In certain embodiments, the at least two containers house a beneficial substance and/or medicament in a non-standard amount.

In another aspect, the present invention provides a system for the assembly of a beneficial substance, the system comprising: a syringe having at least two entry ports flush mounted to the syringe, the at least two entry ports configured to receive at least two containers; and at least two containers configured to be received by the at least two entry ports of the syringe.

In another aspect, the present invention provides a syringe for the assembly of a beneficial substance, the syringe having at least two entry ports abutting the syringe, the at least two entry ports configured to receive at least two containers.

In another aspect, the present invention provides a syringe for the assembly of a beneficial substance, the syringe having at least two entry ports flush mounted to the syringe, the at least two entry ports configured to receive at least two containers. In another aspect, the present invention provides a syringe for the assembly of a beneficial substance, the syringe having at least two entry ports surface mounted to the syringe, the at least two entry ports configured to receive at least two containers.

In another aspect, the present invention provides a syringe for the assembly of a beneficial substance, the syringe having at least one entry port and at least one exit port, the at least one entry port configured to receive at least one container. In another aspect, the present invention provides a syringe for the assembly of a beneficial substance, the syringe having at least one entry port, the at least one entry port configured to receive at least one container. In another aspect, the present invention provides a syringe for the assembly of a beneficial substance, the syringe having at least one entry port, the at least one entry port configured to directly receive at least one container. In another aspect, the present invention provides a syringe for the assembly of a beneficial substance, the syringe having at least two entry ports, the at least two entry ports configured to receive at least two containers. In another aspect, the present invention provides a syringe for the assembly of a beneficial substance, the syringe having at least two entry ports, the at least two entry ports configured to directly receive at least two containers. In another aspect, the present invention provides a syringe for the assembly of a beneficial substance, the syringe having at least one entry port and one exit port, the at least one entry port configured to receive a connector. In another aspect, the present invention provides a syringe for the assembly of a beneficial substance, the syringe having at least two entry ports, the at least two entry ports configured to receive at least two connectors.

In another aspect, the present invention provides a syringe having at least one decontamination device. In another aspect, the present invention provides a syringe with plurality of decontamination devices. In another aspect, the present invention provides a syringe with a plurality of entry ports and a plurality of decontamination devices.

In another aspect, the present invention provides a syringe with at least two decontamination devices covering at least two entry ports. In another aspect, the present invention provides a container with an expulsion member having at least two entry ports, the entry ports configured to engage at least two containers. In another aspect the present invention provides a container with an expulsion member having at least two entry ports, the entry ports configured to engage at least two connectors. In another aspect, the present invention provides a container having an expulsion member, at least two entry ports, and at least two displaceable interfaces and/or surfaces. In another aspect, the present invention provides a container having an expulsion member, at least two entry ports, and at least two decontamination devices. In another aspect, the present invention provides a container having a decontamination device on or attached to an exit port of the container.

In certain embodiments, the container is a syringe.

In another aspect, the present invention provides a syringe having a decontamination device on or attached to an exit port of the syringe.

In another aspect, the present invention provides a system for the assembly of a beneficial substance, comprising: a bag having at least one piercing member disposed within the bag and at least one entry port, wherein the at least one entry port is configured to receive at least one container; and at least one container configured to be received by the at least one entry port of the bag.

In certain embodiments, the piercing member is disposed within a port of the bag. In certain embodiments, the piercing member is disposed within a chamber and/or compartment of the bag. In certain embodiments, the piercing member is concealed from ambient and/or environmental air. In certain embodiments, the piercing member is concealed from ambient and/or environmental air until about the time of piercing and/or actuation of the piercing member. In certain embodiments, the piercing member is a needle. In certain embodiments, the needle is a hollowed needle. In certain embodiments, the hollowed needle is configured to provide a fluidic passageway between the bag and the at least one container. In certain embodiments, the container is a vial. In certain embodiments, the container is a bottle. In certain embodiments, the container has an expulsion member.

In another aspect, the present invention provides a bag having at least one piercing member disposed within the bag and at least one entry port abutting the bag, wherein the at least one entry port is configured to receive at least one container; and at least one container configured to be received by the at least one entry port of the bag.

In certain embodiments, the piercing member is disposed within a port of the bag. In certain embodiments, the piercing member is disposed within a chamber and/or compartment of the bag. In certain embodiments, the piercing member is concealed from ambient and/or environmental air. In certain embodiments, the piercing member is concealed from ambient and/or environmental air until about the time of piercing and/or actuation of the piercing member. In certain embodiments, the piercing member is a needle. In certain embodiments, the needle is a hollowed needle. In certain embodiments, the hollowed needle is configured to provide a fluidic passageway between the bag and the at least one container.

In certain embodiments, the container is a vial. In certain embodiments, the container is a bottle. In certain embodiments, the container has an expulsion member.

In another aspect, the present invention provides a bag having at least one piercing member disposed within the bag and at least one entry port flush mounted to the bag, wherein the at least one entry port is configured to receive at least one container; and at least one container configured to be received by the at least one entry port of the bag.

In certain embodiments, the piercing member is disposed within a port of the bag. In certain embodiments, the piercing member is disposed within a chamber and/or compartment of the bag. In certain embodiments, the piercing member is concealed from ambient and/or environmental air. In certain embodiments, the piercing member is concealed from ambient and/or environmental air until about the time of piercing and/or actuation of the piercing member. In certain embodiments, the piercing member is a needle. In certain embodiments, the needle is a hollowed needle. In certain embodiments, the hollowed needle is configured to provide a fluidic passageway between the bag and the at least one container.

In certain embodiments, the container is a vial. In certain embodiments, the container is a bottle. In certain embodiments, the container has an expulsion member.

In another aspect, the present invention provides a bag having at least one piercing member disposed within the bag and at least one entry port, wherein the at least one entry port is configured to receive at least one container.

In another aspect, the present invention provides a bag having at least one piercing member disposed within the bag and at least one entry port abutting the bag, wherein the at least one entry port is configured to receive at least one container.

In another aspect, the present invention provides a bag having at least one piercing member disposed within the bag and at least one entry port surface mounted to the bag, wherein the at least one entry port is configured to receive at least one container.

In certain embodiments, the piercing member is disposed within a port of the bag. In certain embodiments, the piercing member is disposed within a chamber and/or compartment of the bag. In certain embodiments, the piercing member is concealed from ambient and/or environmental air. In certain embodiments, the piercing member is concealed from ambient and/or environmental air until about the time of piercing and/or actuation of the piercing member. In certain embodiments, the piercing member is a needle. In certain embodiments, the needle is a hollowed needle. In certain embodiments, the hollowed needle is configured to provide a fluidic passageway between the bag and the at least one container.

In certain embodiments, the container is a vial. In certain embodiments, the container is a bottle. In certain embodiments, the container has an expulsion member. In one or more embodiments, the piercing member is concealed from ambient air. In one or more embodiments, the piercing member is disposed within a port of the bag. In one or more embodiments, the piercing member is disposed within the main chamber of the bag. In one or more embodiments, the piercing member is disposed within a secondary chamber of the bag. In one or more embodiments, the bag further comprises a second piercing member disposed within the bag. In one or more embodiments, a third piercing member is disposed within the bag. In one or more embodiments, at least a fourth piercing member is disposed within the bag. In one or more embodiments, the bag has a plurality of piercing members disposed within the bag and concealed from ambient air. In one or more embodiments, the plurality of piercing members are disposed within a port of the bag. In one or more embodiments, the plurality of piercing members are disposed within the main chamber of the bag. In one or more embodiments, the plurality of piercing members are disposed within a secondary chamber of the bag.

In one or more embodiments, an actuator is in the bag and is configured to move the piercing member through a surface of the bag. In one or more embodiments, a plurality of actuators are configured to move the piercing members through a surface of the bag. In one or more embodiments, an unlocking mechanism is provided and is configured to unlock the at least one piercing member. In one or more embodiments, an unlocking mechanism is provided and is configured to unlock the at least two actuators thus allowing the actuators to move the at least two piercing members through a surface of the bag.

In one or more embodiments, an unlocking member is configured to unlock the at least one piercing member. In one or more embodiments, an unlocking member is configured to unlock the at least two actuators thus allowing the actuators to move the at least two piercing members through a surface of the bag.

In one or more embodiments, an unlocking member on bag or vial engages an unlocking mechanism on other bag or vial resulting in release of a piercing member/actuator/displaceable vessel surface or seal.

In one or more embodiments, fluidic communication cannot be established unless the unlocking member engages the unlocking mechanism. This safety feature provides for hermetic engagement first, then afterwards establishment of fluidic communication. This prevents toxic chemotherapeutic substance in a vial from prematurely being released/spilled into the environmental surroundings/ambient air.

In one or more embodiments, a plurality of piercing members are provided that are concealed from ambient air. In one or more embodiments, a plurality of piercing members are provided that are concealed from ambient air and a plurality of entry ports are configured to receive a plurality of containers. In one or more embodiments, the piercing members are needles. In one or more embodiments, the needles are hollowed needles. In one or more embodiments, the piercing members have at least one sharp surface. In one or more embodiments, the piercing member are located inside a vessel. In one or more embodiments, the piercing members are located inside the bag. In one or more embodiments, the piercing member are located within the ports of the bag. In one or more embodiments, the piercing members are located in a chamber of the bag. In one or more embodiments, the piercing members are located within a plurality of entry ports of the bag. In one or more embodiments, the piercing member is located within at least one entry port of the bag.

In one or more embodiments, bags/containers may have locking mechanisms that lock another container to the bag/first container. In one or more embodiments fixed locking and/or irreversible locking occurs. In one or more embodiments, first engagement and locking occurs, then hermetic seal established, then fluidic communication. In one or more embodiments, first a hermetic seal is established between the bag and the containers, then locking occurs, then fluid communication between the bag and the containers.

In one or more embodiments, bags/containers may have “unlocking” mechanisms/members that “unlock the piercing member” on the other container, so that the piercing members don't “prematurely” pierce the vessel surfaces.

In one or more embodiments, bags/containers may have unlocking members that unlock an “actuator” that moves the piercing members that are disposed in the bag/container.

In one or more embodiments, the piercing members are concealed from ambient air. In one or more embodiments, other fluidic communication mechanisms are contemplated in addition to the piercing members. In one or more embodiments, a displaceable container surface that is “unlocked” at about the time of engagement of containers. In one or more embodiments, the displaceable container is unlocked after engagement of containers. In one or more embodiments, the container surface may be unlocked by an unlocking member located on another container. In one or more embodiments, the container surface then displaces allowing for fluidic communication between containers.

In another aspect, the present invention provides a modular dosing system for adding at least amount and/or at least one dose of a medicament to a vessel or container, the system comprising: at least two containers, at least one of the at least two containers including an amount and/or dose of a medicament and/or beneficial substance; wherein each of the at least two containers are configured to be connected to at least one another one of the at least two containers, wherein upon connection of one of the at least two containers to another one of the at least two containers, the dose of medicament in one of the at least two containers is in fluid communication with the other one of the at least two containers.

In certain embodiments, at least one of the at least two containers has a decontamination interface which operates as a dual entry and exit port. In certain embodiments, at least one of the at least two containers has a decontamination interface which operates as the exit port into a device selected from the following group of an infusion line, a filter, a manifold, a connector, or a needle. In certain embodiments, the force of gravity pulls the amount of medicament into an infusion line that operates as the exit port. In certain embodiments, at least one of the at least two containers are attached to the other container having at least one of the entry ports in a vertical or horizontal manner on any side of the container.

In certain embodiments, the system is selected from a group consisting of two containers, three containers, four containers or five containers. In certain embodiments, the at least two containers are selected from a group consisting of a vial, an ampule, a capsule, a cartridge, a pre-loaded vial, a pre-loaded ampule, a pre-loaded capsule, or a pre-loaded ampule. In certain embodiments, the at least two containers are designed to allow the user to double check the dosage regimen by comprising an element selected from a group consisting of enlarged font written doses, color coding, raised bumps or protuberant located on the at least two containers.

In certain embodiments, the decontamination interface comprises: a first connection interface attached to one of the at least two entry ports of the vessel; and a second connection interface attached to the at least one container, wherein said first connection interface and said second connection interface are configured to allow for an engagement between said one of the at least two entry ports of the vessel and the at least one container, and wherein said first and second connection interfaces are further configured to externally displace from said engagement between said one of the at least two entry ports and said at least one container while a hermetically sealed connection is maintained between said first vessel and said second vessel.

In certain embodiments, the decontamination interface comprises: a first connection interface configured to be coupled to one of the at least two entry ports of the vessel; and a second connection interface configured to be coupled to the at least one container; wherein the first and second connection interfaces are configured to engage with each other and entrap contaminants, and wherein the first connection interface and the second connection interface, following said engagement, are configured to internally displace within the at least two entry ports or said at least one container, while allowing for a contaminant-free fluid passageway and hermetically sealed engagement of the vessel and the at least one container.

In certain embodiments, the dosing regimen is selected from a group consisting of various drugs set forth in Table 1 and/or Table 2, or a therapeutically equivalent formulation/salt thereof.

In certain embodiments, the dosing regimen is in a non-standard amount or an amount not provided in a commercially prepackaged container.

In another aspect, the present invention provides a method for adding one amount of a medicament to a modular dosing system, the method comprising: providing at least one container with at least one entry port and at least one exit port; providing at least one other container with at least one other exit port; connecting the at least one container with at least one entry port and at least one exit port to the at least one other container with at least one other exit port, transferring the beneficial substance or medicament from the at least one other container with at least one other exit port into the at least one container with at least one entry port and at least one exit port.

In certain embodiments, the connecting of the at least one container with at least one entry port and at least one exit port to the at least one other container with at least one other exit port, can be connected in any of the following ways or combination thereof: horizontal, vertical, lateral, normal, diagonal, longitudinal, linear, three-dimensional or other orientations.

In another aspect, the present invention provides a system for the assembly of a beneficial substance, the system comprising: a first container having at least one entry port configured to engage a second container; a second container having at least one entry port and at least one exit port, wherein the at least one entry port is configured to engage a third container and the at least one exit port is configured to engage the first container; at least a third container having at least one exit port; wherein upon engagement of the first container to the second container, and upon engagement of the second container to the third container, the contents of the third container flows into the second container and flows-through along with the contents of the second container into the first container. In one or more embodiments, the system for assembling the beneficial substance is modular by design. In one or more embodiments, a fourth container, a fifth container, or six or more containers may be provided by the system allowing a user of the system to modularly assemble any final amount of a beneficial substance and/or medicament.

In certain embodiments, the second container houses a beneficial substance, wherein the beneficial substance from the third container flows-through the second container and into the first container. In one or more embodiments, the modular system provides beneficial substances and/or medicaments in commercially packaged non-standard amounts. In one or more embodiments, commercially packaged means prepackaged. In one or more embodiments, commercially packaged means packaged by a drug/pharmaceutical manufacturer.

In another aspect, the present invention provides a system for displaying a dosing regimen or single amount of a medicament, the system comprising: a vessel including at least one entry port and at least one exit port; at least one other container including at least one dosing regimen, the amount of at least one dosing regimen being displayed upon an exterior surface of the at least one container; wherein the at least one container is configured to be received by one of the at least one entry port of the vessel; and the exterior surface of the container is configured to allow the user to easily double check and identify the contents and amounts of the dosing regimen.

In certain embodiments, the connection of the at least one container to the vessel allows for a user to view the dosing regimen written upon the exterior surface of the at least one container, so that the user is able to quickly identify the dosing regimen provided to the patient.

In certain embodiments, the displayed amounts are in non-standard amounts.

In certain embodiments, the displayed amounts are in standard amounts. In certain embodiments, the displayed amounts are in non-standard and standard amounts. In certain embodiments, the displayed amounts are in different colors to indicate different types of amounts and rapidly identify the contents of the at least one container. In certain embodiments, the displayed amounts are written on an exterior surface of the at least one container. In certain embodiments, the at least one container includes at least one protrusion including the displayed amounts.

In certain embodiments, the exterior surface contains at least one raised bump or protuberance to indicate different types of amounts and rapidly identify the contents of the at least one container. In certain embodiments, the exterior surface display contains at least one geometric shape to indicate different types of amounts and rapidly identify the contents of the at least one container. In certain embodiments, the exterior surface display reflects the said at least one container's total volume. In certain embodiments, the exterior surface display of the at least one container is demarcated with at least one line such that the amount of the dosing regimen inside can be visually compared against the at least one demarcation line for an estimate of the total volume.

In certain embodiments, the exterior surface of the vessel is demarcated with at least one line such that the amount of the dosing regimen inside can be visually compared against the at least one demarcation line for an estimate of the total volume.

In other aspects, the present invention provides a method for double checking the dosage container contents in a dosing system, the method comprising the steps of: providing at least one container designed to be modular and part of a potential plurality of containers, hence the necessity for double checking dosage; providing an exterior surface of a container with an amount of medicament whose contents indicated by at least one item selected from the following group or a combination thereof: markings, letters, numbers, physical bumps and indentations, or colorings that are legible to the naked human eye.

In other aspects, the present invention provides a method for double checking the identity container contents in a dosing system, the method comprising the steps of: providing at least one container designed to be modular and part of a potential plurality of containers, hence the necessity for double checking identity; providing an exterior surface of a container with an amount of medicament whose contents indicated by at least one item selected from the following group or a combination thereof: markings, letters, numbers, physical bumps and indentations, or colorings that are legible to the naked human eye.

In certain embodiments, the contents indication is inverted.

In other aspects, the present invention provides a plurality of entry ports abutting a wall of a container. In certain embodiments a plurality of entry ports are flush mounted to a wall of a container. In certain embodiments, a plurality of entry ports are surface mounted to a wall of a container.

In certain embodiments, a plurality of engagement mechanisms abut a wall of the container, are surface mounted to the container or are flush mounted to the container. In certain embodiments, the engagement mechanisms are selected from a group consisting of threads, a luers, smart sites, ratchet teeth, etc.

In other aspects, the present invention provides a plurality of decontamination devices abutting, flush mounted, or surface mounted to a wall of a container.

In other aspects, the present invention provides a system for the modular assembly of a beneficial substance, comprising: a vessel having a plurality of openings configured to couple with a plurality of containers; a plurality of containers having a decontamination device, wherein the containers are configured to couple with the vessel.

In certain embodiments, the plurality of containers house a medicament. In certain embodiments, at least one of the containers houses a medicament in a nonstandard amount. In certain embodiments, at least two of the containers houses a medicament in a nonstandard amount.

In certain embodiments, the vessel is a bag. In certain embodiments, the vessel is a bottle. In certain embodiments, the containers are bottles or bags. In certain embodiments, the containers are vials.

In certain embodiments, the decontamination devices are integrally manufactured with the containers. In certain embodiments, the decontamination devices form a unitary structure with the containers.

In certain embodiments, the coupling between the plurality of containers and the vessel forms an airtight coupling.

In certain embodiments, a first container housing a drug or a pharmaceutically equivalent formulation thereof in an amount less than about 5% of a Table 1 Column A amount, in an amount less than about 10% of a Table 1 Column A amount, in an amount less than 20% of a Table 1 Column A amount, less than about 30% of a Table 1 Column A amount, or less than about 50%of a Table 1 Column A amount.

In certain embodiments, a second container houses a drug or a pharmaceutically equivalent formulation thereof in an amount less than about 5% of a Table 1 Column A amount, in an amount less than about 10% of a Table 1 Column A amount, in an amount less than 20% of a Table 1 Column A amount, less than about 30% of a Table 1 Column A amount, or less than about 50% of a Table 1 Column A amount.

In certain embodiments, a third container houses a drug or a pharmaceutically equivalent formulation thereof in an amount less than about 5% of a Table 1 Column A amount, in an amount less than about 10% of a Table 1 Column A amount, in an amount less than 20% of a Table 1 Column A amount, less than about 30% of a Table 1 Column A amount, or less than about 50% of a Table 1 Column A amount.

In certain embodiments, a fourth container houses a drug or a pharmaceutically equivalent formulation thereof in an amount less than about 5% of a Table 1 Column A amount, in an amount less than about 10% of a Table 1 Column A amount, in an amount less than 20% of a Table 1 Column A amount, less than about 30% of a Table 1 Column A amount, or less than about 50% of a Table 1 Column A amount.

In certain embodiments, a fifth container houses a drug or a pharmaceutically equivalent formulation thereof in an amount less than about 5% of a Table 1 Column A amount, in an amount less than about 10% of a Table 1 Column A amount, in an amount less than 20% of a Table 1 Column A amount, less than about 30% of a Table 1 Column A amount, or less than about 50% of a Table 1 Column A amount.

In certain embodiments, the system further comprises a second container housing a beneficial substance in a nonstandard or standard amount.

In other aspects, the present invention provides a vessel with plurality of entry ports flush mounted / surface mounted.

In other aspects, the present invention provides a system of vessels with plurality of entry ports+plurality of containers. In other aspects, the present invention provides a system of vessel with decontamination devices+plurality of containers. In other aspects, the present invention provides a system of vessel+plurality of containers with decontamination devices. In other aspects, the present invention provides a modular assembly system. In other aspects, the present invention provides a modular assembly system with decontamination devices. In other aspects, the present invention provides a syringe with plurality of ports. In other aspects, the present invention provides a syringe with plurality of decontamination devices.

In other aspects, the present invention provides a unitary multiple entry port structure configured to receive a plurality of containers.

In certain embodiments, the unitary multiple entry port structure is attached to a container.

In certain embodiments, the container is a bag.

In certain embodiments, the container is a bottle.

In certain embodiments, the unitary multiple entry port structure is integrally attached to the container.

In certain embodiments, the unitary multiple entry port structure is integrally attached to the bag.

In certain embodiments, the unitary multiple entry port structure is integrally attached to the bottle.

In certain embodiments, the unitary multiple entry port structure forms a unitary structure with a container.

In certain embodiments, the unitary multiple entry port structure forms a unitary structure with the bag.

In certain embodiments, the unitary multiple entry port structure forms a unitary structure with the bottle.

In certain embodiments, the unitary multiple entry port structure further comprising a cover.

In certain embodiments, the unitary multiple entry port structure further comprising a cover with buttons.

In certain embodiments, the unitary multiple entry port structure further comprising a plurality of buttons.

In certain embodiments, the unitary multiple entry port structure further comprising a lever.

In certain embodiments, the unitary multiple entry port structure further comprising a plurality of levers.

In certain embodiments, the cover configured to hermetically seal the unitary multiple entry port structure.

In certain embodiments, the unitary multiple entry port structure having a cover with a plurality of buttons, the buttons configured to move through the cover.

In certain embodiments, the unitary multiple entry port structure having a cover with a plurality of buttons, the buttons configured to move through the cover while the cover maintains the hermetic of the unitary multiple entry port structure.

In other aspects, the present invention provides a unitary multiple entry port structure having a cover with a plurality of buttons, the unitary multiple entry port structure configured to receive a plurality of containers and the cover configured to hermetically seal the plurality of the containers inside the unitary multiple entry port structure, the plurality of buttons configured to move through the cover to actuate expulsion of a beneficial substance from a plurality of containers.

In other aspects, the present invention provides a unitary multiple entry port structure having a cover with a plurality of levers, the unitary multiple entry port structure configured to receive a plurality of containers and the cover configured to hermetically seal the plurality of the containers inside the unitary multiple entry port structure, the plurality of the levers configured to extend through a wall of the unitary multiple port structure to engage with a plurality of plungers of the plurality of the containers to move the plungers and actuate expulsion of a beneficial substance from a plurality of containers.

In other aspects, the present invention provides a container having a plurality of protective ports.

In certain embodiments, the protective ports further comprising flaps.

In certain embodiments, the protective ports further comprising a plurality of flaps.

In certain embodiments, the flaps configured to hermetically seal a container inside the protective ports.

In certain embodiments, the plurality of the flaps configured to hermetically seal a plurality of containers inside the protective ports.

In certain embodiments, the protective ports further comprising covers.

In certain embodiments, the plurality of the protective ports further comprising a plurality of covers.

In certain embodiments, the covers configured hermetically seal a container inside the protective ports.

In certain embodiments, the covers configured to hermetically seal a plurality of containers inside a plurality of the protective ports.

In certain embodiments, the protective ports are configured to engulf containers.

In certain embodiments, the protective ports are configured to entirely engulf containers.

In certain embodiments, the protective ports are made of a rigid material.

In certain embodiments, the rigid material is a plastic, a metal allow, a glass material, and combinations thereof.

In certain embodiments, the protective ports further comprise a port closure mechanism.

In other aspects, the present invention provides a container having at least one entry port, the at least one entry port including a protective peripheral wall enclosing cavity, the protective peripheral wall enclosing cavity configured to receive at least one container and engulf thereof, thereby providing a protective entry port structure.

In certain embodiments, the container is a bag.

In certain embodiments, the container is a bottle.

In certain embodiments, the container is a syringe.

In certain embodiments, the protective entry port structure further comprises a cover.

In certain embodiments, the cover configured to hermetically seal the protective entry port structure.

In certain embodiments, the cover is at least one flap.

In certain embodiments, the cover comprises two flaps.

In certain embodiments, the cover further comprising at least one actuator configured to move through the cover.

In certain embodiments, the at least one actuator is a button.

In certain embodiments, the cover further comprising a button configured to move through a wall of the cover.

In certain embodiments, the cover further comprising at least one button configured to move through a wall of the cover.

In certain embodiments, the cover further comprising a plurality of buttons configured to move through a wall of the cover.

In certain embodiments, the buttons when pushed inwards towards the container are configured to move a plunger of the container disposed inside the protective peripheral wall enclosing cavity.

In certain embodiments, the interior wall of the entry port facing the interior of the protective peripheral wall enclosing cavity further comprising an engagement mechanism configured to engage a container that will enter the protective peripheral wall enclosing cavity.

In certain embodiments, the engagement mechanism is a thread configured to engage a complimentary thread disposed on an exterior surface of the container that will enter the peripheral wall enclosing cavity.

In certain embodiments, the at least one entry port further comprising a cover configured to hermetically seal a container inside the protective peripheral wall enclosing cavity.

In certain embodiments, the protective peripheral wall enclosing cavity is made from a plastic material, a metal alloy, a glass material, and combinations thereof.

In other aspects, the present invention provides a unitary multiple entry port structure having a cover, the unitary multiple entry port structure configured to receive a plurality of containers and the cover configured to hermetically seal the plurality of the containers inside the unitary multiple entry port structure.

In certain embodiments, the unitary multiple entry port structure has a plurality of entry ports configured to allow entry of a plurality of containers inside the unitary multiple entry port structure.

In certain embodiments, the unitary multiple entry port structure further comprising an engagement mechanism configured to engage with an engagement mechanism of a container.

In certain embodiments, the engagement mechanism of the unitary multiple entry port structure is a hook.

In certain embodiments, the hook is configured to engage and/or couple to a pin on a container.

In certain embodiments, the engagement mechanism of the container is a pin.

In certain embodiments, the pin of the container is configured to engage and/or couple with the hook of the unitary multiple entry port structure.

In certain embodiments, the container is a bag or a bottle.

In certain embodiments, the unitary multiple entry port structure is a connector.

In certain embodiments, the unitary multiple entry port structure is a manifold.

In other aspects, a method is provided for preparing an amount of a beneficial substance, the method comprising:
providing a unitary multiple entry port structure configured to allow entry of a plurality of containers;
providing a plurality of containers containing a beneficial substance;
providing a bag configured to couple with the unitary multiple entry port structure; and
connecting the unitary multiple entry port structure to the bag.
In certain embodiments of the method, the unitary multiple entry port structure further comprising an engagement mechanism configured to engage and/or couple to the bag.
In certain embodiments of the method, the bag further comprising an engagement mechanism configured to engage and/or couple to the unitary multiple entry port structure.
In certain embodiments, the method further comprising engaging/coupling the unitary multiple entry port structure with the bag.
In certain embodiments, the method further comprising establishing a fluidic communication between the plurality of the containers disposed inside the unitary multiple entry port structure and the bag.
In certain embodiments, at least one of the bag and the unitary multiple entry port structure further comprising a piercing member configured to pierce through a surface of at least one of the plurality of the containers.
In certain embodiments, the method further comprising the piercing member piercing through a surface of at least one of the plurality of the containers.

In other aspects, a method is provided wherein a plurality of containers housing a beneficial substance are provided, the plurality of the container are then placed inside a unitary multiple entry port structure, then a cover seals the plurality of the containers inside the unitary multiple entry port structure, then the unitary multiple entry port structure is coupled to a bag, optionally a bottle, then fluidic communication is established between the plurality of the containers located inside the unitary multiple entry port structure and the bag or bottle. In certain embodiments, the establishment of the fluidic communication between the plurality of the containers and the bag or bottle is mediated via a piercing member and/or valve which may be disposed in/on at least one of unitary multiple entry port structure and bag/bottle. In certain embodiments, coupling between unitary multiple entry port structure and bag/bottle may be mediated via a hook-pin engagement mechanism, a ratchet teeth mechanism, a thread-complimentary thread mechanism, and combinations thereof. In certain embodiments, the unitary multiple entry port structure is a connector. In certain embodiments, the unitary multiple entry port structure is a manifold. In certain embodiments, the cover hermetically seals the plurality of the containers inside the unitary multiple entry port structure/connector/manifold. In certain embodiments, the unitary multiple entry port structure/connector/manifold further comprising a cover having at least one button configured to move through the cover to push at least one plunger of the plurality of the containers thus expelling any contents contained in at least one of the containers from the containers into the bag/bottle.

In other aspects, the present invention provides a system for intermixing beneficial substances, comprising:
a first container having a unitary multiple entry port structure, the unitary multiple entry port structure configured to receive a plurality of containers and engulf thereof, the unitary multiple port structure further comprising a cover configured to seal the plurality of the containers inside the unitary multiple entry port structure, thereby providing a protective entry port structure; and
a plurality of containers containing a beneficial substance, the plurality of the containers configured to enter the unitary multiple entry port structure,
wherein upon entry of the plurality of the containers inside the unitary multiple entry port structure, the plurality of the containers are completely enclosed inside the unitary multiple entry port structure thus providing for leak-free establishment of fluidic communication between the plurality of the first container and the plurality of the containers.

In certain embodiments, the cover is configured to hermetically seal the unitary multiple entry port structure.

In certain embodiments, the port unitary cover is configured to hermetically seal the plurality of the containers inside the unitary multiple entry port structure when the port unitary cover is in a closed position.

In certain embodiments, the unitary multiple entry port structure further comprising at least one button configured to move through the cover.

In certain embodiments, the unitary multiple entry port structure further comprising a plurality of buttons configured to move through the cover to actuate movement of a plurality of plungers of the plurality of the containers.

In certain embodiments, the plurality of the containers having a plunger.

In certain embodiments, the unitary multiple entry port structure further comprising at least one lever disposed through the unitary multiple entry port structure, the at least one lever configured to engage at least one plunger of the plurality of the containers and to move at least one plunger of the plurality of the containers.

In certain embodiments, the unitary multiple entry port structure further comprising at least one negative pressure compartment.

In certain embodiments, the unitary multiple entry port structure has at least one conduit connecting the at least one negative pressure compartment with the interior of the unitary multiple entry port structure.

In certain embodiments, the unitary multiple entry port structure further comprising a valve disposed inside or covering the conduit.

In certain embodiments, the unitary multiple entry port structure includes a peripheral wall enclosing cavity configured to receive the plurality of the containers and engulf thereof, thereby providing a protective entry port structure.

In certain embodiments, the unitary multiple entry port structure includes at least one conduit fluidly connecting the first container to the plurality of the containers.

In certain embodiments, the first container is a bag or a bottle.

In certain embodiments, the plurality of the containers are selected from a group consisting of a bottle, a syringe, and a container with a plunger.

In certain embodiments, the at least one negative pressure compartment having a lower pressure than ambient air pressure.

In certain embodiments, the cover includes a cover closure mechanism for locking the cover to the unitary multiple entry port structure.

In certain embodiments, the cover closure mechanism is selected from a group consisting of flaps, pin-slot, latch-slot, latch protrusion, and hook-slot.

In certain embodiments, the unitary multiple entry port structure further comprising at least one decontamination device.

In certain embodiments, the decontamination device comprises a wiping member disposed inside the unitary multiple entry port structure, the wiping member configured to move within the unitary multiple entry port structure to wipe of a surface of at least one of the plurality of the containers.

In certain embodiments, the unitary multiple entry port structure further comprises a plurality of cap members configured to couple with a plurality of cap members of the plurality of the containers, wherein after coupling the plurality of the cap members of the unitary multiple entry port structure with the plurality of the cap members of the plurality of the containers the coupled cap members entrap contaminants between the coupled cap members and displace internally into the first container providing a contaminant-free engagement of the plurality of the containers to the first container.

In certain embodiments, the unitary multiple entry port structure further comprises a plurality of decontamination interfaces and the plurality of the containers further comprise a plurality of decontamination interfaces, wherein upon engagement of the plurality of the decontamination interfaces of the unitary multiple entry port structure with the plurality of the decontamination interfaces of the plurality of the containers the engaged decontamination interfaces displace external to the unitary multiple entry port structure through an aperture in the unitary multiple entry port structure.

In certain embodiments, the unitary multiple entry port structure is surface mounted to the first container.

In certain embodiments, the unitary multiple entry port structure abuts the first container.

In certain embodiments, the unitary multiple entry port structure is flush mounted to the first container.

In certain embodiments, the first container further comprising a peripheral wall enclosing a cavity configured to receive at least one of the plurality of the containers and engulf thereof, thereby providing a protective entry port structure.

In certain embodiments, the first container further comprising a peripheral wall enclosing a cavity configured to receive a plurality of the containers and engulf thereof, thereby providing a protective entry port structure.

In certain embodiments, the first container further comprising a peripheral wall enclosing a cavity configured to receive a plurality of the containers and completely engulf thereof, thereby providing a protective entry port structure.

In certain embodiments, the cover is in a closed position the plurality of the containers are completely enclosed inside the unitary multiple entry port structure and any vapor and/or fluid leaks produced from the fluidic communication between the first container and the plurality of the containers is contained inside the unitary multiple entry port structure.

In certain embodiments, the cover are flaps.

In certain embodiments, the unitary multiple entry port structure further comprises a plurality of piercing members configured to pierce through a surface of at least one of the first container and the plurality of the containers.

In certain embodiments, the unitary multiple entry port structure further comprising a rail mechanism configured to allow the cover to move along the rail mechanism to seal the plurality of the containers inside the unitary multiple entry port structure.

In certain embodiments, the unitary multiple entry port structure further comprising a hinge mechanism configured to allow the cover to move from an open position to a closed position.

In certain embodiments, the unitary multiple entry port structure further comprising a plurality of plunger unlock mechanisms in the form of rods and the plurality of the containers further comprising plunger lock mechanisms configured to be unlocked by the rods, wherein upon engagement of the rods to the plunger lock mechanisms the plunger lock mechanisms are unlocked thus allowing the plungers of the plurality of the containers to move.

In certain embodiments, the unitary multiple entry port structure further comprising at least one button lock mechanism configured to maintain the plurality of the buttons in an extended position until about the time and/or after the cover is in a closed position at which time the at least one button lock mechanism is unlocked thus allowing movement of buttons through the cover.

In certain embodiments, the unitary multiple entry port structure further comprising a piercing member lock mechanism configured to lock piercing members and wherein the plurality of the containers further comprising piercing member unlock mechanisms configured to unlock the piercing members at about the time or after entry of the plurality of the containers inside the unitary multiple entry port structure.

In certain embodiments, the unitary multiple entry port structure further comprising at least one valve.

In certain embodiments, the unitary multiple entry port structure further comprising a plurality of valves.

In certain embodiments, the valves configured to engage at least one container.

In certain embodiments, the valves configured to engage a plurality of containers.

In certain embodiments, the unitary multiple entry port structure further comprising a valve unlock mechanism, the valve unlock mechanism configured to open the valve, the valve unlock mechanism configured to be actuated by closure of the cover.

In certain embodiments, the unitary multiple entry port structure further comprising at least one lever lock mechanism in the form of a retractable pin, the retractable pin configure to prevent the lever from moving until after the plurality of the containers have been placed inside the unitary multiple entry port structure and after the cover is in a closed position sealing the plurality of the containers inside the unitary multiple entry port structure.

In certain embodiments, the unitary multiple entry port structure further comprising a thread mechanism configured to engage a complimentary thread on a container.

In certain embodiments, the unitary multiple entry port structure further comprising a plurality of threads configured to engage a plurality of threads disposed on a plurality of the containers.

In certain embodiments, the unitary multiple entry port structure comprises a plurality of entry ports configured to allow entry of a plurality of containers inside the plurality of the entry ports, the plurality of the entry ports connected to each other.

In certain embodiments, the unitary multiple entry port structure further comprising a plurality of smart-site engagement mechanisms configured to engage and provide a fluidic passageway between a plurality of the containers and the first container.

In certain embodiments, the plurality of the smart-site engagement mechanisms are disposed inside the unitary multiple entry port structure.

In certain embodiments, the plurality of the smart-site engagement mechanisms are disposed on an interior wall of the unitary multiple entry port structure.

In certain embodiments, the plurality of the smart-site engagement mechanisms are disposed through an interior wall of the unitary multiple entry port structure.

In certain embodiments, the unitary multiple entry port structure is made of a plastic material, a metal alloy, a glass material, and combinations thereof.

In other aspects, the present invention provides a method for intermixing beneficial substances, comprising:
providing a first container having a unitary multiple entry port structure, the unitary multiple entry port structure having a cover and a plurality of piercing members;
providing a plurality of containers, the plurality of the containers containing a beneficial substance;
placing the plurality of the containers inside the unitary multiple entry port structure;
closing the cover of the unitary multiple entry port structure; and
piercing of a surface of the plurality of the containers by the plurality of piercing members.

In certain embodiments, the closing the cover of the unitary multiple entry port structure hermetically seals the plurality of the containers inside the unitary multiple entry port structure.

In certain embodiments, the piercing of a surface of the plurality of the containers by the plurality of the piercing members establishes a fluidic communication between the interior of the first container and the plurality of the containers.

In certain embodiments, the cover further comprising at least one actuator configured to move through the cover.

In certain embodiments, the at least one actuator is a button.

In certain embodiments, the method further comprising pushing at least one button through the cover.

In certain embodiments, the plurality of the containers further comprise plungers.

In certain embodiments, pushing the button through the cover allows the button to push a plunger of the plurality of the container.

In certain embodiments, pushing at least one button through the cover moves at least one plunger of the plurality of the containers which expels the contents of the plurality of the containers into the first container.

In certain embodiments, the first container is a bag.

In certain embodiments, the first container is a bottle.

Unless otherwise defined, all technical or/and scientific terms used herein have the same meaning as commonly understood by one of ordinary skill in the art to which the invention pertains. Although methods and materials similar or equivalent to those described herein can be used in the practice or testing of embodiments of the invention, exemplary methods or/and materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1E are schematic front cut view illustrations presenting an exemplary system which includes an IV bag having a plurality of entry ports and an exit port, wherein a plurality of containers are received and engaged by the plurality of entry ports to transfer an amount from the plurality of containers to the IV bag, according to some embodiments of the invention.

FIGS. 2A-2E are schematic front cut view illustrations presenting a further exemplary system which includes an IV bag having a plurality of entry ports and an exit port, wherein a plurality of containers are received and engaged by the plurality of entry ports to transfer a dose or amount of a beneficial substance from the plurality of containers to the IV bag, according to some embodiments of the invention.

FIGS. 3A-3E are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 4A-4D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 5A-5D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 6A-6D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 7A-7D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 8A-8D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 9 is a schematic front cut view illustration presenting a further exemplary system which includes an IV bag having a plurality of entry ports and an exit port, according to some embodiments of the invention.

FIG. 10 is a schematic front cut view illustration presenting a further exemplary system which includes an IV bag having a plurality of entry ports and an exit port, according to some embodiments of the invention.

FIG. 11 is a schematic front cut view illustration presenting a further exemplary system which includes an IV bag having a plurality of entry ports and an exit port, according to some embodiments of the invention.

FIGS. 12A-12E are schematic front cut view illustrations presenting a further exemplary system which includes an IV bag having a plurality of entry ports and an exit port, wherein a plurality of syringe elements are received and engaged by the plurality of entry ports to transfer a dose from the plurality of syringe elements to the IV bag, according to some embodiments of the invention.

FIGS. 13A-13H are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 14 is schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 15 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 16 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 17A-17D are schematic front cut view illustrations presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIGS. 18A-18D are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIGS. 19A-19D are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIGS. 20A-20D are schematic front cut view illustrations presenting a further exemplary system which includes a syringe having a plurality of entry ports and an exit port, wherein a plurality of containers are received and engaged by the plurality of entry ports to transfer a dose from the plurality of containers to the syringe, according to some embodiments of the invention.

FIGS. 21A-21E are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIG. 22 is a schematic front cut view illustration presenting a further exemplary system which includes a syringe having a plurality of entry ports, showing various objects able to be received by the plurality of entry ports, according to some embodiments of the invention.

FIGS. 23A-23E are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIGS. 24A-24E are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIGS. 25A-25I are schematic front cut view illustrations presenting a further exemplary system which includes a syringe having a plurality of entry ports, wherein a plurality of containers are received and engaged by the plurality of entry ports to transfer a dose from the plurality of containers to the syringe, according to some embodiments of the invention.

FIGS. 26A-26K are schematic front cut view illustrations presenting a further exemplary system which includes a syringe having a plurality of entry ports and a plurality of decontamination devices, wherein a plurality of containers are received and engaged by the plurality of entry ports and decontamination devices to transfer a dose from the plurality of containers to the syringe, according to some embodiments of the invention.

FIGS. 27A-27B are schematic front cut view illustrations presenting a further exemplary system which includes a modular dosing system of a plurality of containers, whereby the containers are configured to be connected to one another, according to some embodiments of the invention.

FIGS. 28A-28B are schematic front cut view illustrations presenting a further exemplary system which includes a modular dosing system of a plurality of containers, whereby the containers are configured to be connected to one another in a stackable orientation, according to some embodiments of the invention.

FIGS. 29A-29B are schematic front cut view illustrations presenting a further exemplary system which includes a modular dosing system of a plurality of containers, whereby the containers are configured to be connected to one another, according to some embodiments of the invention.

FIGS. 30A-30B are schematic front cut view illustrations presenting a further exemplary system which includes a modular dosing system of a plurality of containers, whereby the containers are configured to be connected to one another, according to some embodiments of the invention.

FIGS. 31A-31D are schematic front cut view illustrations presenting a further exemplary system which includes a modular dosing system of a plurality of containers, whereby the containers are configured to be connected to one another via decontamination devices, according to some embodiments of the invention.

FIGS. 32A-32G are schematic front cut view illustrations presenting a further exemplary system which includes a modular dosing system of a plurality of containers, whereby the containers are configured to be connected to one another, according to some embodiments of the invention.

FIGS. 33A-33C are schematic front cut view illustrations presenting a further exemplary system which includes a modular dosing system of a plurality of containers, whereby the containers are configured to be connected to one another, according to some embodiments of the invention.

FIGS. 34A-34F are schematic front cut view illustrations presenting a further exemplary system which includes a modular dosing system of a plurality of containers, whereby the containers are configured to be connected to one another, according to some embodiments of the invention.

FIG. 35 is a schematic front cut view illustration presenting a further exemplary system which includes an IV bag having a plurality of entry ports and decontamination devices, and an exit port, wherein a plurality of containers are received and engaged by the plurality of entry ports and decontamination devices to transfer a dose from the plurality of containers to the IV bag, according to some embodiments of the invention.

FIG. 36 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 37 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 38 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 39 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 40 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 41 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 42 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 43 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention;

FIG. 44 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 45 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 46 is a schematic front cut view illustration presenting a further exemplary system which includes a modular dosing system of a plurality of containers, whereby the containers are configured to be connected to one another, according to some embodiments of the invention.

FIG. 47 is a schematic front cut view illustration presenting a further exemplary system which includes a modular dosing system of a plurality of containers, whereby the containers are configured to be connected to one another, according to some embodiments of the invention.

FIG. 48 is a schematic front cut view illustration presenting a further exemplary system which includes a modular dosing system of a plurality of containers, whereby the containers are configured to be connected to one another, according to some embodiments of the invention.

FIG. 49 is a schematic front cut view illustration presenting a further exemplary system which includes a modular dosing system of a plurality of containers, whereby the containers are configured to be connected to one another, according to some embodiments of the invention.

FIG. 50 is a schematic front cut view illustration presenting a further exemplary system which includes an IV bag having a plurality of entry ports with external displacement interfaces and an exit port, showing various objects able to be received by the plurality of entry ports, according to some embodiments of the invention.

FIG. 51 is a schematic front cut view illustration presenting a further exemplary system which includes an IV bag having a plurality of entry ports and an exit port, showing various objects able to be received by the plurality of entry ports, according to some embodiments of the invention.

FIG. 52 is a schematic front cut view illustration presenting a further exemplary system which includes an IV bag having a plurality of decontamination devices and an exit port, showing vials/containers able to be received by the plurality of decontamination devices, according to some embodiments of the invention.

FIGS. 53A-53B is a schematic front cut view illustration presenting a further exemplary system which includes a modular dosing system of a plurality of containers showing amounts of dosing regimens, whereby the containers are configured to be connected to one another in a stackable orientation, according to some embodiments of the invention.

FIG. 54 is a schematic front cut view illustration presenting a further exemplary system which includes an IV bag having a plurality of entry ports and an exit port, wherein a plurality of containers are received and engaged by the plurality of entry ports to transfer a dose from the plurality of containers to the IV bag, according to some embodiments of the invention.

FIG. 55 is a schematic front cut view illustration presenting a further exemplary system which includes a syringe or container with an expulsion member having a plurality of entry ports and an exit port, wherein a plurality of containers are received and engaged by the plurality of entry ports to transfer a dose from the plurality of containers to the syringe or container with an expulsion member, according to some embodiments of the invention.

FIG. 56 is a schematic front cut view illustration presenting a further exemplary system which includes a bottle having a plurality of entry ports and an exit port, wherein a plurality of containers are received and engaged by the plurality of entry ports to transfer a dose from the plurality of containers to the bottle, according to some embodiments of the invention.

FIGS. 57A-57D are schematic front cut view illustrations presenting a further exemplary IV bag and a system comprising same, the IV bag having an entry port with a peripheral wall enclosing a cavity configured to accommodate a container and allow to transfer a dose from the container to the IV bag, according to some embodiments of the invention.

FIGS. 58A-58B are schematic front cut view illustrations presenting a further exemplary IV bag and a system comprising same, the IV bag having a plurality of entry ports with peripheral walls enclosing cavities configured to accommodate a plurality of containers and allow to transfer a dose from the containers to the IV bag, according to some embodiments of the invention.

FIG. 59 is a schematic front cut view illustration presenting a further exemplary system which includes an IV bag having a plurality of entry ports with peripheral walls enclosing cavities configured to accommodate containers in the form of syringes and allow to transfer a dose from the plurality of syringes to the IV bag, according to some embodiments of the invention.

FIG. 60 is a schematic front cut view illustration presenting a further exemplary system which includes an IV bag having a plurality of entry ports with peripheral walls enclosing cavities configured to accommodate containers in the form of bottles/vials and allow to transfer a dose from the plurality of bottles/vials to the IV bag, according to some embodiments of the invention.

FIG. 61 is a schematic front cut view illustration presenting a further exemplary system which includes an IV bag having a plurality of entry ports connected directly to the IV bag, the entry ports include protective peripheral walls enclosing cavities configured to accommodate containers and allow to transfer a dose from the plurality of containers to the IV bag, according to some embodiments of the invention.

FIG. 62 is a schematic front cut view illustration presenting a further exemplary system which includes an IV bag having a plurality of entry ports connected directly to the IV bag, the entry ports include peripheral protective walls enclosing cavities configured to accommodate containers in the form of bottles and allow to transfer a dose from the plurality of bottles to the IV bag, according to some embodiments of the invention.

FIG. 63 is a schematic front cut view illustration presenting a further exemplary system which includes an IV bag having a plurality of entry ports connected directly to the IV bag, the entry ports include peripheral walls enclosing cavities configured to accommodate containers in the form of syringes and allow to transfer a dose from the plurality of syringes to the IV bag, according to some embodiments of the invention.

FIG. 64 is a schematic front cut view illustration presenting a further exemplary system which includes an IV bag having a plurality of entry ports with peripheral walls enclosing cavities configured to accommodate containers and allow to transfer a dose from the plurality of containers to the IV bag, the entry ports include negative pressure compartments and covers for exerting a lower pressure in the ports compared to ambient air pressure, according to some embodiments of the invention.

FIGS. 65A-65B are schematic front cut view illustrations presenting a further exemplary system which includes an IV bag having a plurality of entry ports with peripheral walls and covers enclosing cavities configured to accommodate containers and allow to transfer a dose from the plurality of containers to the IV bag, the covers include a lock mechanism in the form of latches, according to some embodiments of the invention.

FIGS. 66A-66B are schematic front cut view illustrations presenting a further exemplary system which includes an IV bag having a plurality of entry ports with negative pressure compartments connected to peripheral walls and covers enclosing cavities configured to accommodate containers and allow to transfer a dose from the plurality of containers to the IV bag, the covers include a lock mechanism in the form of latches, according to some embodiments of the invention.

FIG. 67 is a schematic front cut view illustration presenting a further exemplary system which includes an IV bag having a plurality of entry ports with negative pressure compartments connected to peripheral walls and covers enclosing cavities configured to accommodate containers and allow to transfer a dose from the plurality of containers to the IV bag, the covers include a lock mechanism in the form of hooks and a sliding mechanism for allowing closing the entry ports, according to some embodiments of the invention.

FIGS. 68A-68B are schematic front cut view illustrations presenting a further exemplary system which includes an IV bag having a unitary multiple entry port structure configured to accommodate a plurality of containers and allow to transfer a dose from the plurality of containers to the IV bag, a singular cover is hingedly connected to an upper entry port to cover the unitary multiple entry port structure, according to some embodiments of the invention.

FIGS. 69A-69C are schematic front cut view illustrations presenting a further exemplary system which includes an IV bag having a unitary multiple entry port structure configured to accommodate a plurality of containers and allow to transfer a dose from the plurality of containers to the IV bag, a singular slidable cover is connected to the entry port structure to cover the structure, according to some embodiments of the invention.

FIGS. 70A-70E are front view illustrations presenting an exemplary unitary multiple entry port structure which includes apertures for receiving containers, a cover and a negative pressure compartment, according to some embodiments of the invention.

FIG. 71 is a schematic front cut view illustration presenting a further exemplary system which includes an IV bag having a plurality of entry ports with peripheral walls and covers in the form of flaps enclosing cavities configured to accommodate containers, the containers include a plunger and a plunger lock mechanism, and the entry ports include a plunger unlock mechanism for allowing to transfer a dose from the plurality of containers to the IV bag following an engagement between the containers and the entry ports, according to some embodiments of the invention.

FIG. 72 is a schematic front cut view illustration presenting a further exemplary system which includes an IV bag having a plurality of entry ports with peripheral walls and hinged covers enclosing cavities configured to accommodate containers, the containers include a plunger and a plunger lock mechanism, and the entry ports include a plunger unlock mechanism for allowing to transfer a dose from the plurality of containers to the IV bag following an engagement between the containers and the entry ports, according to some embodiments of the invention.

FIG. 73 is a schematic front cut view illustration presenting a further exemplary system which includes an IV bag having a plurality of entry ports with peripheral walls and slidable covers enclosing cavities configured to accommodate containers, the containers include a plunger and a plunger lock mechanism, and the entry ports include a plunger unlock mechanism for allowing to transfer a dose from the plurality of containers to the IV bag following an engagement between the containers and the entry ports, according to some embodiments of the invention.

FIGS. 74A-74B are schematic front cut view illustrations presenting a further exemplary system which includes an IV bag having a plurality of entry ports with peripheral walls and covers enclosing cavities configured to accommodate containers, the covers include push buttons for allowing to transfer a dose from the plurality of containers to the IV bag following an engagement between the containers and the IV bag, according to some embodiments of the invention.

FIGS. 75A-75D are schematic front cut view illustrations presenting an exemplary system with a unitary multiple entry port structure (FIGS. 75A, and 75B), front view illustrations (FIG. 75C) and a side view illustration (FIG. 75D) of a unitary multiple entry port structure which includes apertures for receiving containers, a cover and a negative pressure compartment, the cover includes push buttons for exerting movement of containers' plungers to transfer a dose from the plurality of containers to the IV bag following an engagement between the containers and the IV bag, according to some embodiments of the invention.

FIGS. 76A-76B are schematic front cut view illustrations presenting a further exemplary system which includes an IV bag having a unitary multiple entry port structure with peripheral walls and a slidable cover enclosing cavities configured to accommodate containers, the cover includes a plurality of push buttons for allowing to transfer a dose from the plurality of containers to the IV bag following an engagement between the containers and the IV bag, according to some embodiments of the invention.

FIGS. 77A-77D are schematic front cut view illustrations (FIGS. 77A and 77B) and bottom views (FIGS. 77C and 77D) presenting a further exemplary system which includes an IV bag having a plurality of entry ports with peripheral walls and covers enclosing cavities configured to accommodate containers, a lever configured to connect plungers of the containers passes through the peripheral wall of the entry ports for allowing to transfer a dose from the plurality of containers to the IV bag following an engagement between the containers and the IV bag, according to some embodiments of the invention.

FIGS. 78A-78B are schematic front cut view illustrations presenting a further exemplary system which includes an IV bag having a unitary multiple entry port structure with peripheral walls and a slidable cover enclosing cavities configured to accommodate containers, the bag includes negative air pressure compartments to allow a lower air pressure within the cavities of the port structure compared to ambient air pressure and thereby allow to transfer a dose from the plurality of containers to the IV bag following an engagement between the containers and the IV bag, according to some embodiments of the invention.

FIGS. 79A-79B are schematic front cut view illustrations presenting a further exemplary system which includes an IV bag having a unitary multiple entry port structure with peripheral walls and a hinged cover enclosing cavities configured to accommodate containers, the bag includes negative air pressure compartments to allow a lower air pressure within the cavities of the port structure compared to ambient air pressure and thereby allow to transfer a dose from the plurality of containers to the IV bag following an engagement between the containers and the IV bag, according to some embodiments of the invention.

FIG. 80 is a schematic front cut view illustration presenting a further exemplary system which includes an IV bag having a plurality of entry ports with peripheral walls and slidable covers enclosing cavities configured to accommodate containers, the bag includes a piercing member configured to pierce through a cap/seal or surface of the containers to thereby allow to transfer a dose from the plurality of containers to the IV bag following an engagement between the containers and the entry ports, according to some embodiments of the invention.

FIGS. 81A-81B are schematic front cut view illustrations presenting a further exemplary system which includes an IV bag having a plurality of entry ports with peripheral walls and a hinged cover enclosing cavities configured to accommodate containers, the plurality of entry ports include valves between negative air pressure compartments and cavities of the entry ports, according to some embodiments of the invention.

FIGS. 82A-82B are schematic front cut view illustrations presenting a further exemplary system which includes an IV bag having a unitary multiple entry port structure with peripheral walls and a hinged cover enclosing cavities configured to accommodate containers, the unitary multiple entry port structure includes valves between negative air pressure compartments and the cavities of the entry port, according to some embodiments of the invention.

FIGS. 83A-83B are schematic front cut view illustrations presenting a further exemplary system which includes an IV bag having a unitary multiple entry port structure with peripheral walls and a hinged cover enclosing cavities configured to accommodate containers, the unitary multiple entry port structure includes valves between negative air pressure compartments and the cavities of the entry port, the unitary multiple entry port structure further includes one or more of a valve unlock mechanism, according to some embodiments of the invention.

FIG. 84 is a schematic front cut view illustration presenting a further exemplary system which includes an IV bag having a plurality of entry ports with peripheral walls and slidable covers enclosing cavities configured to accommodate containers, the containers include a plunger and a plunger lock mechanism, and the entry ports include a plunger unlock mechanism for allowing to transfer a dose from the plurality of containers to the IV bag following an engagement between the containers and the entry ports, according to some embodiments of the invention.

FIG. 85 is a schematic front cut view illustration presenting a further exemplary system which includes an IV bag having a plurality of entry ports with peripheral walls and slidable covers enclosing cavities configured to accommodate containers, the containers include a plunger and a plunger lock mechanism, and the entry ports include a plunger unlock mechanism, the bag includes a piercing member configured to pierce through a cap or surface of the containers to thereby allow to transfer a dose from the plurality of containers to the IV bag following an engagement between the containers and the entry ports, according to some embodiments of the invention.

FIG. 86 is a schematic front cut view illustration presenting a further exemplary system which includes an IV bag having a plurality of entry ports with peripheral walls and covers enclosing cavities configured to accommodate containers, the plurality of entry ports include wiping members and actuators thereof to wipe off the surface of the containers and allow a contaminants-free transfer of a dose from the plurality of containers to the IV bag, according to some embodiments of the invention.

FIGS. 87A-87B are schematic front cut view illustrations presenting a further exemplary system which includes an IV bag having a unitary multiple entry ports structure with peripheral walls and a cover enclosing cavities configured to accommodate containers, the entry port structure includes wiping members and actuators thereof to wipe off the surface of the containers and allow a contaminant-free transfer of a dose from the plurality of containers to the IV bag, according to some embodiments of the invention.

FIGS. 88A-88B are schematic front cut view illustrations presenting a further exemplary system which includes an IV bag having a unitary multiple entry ports structure with peripheral walls and a cover enclosing cavities configured to accommodate containers, the entry port structure includes cap members and the containers include cap members, the cap members configured to engage with one another, entrap contaminants and displace internally into the IV bag, allowing contaminants-free transfer of a dose from the plurality of containers to the IV bag, according to some embodiments of the invention.

FIGS. 89A-89B are schematic front cut view illustrations presenting a further exemplary system which includes an IV bag having a unitary multiple entry ports structure with peripheral walls and a cover enclosing cavities configured to accommodate containers, the entry port structure includes decontamination interfaces and the containers include decontamination interfaces, the decontamination interfaces configured to engage with one another, entrap contaminants between the interfaces and displace externally to the site/location of fluidic communication between the bag and the containers, allowing contaminant-free transfer of a dose from the plurality of containers to the IV bag, according to some embodiments of the invention.

FIGS. 90A-90B are schematic side cut view illustrations presenting a unitary multiple entry port structure with peripheral walls and a cover enclosing cavities configured to accommodate containers, according to some embodiments of the invention.

FIG. 91 is a schematic front cut view illustration presenting a further exemplary system which includes an IV bag and a unitary multiple entry port structure with a peripheral wall and a cover enclosing cavities configured to accommodate containers, the system includes an engagement mechanism to connect the unitary multiple entry port structure to the IV bag, according to some embodiments of the invention.

FIGS. 92A-92B are schematic front cut view illustrations presenting a further exemplary system which includes an IV bag having a unitary multiple entry ports structure with peripheral walls and a cover enclosing cavities configured to accommodate containers, the containers, IV bag and entry ports structure include a snap on engagement mechanism to connect the containers to the IV bag, according to some embodiments of the invention.

It should be appreciated that for simplicity and clarity of illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

### DETAILED DESCRIPTION OF THE INVENTION

It is understood that the invention is not limited to the particular methodology, devices, items or products etc., described herein, as these may vary as the skilled artisan will recognize. It is also to be understood that the terminology used herein is used for the purpose of describing particular embodiments only, and is not intended to limit the scope of the invention. The following exemplary embodiments may be described in the context of exemplary medical systems for ease of description and understanding. However, the invention is not limited to the specifically described products and methods and may be adapted to various applications without departing from the overall scope of the invention. All ranges disclosed herein include the endpoints. The use of the term “or” shall be construed to mean “and/or” unless the specific context indicates otherwise.

The present invention relates, in some embodiments thereof, to systems, containers and substance transfer methods to establish fluid communication between medical vessels.

The present invention relates, in some embodiments thereof, to devices, methods and systems allowing an engagement of a vessel, such as an IV bag, syringe or bottle, with two or more containers in a sterile or decontaminated manner. In some embodiments of the invention, the systems and devices of the invention include a vessel comprising at least two entry ports and at least one exit port, and at least one container containing a dosing regimen, the at least one container configured to be received by one of the at least two entry ports of the vessel, whereby upon connection of the at least one container to the one of the at least two entry ports of the vessel, the dosing regimen in the at least one container is transferred into the vessel, thereby allowing the user to assemble virtually any customized dosage amount of a beneficial substance for an individual with maximum flexibility and without the need for manually manipulating and measuring the beneficial substance.

The present invention relates, in some embodiments thereof, to devices, methods and systems allowing an engagement of containers such as vials with one another in a modular configuration. In some embodiments of the invention, the systems and devices of the invention involve a modular dosing system for adding at least one dose of a medicament to a preparation in a modular construction.

The present invention relates to providing a “customized/individualized” final dose of an injectable or intracorporeally administered medication and how it provides flexibility to “assemble” a customized amount of a medicament in a pharmacy, doctor's office, and/or at the point of care.

The present invention relates, in some embodiments thereof, to devices, methods and systems allowing for displaying a dosing regimen or single dose of a medicament, so that the administrator of the dose is able to precisely ascertain the product identity and dose administered to a patient.

The present invention relates, in some embodiments thereof, to devices, methods and systems allowing for engaging and/or coupling of a plurality of containers to a bag and/or bottle in a leak-free manner.

The present invention relates, in some embodiments thereof, to devices, methods and systems allowing for the engaging and/or coupling of a plurality of containers to a bag and/or bottle in a manner that prevents breakage/cracking of the plurality of the containers.

The present devices, methods and systems are particularly useful for medical purposes, wherein sterile preparations of medical substances are vastly needed, especially for customized dosage regimens requiring a plurality of packaged containers housing beneficial substances. In one embodiment, the present invention provides a vessel with multiple connection interfaces and entry ports, that may be coupled to, or integrally formed with, medical vessels or containers, such as vials, syringes, containers, bags, bottles, etc.

The invention provides a solution to an unmet and long felt need in the medical setting and allows connecting in a sterile manner and/or leak-free manner, a vessel with containers that house amounts of beneficial substances. The herein disclosed devices and systems are user friendly, cost effective and abolish the need for complicated and expensive known methods for transferring medical substances. In an embodiment of the invention, the herein disclosed devices and systems are disposable. In an embodiment of the invention, the herein disclosed devices and systems are non-disposable.

The application incorporates by reference various types of piercing members, piercing member lock-unlock mechanisms, valves, valve lock-unlock mechanisms, plungers, plunger lock-unlock mechanisms, engagement mechanisms, safety mechanisms, and decontamination devices set forth in the following applications:

U.S. Ser. No. 16/100,594 filed on Aug. 10, 2018;

U.S. Ser. No. 16/100,712 filed on Aug. 10, 2018;

U.S. Ser. No. 16/100,840 filed on Aug. 10, 2018;

U.S. Ser. No. 16/100,964 filed on Aug. 10, 2018;

U.S. Ser. No. 16/168,759 filed on Oct. 23, 2018

U.S. Ser. No. 16/169,695 filed on Oct. 24, 2018;

U.S. Ser. No. 16/196,814 filed on Nov. 20, 2018;

U.S. Ser. No. 16/199,009 filed on Nov. 23, 2018;

U.S. Ser. No. 16/233,923 filed on Dec. 27, 2018

U.S. Ser. No. 16/254,576 filed on Jan. 22, 2019;

U.S. Ser. No. 16/274,717 filed on Feb. 13, 2019;

U.S. Ser. No. 16/358,434 filed on Mar. 19, 2019;

U.S. Ser. No. 16/358,389 filed on Mar. 19, 2019;

U.S. Ser. No. 16/423,120 filed on May 27, 2019;

U.S. Ser. No. 16/439,851 filed on Jun. 13, 2019

U.S. Ser. No. 16/504,286 filed on Jul. 7, 2019;

Any of the systems, containers, devices, and methods disclosed in the teachings of the above listed U.S. Non-Provisional Patent Applications may be incorporated into any of the systems, containers, devices, and methods herein application/specification. In one example, a unitary multiple entry port structure may incorporate any and/or any combination of systems, containers, devices, and/or methods disclosed in the teachings of the above listed U.S. Non-Provisional Patent Applications.

In an aspect of the invention, the devices and systems of the invention include a vessel, the vessel may be a bag, bottle, syringe, infusion line, connector, connector with a plurality of ports, a vial, a filter, manifold and/or any type of container and/or medicinal device used for the housing and/or administration of a medicinal substance to a patient. Additionally, the vessel is designed to be coupled with at least two containers containing a dose and subsequent delivery of the assembled substance to a patient for administration. Optionally, the vessel may be designed to couple with at least two connectors, and/or a plurality of connectors, wherein the connectors are configured to couple to at least two or a plurality of containers. Administration may be intracorporal administration to a patient. The medicinal substance may be a medicament, a nutritional substance, vitamins, minerals, elements, trace elements a fluid, a sterile fluid, a solid, a semi-solid, a lyophilized substance, a diluent, a diagnostic substance, a pharmaceutical substance, a substance used form dialysis, a substance used for hemodialysis and/or etc.

In certain aspects, the vessel has at least two entry ports and at least one exit port collectively comprising a plurality of fluid communications. The entry ports and exit ports may be integrally/fixedly attached to the container. The entry ports and exit ports may form a unitary structure with the container. The entry ports may be flush mounted or surface mounted to the vessel. The entry ports may be adhered to the vessel via an adhesive or may be constructed to be within or integrally built into the vessel. The entry ports may abut the container. The entry ports may abut a wall of the container. The entry ports may include a conduit that fluidly connects the entry ports to the bag. The entry ports may be provided as separate elements that can be connected to the vessel. Optionally, two or more entry ports are connected to each other forming a monolithic single unitary multiple entry port structure. Various engagement means/mechanisms between the entry ports and the vessel are contemplated including, a thread and a complementary thread, ratchet teeth, a snap-on connection, adhesives, hooks, fasteners, and/or latches.

The entry ports may include a peripheral wall enclosing a cavity for accommodating therein a container. The peripheral wall provides a protective structure for the containers, preventing damages that may be associated with the use of the containers, or with accidental falls, hits, and the alike. The peripheral wall may prevent breakage/cracking of container(s) (e.g. vials, syringes, cartridges, bottles) if the cavity and containers fall to the ground. The peripheral wall may be made of a rigid material such as a rigid plastic, a metal, a metal alloy, glass, and combinations thereof In one or more embodiments, the peripheral wall may be made of any type of plastic. In one or more embodiments, the peripheral wall may be made of a soft plastic, a rubber material, rubber, an elastomeric material, and combinations thereof. The peripheral wall may engulf the entire body of a container or may at least partially or mostly engulf a body of the container. The peripheral wall may engulf the entire length and/or width of a body of the container. The peripheral wall may engulf the entire volume of a body of a container. The peripheral wall may engulf the entire container. The peripheral wall may engulf the entire container including the container's port. The peripheral wall may engulf the entire container including the container's plunger, plunger handle, and any other structures the container may possess. Optionally, the entry ports include a cover for providing a full coverage of the container. A cover of the entry ports may include a closure mechanism for locking permanently or temporarily the entry ports. Various closure mechanisms are contemplated including, without limitation, a snap-on connection, fasteners, latches, pins, hooks and a combination thereof

A mechanism for fluid transfer may be incorporated to the herein disclosed entry port to allow a transfer of a dose from the containers to the vessel/bag. In certain embodiments, the mechanism for fluid transfer include means for moving a plunger of the containers. The means for moving a plunger of the container may include push buttons provided on a cover of the entry ports. The push buttons may be pushed externally by a user such to insert the buttons into the entry port and move forward a plunger of the container. In alternative embodiments, the means for moving a plunger include push buttons provided on a peripheral wall enclosing cavity for accommodating at least one container and/or a plurality of containers. The push buttons may be pushed externally by a user such to insert the buttons into the entry port and move forward a plunger of the container. In alternative embodiments, the means for moving a plunger include a lever which can connect the plunger of a container following the engagement of the container with the entry port. The lever may be pushed externally by a user such to move forward a plunger of the container. The lever may be attached to a peripheral wall enclosing cavity for accommodating therein a container. Optionally, the lever may be attached to a port of a vessel (e.g. bag, bottle). Optionally, the lever may be attached to a bag or bottle. The bag may be an intravenous bag which is empty or which contains a fluid. The fluid may be a dextrose solution, a saline solution, sterile water, and/or any other fluid typically used in the healthcare setting.

The entry ports may include, a negative air pressure compartment for exerting an air pressure lower in the entry port compared to ambient air pressure. The negative air pressure compartment may be integrally/fixedly attached to the wall of the entry port. The negative air pressure compartment may be integrally/fixedly attached to a wall of the container/bag and in communication with the entry port. The purpose of the negative pressure compartment(s) is to withdraw any fluid or vapor leaks between a bag/bottle and container(s) (e.g. vials, syringes, cartridges) that may be present within/inside the peripheral wall enclosing cavity. The negative pressure compartment(s) provide a second line of defense against leakage into the environment of fluids and/or vapors from between an intravenous bag/bottle and vials/syringes/cartridges that are attached/engaged/coupled to the intravenous bag/bottle. The first line of defense against such leakages is a hermetically sealed peripheral wall enclosing cavity which hermetically seals at least one and/or a plurality of containers inside the peripheral wall enclosing cavity in an airtight manner which prevents escape of a fluid or vapor leak into the environment. Additionally, the negative pressure compartment(s) suck out/withdraws any fluid or vapor leaks from within the peripheral wall enclosing cavity into the negative pressure compartment(s). A valve may be incorporated within the negative air pressure compartment, optionally within and/or on and/or over an opening or aperture between the entry ports and the negative air pressure compartment. The opening of the valve may be mediated via a valve unlock mechanism that may unlock the valve and/or a lock mechanism thereof, allowing the negative air pressure compartment to suck air from a cavity of the entry ports. Optionally, the valve may be disposed on and/or within a peripheral wall enclosing cavity, and a negative air pressure compartment(s) may be attached, optionally integrally attached, to the peripheral wall enclosing cavity. In one or more embodiments, the negative pressure compartment(s) may be disposed on and/or within a wall of a bag, bottle, intravenous bag. The valve may be a one-way valve which allows movement of fluid and/or vapors from within the peripheral wall enclosing cavity into the negative pressure compartment. In one or more embodiments, a monolithic single unitary multiple entry port structure may have at least one and/or a plurality of negative pressure compartments with or without valves. The negative pressure compartment(s) create a negative pressure environment within the monolithic single unitary multiple entry port structure and/or within the peripheral wall enclosing cavity. In one or more embodiments, the negative pressure compartment has a pressure differential of at least −0.1 i.w.c. (at least negative 0.1 inches of water column) compared to ambient air. In one or more embodiments, the negative pressure compartment has a pressure differential of between −0.1 i.w.c. and −0.3 i.w.c. (between negative 0.1 inches water column and negative 0.3 inches water column). In one or more embodiments, the negative pressure compartment has a pressure differential of less than −0.1 i.w.c. (negative 0.1 inches water column). In one or more embodiments, the negative pressure compartment has a pressure differential greater than −0.1 i.w.c. (negative 0.1 inches water column). In one or more embodiments, the negative pressure compartment(s) have a pressure less than ambient air pressure. In one or more embodiments, the negative pressure compartment(s) have a pressure less than ambient air pressure at sea level.

In some embodiments of the invention the ports are designed universally in that they can connect with all other universally designed types of ports on containers, vials, syringes, vessels, and/or connectors.

Embodiments of the invention may include a modular assembly of a plurality of containers to a manifold, wherein the containers house non-standard and/or standard amounts of beneficial substances and/or medicaments allowing for assembly of a final customized amount of a beneficial substance and/or medicament. Optionally, the manifold may be connected to an infusion line, container or a syringe. In one or more embodiments, the manifold has a unitary multiple entry port structure. In one or more embodiments, the manifold has a monolithic single unitary multiple entry port structure. In one or more embodiments, the manifold has a peripheral wall enclosing a cavity for accommodating a container. In one or more embodiments, the manifold has a peripheral wall enclosing a cavity for accommodating a plurality of containers. In one or more embodiments, the manifold hermetically seals at least one container within the manifold. In one or more embodiments, the manifold hermetically seals a plurality of container within the manifold. In one or more embodiments, the manifold has a peripheral wall enclosing a cavity for accommodating a plurality of containers, the peripheral wall enclosing cavity configured to hermetically seal the containers within the cavity. In one or more embodiments, any of the mentioned manifolds in this paragraph may further comprise a decontamination device. The decontamination device may be located inside the peripheral wall enclosing cavity, on a surface of the peripheral wall enclosing cavity, and/or through a wall of the peripheral wall enclosing cavity. The decontamination device may be an external displacement decontamination device, an internal displacement decontamination device, a decontamination device having a wiping member configured to wipe off a surface of at least one vessel, and combinations thereof. In one or more embodiments, the manifold may have a single unitary multiple entry port structure and any and/or any combinations of decontamination devices listed in paragraph [00328] of this specification. In one or more embodiments, the manifold may have a peripheral wall enclosing cavity for accommodating at least one and/or a plurality of containers and any decontamination devices listed in paragraph [00328] of this specification. In one or more embodiments, the manifold may be a connector, the connector configured to couple a plurality of containers to an intravenous bag or bottle. In one or more embodiments, the containers may be vials, syringes, cartridges, or bottles having plungers.

Embodiments of the invention may include a container having a unitary multiple entry port structure with a decontamination device. Embodiments of the invention may include a container having a unitary multiple entry port structure and a plurality of decontamination devices. The decontamination devices may be the same type of decontamination devices or may be different types of decontamination devices. Embodiments of the invention may include a container having a peripheral wall enclosing cavity for accommodating a container and a decontamination device. Embodiments of the invention may include a container having a peripheral wall enclosing cavity for accommodating a plurality of containers and a plurality of decontamination devices. The decontamination devices may be any devices described in any of the applications incorporated by reference into this application.

The application incorporates by reference various types of connection mechanisms and decontamination devices set forth in the following applications:

U.S. Ser. No. 16/100,594 filed on Aug. 10, 2018;

U.S. Ser. No. 16/100,712 filed on Aug. 10, 2018;

U.S. Ser. No. 16/100,840 filed on Aug. 10, 2018;

U.S. Ser. No. 16/100,964 filed on Aug. 10, 2018;

U.S. Ser. No. 16/168,759 filed on Oct. 23, 2018

U.S. Ser. No. 16/169,695 filed on Oct. 24, 2018;

U.S. Ser. No. 16/196,814 filed on Nov. 20, 2018;

U.S. Ser. No. 16/199,009 filed on Nov. 23, 2018;

U.S. Ser. No. 16/233,923 filed on Dec. 27, 2018

U.S. Ser. No. 16/254,576 filed on Jan. 22, 2019;

U.S. Ser. No. 16/274,717 filed on Feb. 13, 2019;

U.S. Ser. No. 16/358,434 filed on Mar. 19, 2019;

U.S. Ser. No. 16/358,389 filed on Mar. 19, 2019;

U.S. Ser. No. 16/423,120 filed on May 27, 2019;

U.S. Ser. No. 16/439,851 filed on Jun. 13, 2019

U.S. Ser. No. 16/504,286 filed on Jul. 7, 2019;

The entry and/or exit ports may incorporate decontamination devices to provide for a sterile contaminant-free engagement between the plurality of fluid communications. Contaminant-free may also mean air particle-free engagement between vessels. Any of the above listed decontamination devices may be disposed on and/or in and/or within an exit port of a container. Any of the above listed decontamination devices may be disposed on and/or in and/or within a manifold. Any decontamination device(s) disclosed within the above patent applications in paragraph [00328] may be disposed on and/or in and/or within a single unitary multiple entry port structure of a container. Any decontamination device(s) disclosed within the above patent applications in paragraph [00328] may be disposed on and/or in and/or within a peripheral wall enclosing cavity of a container.

In certain embodiments, the vessel includes a plurality (meaning at least 2, at least 3, at least 4, at least 5, 6 or more) of entry and/or exit ports and provides for the assembly of a customized amount of a beneficial substance without requiring a user to manually manipulate (draw up, measure, compound, intermix, mix) a beneficial sub stance.

The system comprises providing a plurality of containers, the vessels may be vials, syringes or bottles housing a beneficial substance, such as a dosing regimen. The beneficial substance in each of the vials may be the same beneficial substance, may be the same beneficial substance in different amounts or in the same amount, or may be different beneficial substances.

For example, if a parenteral nutrition is required to be prepared the user (usually a nurse/pharmacist/doctor) may simply attach a vial of multivitamins to a bag/bottle, then attach a vial containing a protein substance, then attach a vial containing elements/trace elements, then attach a vial containing insulin, then attach a vial containing any other needed substance to the bag/bottle. Instead of manually drawing up each of these beneficial substances in a syringe and visually measuring the amounts drawn up the user may simply attach a plurality of the mentioned vials to the vessel (bag/bottle/container) and then dispense the final product to a nurse or to the patient. No manual manipulation and measuring of the beneficial substances is required in a sterile environment.

The plurality of entry and/or exit ports may be located on a side of a vessel, on the top of the vessel, on the bottom of a vessel, and combination thereof. The vessel may be empty. The vessel may house a fluid. The fluid may be a sterile fluid. The fluid may be a diluent. The fluid may be a solution. The fluid may be a suspension. The vessel may have a negative pressure relative ambient air pressure, ambient air pressure at sea level, and/or atmospheric pressure. Optionally, the vessel may have a negative pressure relative a container and/or a plurality of containers that are intended to couple with the vessel.

In one or more embodiments, the herein disclosed invention allows transferring medical substances in a contaminant-free, or in a substantially contaminant-free manner.

In one or more embodiments, the herein disclosed invention affords an engagement of vessels with containers, containers with syringes, and containers with other containers in a contaminant-free, or in a substantially contaminant-free manner.

In one or more embodiments, the herein disclosed invention provides a fluidic passageway or communication between vessels with containers, containers with syringes, and containers with other containers in a contaminant-free, or in a substantially contaminant-free manner.

In one or more embodiments, the herein disclosed invention affords to isolate and/or entrap ambient air particles present between medical vessels and containers, containers with syringes, and containers with other containers, and between interfaces and other interfaces. In one or more embodiments, the herein disclosed invention, allows to substantially decrease the chances to introduce contaminants within a medical substance, when preparing medical substances for administration to patients.

As used herein the term “substances” refers to various types of materials that should be kept sterile. The substances may be liquid, semi-solid, solid, lyophilized solid or gas. In one or more embodiments, the substances are “medical substances”. As used herein the term “medical substances” refers to and encompasses any of the various medical drugs, fluids, nutritional products, liquids, solids, suspensions and the like.

As used herein the term “contaminant-free” is interchangeable with the term “sterile”, “disinfected”, and “decontaminated”. The term refers to substances that are free or substantially free of ambient air particles and/or pathogens. Typically, when less or no air is introduced within medical substances, the chances of contamination by pathogens, such as, bacteria, viruses, funguses, spores, pyrogens or the alike is completely abolished or significantly reduced.

As used herein, the term “substantially contaminant-free” means significantly less ambient air present when transferring medical substances with the herein disclosed vessels and systems, as compared to comparable conditions for transferring medical substances without the herein disclosed vessels and systems.

As used herein the term “ambient air particles” is interchangeable with the term “environmental air particles” and refers to air particles present in a non-filtered environment. For example, air can be purified by filters, such as a High Efficiency Particulate Air (HEPA) filter.

As used herein the term “connection interface” encompasses any surface, layer, plane or the alike that can be attached to a vessel. The term may encompass a structure that can be coupled or adhered to a vessel and that can engage with a complementary connection interface.

As used herein the term “external displacement” refers to a displacement (i.e., dislocation) of the herein disclosed first and/or second, and/or any additional connection interfaces. In an embodiment of the invention, the displacement is external, namely, outside the vessels being connected by the herein disclosed system. In an embodiment of the invention, the displacement is external to the fluid communication established following engagement of the vessels being connected by the herein disclosed system, methods and devices. In an embodiment of the invention, the displacement maintains hermetic seal of the connection interfaces and/or the vessels. The displacement may occur via a sliding motion, or by a pulling out motion, or by peeling the connections. In an embodiment of the invention, the displacement occurs for both the first and second connection interfaces. The external displacement may optionally occur simultaneously for both connection interfaces or may occur consecutively. In an embodiment of the invention, the external displacement established a fluid passageway between two or more vessels. In one or more embodiments, the connection interface is configured to hermetically seal an aperture present in a vessel or on a wall of a vessel. In one or more embodiments, at about the time or following the external displacement, the aperture of a vessel reseals, allowing a hermetic airtight connection between two or more vessels.

As used herein the term “internal displacement” refers to a displacement (i.e., dislocation) of the herein disclosed first and/or second connection interfaces. In an embodiment of the invention, the displacement is internal, namely, dislocation into one of the vessels associated with a connection interface. In an embodiment of the invention, the displacement is within the fluid passageway established following engagement of the herein disclosed vessels. In an embodiment of the invention, the internal displacement occurs for one or both the first and second connection interfaces. The internal displacement may optionally occur simultaneously for both connection interfaces or may occur consecutively. The displacement may occur via a pressure exerted on the exterior of the connection interfaces, a pressure exerted through a flexible wall of a vessel or container, a twisting of the connection interfaces with respect to one another, or an engagement of the interfaces with one another and actuation by a user.

As used herein the term “vessel” refers to any device utilized for containing substances as herein disclosed. In one or more embodiments, the vessel may be used for containing medical substances. In one or more embodiments, the vessel may be used for housing medical substances. In an embodiment of the invention, the vessel is a medical vessel. In an embodiment of the invention, the vessel is a medical device. In an embodiment of the invention, the vessels are used for, and adapted to allow connection to another vessel(s). In an embodiment of the invention, the vessel may be a medical container utilized for accommodating medical substances. Various types of medical containers are contemplated. The medical container may be selected, without limitation, from a vial, a bag, a chamber, a bottle, and the alike. In an embodiment of the invention, the term vessel further encompasses elements that can be used to connect between vessels. In accordance with this embodiment, the vessel may be selected, without limitation, from a connector, a connector with a plurality of openings, a connector with a plurality of ports, a port, a syringe, an infusion line, a tubing, a syringe, a filter, a spike, a port and a manifold. In an embodiment of the invention, one or more connection interfaces (for example, two or more, three or more, etc.) may be coupled to a first vessel and each of those connection interfaces may be coupled and engage with a second connection interface present on a second vessel. In one or more embodiments, the vessels to be engaged may have similar surface area or similar contact surface area (i.e., surface onto which the connection interface is coupled to). For example, a first vessel and a second vessel may have similar surface area or similar contact surface area. In one or more embodiments, the vessels to be engaged may have different surface area or different contact surface area. For example, a first connection interface may have a greater surface area or contact surface area than a second vessel. In an embodiment of the invention, one or more decontamination devices (for example, two or more, three or more, etc.) may be coupled to a first vessel and each of those decontamination devices may be coupled and engage with a container or a connector.

As used herein the term “fluid communication” refers to two or more vessels in which substances may pass therethrough either directly or indirectly. The fluid communication may occur via a fluid passageway that allows for the flow/transfer of substances.

As used herein the term “directly receives” refers to providing a substance to another container without an intermediary.

As used herein, the term “non-standard amount” is an amount or dosing regimen that is not available in a commercially prepackaged amount.

As used herein, the term “sub-therapeutic amount” is a dosing amount that is less than a therapeutic amount given to a patient.

As used herein, the term “dosing regimen(s)” refers to an amount of a beneficial substance. The term “dosing regimen(s)” and “amount” may be used interchangeably. In one or more embodiments, the beneficial substance may be a medicament, a nutritional substance and the alike.

As shown below, various drugs, or therapeutically equivalent drugs and/or formulations, that can be used in system and methods of the invention include, but are not limited to: Abciximab, Acetaminophen, Acetazolamide, Ado-trastuzumab, Aldesleukin, Alefacept, Alemtuzumab, Alfentanil, Allopurinol, Alprostadil, Amifostine, Aminocaproic Acid, Ammonium Chloride, Amoxicillin, Amsacrine, Antithymocyte Globulin Rabbit, Argatroban, Aripiprazole, Arsenic Trioxide, Asparaginase Erwinia Chrysanthemi, Atezolizumab, Azathioprine Sodium, Azithromycin, Baclofen, Benztropine, Bezlotoxumab, Bivalirudin, Blinatumomab, Bortezomib, Brentuximab, Bretylium Tosylate, Brivaracetam, Brodalumab, Buprenorphine, Busulfan, Calcitriol, Calcium Chloride, Canakinumab, Cangrelor, Capromab, Carbamazepine, Carmustine, Ceftolozane Sulfate/Tazobactam Sodium, Ceftolizumab, Chloramphenicol, Chlorothiazide, Cidofovir, Cladribine, Clarithromycin, Clonazepam, Colistimethate, Conivaptan, Cyclizine Lactate, Cyclosporine, Daclizumab, Dactinomycin, Dalbavancin, Dantrolene, Daptomycin, Daunorubicin, Denosumab, Diclofenac Sodium, Dinutuximab, Diphenhydramine, Doxapram, Dupilumab, Eculizumab, Edetate Calcium Disodium, Efalizumab, Ephedrine, Ertapenem, Estrogens Conjugated, Ethacrynate Sodium, Floxuridine, Fludarabine, Fluphenazine Hydrochloride, Folic Acid, Fomepizole, Fosaprepitant Dimeglumine, Foscarnet, Fusidate Sodium, Gallium, Ganciclovir, Gemcitabine, Gemtuzumab, Gentamicin Pediatric Formulation, Golimumab, Guselkumab, Hyaluronidase, Hydralazine, Ibandronate Sodium, Ibuprofen Lysinate, Ibutilide, Ibritumomab Tiuxetan, Idarucizumab, Indomethacin Sodium Trihydrate, Infliximab, Iodipamide Meglumine 52%, Isavuconazium sulfate, Ixekizumab, Lepirudin, Mechlorethamine Hydrochloride, Melphalan Hydrochloride, Mepolizumab, Mesna, Methadone, Methocarbamol, Methohexital Sodium, Methotrimeprazine Hydrochloride, Methyldopate Hydrochloride, Metoprolol, Metronidazole, Mexilitene Hydrochloride, Mitoxantrone, Moxifloxacin, Multivitamins, Mycophenolate, Natalizumab, Necitumumab, Nesiritide, Nicardipine, Norepinephrine, Obiltoxaximab, Obinutuzumab, Ocrelizumab, Olaratumab, Omaliumab, Omeprazole, Oritavancin Diphosphate, Pantoprazole, Pemetrexed, Penicillin G Potassium, Pentamidine Isethionate, Pentazocine, Pentostatin, Peramivir, Pertuzumab, Phentolamine Mesylate, Polymyxin B Sulfate, Posaconazole, Pralidoxime, Procainamide, Propranolol Hydrochloride, Quinidine Gluconate, Raxibacumab, Reslizumab, Reteplase, Rifampin, Salbutamol, Sargramostim, Scopolamine Butylbromide, Secukinumab, Sodium Ferric Gluconate Complex, Sodium Lactate, Sodium Nitroprusside, Sodium Thiosulfate, Streptomycin Sulfate, Streptozocin, Tacrolimus, Tedizolid Phosphate, Teniposide, Terbutaline Sulfate, Tetracaine Hydrochloride, Thiotepa, Ticarcillin Disodium/Clavulanate Potassium, Tigecycline, Topotecan Hydrochoride, Tranexamice Acid, Ustekinumab Intravenous Formulation, Valproate, Vedolizumab, Vinblastine Sulfate, Vincristine, Vincristine Sulfate Liposomal, Vitamin A, Voriconazole, Zidovudine, Zoledronic Acid, Bacitracin, Chromium (chromic chloride injection), Copper (cupric chloride injection), Carfilzomib.

As shown below is a table of injectable drugs and currently commercially available packaged amounts the drugs are supplied in by drug manufacturers. The amounts listed below in Table 1 are referred to as “standard amounts” as the drug manufacturers and the Food and Drug Administration have decided to commercially supply and give regulatory approval for the following amounts. The below drugs may be prepared and administered to patients using embodiments of the present invention:

TABLE 1

| DRUG | COLUMN A | | COLUMN B | | COLUMN C | | COLUMN D | |
|---|---|---|---|---|---|---|---|---|
| Acetycysteine | 3 | gm | 6 | gm | | | | |
| Acyclovir | 500 | mg | 1 | gm | | | | |
| Adalimumab | 10 | mg | 20 | mg | 40 | mg | 80 | mg |
| Adalimumab-atto | 20 | mg | 40 | mg | | | | |
| Adenosine | 60 | mg | 90 | mg | 3 | gm | | |
| Albumin 5% | | | | | | | | |
| Albumin 20% | | | | | | | | |
| Albumin 25% | 50 | ml | 100 | ml | | | | |
| Alirocumab | 75 | mg | 150 | mg | | | | |
| Alteplase | 2 | mg | 50 | mg | 100 | mg | | |
| Amikacin | 100 | mg | 500 | mg | 1 | gm | | |
| Aminophylline | 250 | mg | 500 | mg | | | | |
| Amiodaroine | 150 | mg | 450 | mg | 900 | mg | | |
| Amoxicillin/Clavulanate | 600 | mg | 1.2 | gm | | | | |
| Amphotericin B | 50 | mg | 100 | mg | | | | |
| Amphotericin B Cholesteryl | 50 | mg | 100 | mg | | | | |
| Sulfate Complex | | | | | | | | |
| Amphotericin B Liposomal | 50 | mg | 100 | mg | | | | |
| Ampicillin | 125 | mg | 250 | mg | 500 | mg | 1 | gm |
| Ampicillin Sodium/ | 1.5 gm (1 gm/0.5 gm) | | 3 gm (2 gm/1 gm) | | | | | |
| Sulbactam Sodium | | | | | | | | |
| Anidulafungin | 50 | mg | 100 | mg | | | | |
| Anti-Hemophilic Factor | 250 | IU | 500 | IU | 1000 | IU | 3000 | IU |
| Ascorbic Acid | 500 | mg | 1 | gm | | | | |
| Atracurium | 50 | mg | 100 | mg | | | | |
| Atropine | 0.4 | mg | 0.5 | mg | 1 | mg | | |
| Aztreonam | 500 | mg | 1 | gm | 2 | gm | | |
| Basiliximab | 10 | mg | 20 | mg | | | | |
| Belimumab | 120 | mg | 400 | mg | | | | |
| Caffeine Citrate | 30 | mg | 60 | mg | | | | |
| Bendamustine | 25 | mg | 100 | mg | | | | |
| Bevacizumab | 100 | mg | 400 | mg | | | | |
| Bleomycin | 15 | units | 30 | units | | | | |
| Bumetanide | 0.5 | mg | 1 | mg | 2.5 | mg | | |
| Bupivacaine PERCENTAGE | 0.25 | mg | 0.5 | mg | 7.5 | mg | | |
| Butorphanol | 1 | mg | 2 | mg | 4 | mg | 20 | mg |
| Calcium Gluconate 10% | 10 | ml | 50 | ml | 100 | ml | | |
| Carboplatin | 50 | mg | 150 | mg | 450 | mg | 600 | mg |
| Caspofungin | 50 | mg | 70 | mg | | | | |
| Cefoperazone | 1 | gm | 2 | gm | 10 | gm | | |
| Cefazolin | 500 | mg | 1 | gm | 10 | gm | 20 | gm |
| Cefepime | 500 | mg | 1 | gm | 2 | gm | | |
| Cefotaxime | 500 | mg | 1 | gm | 2 | gm | 10 | gm |
| Cefotetan | 1 | gm | 2 | gm | 10 | gm | | |
| Cefoxitin | 1 | gm | 2 | gm | 10 | gm | | |
| Ceftaroline | 400 | mg | 600 | mg | | | | |
| Ceftazidime | 500 | mg | 1 | gm | 2 | gm | 6 | gm |
| Ceftriaxone | 250 | mg | 500 | mg | 1 | gm | 2 | gm |
| Cefuroxime | 750 | mg | 1.5 | gm | 7.5 | gm | | |
| Cetuximab | 100 | mg | 200 | mg | | | | |
| Chlorpromazine | 25 | mg | 50 | mg | | | | |
| Cimetadine | 300 | mg | ???? | | | | | |
| Ciprofloxacin | 200 | mg | 400 | mg | | | | |
| Cisatracurium | 10 | mg | 20 | mg | 200 | mg | | |
| Cisplatin | 50 | mg | 100 | mg | 200 | mg | | |
| Cleviprex | 25 | mg | 50 | mg | | | | |
| Clindamycin | 300 | mg | 600 | mg | 900 | mg | | |
| Clonidine | 1 | mg | 5 | mg | | | | |
| Cloxacillin Sodium | 250 | mg | 500 | mg | 1 | gm | 2 | gm |
| Cyanocobalamin | 100 | mcg | 1 | mg | | | | |
| Cyclophosphamide | 500 | mg | 1 | gm | 2 | gm | | |
| Cytarabine | 100 | mg | 500 | mg | 1 | gm | | |
| Dacarbazine | 100 | mg | 200 | mg | | | | |
| Daratumumab | 100 | mg | 400 | mg | | | | |
| Deferoxamine | 500 | mg | 2 | gm | | | | |
| Defibrotide | | | | | | | | |
| Desmopressin Acetate | 4 | mcg | 40 | mcg | | | | |
| Dexamethasone sodium | 4 | mg | 10 | mg | | | | |
| Phosphate | | | | | | | | |
| Dexmedetomidine | 200 | mcg | 400 | mcg | | | | |
| Hydrochloride | | | | | | | | |
| Dexrazoxane | 250 | mg | 500 | mg | | | | |
| Dextrose 50% | 50 | ml | 500 | ml | 1 | Liter | | |
| Diamorphine | 10 | mg | 30 | mg | 100 | mg | 500 | mg |
| Diazepam | 10 | mg | 50 | mg | | | | |
| Digoxin | 0.25 | mg | 0.5 | mg | | | | |
| Diltiazem | 25 | mg | 50 | mg | 125 | mg | | |
| Dimenhydrinate | 50 | mg | 500 | mg | | | | |
| Dobutamine | 250 | mg | 500 | mg | 1250 | mg | | |
| Docetaxel | 20 | mg | 40 | mg | 80 | mg | | |
| Dolasetron | 12.5 | mg | 100 | mg | | | | |
| Dopamine | 200 | mg | 400 | mg | 800 | mg | | |
| Doripenem | 250 | mg | 500 | mg | | | | |
| Doxorubicin | 20 | mg | 50 | mg | | | | |
| Doxycycline Hyclate | 100 | mg | 200 | mg | | | | |
| Droperidol | 2.5 | mg | 5 | mg | | | | |
| Durvalumab | 120 | mg | 500 | mg | | | | |
| Elotuzumab | 300 | mg | 400 | mg | | | | |
| Enalaprilat | 1.25 | mg | 2.5 | mg | | | | |
| Epirubicin | 50 | mg | 200 | mg | | | | |
| Epoprostenol Sodium | 0.5 | mg | 1.5 | mg | | | | |
| Eptifibatide | 20 | mg | 75 | mg | 200 | mg | | |
| Erythromycin Lactobionate | 500 | mg | 1 | gm | | | | |
| Esmolol | 100 | mg | 2 | gm | 2.5 | gm | | |
| Esomeprazole | 20 | mg | 40 | mg | | | | |
| Etomidate | 20 | mg | 40 | gm | | | | |
| Etoposide | 100 | mg | 500 | mg | 1 | gm | | |
| Evolocumab | 140 | mg | 420 | mg | | | | |
| Famotidine | 20 | mg | 40 | mg | 200 | mg | | |
| Fenoldopam | 10 | mg | 20 | mg | | | | |
| Fentanyl | 100 | mcg | 250 | mcg | 500 | mcg | 1000 | mcg |
| Filgrastim | 300 | mcg | 480 | mcg | | | | |
| Floxacillin | 250 | mg | 500 | mg | 1 | gm | | |
| Fluconazole | 200 | mg | 400 | mg | | | | |
| Flumazenil | 0.5 | mg | 1 | mg | | | | |
| Fluorouracil (5-Fluorouracil) | 500 | mg | 1 | gm | 2.5 | gm | 5 | gm |
| Fosphenytoin | 100 | mgPE | 500 | mgPE | | | | |
| Furosemide | 20 | mg | 40 | mg | 100 | mg | | |
| Gentamicin (Adult Formulation) | 80 | mg | 800 | mg | | | | |
| Glycopyrrolate | 0.2 | mg | 0.4 | mg | 1 | mg | 4 | mg |
| Granisetron | 1 | mg | 4 | mg | | | | |
| Haloperidol Lactate | 5 | mg | 50 | mg | | | | |
| Hydrocortisone Sodium | 100 | mg | 250 | mg | 500 | mg | 1 | gm |
| Succinate | | | | | | | | |
| Hydromorphone Hydrochloride | | | | | | | | |
| Hydroxyzine | 25 | mg | 50 | mg | 100 | mg | 250 | mg |
| Ibuprofen - Caldolor brand | 400 | mg | 800 | mg | | | | |
| Idarubicin | 5 | mg | 10 | mg | 20 | mg | | |
| Ifosfamide | 1 | gm | 3 | gm | | | | |
| Imipenam/Cilastatin Sodium | 250 | mg | 500 | mg | | | | |
| Immune Globulin Human | ???? | | | | | | | |
| Iron Dextran | 50 | mg | 100 | mg | | | | |
| Insulin Regular | 30 | units | 100 | units | | | | |
| Interferone Alfa-2b | 10 million IU | | 18 million IU | | 50 million IU | | | |
| Iodixanol | 270 | mg | 550 | mg | 320 | mg | | |
| Iohexol | | | | | | | | |
| Iopamidol | | | | | | | | |
| Iothalmate Meglumine | | | | | | | | |
| Ioxaglate Meglumine and | | | | | | | | |
| Ioxaglate Sodium | | | | | | | | |
| Ipilimumab | 50 | mg | 200 | mg | | | | |
| Ironotecan | 40 | mg | 100 | mg | | | | |
| Isoproterenol | 0.2 | mg | 1 | mg | | | | |
| Isosorbide Dinitrate | 10 | mg | 50 | mg | 100 | mg | | |
| OTHER IRON PRODUCTS | | | | | | | | |
| Ketamine | 50 | mg | 100 | mg | 200 | mg | 250 | mg |
| Ketorolac | 15 | mg | 30 | mg | 60 | mg | | |
| Labetalol | 20 | mg | 40 | mg | 100 | mg | 200 | mg |
| Lenograstim | 13.4 million IU | | 33.6 million IU | | | | | |
| Leucovorin | 50 | mg | 100 | mg | 200 | mg | 350 | mg |
| Levetiracetam | 500 | mg | 1 | gm | 1.5 | gm | | |
| Levofloxacin | 250 | mg | 500 | mg | 750 | mg | | |
| Levothyroxine | 100 | mcg | 200 | mcg | 500 | mcg | | |
| Lidocaine Hydrochloride | 50 | mg | 100 | mg | 500 | mg | 1 | gm |
| Lincomycin | 600 | mg | 3 | gm | | | | |
| Linezolild | 200 | mg | 400 | mg | 600 | mg | | |
| Lorazepam | 2 | mg | 4 | mg | 20 | mg | 40 | mg |
| Magnesium Sulfate | | | | | | | | |
| Mannitol | | | | | | | | |
| Meropenem | 500 | mg | 1 | gm | | | | |
| Methotrexate | 50 | mg | 1 | gm | | | | |
| Methylprednisolone Acetate | 40 | mg | 80 | mg | 100 | mg | 200 | mg |
| Methylprednisolone Sodium | 40 | mg | 125 | mg | 500 | mg | 1 | gm |
| Succinate | | | | | | | | |
| Metoclopramide Hydrochloride | 10 | mg | 50 | mg | 150 | mg | | |
| Micafungin | 50 | mg | 100 | mg | | | | |
| Midazolam | 5 | mg | 10 | mg | 25 | mg | 50 | mg |
| Milrinone | 10 | mg | 20 | mg | 40 | mg | 50 | mg |
| Mitomycin | 5 | mg | 20 | mg | 40 | mg | 50 | mg |
| Nafcillin | 1 | gm | 2 | gm | | | | |
| Nalbuphine Hydrochloride | 10 | mg | 20 | mg | 100 | mg | 200 | mg |
| Naloxone | 0.04 | mg | 0.4 | mg | 2 | mg | 4 | mg |
| Neostigmine | 5 | mg | 10 | mg | | | | |
| Nimodipine | 10 | mg | 50 | mg | | | | |
| Nitroglycerin | 25 | mg | 50 | mg | | | | |
| Nivolumab | 40 | mg | 100 | mg | | | | |
| Ofatumumab | 100 | mg | 1000 | mg | | | | |
| Octreotide | 50 | mcg | 100 | mcg | 200 | mcg | 500 | mcg |
| Ondansetron | 4 | mg | 40 | mg | | | | |
| Oxacillin | 1 | gm | 2 | gm | | | | |
| Oxaliplatin | 50 | mg | 100 | mg | 200 | mg | | |
| Oxycodone Hydrochloride | 10 | mg | 20 | mg | | | | |
| Oxytocin | 10 | units | 100 | units | 300 | units | 500 | units |
| Paclitaxel | 30 | mg | 150 | mg | 300 | mg | | |
| Palivizumab | 50 | mg | 100 | mg | | | | |
| Palonsetron Hydrochloride | 0.075 | mg | 0.25 | mg | | | | |
| Pancuronium Bromide | 4 | mg | 10 | mg | | | | |
| Panitumumab | 100 | mg | 200 | mg | 400 | mg | | |
| Papaverine | 60 | mg | 300 | mg | | | | |
| Pembrolilzumab | 50 | mg | 100 | mg | | | | |
| Pentobarbital Sodium | 1 | gm | 2.5 | gm | | | | |
| Phenobarbital | 30 | mg | 60 | mg | 65 | mg | 130 | mg |
| Phenylephrine Hydrochloride | 10 | mg | 50 | mg | 100 | mg | | |
| Phenytoin Sodium | 100 | mg | 250 | mg | | | | |
| Phytonadione | 1 | mg | 10 | mg | 50 | mg | | |
| Piperacillin Sodium/ | 2.25 gm (2 gm/250 mg) | | 3.375 gm (3 gm/750 mg) | | 4.5 gm (4 gm/500 mg) | | | |
| Tazobactam Sodium | | | | | | | | |
| Potassium Acetate | 40 | mEq | 100 | mEq | 200 | mEq | | |
| Potassium Chloride | 15 | mEq | 20 | mEq | | | | |
| Potassium Phosphates | 15 | mMol | 45 | mMol | | | | |
| Prochlorperazine Edisylate | 10 | mg | 50 | mg | | | | |
| Promethazine Hydrochloride | 25 | mg | 50 | mg | | | | |
| Propofol | 200 | mg | 500 | mg | 1 | gm | | |
| Protamine Sulfate | 50 | mg | 250 | mg | | | | |
| Pyridoxine Hydrochloride | 100 | mg | 1 | gm | 3 | gm | | |
| Quinpristin/Dalfopristin | 500 | mg | 600 | mg | | | | |
| Ramucirumab | 100 | mg | 500 | mg | | | | |
| Ranibizumab | 6 | mg | 10 | mg | | | | |
| Ranitidine Hydrochloride | 50 | mg | 150 | mg | 1 | gm | | |
| Rasburicase | 1.5 | mg | 7.5 | mg | | | | |
| Remifentanil Hydrochloride | 1 | mg | 2 | mg | 5 | mg | | |
| Rituximab | 100 | mg | 500 | mg | | | | |
| Rituximab Hyaluronidase | 1400 mg/23,400 units | | 1600 mg/26,800 units | | | | | |
| Rocuronium Bromide | 50 | mg | 100 | mg | | | | |
| Ropivacaine Hydrochloride | 2 | mg | 5 | mg | 7.5 | mg | 200 | mg |
| Scopolamine Hydrobromide | 0.4 | mg | 1 | mg | | | | |
| Iron Sucrose | 100 | mg | 200 | mg | | | | |
| Siltuximab | 100 | mg | 400 | mg | | | | |
| Sodium Acetate | 40 | mEq | 100 | mEq | 200 | mEq | 400 | mEq |
| Sodium Bicarbonate | VARIOUS SIZES | | | | | | | |
| Sodium Chloride | VARIOUS SIZES | | | | | | | |
| Sodium Phosphates | 15 | mMol | 45 | mMol | 150 | mMol | | |
| Somatropin | 1.5 mg-24 mg | | | | | | | |
| Sorilumab | 150 | mg | 200 | mg | | | | |
| Succinylcholine Chloride | 100 | mg | 200 | mg | | | | |
| Sufentanil Citrate | 50 | mcg | 100 | mcg | 250 | mcg | | |
| Sugammadex Sodium | 200 | mg | 500 | mg | | | | |
| Sumatriptan Succinate | 4 | mg | 6 | mg | | | | |
| Teicoplanin | 200 | mg | 400 | mg | | | | |
| Telavancin Hydrochloride | 250 | mg | 750 | mg | | | | |
| Tenoxicam | 20 | mg | 40 | mg | | | | |
| Theophylline | VARIOUS SIZES | | | | | | | |
| Thiamine Hydrochloride | 100 | mg | 200 | mg | | | | |
| Tirofigan Hydrochloride | 5 | mg | 12.5 | mg | | | | |
| Tobramycin Sulfate | 20 | mg | | | | | | |
| Pediatric Formulation | | | | | | | | |
| Tobramycin Sulfate | 60 | mg | 80 | mg | 2 | gm | | |
| Adult Formulation | | | | | | | | |
| Tocilizumab | 80 | mg | 200 | mg | 400 | mg | | |
| Torsemide | 20 | mg | 50 | mg | | | | |
| Tramadol Hydrochloride | 50 | mg | 100 | mg | | | | |
| Trastuzumab | 150 | mg | 420 | mg | | | | |
| Treprostinil Sodium | 10 | mg | 25 | mg | 50 | mg | 200 | mg |
| Trimethobenzamide | 200 | mg | 2 | gm | | | | |
| Trimethoprim/Sulfamethoxazole | 80 mg/400 mg | | 160 mg/800 mg | | 480 mg/2400 mg | | | |
| Tropisetron Hydrochloride | 2 | mg | 5 | mg | | | | |
| Vancomycin Hydrochloride | 500 | mg | 1 | gm | 5 | gm | 10 | gm |
| Vasopressin | 20 | units | | | | | | |
| Vecuronium | 10 | mg | 20 | mg | | | | |
| Verapamil Hydrochloride | 5 | mg | 10 | mg | | | | |
| Vincristine Sulfate | 1 | mg | 2 | mg | | | | |
| Vinorelbine Tartrate | 10 | mg | 50 | mg | | | | |
| Ziconotide Acetate | 100 | mcg | 200 | mcg | 500 | mcg | | |
| Ziv-Aflibercept | 100 | mg | 200 | mg | | | | |

: [00272] As shown below is a table of injectable drugs and currently commercially available packaged amounts the drugs are supplied in by drug manufacturers. The amounts listed below in Table 2 are referred to as “standard amounts” as the drug manufacturers and the Food and Drug Administration have decided to commercially supply and give regulatory approval for the following amounts. The below drugs may be prepared and administered to patients using embodiments of the present invention:

TABLE 2

| | |
|---|---|
| | Commercially |
| Injectable | Available Amounts |
| Medicament | Column A Amount |

| | | |
|---|---|---|
| Abciximab | 2 | mg |
| Acetaminophen | 1000 | mg |
| Acetazolamide | 500 | mg |
| Ado-trastuzumab | 160 | mg |

| | |
|---|---|
| Aldesleukin | 22 million IU |

| | | |
|---|---|---|
| Alefacept | 15 | mg |
| Alemtuzumab | 30 | mg |
| Alfentanil | 2 | ml |
| Allopurinol | 500 | mg |
| Alprostadil | 500 | mcg |
| Amifostine | 500 | mg |
| Aminocaproic Acid | 5 | gm |
| Ammonium Chloride | 100 | mEq |
| Amoxicillin | 250 | mg |
| Amsacrine | 75 | mg |
| Antithymocyte | 25 | mg |
| Globulin Rabbit | | |
| Argatroban | 250 | mg |
| Aripiprazole | 9.75 | mg |
| Arsenic Trioxide | 10 | mg |
| Asparaginase Erwinia | 10,000 | IU |
| Chrysanthemi | | |
| Atezolizumab | 1200 | mg |
| Azathioprine Sodium | 100 | mg |
| Azithromycin | 500 | mg |
| Baclofen | 10 | mg |
| Benztropine | 2 | mg |
| Bezlotoxumab | 1000 | mg |
| Bivalirudin | 250 | mg |
| Blinatumomab | 35 | mcg |
| Bortezomib | 3.5 | mg |
| Brentuximab | 50 | mg |
| Bretylium Tosylate | 500 | mg |
| Brivaracetam | 500 | mg |
| Brodalumab | 210 | mg |
| Buprenorphine | 0.3 | mg |
| Busulfan | 6 | mg |
| Calcitriol | 1 | mcg |
| Calcium Chloride | 1 | gm |
| Canakinumab | 150 | mg |
| Cangrelor | 50 | mg |
| Capromab | 0.5 | mg |
| Carbamazepine | | |
| Carmustine | 100 | mg |

| | |
|---|---|
| Ceftolozane Sulfate/ | 1.5 gm (1 gm/0.5 gm) |
| Tazobactam Sodium | |

| | | | |
|---|---|---|---|
| Ceftolizumab | 200 | mg | |
| Chloramphenicol | 1 | gm | |
| Chlorothiazide | 500 | mg | |
| Cidofovir | 375 | mg | |
| Cladribine | 10 | mg | |
| Clarithromycin | 500 | mg | |
| Clonazepam | 1 | mg | |
| Colistimethate | 150 | mg | |
| Conivaptan | 20 | mg | |
| Cyclizine Lactate | 50 | mg | |
| Cyclosporine | 250 | mg | |
| Daclizumab | 25 | mg | 150 mg |
| Dactinomycin | 0.5 | mg | |
| Dalbavancin | 500 | mg | |
| Dantrolene | 500 | mg | |
| Daptomycin | 500 | mg | |
| Daunorubicin | 20 | mg | |
| Denosumab | 60 | mg | |
| Diclofenac Sodium | 37.5 | mg | |
| Dinutuximab | 17.5 | mg | |
| Diphenhydramine | 50 | mg | |
| Doxapram | 20 | mg | |
| Dupilumab | 300 | mg | |
| Eculizumab | 300 | mg | |
| Edetate Calcium | 500 | mg | |
| Disodium | | | |
| Efalizumab | 125 | mg | |
| Ephedrine | 50 | mg | |
| Ertapenem | 1 | gm | |
| Estrogens Conjugated | 25 | mg | |
| Ethacrynate Sodium | 50 | mg | |
| Floxuridine | 500 | mg | |
| Fludarabine | 50 | mg | |
| Fluphenazine | 25 | mg | |
| Hydrochloride | | | |
| Folic Acid | 50 | mg | |
| Fomepizole | 1.5 | mg | |
| Fosaprepitant | 150 | mg | |
| Dimeglumine | | | |
| Foscarnet | 6 | gm | |
| Fusidate Sodium | 500 | mg | |
| Gallium | 500 | mg | |
| Ganciclovir | 500 | mg | |
| Gemcitabine | 200 | mg | |
| Gemtuzumab | 5 | mg | |
| Gentamicin Pediatric | 20 | mg | |
| Formulation | | | |
| Golimumab | 50 | mg | |
| Guselkumab | 100 | mg | |
| Hyaluronidase | 150 | units | |
| Hydralazine | 20 | mg | |
| Ibandronate Sodium | 3 | mg | |
| Ibuprofen Lysinate | 20 | mg | |
| Ibutilide | 1 | mg | |
| Ibritumomab | 3.2 | mg | |
| Tiuxetan | | | |
| Idarucizumab | 2.5 | gm | |
| Indomethacin Sodium | 1 | mg | |
| Trihydrate | | | |
| Infliximab | 100 | mg | |
| Iodipamide | 20 | ml | |
| Meglumine 52% | | | |

| | |
|---|---|
| Isavuconazium sulfate | 300 mg sulfate = 200 mg |

| | | |
|---|---|---|
| Ixekizumab | 80 | mg |
| Lepirudin | 50 | mg |
| Mechlorethamine | 10 | mg |
| Hydrochloride | | |
| Melphalan | 10 | mg |
| Hydrochloride | | |
| Mepolizumab | 100 | mg |
| Mesna | 1 | gm |
| Methadone | 200 | mg |
| Methocarbamol | 1 | gm |
| Methohexital Sodium | 200 | mg |
| Methotrimeprazine | 25 | mg |
| Hydrochloride | | |
| Methyldopate | 250 | mg |
| Hydrochloride | | |
| Metoprolol | 5 | mg |
| Metronidazole | 500 | mg |
| Mexilitene | 250 | mg |
| Hydrochloride | | |
| Mitoxantrone | 2 | mg |
| Moxifloxacin | 400 | mg |
| Multivitamins | 5 | ml |
| Mycophenolate | 500 | mg |
| Natalizumab | 300 | mg |
| Necitumumab | 800 | mg |
| Nesiritide | 1.5 | mg |
| Nicardipine | 25 | mg |
| Norepinephrine | 4 | mg |
| Obiltoxaximab | 600 | mg |
| Obinutuzumab | 1 | gm |
| Ocrelizumab | 300 | mg |
| Olaratumab | 500 | mg |
| Omaliumab | 150 | mg |
| Omeprazole | 40 | mg |
| Oritavancin | 400 | mg |
| Diphosphate | | |
| Pantoprazole | 40 | mg |
| Pemetrexed | 500 | mg |

| | |
|---|---|
| Penicillin G | 5 million units |
| Potassium | |

| | | | |
|---|---|---|---|
| Pentamidine | 300 | mg | |
| Isethionate | | | |
| Pentazocine | 30 | mg | |
| Pentostatin | 10 | mg | |
| Peramivir | 10 | mg | |
| Pertuzumab | 420 | mg | |
| Phentolamine | 5 | mg | |
| Mesylate | | | |
| Polymyxin B Sulfate | 500,000 | units | |
| Posaconazole | 300 | mg | |
| Pralidoxime | 1 | gm | |
| Procainamide | 1 | gm | |
| Propranolol | 1 | mg | |
| Hydrochloride | | | |
| Quinidine Gluconate | 800 | mg | |
| Raxibacumab | 1700 | mg | |
| Reslizumab | 100 | mg | |
| Reteplase | 10.4 | units | 18.1 mg |
| Rifampin | 600 | mg | |
| Salbutamol | 500 | mcg | |
| Sargramostim | 250 | mcg | |
| Scopolamine | 20 | mg | |
| Butylbromide | | | |
| Secukinumab | 150 | mg | |
| Sodium Ferric | 62.5 | mg | |
| Gluconate Complex | | | |
| Sodium Lactate | 50 | mEq | |
| Sodium Nitroprusside | 50 | mg | |
| Sodium Thiosulfate | 12.5 | gm | |
| Streptomycin Sulfate | 1 | gm | |
| Streptozocin | 1 | gm | |
| Tacrolimus | 5 | mg | |
| Tedizolid Phosphate | 200 | mg | |
| Teniposide | 50 | mg | |
| Terbutaline Sulfate | 1 | mg | |
| Tetracaine | 20 | mg | |
| Hydrochloride | | | |
| Thiotepa | 15 | mg | |

| | |
|---|---|
| Ticarcillin Disodium/ | 3.1 gm (3 mg/100 mg) |
| Clavulanate Potassium | |

| | | |
|---|---|---|
| Tigecycline | 50 | mg |
| Topotecan | 4 | mg |
| Hydrochoride | | |
| Tranexamice Acid | 1 | gm |
| Ustekinumab Intravenous | 130 | mg |
| Formulation | | |
| Valproate | 500 | mg |
| Vedolizumab | 300 | mg |
| Vinblastine Sulfate | 10 | mg |
| Vincristine | | |
| Vincristine Sulfate | 5 | mg |
| Liposomal | | |
| Vitamin A | 100,000 | IU |
| Voriconazole | 200 | mg |
| Zidovudine | 200 | mg |
| Zoledronic Acid | 4 | mg |
| Bacitracin | 50,000 | units |
| Chromium (chromic | 40 | mcg |
| chloride injection) | | |
| Copper (cupric | 4 | mg |
| chloride injection) | | |
| Carfilzomib | 1000 | mg |

“mg” milligrams
“IU” international units
“ml” milliliters
“mcg” micrograms
“gm” grams
“mEq” milliequivalents

The list of drugs set forth above are non-exhaustive and other drugs can be administered via embodiments of the present invention. Moreover, the drugs can be provided in a commercially packaged unit and then administered to patients using embodiments of the present invention.

The present invention is counterintuitive with current FDA thinking and guidance which states that drug manufacturers should package drugs in amounts that would typically provide one dose to a patient. The present invention requires drug manufacturers to package medicaments and beneficial substance in amounts that would typically require the use of more than one or a plurality of vials/containers to provide a typical single dose to a patient. FDA recommends that a drug product's vial fill size should be appropriate for the labeled use of the product. FDA may request justification when there are questions about the proposed labeled fill sizes in an application. When deciding what is appropriate, applicants should consider the following as set forth in the U.S. Department of Health and Human Services Food and Drug Administration Center for Drug Evaluation and Research (CDER) Center for Biologics Evaluation and Research (CBER) June 2015 Pharmaceutical Quality/CMC:
Single dose vials should not contain a significant volume beyond what would be considered a usual or maximum dose for the expected use of the drug product.
Consumers and/or healthcare providers should not be routinely required to use more than one vial to administer a typical single dose of the drug product.
Multiple-dose vials should contain no more than 30 mL of drug product expect under specific circumstances.

In embodiments of the present invention, modular systems “routinely” require the use of more than one vial to prepare or administer a typical single dose of the drug product to a patient or animal. In one or more embodiments, routinely may mean at least 50% of the time it is required to use more than one vial to prepare or administer a typical single dose of the drug product.

In embodiments of the present invention, the dosing and assembly involves the preparation/assembly of customized amounts of medicaments in a ready-to-use/ready-to-assembly format. In embodiments of the present invention, a combination of vessels with a plurality of ports and containers housing non-standard amounts of beneficial substances/medicaments provide for customization of a final assembled dose for a patient. In embodiments of the invention, multiple drugs and/or therapies can be administered to a patient via a vessel or modular construction of containers.

In embodiments of the invention, the vessel and containers include decontamination devices and/or interfaces. In embodiments of the invention, the decontamination devices and interfaces include external, internal, moveable wiper, and static wiper decontamination devices.

In embodiments of the invention, the decontamination devices may be attached to a port or abut a wall of container. In embodiments of the invention, the decontamination devices are integrally attached to the vessel and or containers. In embodiments of the invention, the decontamination devices are in a unitary structure or arrangement with the vessel or container.

In embodiments of the invention, the entry ports include engagement mechanisms abutting the wall of the vessel or container. In embodiments of the invention, the entry ports include engagement mechanisms surface mounted to the wall of the vessel or container. In embodiments of the invention, the entry ports include engagement mechanisms flush mounted to the wall of the vessel or container. In embodiments of the invention, the entry ports include flush mounted engagement mechanisms. In embodiments of the invention, the entry ports include surface mounted engagement mechanisms. In embodiments, of the invention, the entry ports abutting a wall of the container. Advantages of providing entry ports that are surface mounted, flush mounted, and/or abut a container (or a wall of a container) is that there is less chance of bending/breaking of the port when attaching vials/syringes to the port. Bag ports of typically made of plastic material that can bend or break and surface mounted and/or flush mounted ports decrease bending/breaking of the port structure.

In certain embodiments, the methods and systems are useful for pediatric, geriatric, and oncology patients. These patient populations require customized/individualized dosing of injectable medicaments based on age, weight, and/or body surface area.

In certain embodiments, the methods and systems involve preparation of oncology injectable drugs. In certain embodiments, the methods and systems involve dosing a chemotherapeutic/oncolytic/oncology medicament. In certain embodiments, the modular assembly obviates need to mix or intermix hazardous drug products. In certain embodiments, the methods, devices, containers and systems involve assembly of a customized/individualized amount of a medicament or other beneficial substance using commercially prepackaged containers.

In certain embodiments, the methods and systems involve double checking dosing regimens administered to patients. In certain embodiments, the dosing regimens have two double checks: (1) product double check of customized final amount; and (2) dosage double check of customized final amount.

In certain embodiments, the methods and systems involve providing amounts of drugs packaged by a manufacturer in a ready to assemble format in amounts less than about 10% of the amount in Table 1 Column A. For example, if Table 1 Column A amount is 100 milligrams (mg) then an amount less than about 10% of a column Table 1 Column A amount is 10 mg or less. “about” includes 10 mg”. For example, less than about 10% of 100 mg is any of the following 10 mg, 9 mg, 8 mg, 7 mg, 6 mg, 2 mg, 1 mg, 0.5 mg, 0.1 mg, etc.

In certain embodiments, the non-standard amounts of drug involve amounts of drug that are not commonly provided by a drug manufacturer. FDA or another regulatory body would never in the current state of the art approve a non-standard amount that would require a typical user to use 2, 3, 4, 5, 6 or more vials/containers to prepare a single final dose amount for a patient.

In certain embodiments, the present invention provides for the packaging by a drug manufacturer or packager non-standard amounts of beneficial substance and/or drugs in ready to assemble containers. On the lower end of the spectrum commercially prepackaged non-standard amount may be: less than about 25% of a Table 1 Column A amount or Table 2 Column A amount, less than about 20% of a Table 1 Column A amount or a Table 2 Column A amount, less than about 10% of a Table 1 Column A amount or a Table 2 Column A amount, less than about 5% of a Table 1 Column A amount or a Table 2 Column A amount, less than about 3% of a Table 1 Column A or Table 2 Column A amount, less than about 2% of a Table 1 Column A or Table 2 Column A amount, and/or less than about 1% of a Table 1 Column A or Table 2 Column A amount.

In an aspect of the present invention, a vessel having a plurality of entry ports configured to engage a plurality of containers and a plurality of containers housing a beneficial substance and/or a medicament provides for a modular assembly of a final amount of a beneficial substance and/or a medicament.

In an aspect of the present invention, a vessel having a plurality of entry ports configured to engage a plurality of containers and at least one container housing a beneficial substance and/or medicament in a nonstandard amount and at least one container housing a beneficial substance and/or medicament in a standard amount provides for a modular assembly of a final amount of a beneficial substance and/or a medicament.

In an aspect of the present invention, a vessel having a plurality of entry ports configured to engage a plurality of containers and a plurality of containers housing a beneficial substance and/or medicament in a nonstandard amount provides for a modular assembly of a final amount of a beneficial substance and/or a medicament.

A further purpose of this invention is to provide a vessel and entry port that reduces the presence of non-purified air and/or air particles when mixing materials into a vessel. This invention focuses on modular systems and systems to connect dosing regimens to vessel to administer non-standard final amounts to patients.

In a certain aspect of the present invention, the present invention provides a manifold having a plurality of openings or ports configured to connect to a plurality of containers; and a plurality of containers housing a beneficial substance, wherein at least one of the plurality of containers houses a beneficial substance in a nonstandard amount. In one or more embodiments, the opening or ports of the manifold are configured to connect/couple with a plurality of connectors which in turn couple with a plurality of containers housing a beneficial substance. In certain embodiments, at least one of the containers housing a beneficial substance in a nonstandard amount. In certain embodiments, the manifold further comprising a single unitary multiple entry port structure or a peripheral wall enclosing cavity for accommodating the plurality of the containers. In certain embodiments, the manifold further comprising a single unitary multiple entry port structure and a peripheral wall enclosing cavity for accommodating the plurality of the containers. In certain embodiments, the manifold further comprising at least one decontamination device.

In a certain aspect of the present invention, the present invention provides a connector with a plurality of openings or ports configured to connect to at least two containers; and a plurality of containers. In one or more embodiments, one of the at least two containers houses a beneficial substance in a nonstandard amount. In certain embodiments, the connector further comprising a single unitary multiple entry port structure or a peripheral wall enclosing cavity for accommodating the plurality of the containers. In certain embodiments, the connector further comprising a single unitary multiple entry port structure and a peripheral wall enclosing cavity for accommodating the plurality of the containers. In certain embodiments, the connector further comprising at least one decontamination device.

In another aspect, the present invention provides a system for the assembly of a beneficial substance, the system comprising: a first container having at least one entry port configured to engage a second container; a second container having at least one entry port and at least one exit port, wherein the at least one entry port is configured to engage a third container and the at least one exit port is configured to engage the first container; at least a third container having at least one exit port; wherein upon engagement of the first container to the second container, and upon engagement of the second container to the third container, the contents of the third container flows into the second container and flows-through along with the contents of the second container into the first container. In one or more embodiments, the system for assembling the beneficial substance is modular by design. In one or more embodiments, a fourth container, a fifth container, or six or more containers may be provided by the system allowing a user of the system to modularly assemble any final amount of a beneficial substance and/or medicament.

In certain embodiments, the second container houses a beneficial substance, wherein the beneficial substance from the third container flows-through the second container and into the first container. In one or more embodiments, the modular system provides beneficial substances and/or medicaments in commercially packaged non-standard amounts. In one or more embodiments, commercially packaged means prepackaged. In one or more embodiments, commercially packaged means packaged by a drug/pharmaceutical manufacturer.

Referring to the figures:

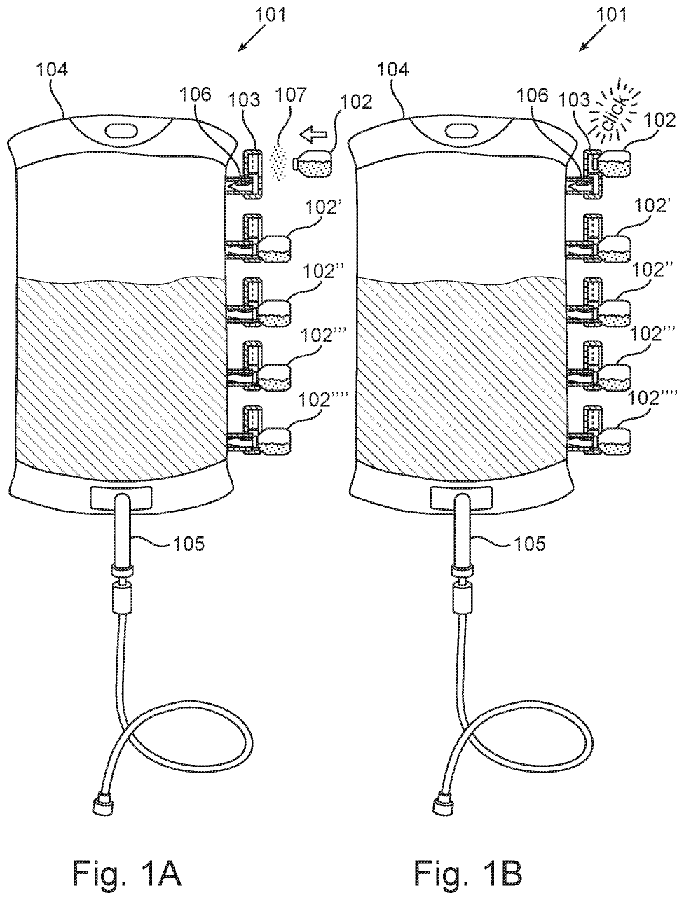

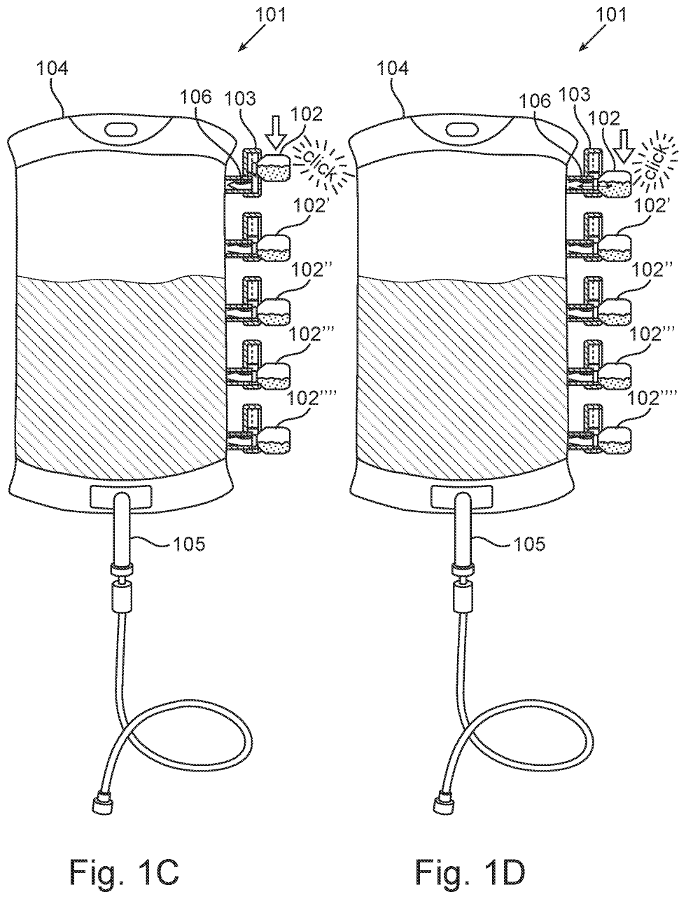

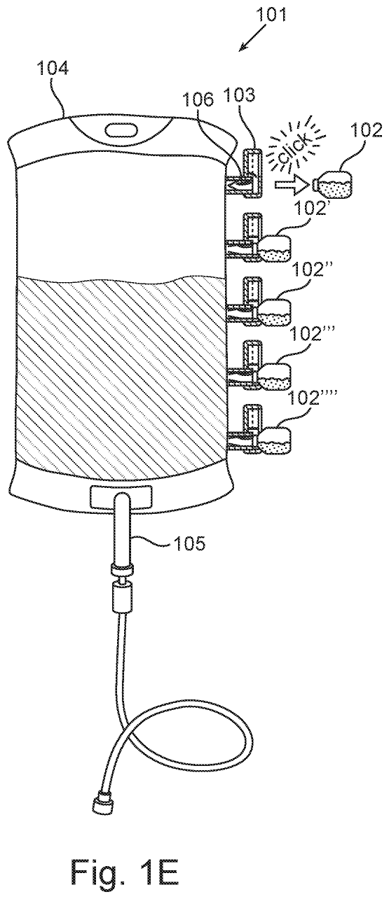

FIGS. 1A-1D are schematic front cut view illustrations presenting an exemplary system 101 which includes an IV bag 104 having a plurality of entry ports 103 and an exit port 105, wherein a plurality of containers 102 are received and engaged by the plurality of entry ports 103 to transfer a dose from the plurality of containers to the IV bag, according to some embodiments of the invention.

As shown in FIG. 1A, contaminants 107 are present between container 102 and entry port 103. In FIG. 1B, container 102 is engaged with entry port 103 and a “click” sound is made. Once the click sound is made, the container 102 is able to slide from a first compartment in the entry port 103 to a second compartment in the entry port 103 as shown in FIG. 1C. The contaminants 107 are not able to enter the second compartment as a wiping member is provided that removes the contaminants from the surface of container 102. The wiping member is disposed between the first and second compartments. In one or more embodiments, the “click” sound may be any other sound that alerts the user that container 102 is engaged to port 103 of IV bag 104.

FIG. 1D shows the transfer of dose from the container 102 through the entry port 103 into the IV bag 104 through which is a contaminant-free fluid passageway. In certain embodiments, a piercing member 106 is provided, such that upon movement of the container 102 from the first compartment to the second compartment, the piercing member 106 pierces the cap or bung and/or seal of container 102, and allows the dose to pass through the contaminant-free fluid passageway, as shown in FIG. 1D. After the dose is transferred to the IV bag 104, FIG. 1E shows the removal of the container 102 from the entry port 103. In certain embodiments, the entry port 103 has a one way valve, so that air and contaminants 107 are not able to enter the IV bag 104. In one or more embodiments, entry port 103 is a decontamination device. In one or more embodiments, IV bag 104 is a container. In one or more embodiments, the container 104 is a bottle. In one or more embodiments, the interior of container 104 has a pressure less than ambient air pressure, ambient air pressure at sea level, and/or atmospheric pressure. In one or more embodiments, container 104 has an interior pressure less than the pressure of container 102. In one or more embodiments, container 104 has an interior pressure less than the pressure of the plurality of containers 102 that connect/couple with ports 103 of container 104. In one or more embodiments, the decontamination device (103) has a wiping member disposed within the decontamination device 103. In one or more embodiments, the decontamination device 103 has a rail or hinge mechanism (not shown). In one or more embodiments, the decontamination device 103 has an engagement mechanism configured to engage container 102. In one or more embodiments, container 104 is a bag. In one or more embodiments, container 104 is an intravenous bag. In one or more embodiments, the container 104 has a plurality of decontamination devices 103. In one or more embodiments, the container 104 has a plurality of decontamination devices 103 with a plurality of wiping member disposed within the decontamination devices 103. In one or more embodiments, the decontamination devices 103 are integrally manufactured with the container. In one or more embodiments, the container 104 is a bag 104. In one or more embodiments, the container 104 is a bottle. In one or more embodiments, the container 104 has a plurality of decontamination devices 103. In one or more embodiments, the decontamination devices 103 are integrally manufactured and form a unitary structure with container 104.

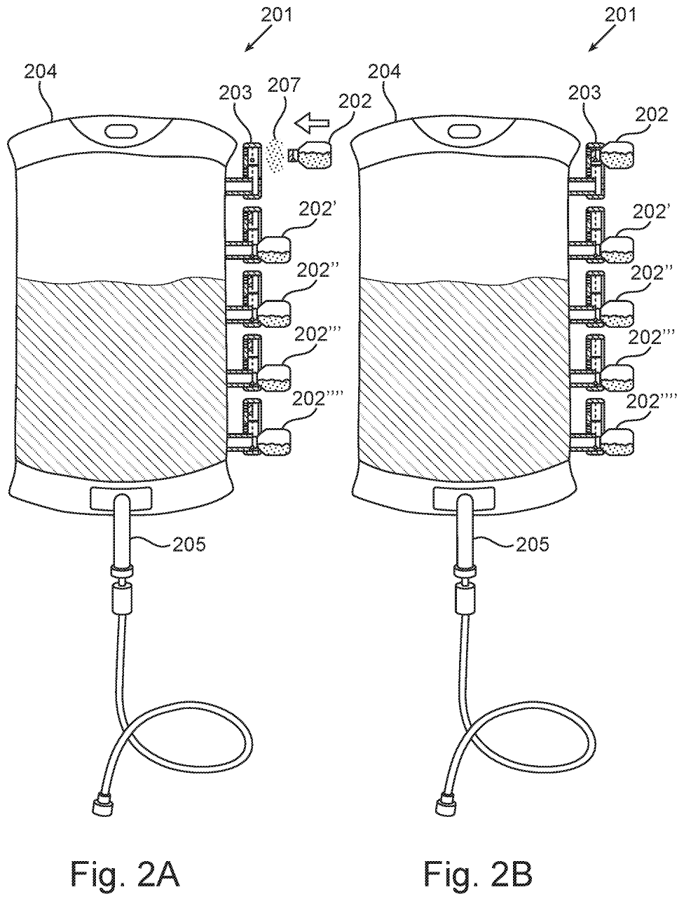

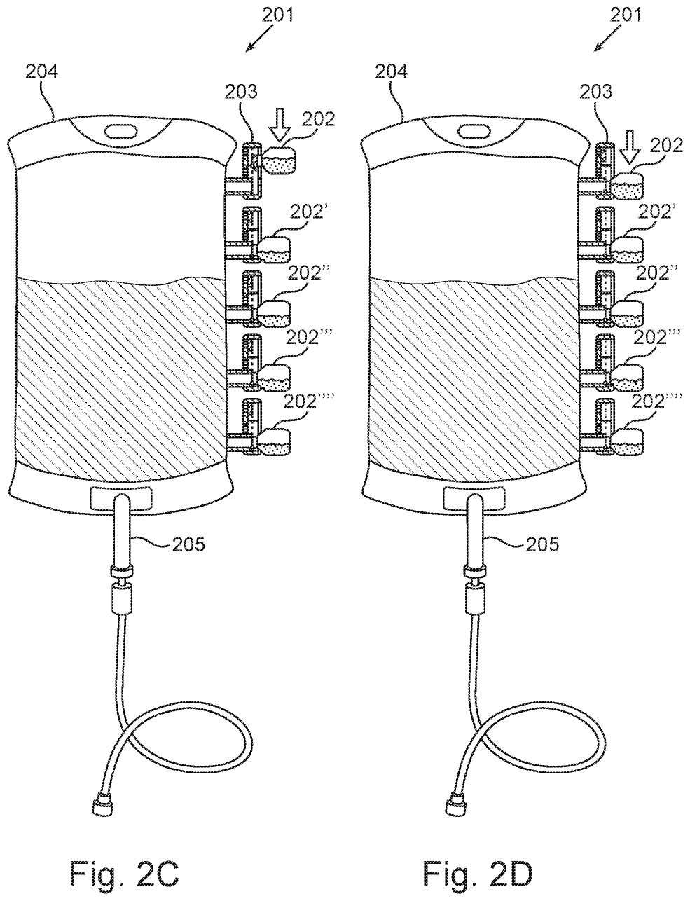

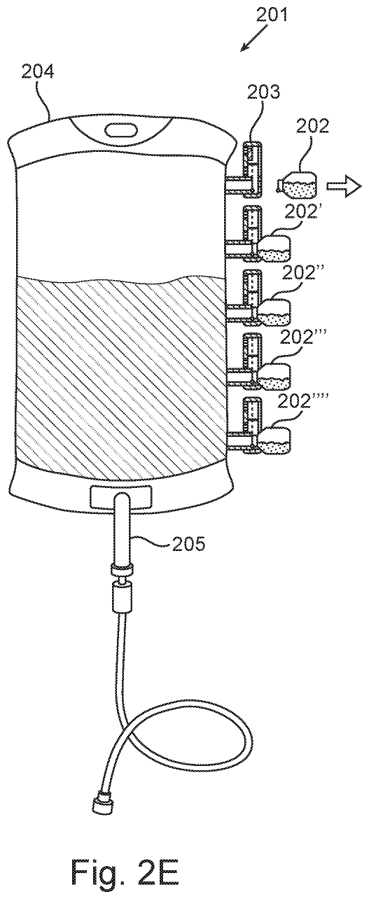

FIGS. 2A-2E are schematic front cut view illustrations presenting a further exemplary system 201 which includes an IV bag 204 having a plurality of entry ports 203 and an exit port 205, wherein a plurality of containers 202 are received and engaged by the plurality of entry ports 203 to transfer a dose from the plurality of containers 202 to the IV bag 204, according to some embodiments of the invention.

As shown in FIG. 2A, contaminants 207 are present between container 202 and entry port 203. In FIG. 2B, container 202 is engaged with entry port 203. The container 202 is able to slide from a first (top) compartment in the entry port 203 to a second (bottom) compartment in the entry port 203 as shown in FIG. 2C. The contaminants 207 are not able to enter the second compartment as a wiping member is provided that removes the contaminants from the surface of container 202. The wiping member is disposed inside entry port 203 and extends between the left and right side walls of the entry port 203. The wiping member separates the first (top) compartment from the second (bottom) compartment of port 203.

FIG. 2D shows the transfer of dose from the container 202 through the entry port 203 into the IV bag 204 through which is a contaminant-free fluid passageway. After the dose is transferred, FIG. 2E shows the removal/detachment of the container 202 from the entry port 203. In certain embodiments, the entry port 203 has a one-way valve (not shown), so that air and contaminants 207 are not able to enter the IV bag 204. In one or more embodiments, the plurality of entry ports 203 are decontamination devices. In one or more embodiments, the decontamination devices may be three, four or five compartment decontamination devices. In one or more embodiments, the decontamination devices have a plurality of internally separated compartments. In one or more embodiments, at least one of the compartments of the decontamination devices houses a sterilizing and/or disinfecting substance.

In one or more embodiments, containers 202 house a beneficial substance and/or a medicament. In one or more embodiments, the beneficial substance and/or medicament is in an nonstandard amount. In one or more embodiments, a plurality of the containers houses a beneficial substance in a nonstandard amount. In one or more embodiments, at least one of the containers 202 houses a beneficial substance/medicament in a standard amount and at least one of the container 202 houses a beneficial substance/medicament in a nonstandard amount. Container 204 may be empty or may container a fluid such as a diluent. Containers 202 may container a medicament or any other beneficial substance (such as nutritional substances, diagnostic substances, etc.). FIG. 2E illustrates a system wherein a container 204 is provided with a plurality of decontamination devices 203 and a plurality of containers 202 containing a medicament in nonstandard amounts, standard amounts, and combinations thereof. Decontamination devices 203 are shown attached to bag 204, however decontamination devices my alternately be provided attached to containers 202 in which case container 204 will not have decontamination devices attached to it. Optionally, or alternately, both container 204 and containers 202 may both have decontamination devices attached to them.

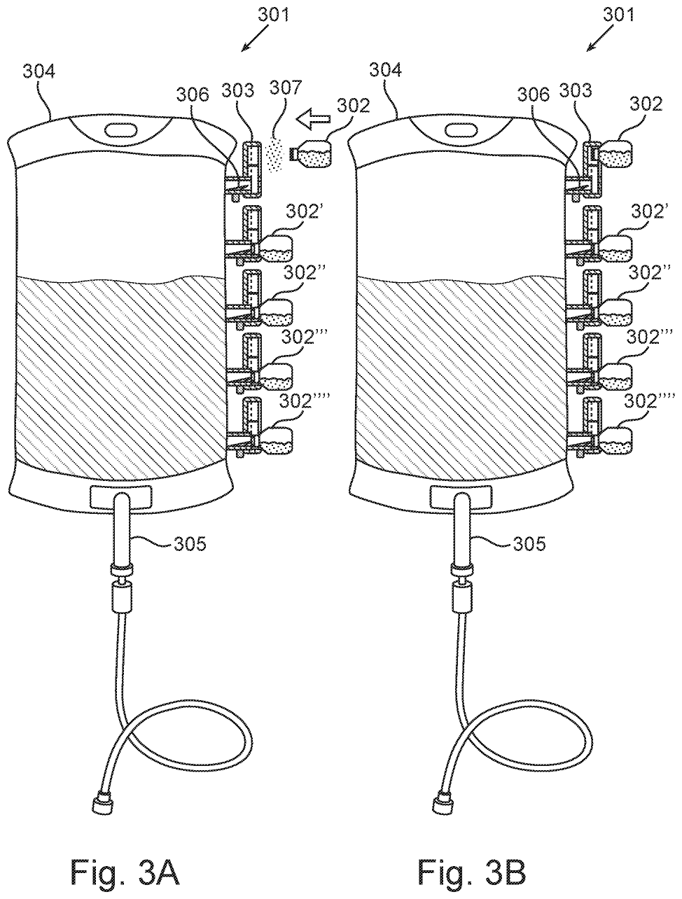

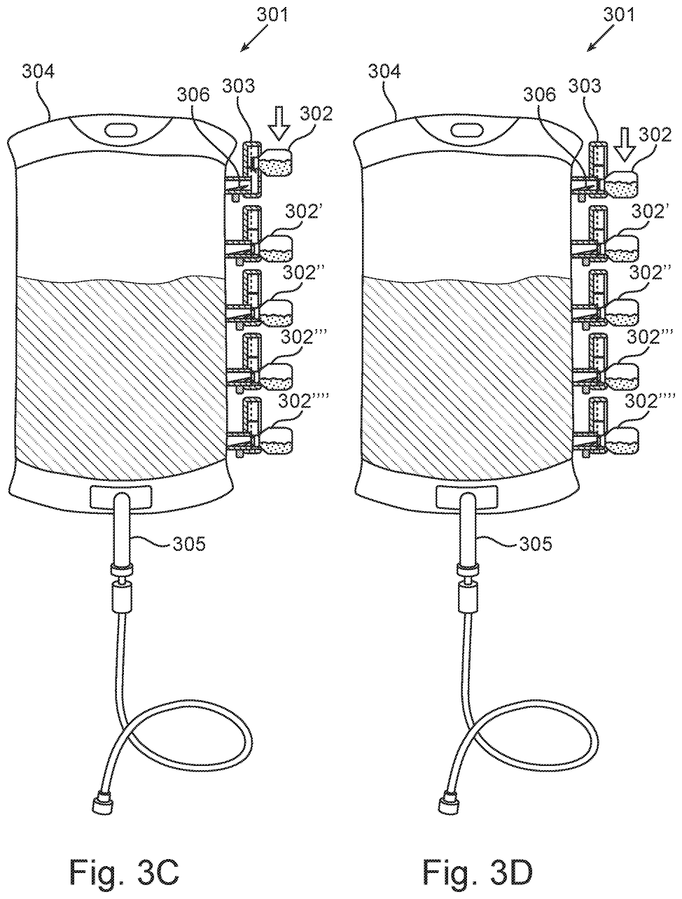

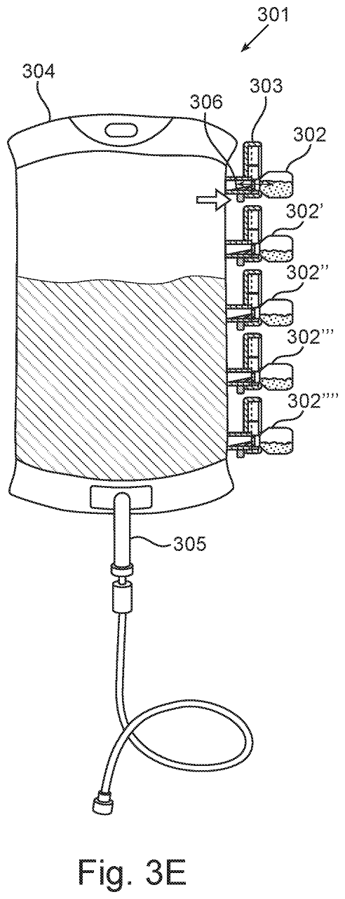

FIGS. 3A-3E are schematic front cut view illustrations presenting a further exemplary system which includes an IV bag 304 having a plurality of entry ports 303 and an exit port 305, wherein a plurality of containers 302 are received and engaged by the plurality of entry ports 303 to transfer a dose from the plurality of containers 302 to the IV bag 304, according to some embodiments of the invention.

As shown in FIG. 3A, contaminants 307 are present between container 302 and entry port 303. In FIG. 3B, container 302 is engaged with entry port 303. The container 302 is able to slide from a first compartment in the entry port 303 to a second compartment in the entry port 303 as shown in FIG. 3C. The contaminants 307 are not able to enter the second compartment as a wiping member is provided that removes the contaminants from the surface of container 302.

FIG. 3D shows the transfer of dose from the container 302 through the entry port 303 into the IV bag 304 through which is a contaminant-free fluid passageway. In certain embodiments, a piercing member 306 is provided, such that upon movement of the container 302 from the first compartment to the second compartment, the piercing member 306 pierces the cap, bung, and/or seal of the container 302 and allows the dose to pass through the contaminant-free fluid passageway, as shown in FIG. 3E. In one or more embodiments, the movement of container 302 within the port 303 actuates and/or causes the piercing member 306 to pierce a surface of container 302. FIG. 3E shows how a user must manually push the container 302 towards the IV bag 304, or optionally how a user must manually push IV bag 304 towards container 302, thus causing the piercing member 306 to pierce the cap and/or seal of container 302. In this manner, the dose or amount in container 302 is able to pass through the contaminant-free fluid passageway. In certain embodiments, the entry port 303 has a one way valve (not shown), so that air and contaminants 307 are not able to enter the IV bag 304. In certain embodiments, entry port 303 is a decontamination device. In certain embodiments, the entry port 303 and/or decontamination device 303 is integrally manufactured with and/or forms a unitary structure with IV bag 304.

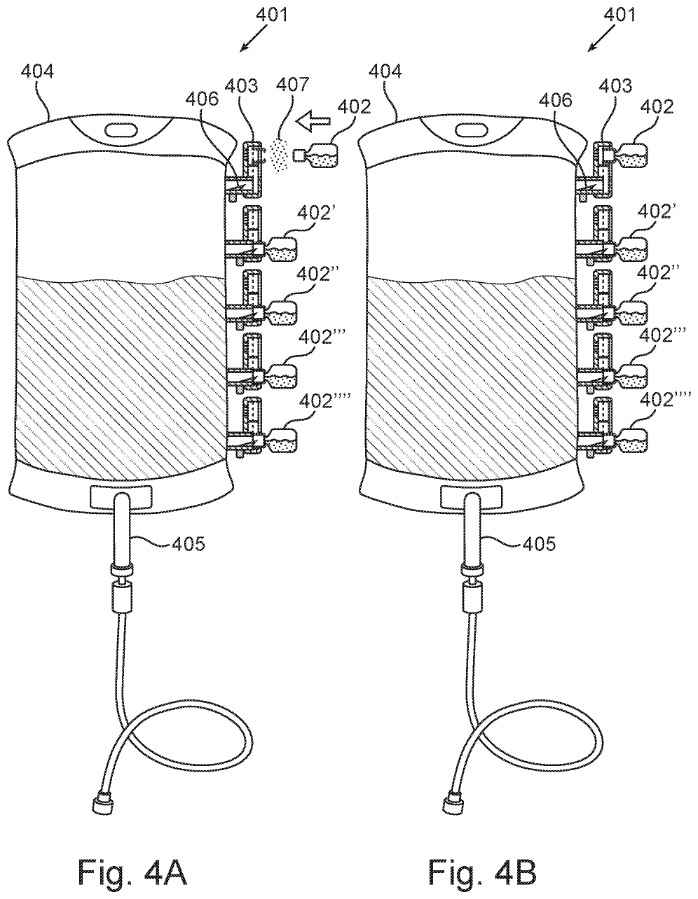

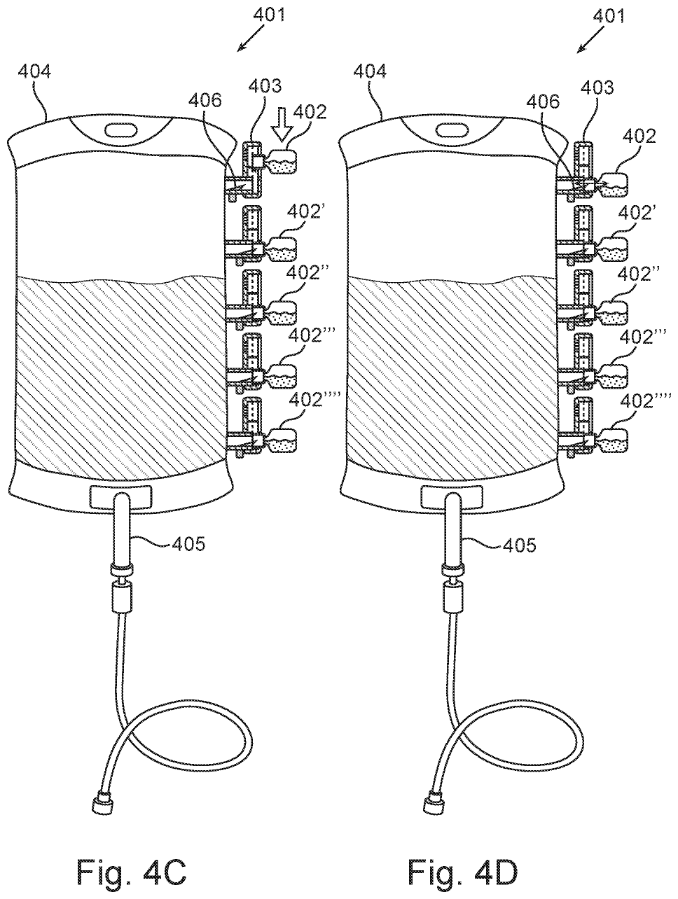

FIGS. 4A-4D are schematic front cut view illustrations presenting a further exemplary system 401 which includes an IV bag 404 having a plurality of entry ports 403 and an exit port 405, wherein a plurality of containers 402 are received and engaged by the plurality of entry ports 403 to transfer a dose from the plurality of containers to the IV bag, according to some embodiments of the invention. The plurality of containers 402 may contain the same beneficial substance or different beneficial substances. Containers 402 may contain medicaments in standard amounts, may container medicaments in nonstandard amounts, or may container medicaments in both standard and nonstandard amounts. Attaching a plurality of containers 402 having medicaments in nonstandard amounts allows a user to provide a customized/individualized final dosage amount of a beneficial substance to a patient without manually manipulating (mixing/intermixing, visually measuring) the beneficial substance contained in containers 402. Thus the system comprising container 404 and containers 402 having medicaments in nonstandard amounts allows a user to “assemble” a final dosage amount of a beneficial substance using commercially prepackaged containers 402. Containers 402 may be commercially prepackaged containers packaged my drug/pharmaceutical manufacturers. FIG. 4A also illustrates a system comprising a container 404 having a plurality of decontamination devices 403 and a plurality of containers 402, the plurality of containers 402 having at least one container 402 containing a beneficial substance in a nonstandard amount.

As shown in FIG. 4A, contaminants 407 are present between container 402 and entry port 403. In FIG. 4B, container 402 is engaged with entry port 403 via a clamping member on the entry port 403. The container 402 is able to slide from a first compartment in the entry port 403 to a second compartment in the entry port 403 as shown in FIG. 4C. The contaminants 407 are not able to enter the second compartment as a wiping member is provided that removes the contaminants from the surface of container 402.

FIG. 4D shows the transfer of dose from the container 402 through the entry port 403 into the IV bag 404 through which is a contaminant-free fluid passageway. In certain embodiments, a piercing member 406 is provided, such that upon movement of the container 402 from the first compartment to the second compartment, the piercing member 406 pierces the cap from the container 402, and allows the dose to pass through the contaminant-free fluid passageway. In certain embodiments, the entry port 403 has a one way valve, so that air and contaminants 407 are not able to enter the IV bag 404. Optionally, piercing member 406 may pierce a surface of IV bag 404. IV bag 404 is used arbitrarily in all the figures and may be interchanged with any other vessel such as a bottle, a container, a manifold, a connector with multiple openings/ports and/or a syringe.

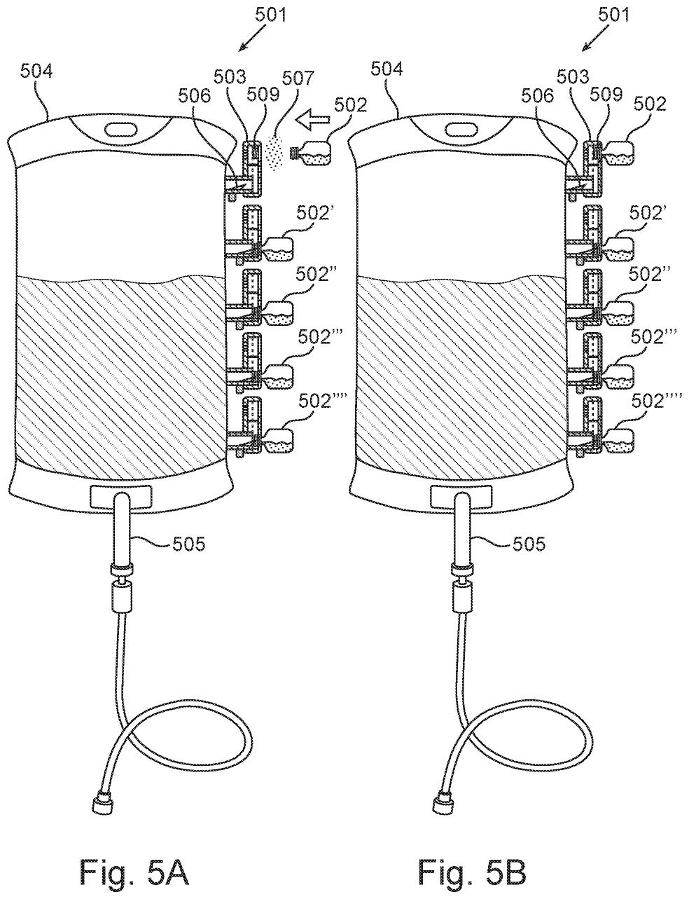

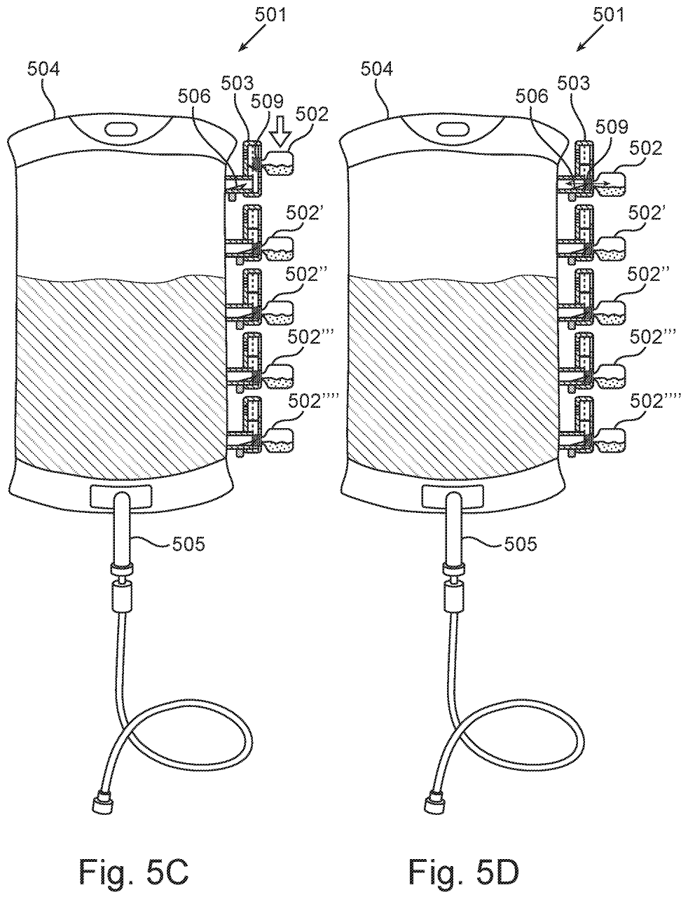

FIGS. 5A-5D are schematic front cut view illustrations presenting a further exemplary system which includes a IV bag 504 having a plurality of entry ports 503 and an exit port 505, wherein a plurality of containers 502 are received and engaged by the plurality of entry ports 503 to transfer a dose from the plurality of containers 502 to the IV bag 504, according to some embodiments of the invention.

As shown in FIG. 5A, contaminants 507 are present between container 502 and entry port 503. In FIG. 5B, container 502 is engaged with entry port 503 via a thread 509 on or in the entry port 503. The container 502 is able to slide from a first compartment in the entry port 503 to a second compartment in the entry port 503 as shown in FIG. 5C. The contaminants 507 are not able to enter the second compartment as a wiping member is provided that removes the contaminants from the surface of container 502. The thread 509 may be a luer, a luer-lock, a luer-slip or a smartsite.

FIG. 5D shows the transfer of dose from the container 502 through the entry port 503 into the IV bag 504 through which is a contaminant-free fluid passageway. In certain embodiments, a piercing member 506 is provided, such that upon movement of the container 502 from the first compartment to the second compartment, the piercing member 506 pierces the cap from the container 502, and allows the dose to pass through the contaminant-free fluid passageway. In certain embodiments, the entry port 503 has a one way-valve, so that air and contaminants 507 are not able to enter the IV bag 504.

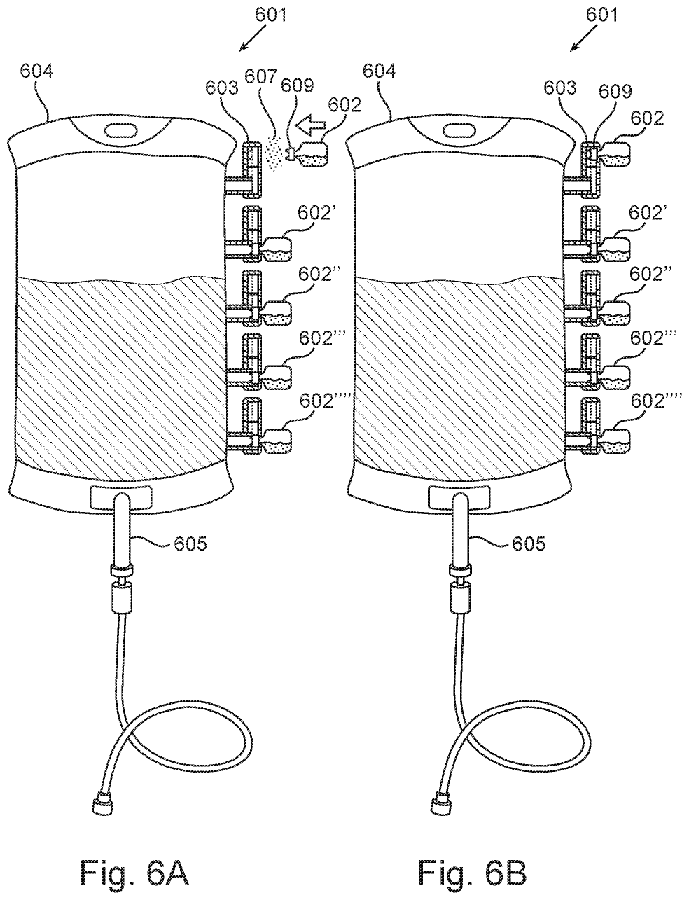

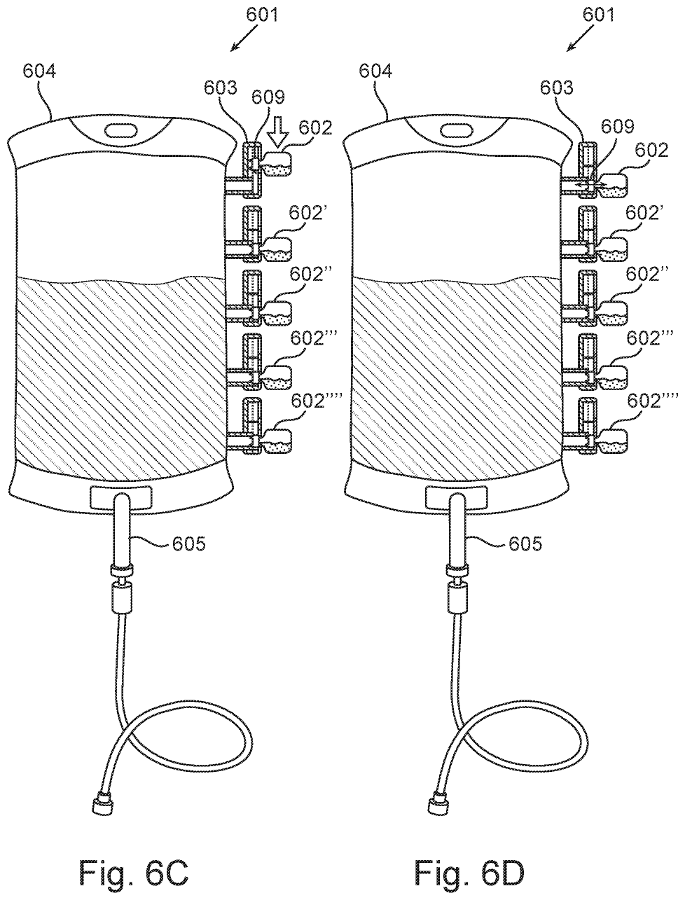

FIGS. 6A-6D are schematic front cut view illustrations presenting a further exemplary system 601 which includes an IV bag 604 having a plurality of entry ports 603 and an exit port 605, wherein a plurality of containers 602 are received and engaged by the plurality of entry ports 603 to transfer a dose from the plurality of containers 602 to the IV bag 604, according to some embodiments of the invention.

As shown in FIG. 6A, contaminants 607 are present between container 602 and entry port 603. In FIG. 6B, container 602 is engaged with entry port 603 via ratchet teeth 609 on the container 602. The container 602 is able to slide from a first compartment in the entry port 603 to a second compartment in the entry port 603 as shown in FIG. 6C. The contaminants 607 are not able to enter the second compartment as a wiping member is provided that removes the contaminants from the surface of container 602. For all of FIGS. 6A-6D, the entry ports 603 may be decontamination Devices. Optionally, entry ports 603 and/or decontamination devices 603 may be flush mounted or surface mounted to IV bag 604. Optionally, entry ports and/or decontamination device 603 may abut a wall of IV bag 604. Optionally, entry and/or decontamination devices 603 may abut a side wall of IV bag 604. IV bag 604 is used arbitrarily and may be any vessel such as a container, a bottle, a vial, a cartridge, or a syringe.

FIG. 6D shows the transfer of dose from the container 602 through the entry port 603 into the IV bag 604 through which is a contaminant-free fluid passageway. In certain embodiments, the entry port 603 has a one way valve, so that air and contaminants 607 are not able to enter the IV bag 604.

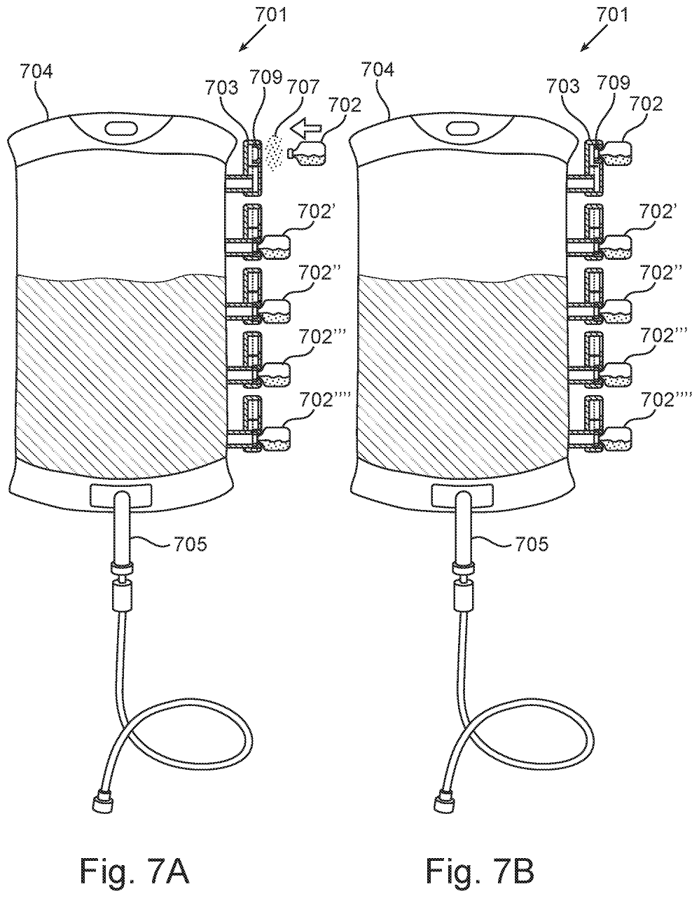

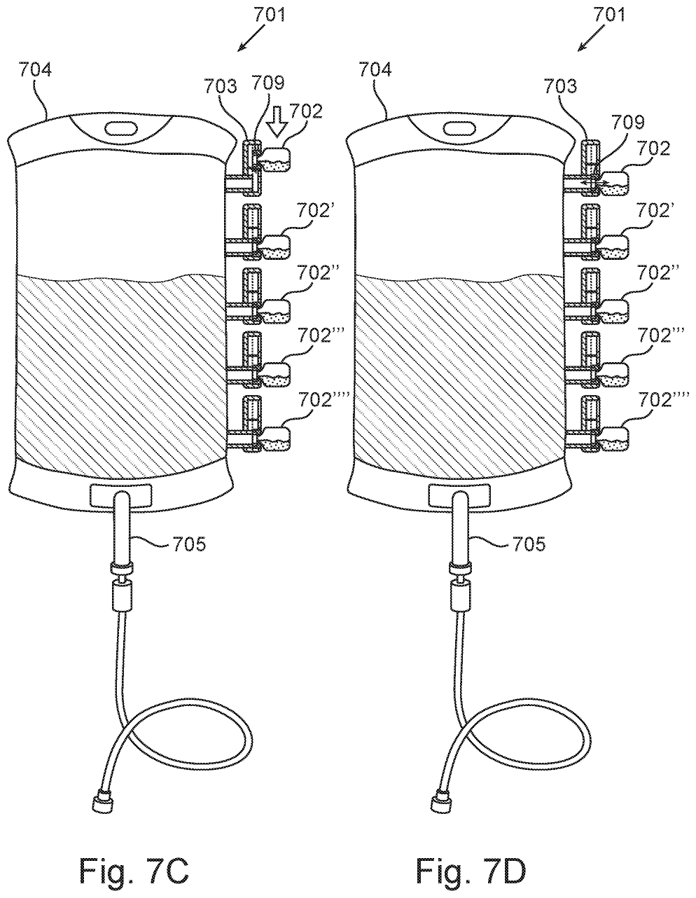

FIGS. 7A-7D are schematic front cut view illustrations presenting a further exemplary system 701 which includes an IV bag 704 having a plurality of entry ports 703 and an exit port 705, wherein a plurality of containers 702 are received and engaged by the plurality of entry ports 703 to transfer a dose from the plurality of containers 702 to the IV bag 704, according to some embodiments of the invention.

As shown in FIG. 7A, contaminants 707 are present between container 702 and entry port 703. In FIG. 7B, container 702 is engaged with entry port 703. A circumferential wiper 709 is provided within the entry port 703 which wipes the sides of the ports of container 702 at about the time and/or at the time of engagement/entry of the port of container 702 to entry port 703. In one or more embodiments, the circumferential wiper 709 may be made of an elastomeric and/or rubber material. In one or more embodiments, the circumferential wiper 709 may be covered by a sterilizing and/or disinfecting agent. In one or more embodiments, the sterilizing and/or disinfecting agent may be alcohol, 70% isopropyl alcohol, peroxide, etc. The container 702 is able to slide from a first compartment in the entry port 703 to a second compartment in the entry port 703 as shown in FIG. 7C. The contaminants 707 are not able to enter the second compartment as a wiping member is provided that removes the contaminants from the surface of container 702.

FIG. 7D shows the transfer of dose from the container 702 through the entry port 703 into the IV bag 704 through which is a contaminant-free fluid passageway. In certain embodiments, the entry port 703 has a one way valve, so that air and contaminants 707 are not able to enter the IV bag 704.

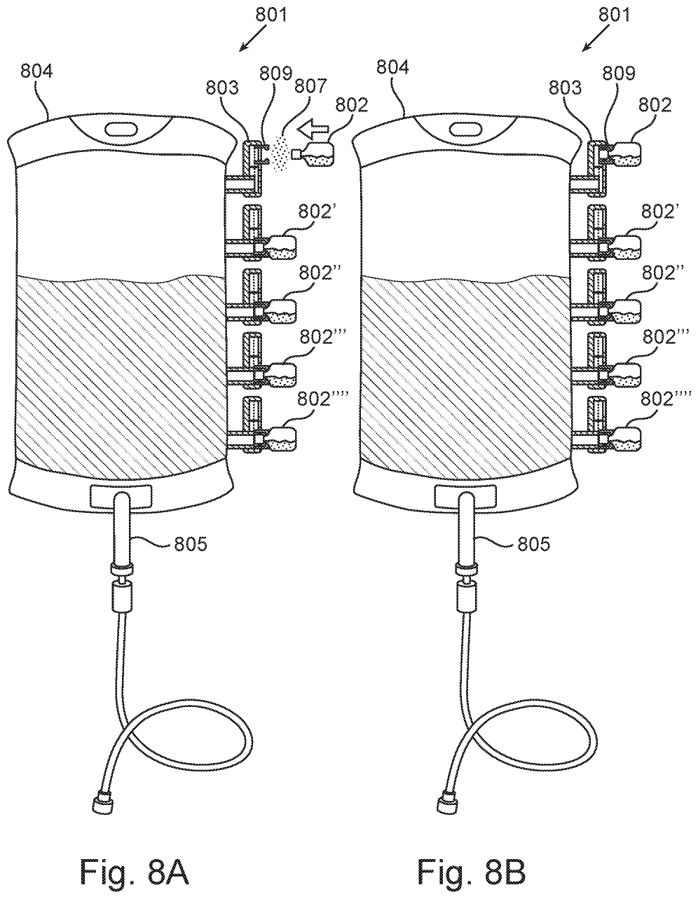

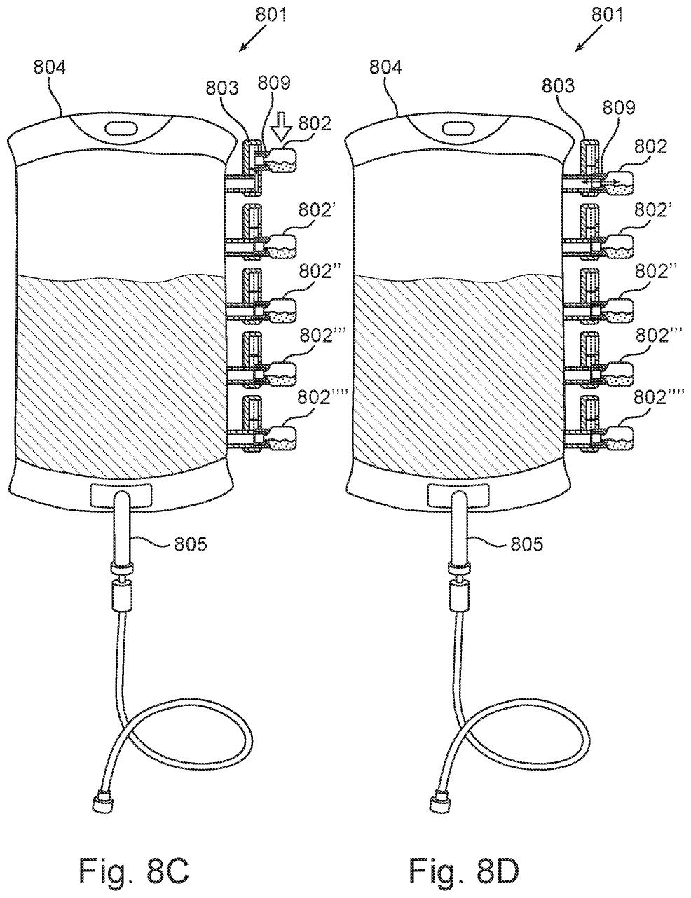

FIGS. 8A-8D are schematic front cut view illustrations presenting a further exemplary system 801 which includes a IV bag 804 having a plurality of entry ports 803 and an exit port 805, wherein a plurality of containers 802 are received and engaged by the plurality of entry ports 803 to transfer a dose from the plurality of containers 802 to the IV bag 804, according to some embodiments of the invention.

As shown in FIG. 8A, contaminants 807 are present between container 802 and entry port 803. In FIG. 8B, container 802 is engaged with entry port 803 via a clasping member 809. Clasping member 809 is shown grabbing/clasping the port of container 802, however clasping member 809 may be provided having elongated clasping members (not shown) which may extend the length of container 802 and grab/clasp the bottom of container 802. The container 802 is able to slide from a first compartment in the entry port 803 to a second compartment in the entry port 803 as shown in FIG. 8C via a rail or hinge mechanism. The contaminants 807 are not able to enter the second compartment as a wiping member is provided within the ports 803 that removes the contaminants from the surface of container 802.

FIG. 8D shows the transfer of dose from the container 802 through the entry port 803 into the IV bag 804 through which is a contaminant-free fluid passageway. In certain embodiments, the entry port 803 has a one way valve, so that air and contaminants 807 are not able to enter the IV bag 804. The one way valve of entry port 803 may prevent backflow of a beneficial substance from IV bag 804 to containers 802. Optionally, containers 802 may have a valve, wherein the valve may be a one way valve.

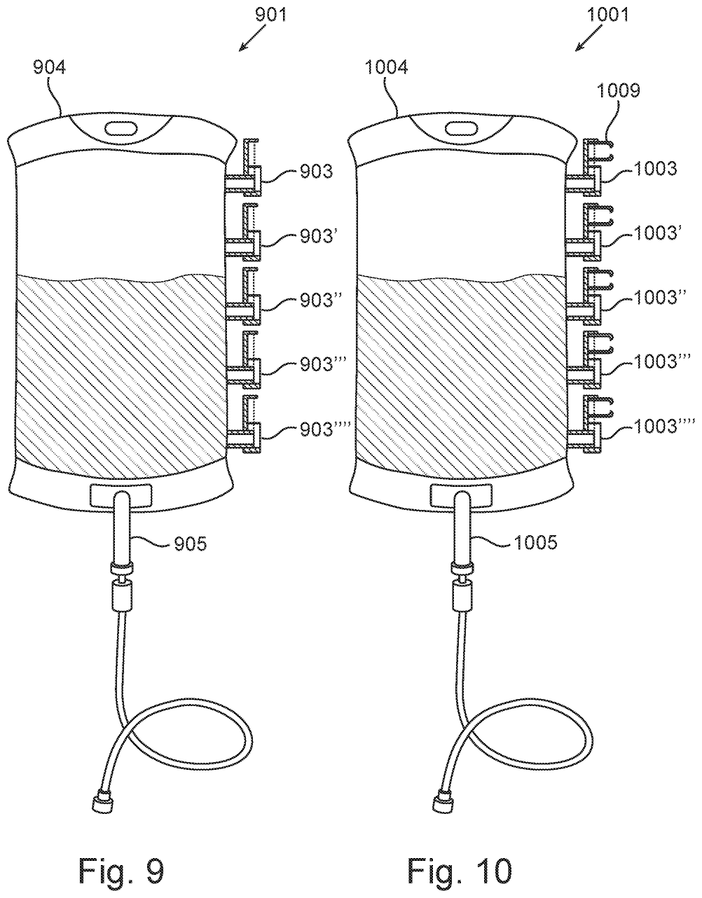

FIG. 9 is a schematic front cut view illustration presenting a further exemplary system 901 which includes a IV bag 904 having a plurality of entry ports 903 and an exit port 905, according to some embodiments of the invention. FIG. 9 shows a rail member such that a container is able to be received by the rail member and slide from a first position to a second position, which includes a contaminant-free fluid passageway that is hermetically sealed in order to transfer a dose into the IV bag 904. Rail member is shown as the dotted line on/within entry ports 903.

FIG. 10 is a schematic front cut view illustration presenting a further exemplary system 1001 which includes a IV bag 1004 having a plurality of entry ports 1003 and an exit port 1005, according to some embodiments of the invention. FIG. 10 shows a clasping member 1009 and a rail member 1003 such that a container is able to be received by the rail member and slide from a first position to a second position, which includes a contaminant-free fluid passageway that is hermetically sealed in order to transfer a dose into the IV bag 1004. The IV bag 1004 has a plurality of rail members 903. IV bag 1004 may be a bottle in some embodiments. IV bag 1004 may be a bag used for dialysis/hemodialysis in some embodiments.

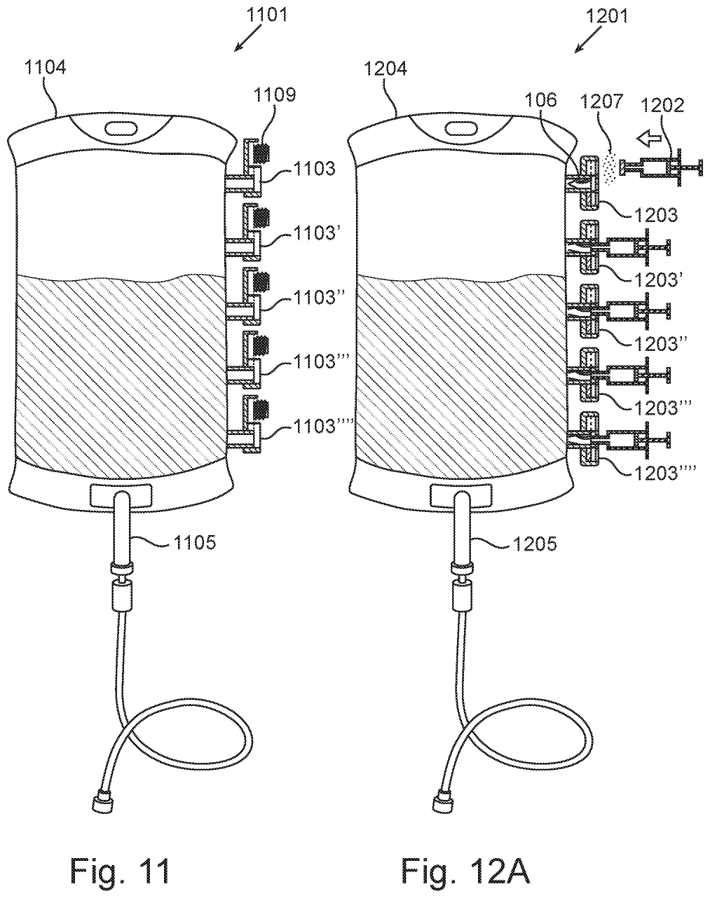

FIG. 11 is a schematic front cut view illustration presenting a further exemplary system 1101 which includes IV bag 1104 having a plurality of entry ports 1003 and an exit port 1105, according to some embodiments of the invention. FIG. 11 shows a thread 1109 such that a container is able to be received by the thread and slide from a first position to a second position, which includes a contaminant-free fluid passageway that is hermetically sealed in order to transfer a dose into the IV bag 1104.

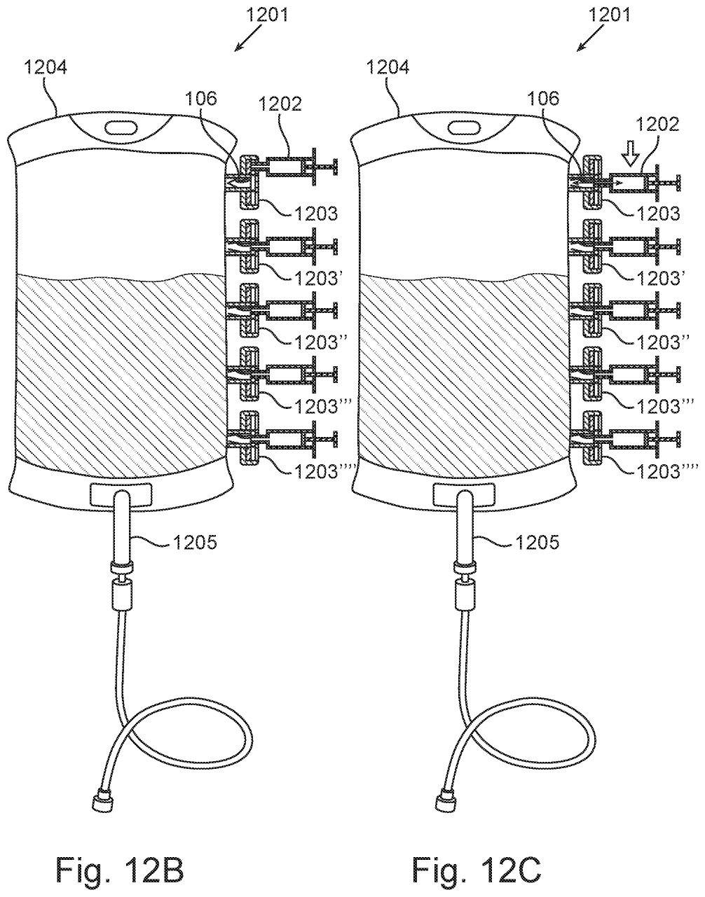

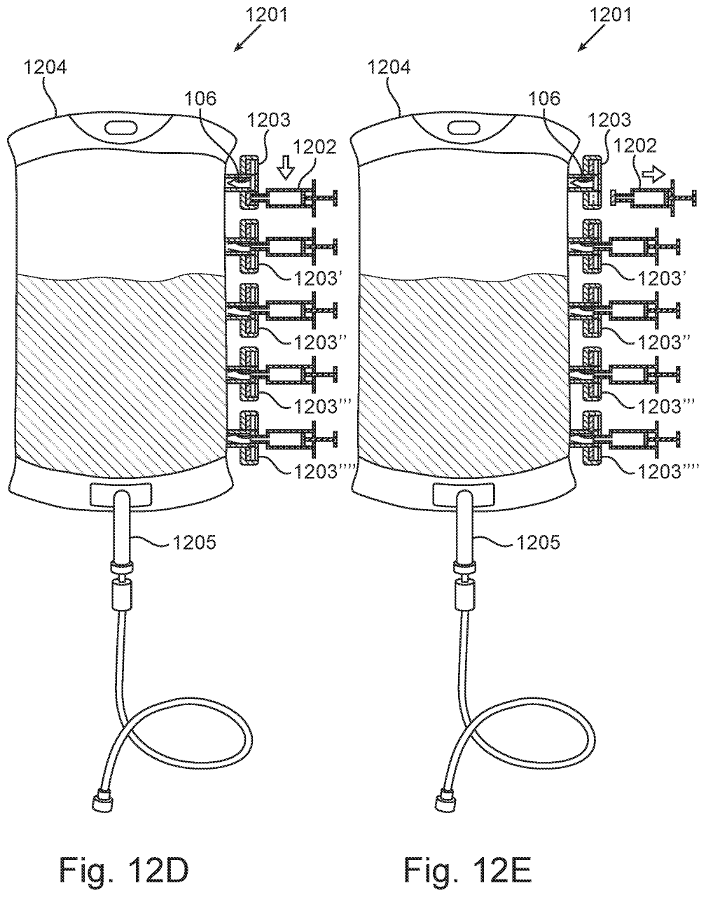

FIGS. 12A-12E are schematic front cut view illustrations presenting a further exemplary system 1201 which includes a IV bag 1204 having a plurality of entry ports 1203 and an exit port 1205, wherein a plurality of syringe elements 1202 are received and engaged by the plurality of entry ports 1203 to transfer a dose from the plurality of syringe elements 1202 to the IV bag 1204, according to some embodiments of the invention. Optionally, the syringe elements 1202 may be containers with an expulsion member. In one or more embodiments, at least one of syringe elements 1202 may house a beneficial substance and/or medicament in a nonstandard amount. In one or more embodiments, a plurality of syringe elements 1202 may house a beneficial substance and/or medicament in a nonstandard amount.

As shown in FIG. 12A, contaminants 1207 are present between syringe element 1202 and entry port 1203. In FIG. 12B, syringe element 1202 is engaged with entry port 1203. The syringe element 1202 is able to slide from a first compartment in the entry port 1203 to a second compartment in the entry port 1203 as shown in FIG. 12C. The contaminants 1207 are not able to enter the second compartment as a wiping member is provided that removes the contaminants from the surface of syringe element 1202.

FIG. 12C shows the transfer of dose from the syringe element 1202 through the entry port 1203 into the IV bag 1204 through which is a contaminant-free fluid passageway in the second/middle compartment. After the dose is transferred, FIG. 12D shows the syringe element 1202 sliding to a third compartment whereby the syringe element 1202 is able to be removed from the entry port 1203. In certain embodiments, the entry port 1203 has a one way valve, so that air and contaminants 1207 are not able to enter the IV bag 1204. Optionally, entry ports 1203 may have actuators that move the piercing member 106 through a surface of at least one of IV bag 1204 and/or syringe element 1202. Optionally, entry ports 1203 may have a frangible seal in the middle compartment that breaks upon the application of pressure to the frangible seal, thus establishing a fluidic passageway between syringe elements 1202 and IV bag 1204. In one or more embodiments, any of the disclosed bags/bottles anywhere in this specification may have a frangible seal that breaks upon the application of pressure. The frangible seal may be disposed in, within, and/or on an entry and/or exit port of any bag, intravenous bag, bottle, vial, syringe, etc.

In certain embodiments, the third compartment of entry ports 1203 have a resealing element, such that upon entering the third compartment, the distal end of the syringe element 1202 mates with the resealing element. Afterwards, the syringe element 1202 is removed from the entry port 1203. The mating of the syringe element 1202 and the resealing element disposed within entry ports 1203 occurs within the third (bottom most) compartment of entry ports 1203. In one or more embodiments, exit port 1205 may have a decontamination device attached, coupled, integrally attached, and/or form a unitary structure with IV bag 1204.

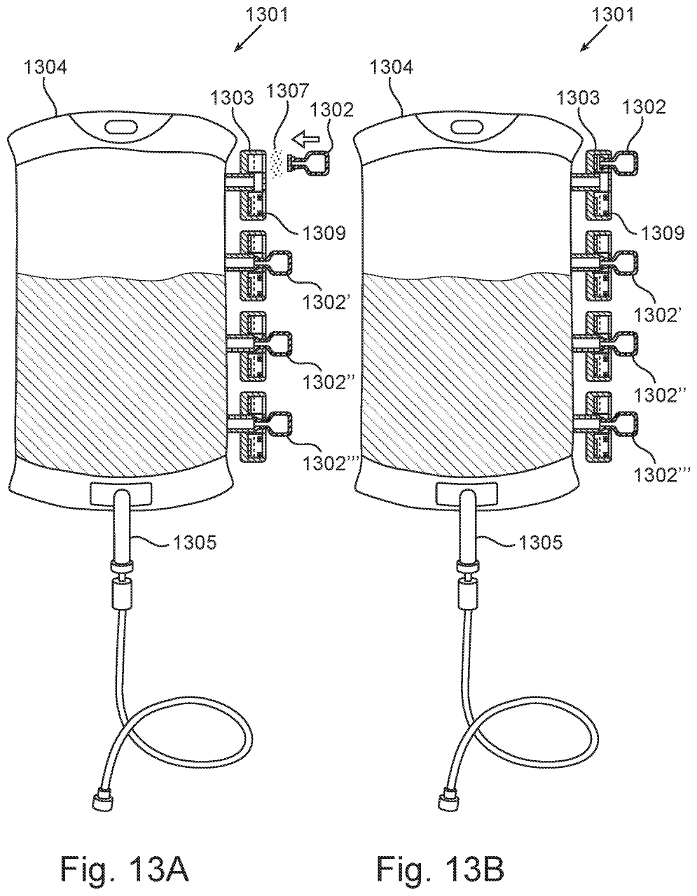

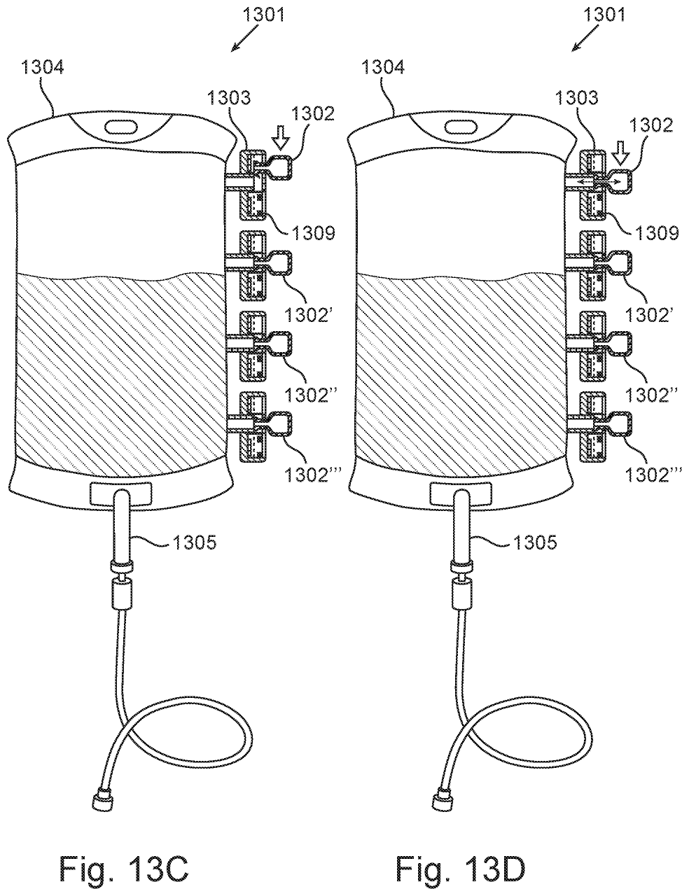

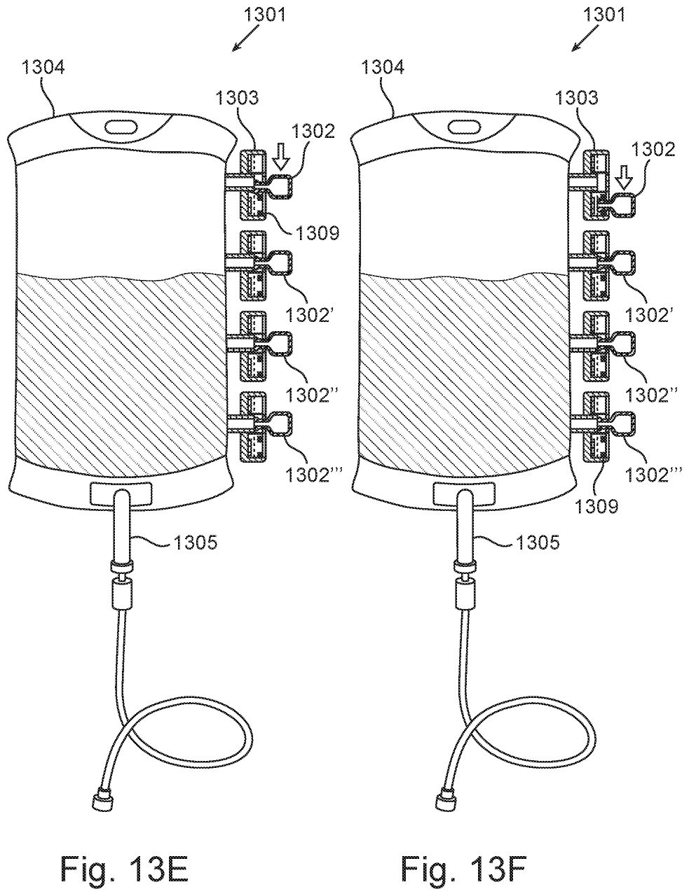

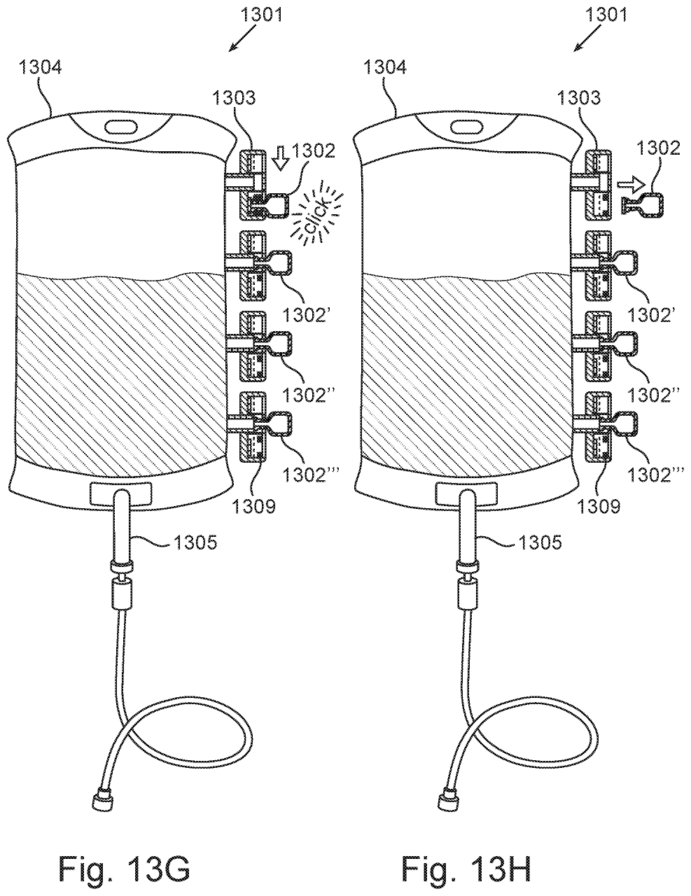

FIGS. 13A-13H are schematic front cut view illustrations presenting a further exemplary system 1301 which includes a IV bag 1304 having a plurality of entry ports 1303 and an exit port 1305, wherein a plurality of containers 1302 are received and engaged by the plurality of entry ports 1303 to transfer a dose from the plurality of containers 1302 to the IV bag 1304, according to some embodiments of the invention. As shown, container 1302 is a bag, a bottle or vial. It must be noted that any of entry ports 1303 may optionally be a four compartment or five compartment entry port.

As shown in FIG. 13A, contaminants 1307 are present between container 1302 and entry port 1303. In FIG. 13B, container 1302 is engaged with entry port 1303. The container 1302 is able to slide from a first compartment in the entry port 1303 to a second compartment in the entry port 1303 as shown in FIG. 13C. The contaminants 1307 are not able to enter the second compartment as a wiping member is provided that removes the contaminants from the surface of container 1302. Optionally, container 1302 may slide to a fourth compartment (not shown) and/or a fifth compartment (not shown) of entry port 1303.

FIG. 13D shows the transfer of dose from the container 1302 through the entry port 1303 into the IV bag 1304 through which is a contaminant-free fluid passageway in the second/middle compartment of entry port 1303. After the dose is transferred, FIGS. 13E-13F shows the container 1302 sliding to a third compartment whereby the container 1302 is able to be removed from the entry port 1303.

FIGS. 13G-13H show the container 1302 pressed down and/or pushed in until a “click sound” is made, whereby the seal between the container 1302 and the entry port 1303 is released. Afterwards, container 1302 is able to be removed from entry port 1303 by pulling or twisting the container 1302 away from entry port 1303 and IV bag 1304. Entry ports 1303 have a spring element 1309 which provide for movement of container 1302 within the third compartment of entry port 1303. Optionally, the spring element 1309 may be a rubber element, an elastomeric material, or any type of flexible material that allows for a surface or port of container 1302 to move within the third compartment of entry port 1303 allowing for the resealing of an aperture on a surface of container 1302 with a displaceable, sealing, and/or resealing member disposed within third compartment of port 1303. In one or more embodiments, the vessel/container 1304 has a plurality of sealing/resealing members disposed within entry ports 1303, wherein the entry ports may be decontamination devices. In one or more embodiments, entry ports 1303 may have four or five compartments. In one or more embodiments, entry ports 1303 may have a plurality of compartment. In one or more embodiments, entry ports 1303 may be decontamination devices having at least four compartments.

In certain embodiments, the third compartment of entry ports 1303 has a resealing element, such that upon entering the third compartment, the distal end (port) of the container 1302 mates with the resealing element. Afterwards, the container 1302 is removed from the entry port 1303. The resealing element disposed within the third compartment of entry ports 1303 may be a cap, a seal, a twist-on cap, a snap-on cap and combinations thereof.

In certain embodiments, container 1303 may be detached from the second compartment of entry port 1303.

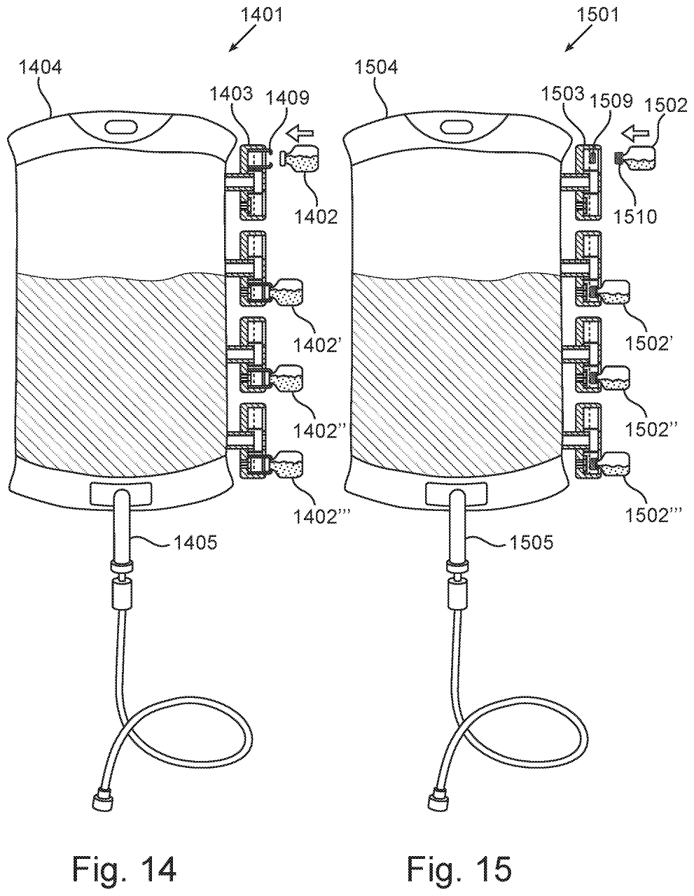

FIG. 14 is schematic front cut view illustrations presenting a further exemplary system 1401 which includes a IV bag 1404 having a plurality of entry ports 1403 and an exit port 1405, wherein a plurality of containers 1402 are received and engaged by the plurality of entry ports 1403 to transfer a dose from the plurality of containers 1402 to the IV bag 1404, according to some embodiments of the invention. FIG. 14 shows a clasping member 1409 and a rail member (dotted line) such that a container 1402 is able to be received by the clasping member 1409 and afterwards the clasping member along with the containers 1402 slide along the rail member (dotted line) and slide from a first (top) position to a second (middle) position, which includes a contaminant-free fluid passageway that is hermetically sealed in order to transfer a dose into the IV bag 1404. Clasping member 1409 may be attached, integrally attached, and/or form a unitary structure with the rail member of entry ports 1403.

FIG. 15 is a schematic front cut view illustration presenting a further exemplary system 1501 which includes a IV bag 1504 having a plurality of entry ports 1503 and an exit port 1505, wherein a plurality of containers 1502 are received and engaged by the plurality of entry ports 1503 to transfer a dose from the plurality of containers 1502 to the IV bag 1504, according to some embodiments of the invention. FIG. 15 shows a thread member 1509 in the entry port and thread member 1510 on the container 1502 that engage and slide the container 1502 from a first position to a second position, which includes a contaminant-free fluid passageway that is hermetically sealed in order to transfer a dose into the IV bag 1504.

After the dose is transferred, the container 1502 slides into a third compartment whereby the container 1502 is able to be removed from the entry port 1503. Container 1502 is able to be removed from entry port 1503 by pulling or twisting or a combination of pulling and twisting the container 1502 away from entry port 1503 and IV bag 1504.

In certain embodiments, the third compartment has a resealing element, such that upon entering the third compartment, the distal end of the container 1502 mates with the resealing element. Afterwards, the container 1502 is removed from the entry port 1503.

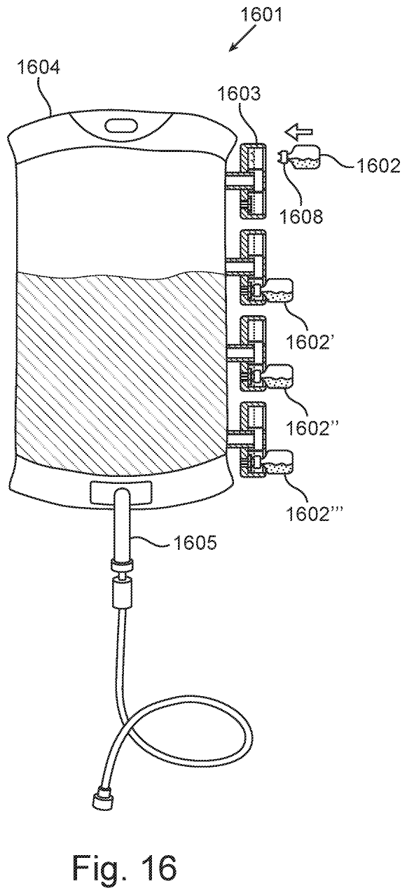

FIG. 16 is a schematic front cut view illustration presenting a further exemplary system 1601 which includes a IV bag 1604 having a plurality of entry ports 1603 and an exit port 1605, wherein a plurality of containers 1602 are received and engaged by the plurality of entry ports 1603 to transfer a dose from the plurality of containers 1602 to the IV bag 1604, according to some embodiments of the invention. FIG. 16 shows a ratchet tooth 1608 on the container 1602 that mates and slide the container 1602 from a first position to a second position, which includes a contaminant-free fluid passageway that is hermetically sealed in order to transfer a dose into the IV bag 1604.

After the dose is transferred, the container 1602 slides into a third compartment whereby the container 1602 is able to be removed from the entry port 1603.

In certain embodiments, the third compartment has a resealing element, such that upon entering the third compartment, the distal end of the container 1602 mates with the resealing element. Afterwards, the container 1602 is removed from the entry port 1603.

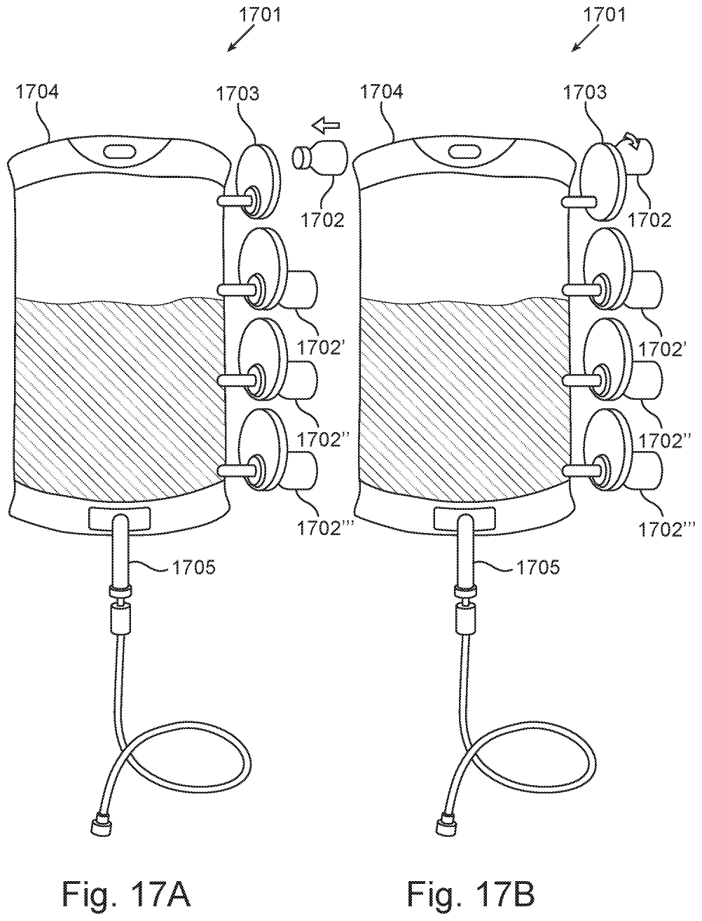

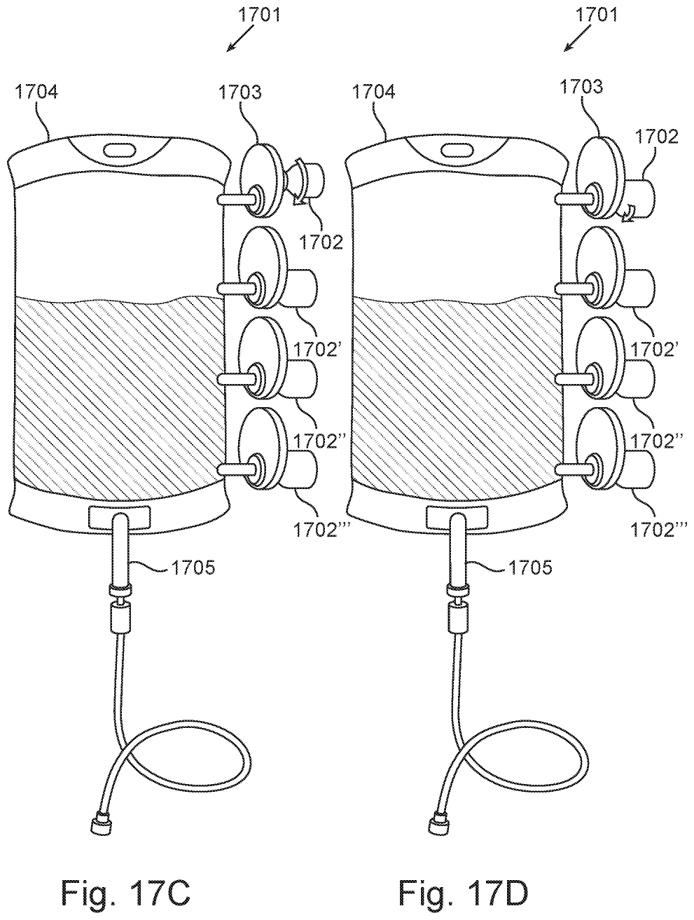

FIGS. 17A-17D are schematic front cut view illustrations presenting a further exemplary system 1701 which includes a IV bag 1704 having a plurality of entry ports 1703 and an exit port 1705, wherein a plurality of containers 1702 are received and engaged by the plurality of entry ports 1703 to transfer a dose from the plurality of containers 1702 to the IV bag 1704, according to some embodiments of the invention. As shown in FIGS. 17A-17D, containers 1702 are vials.

As shown in FIG. 17A, container 1702 and entry port 1703 are separated. In FIG. 17B, container 1702 is engaged with entry port 1703. The container 1702 is able to rotate from a first position in the entry port 1703 to a second compartment in the entry port 1703 as shown in FIGS. 17B-17C. The contaminants are not able to enter the second compartment as a wiping member (not shown) is disposed within entry ports 1703 that removes the contaminants from the surface of container 1702, and the wiping member is within the track between the first and second positions in the entry port 1703. Optionally, wiping member (not shown) is disposed inside the entry ports 1703 and is positioned between a first compartment and a second compartment of entry ports 1703. Entry ports 1703 may be decontamination devices. Optionally, decontamination devices may be abut, be surface mounted or be flush mounted to a wall of IV bag 1704.

FIG. 17D shows container 1702 in the second position whereby the container 1702 is in fluid communication through the entry port 1703 into the IV bag 1704 through which is a contaminant-free fluid passageway.

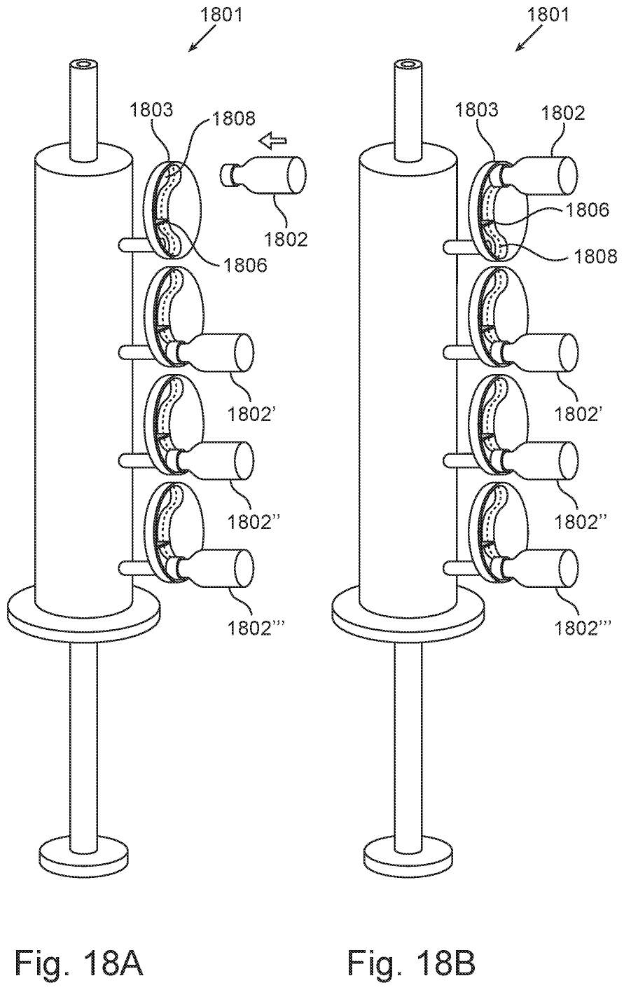

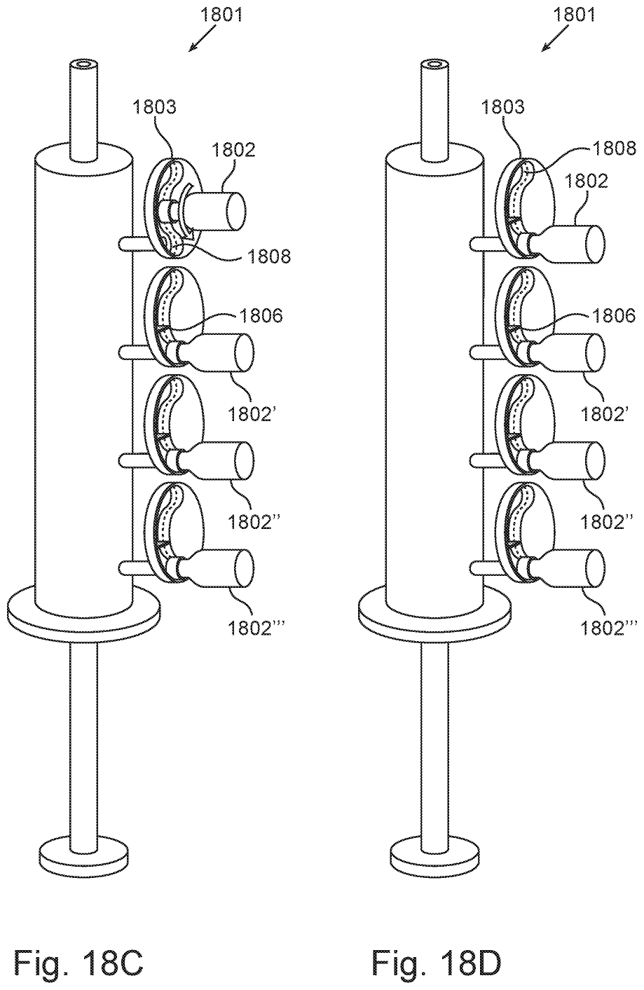

FIGS. 18A-18D are schematic front cut view illustrations presenting a further exemplary system which includes a syringe 1801 having a plurality of entry ports 1803, wherein a plurality of containers 1802 are received and engaged by the plurality of entry ports 1803 to transfer a dose from the plurality of containers 1802 to the syringe 1801, according to some embodiments of the invention. Optionally, the exit port (tip of syringe/syringe tip) may have and/or be attached to a decontamination device. The exit port (tip of syringe/syringe tip) may be integrally attached and/or form a unitary structure with a decontamination device.

As shown in FIG. 18A, container 1802 and entry port 1803 are separated. In FIG. 18B, container 1802 is engaged with entry port 1803. The container 1802 is able to rotate from a first position in the entry port 1803 to a second position in the entry port 1803 as shown in FIGS. 18B-18C. The contaminants are not able to enter the second position as a wiping member 1806 is provided that removes the contaminants from the surface of container 1802, and the wiping member 1806 is within the track 1808 between the first and second positions in the entry port 1803.

FIG. 18D shows container 1802 in the second position whereby the container 1802 is in fluid communication through the entry port 1803 through which a contaminant-free fluid passageway is established into the syringe 1801.

In one or more embodiments, the plurality of entry ports 1803 do not have (are not attached) to decontamination devices. In one or more embodiments, entry ports 1803 are regular entry ports. In one or more embodiments, the syringe has a plurality of entry ports. In one or more embodiments, the syringe has a plurality of entry ports and a plurality of engagement mechanisms configured to engage a plurality of containers 1802.

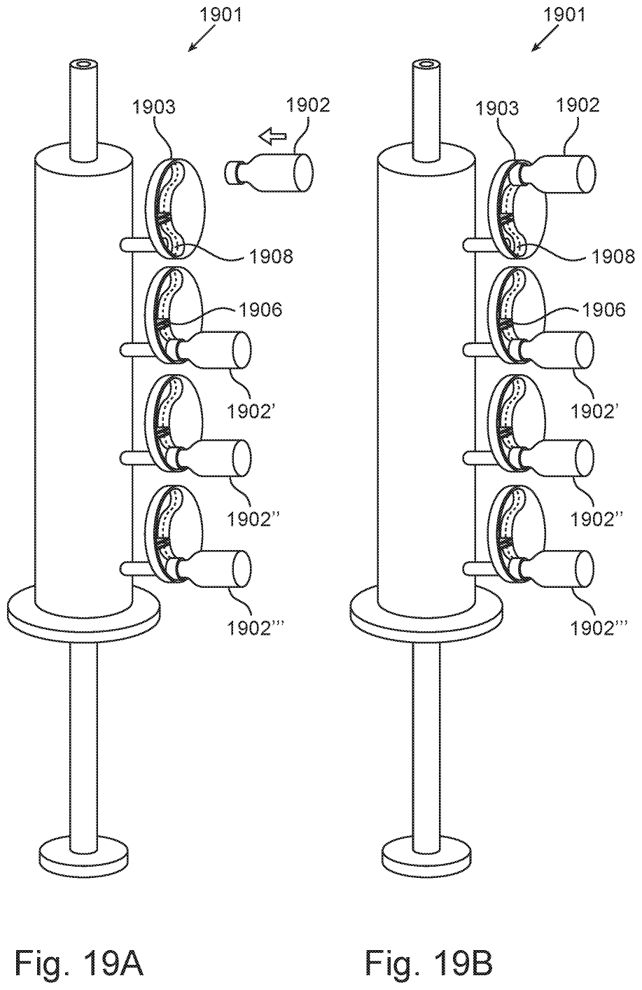

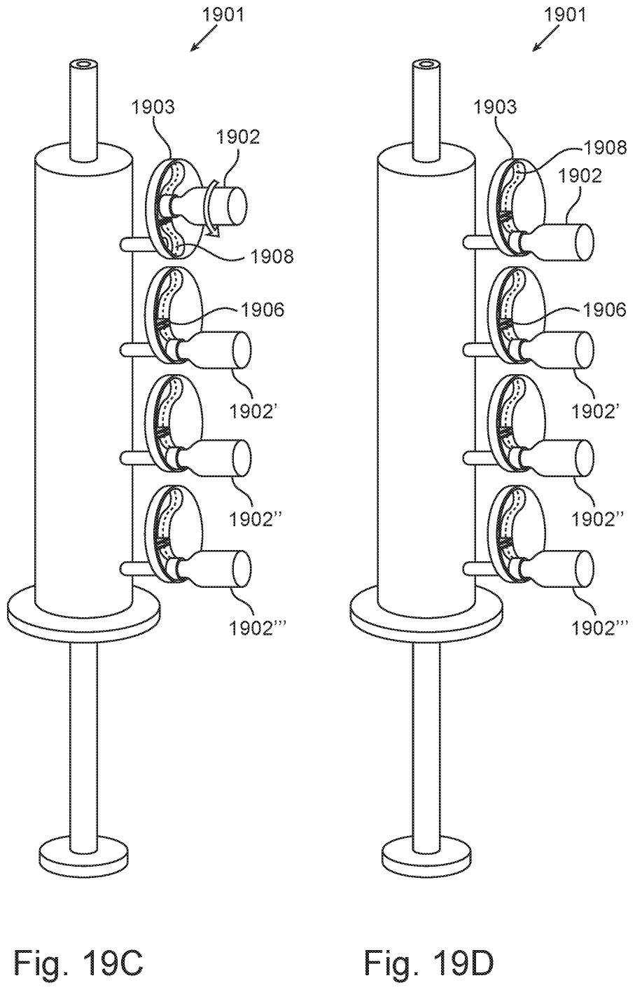

FIGS. 19A-19D are schematic front cut view illustrations presenting a further exemplary system which includes a syringe 1901 having a plurality of entry ports 1903 and, wherein a plurality of containers 1902 are received and engaged by the plurality of entry ports 1903 to transfer a dose from the plurality of containers 1902 to the syringe 1901, according to some embodiments of the invention.

As shown in FIG. 19A, container 1902 and entry port 1903 are separated. In FIG. 19B, container 1902 is engaged with entry port 1903. The container 1902 is able to rotate from a first position in the entry port 1903 to a second position in the entry port 1903 as shown in FIGS. 19B-19C. The contaminants are not able to enter the second position as a double wiping member 1906 is provided that removes the contaminants from the surface of container 1902, and the double wiping member 1906 is within the track 1908 between the first and second positions in the entry port 1903.

FIG. 19D shows container 1902 in the second position whereby the container 1902 is in fluid communication through the entry port 1903 into the syringe 1901 through which is a contaminant-free fluid passageway.

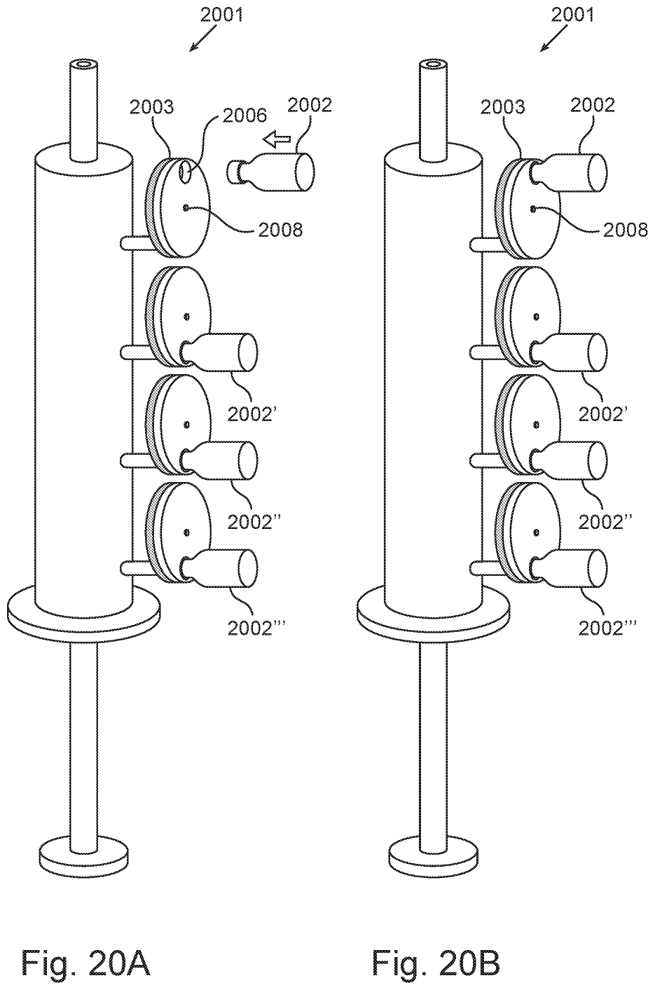

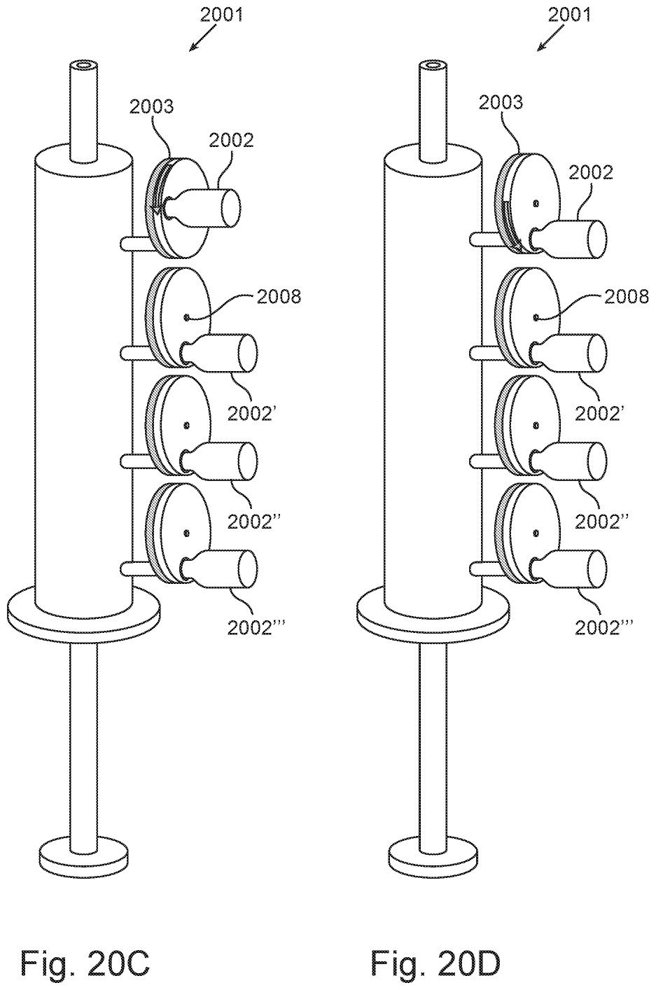

FIGS. 20A-20D are schematic perspective view illustrations presenting a further exemplary system which includes a syringe 2001 having a plurality of entry ports 2003 and an exit port (syringe tip), wherein a plurality of containers 2002 are received and engaged by the plurality of entry ports 2003 to transfer a dose from the plurality of containers 2002 to the syringe 2001, according to some embodiments of the invention.

As shown in FIG. 20, container 2002 and entry port 2003 are separated. In FIG. 20B, container 2002 is engaged with entry port 2003 via entry port opening 2006. Entry port opening 2006 may be covered or sealed prior to attachment of container 2002 to entry port 2003. The cover or seal may be a frangible seal or a removeable cover. The container 2002 is able to rotate from a first position in the entry port 2003 to a second position in the entry port 2003 as shown in FIGS. 20B-20C. As shown, entry port 2003 is composed of two disks that rotate with respect to one another from a first position to a second position. The two discs may rotate with respect to each other via a hinge mechanism 2008 that connects the two discs and provides for the rotation of at least one of the two discs in relation to the other disc. Optionally, the two discs may rotate with respect to each other via a circumferential rail mechanism (not shown) on at least one of the two discs which engages the other disc. The two discs form an airtight and/or hermetic engagement. The contaminants are not able to enter the second position as there is a wiping member disposed between the two discs removes the contaminants from the surface of container 2002, and the wiping member 2006 is within a track 2008 between the first and second positions in the entry port 2003.

FIG. 20D shows container 2002 in the second position whereby the container 2002 is in fluid communication through the entry port 2003 into the syringe 2001 through which is a contaminant-free fluid passageway.

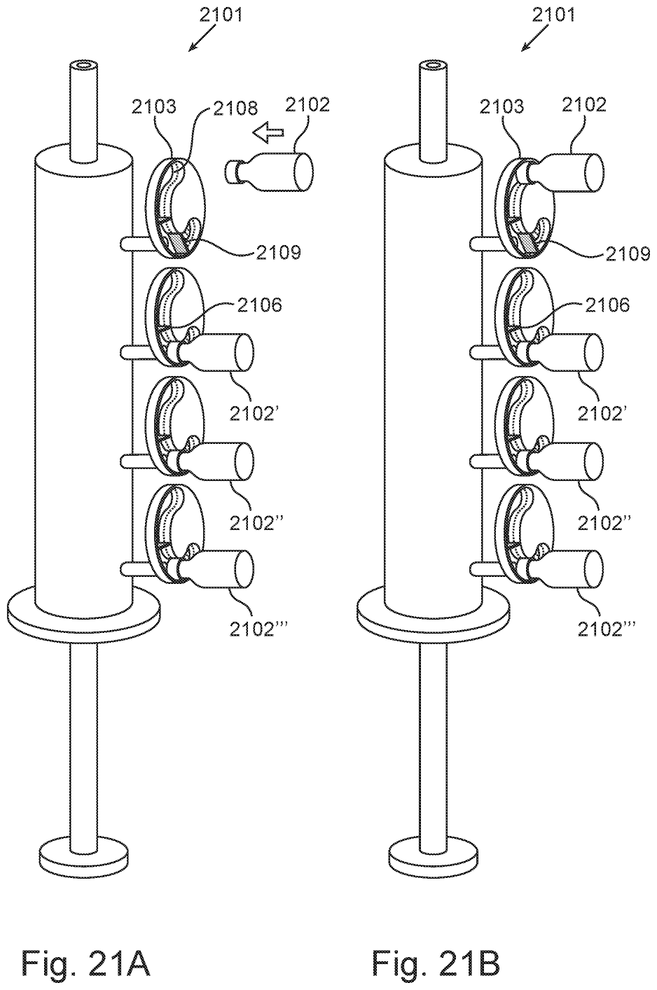

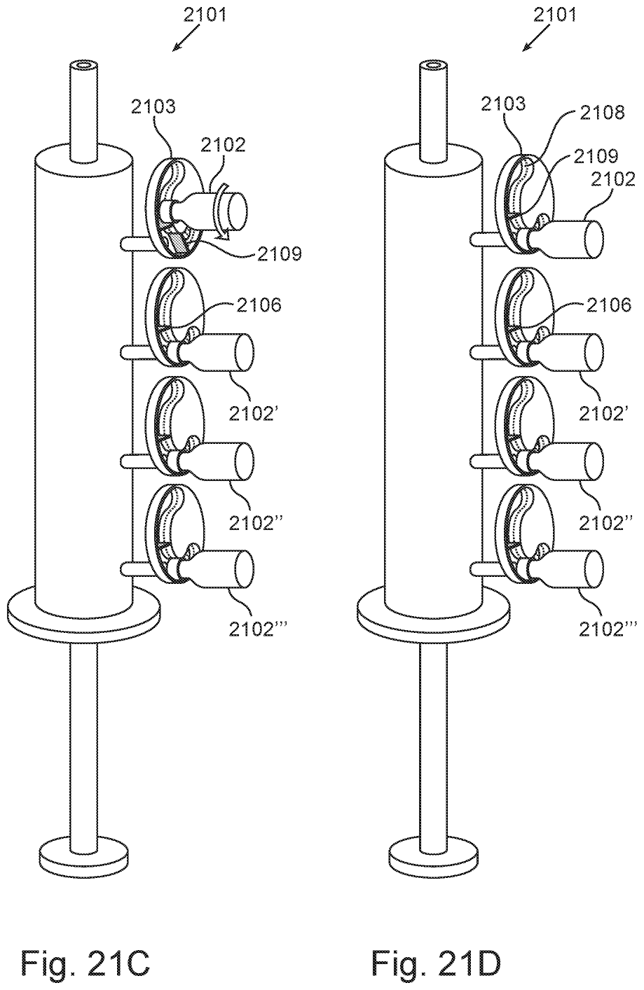

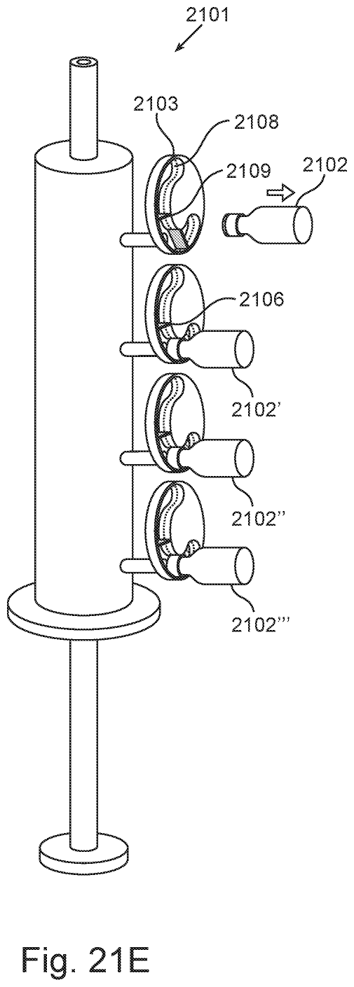

FIGS. 21A-21E are schematic front cut view illustrations presenting a further exemplary system which includes a syringe 2101 having a plurality of entry ports 2103, wherein a plurality of containers 2102 are received and engaged by the plurality of entry ports 2103 to transfer a dose from the plurality of containers 2102 to the syringe 2101, according to some embodiments of the invention.

As shown in FIG. 21, container 2102 and entry port 2103 are separated. In FIG. 21B, container 2102 is engaged with entry port 2103. The container 2102 is able to rotate from a first position in the entry port 2103 to a second position in the entry port 2103 as shown in FIGS. 21B-21C. The contaminants are not able to enter the second position as there is a wiping member 2106 that removes the contaminants from the surface of container 2102, and the wiping member 2106 is within a track 2108 between the first and second positions in the entry port 2103.

FIG. 21D shows container 2102 in the second position whereby the container 2102 is in fluid communication through the entry port 2103 into the syringe 2101 through which is a contaminant-free fluid passageway. FIG. 21E shows the container (or vial) 2102 removed from the track 2108 by pulling the container away from the syringe 2101.

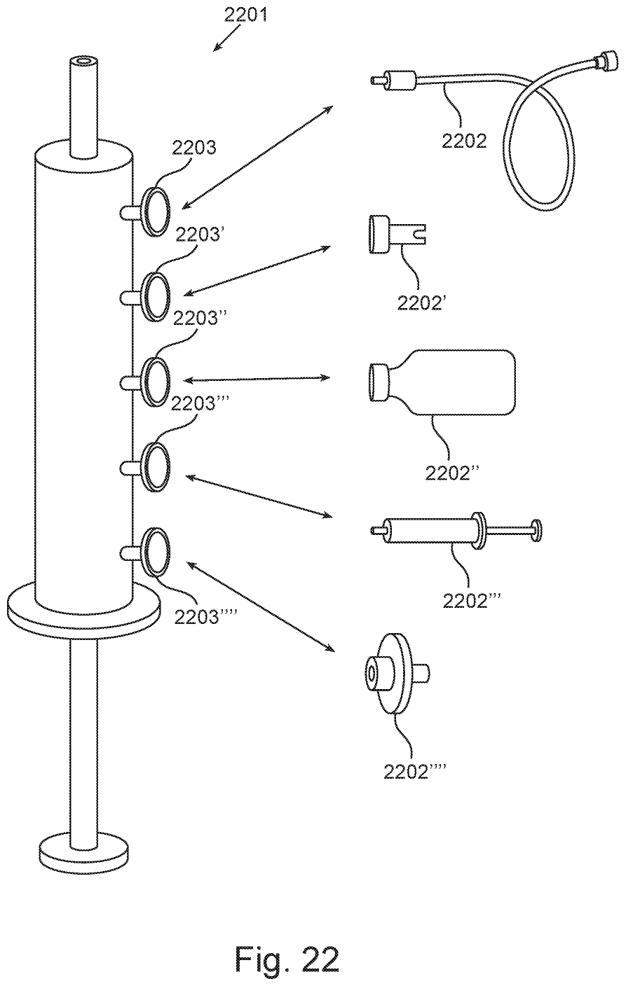

FIG. 22 is a schematic front cut view illustration presenting a further exemplary system which includes a syringe 2201 having a plurality of entry ports 2203, showing various objects 2202, 2202′, 2202″, 2202′″ and 2202″″ able to be received by the plurality of entry ports 2203, according to some embodiments of the invention. As shown the plurality of objects include an IV line, filter, bung, bottle, syringe, connector and other objects that are configured to interface or connect with entry ports 2203. Syringe 2201 may be a container in some embodiments such as a bag, bottle, or vial.

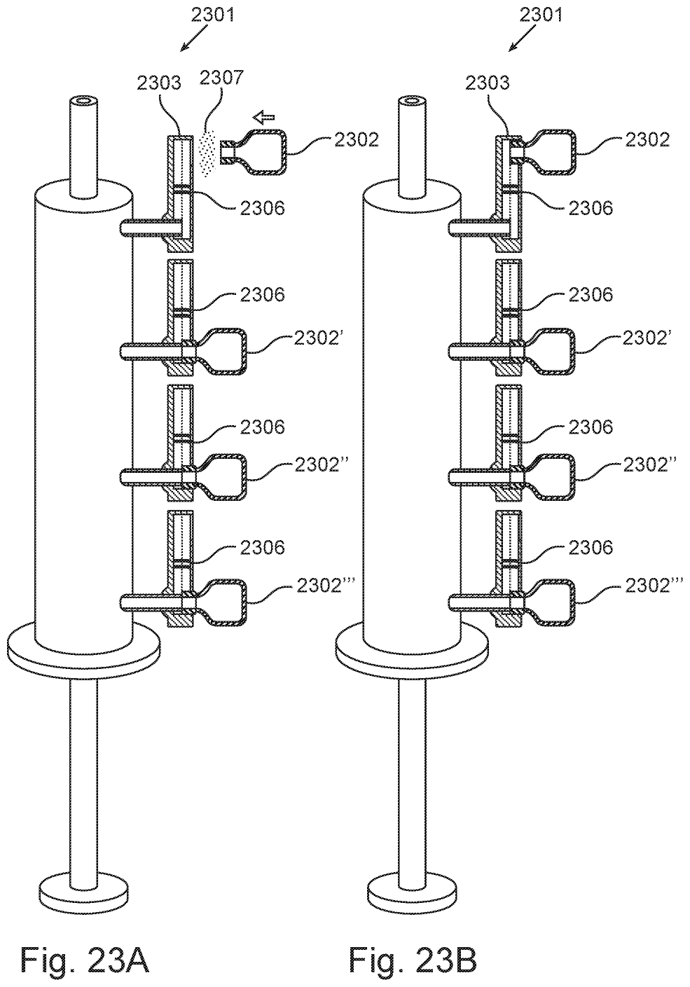

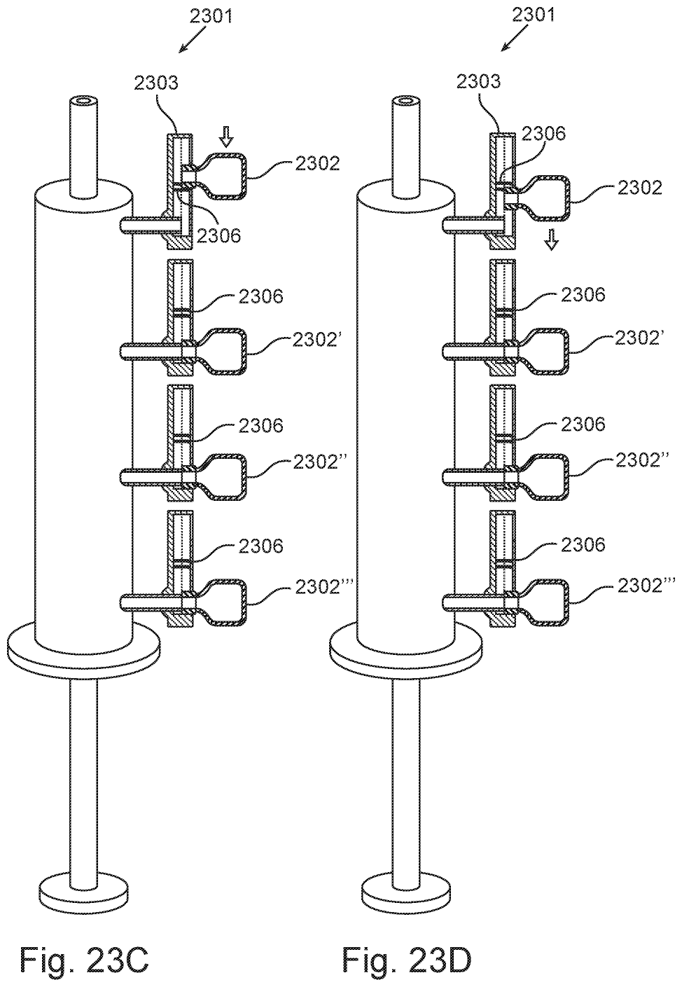

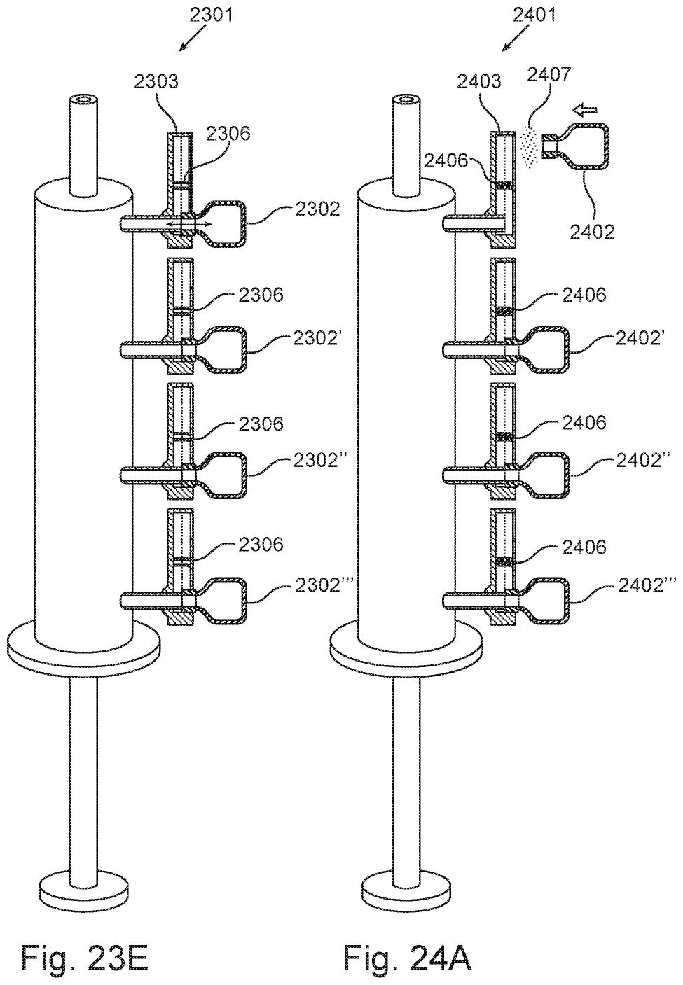

FIGS. 23A-23E are schematic front cut view illustrations presenting a further exemplary system which includes a syringe 2301 having a plurality of entry ports 2303, wherein a plurality of containers 2302 are received and engaged by the plurality of entry ports 2303 to transfer a dose from the plurality of containers 2302 to the syringe 2301, according to some embodiments of the invention.

As shown in FIG. 23A, container 2302 and entry port 2303 are separated and contaminates 2307 are shown on the distal tip of container 2302. In FIG. 23B, container 2302 is engaged with entry port 2303. The container 2302 is able to slide from a first compartment in the entry port 2303 to a second compartment in the entry port 2303 as shown in FIGS. 23C-23D. The contaminants 2307 are not able to enter the second compartment as a double wiping member 2306 is provided that removes the contaminants from the surface of container 2302. Double wiping member 2306 is disposed within entry port 2303 of syringe 2301.

FIG. 23E shows the transfer of dose from the container 2302 through the entry port 2303 into the syringe 2301 through which is a contaminant-free fluid passageway in the second compartment.

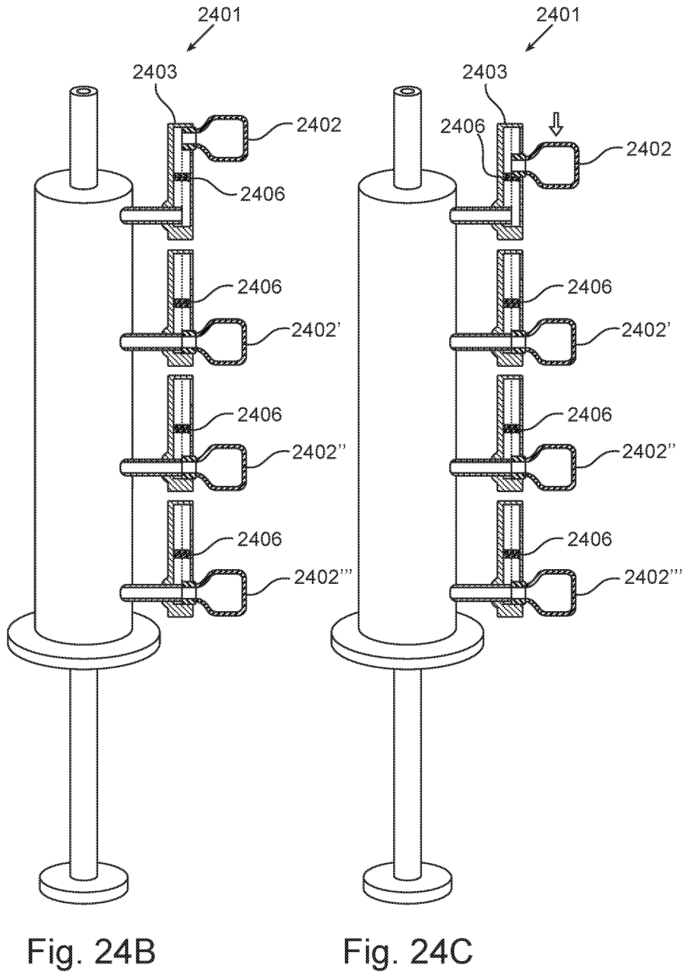

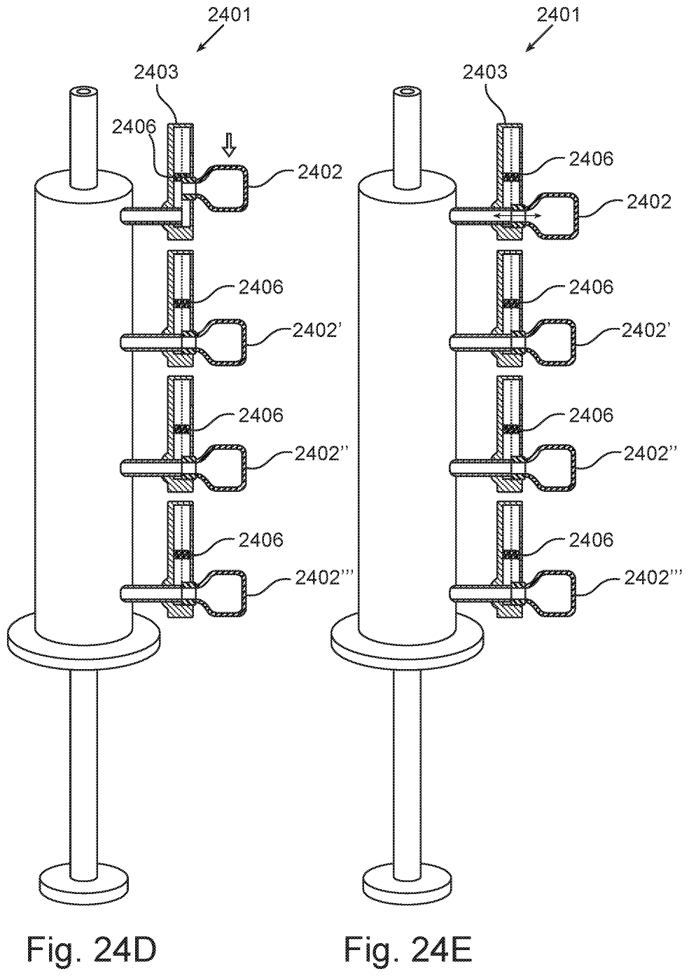

FIGS. 24A-24E are schematic front cut view illustrations presenting a further exemplary system which includes a syringe 2401 having a plurality of entry ports 2403, wherein a plurality of containers 2402 are received and engaged by the plurality of entry ports 2403 to transfer a dose from the plurality of containers 2402 to the syringe 2401, according to some embodiments of the invention.

As shown in FIG. 24A, container 2402 and entry port 2403 are separated and contaminates 2407 are shown on the distal tip of container 2402. In FIG. 24B, container 2402 is engaged with entry port 2403. The container 2402 is able to slide from a first compartment in the entry port 2403 to a second compartment in the entry port 2403 as shown in FIGS. 24C-24D. The contaminants 2407 are not able to enter the second compartment as a wiping member 2406 is provided that removes the contaminants from the surface of container 2402. Wiping member 2406 is a double wiping member, wherein the wipers are adjacent to each other and disposed within entry port 2403 of syringe 2401.

FIG. 24E shows the transfer of dose from the container 2402 through the entry port 2403 into the syringe 2401 through which is a contaminant-free fluid passageway in the second compartment.

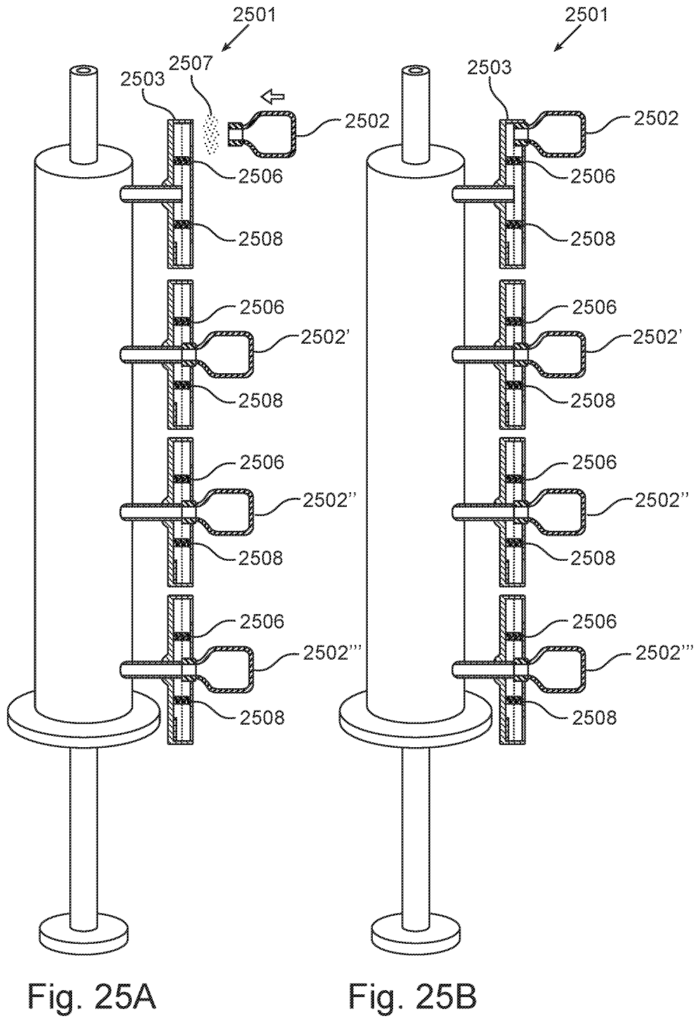

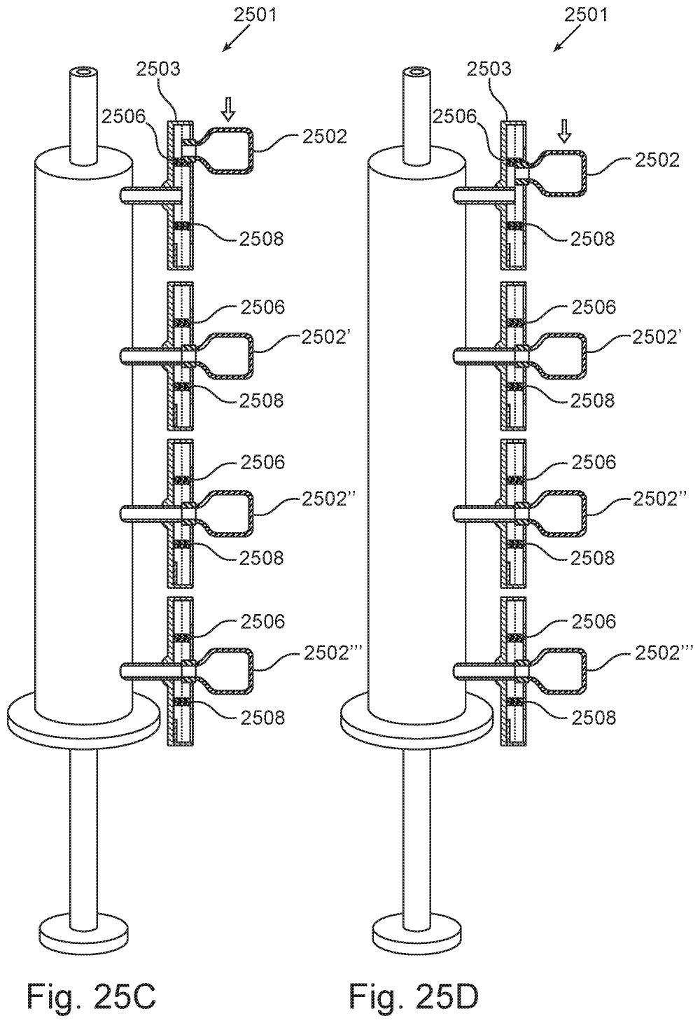

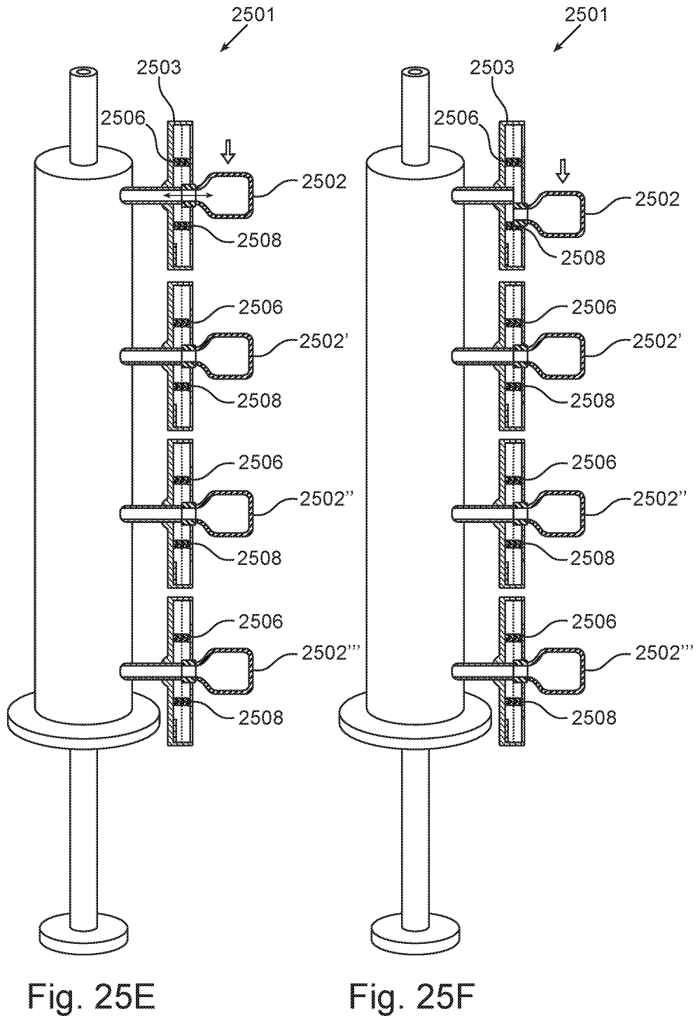

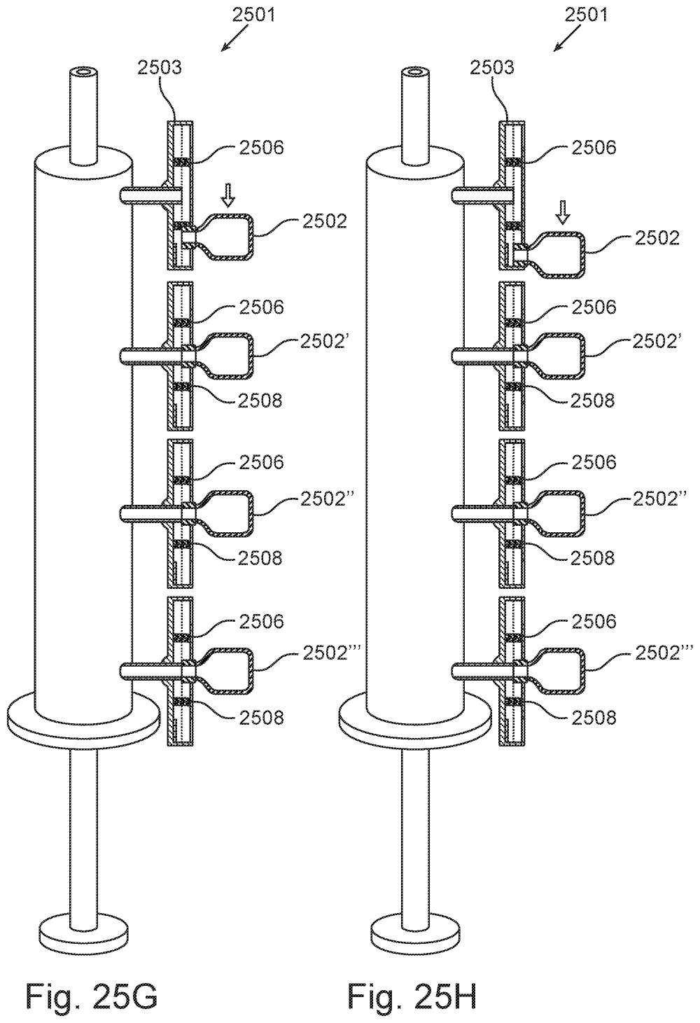

FIGS. 25A-25I are schematic front cut view illustrations presenting a further exemplary system which includes a syringe 2501 having a plurality of entry ports 2503, wherein a plurality of containers 2502 are received and engaged by the plurality of entry ports 2503 to transfer a dose from the plurality of containers 2502 to the syringe 2501, according to some embodiments of the invention.

As shown in FIG. 25A, container 2502 and entry port 2503 are separated and contaminates 2507 are shown on the distal end of container 2502. In FIG. 25B, container 2502 is engaged with entry port 2503. The container 2502 is able to slide from a first compartment in the entry port 2503 to a second compartment in the entry port 2503 as shown in FIGS. 25C-25D. The contaminants 2507 are not able to enter the second compartment as a wiping member 2506 is provided that removes the contaminants from the surface of container 2502.

FIG. 25E shows the transfer of dose from the container 2502 through the entry port 2503 into the syringe 2501through which is a contaminant-free fluid passageway in the second compartment.

After the dose is transferred, FIGS. 25F-25H shows the container 2502 sliding to a third compartment. A wiping member 2508 is used to decontaminate the distal tip of container 2502 prior to passing into the third compartment. FIGS. 25A-25I show a first double wiping member 2506 consisting of two wiping members adjacent to each other and a second double wiping member 2508 consisting of two wiping members adjacent to each other.

In certain embodiments, the third compartment has a resealing element, such that upon entering the third compartment, the distal end of the container 2502 mates with the resealing element. Afterwards, the container 2502 is removed from the entry port 2503 as shown in FIG. 25I. The resealing element may be selected from a group consisting of a thread, a luer, a luer-lock, a luer-slip, a snap-on mechanism, a snap-on mechanism, a rail mechanism, a cap, a cover and combinations thereof. The resealing element is disposed in and/or within entry port 2503. Optionally, the resealing element may be disposed in a second, in a third, in a fourth or in a fifth compartment of entry port 2503 (not shown).

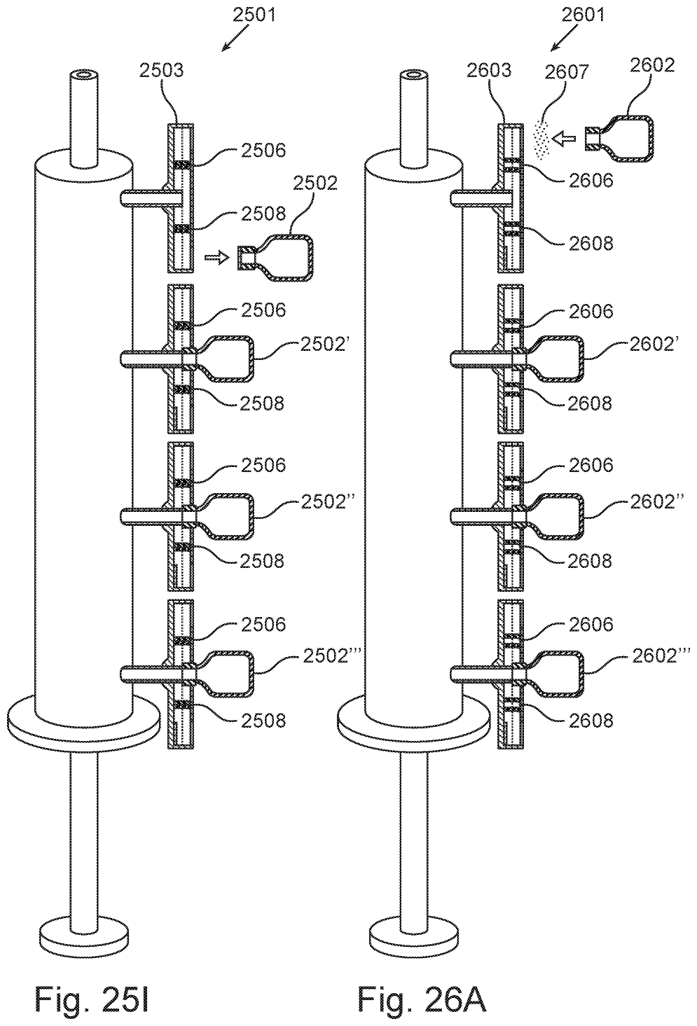

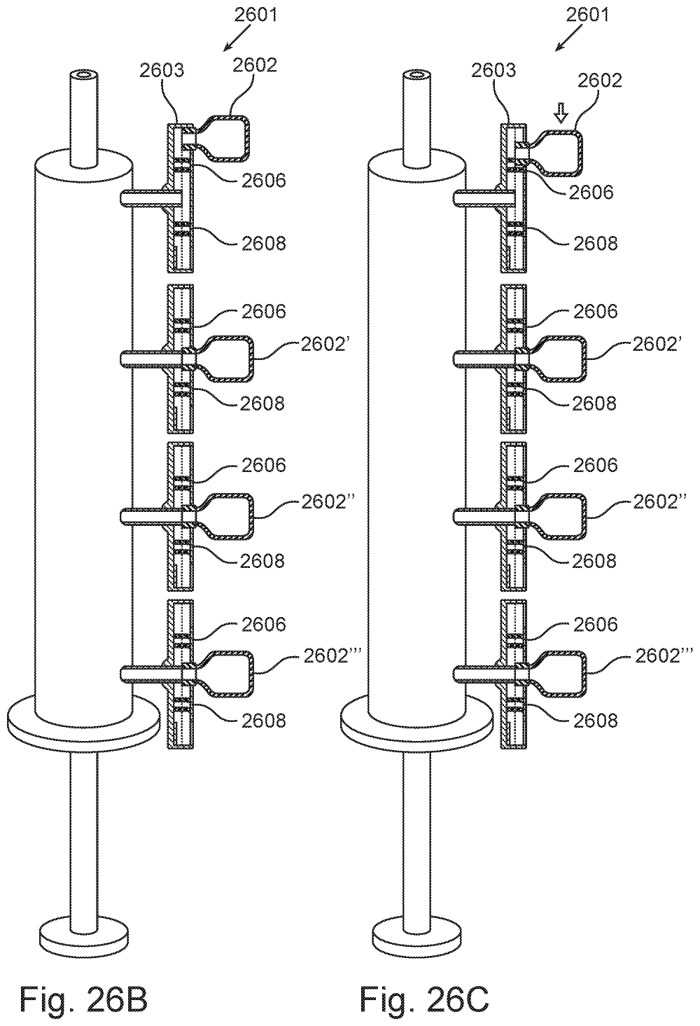

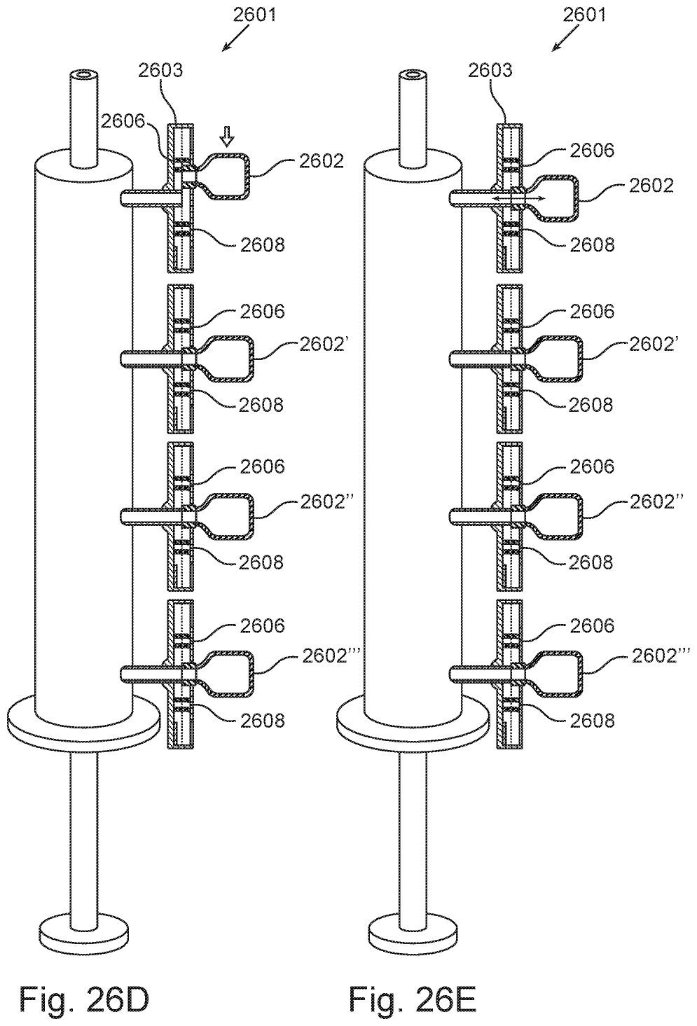

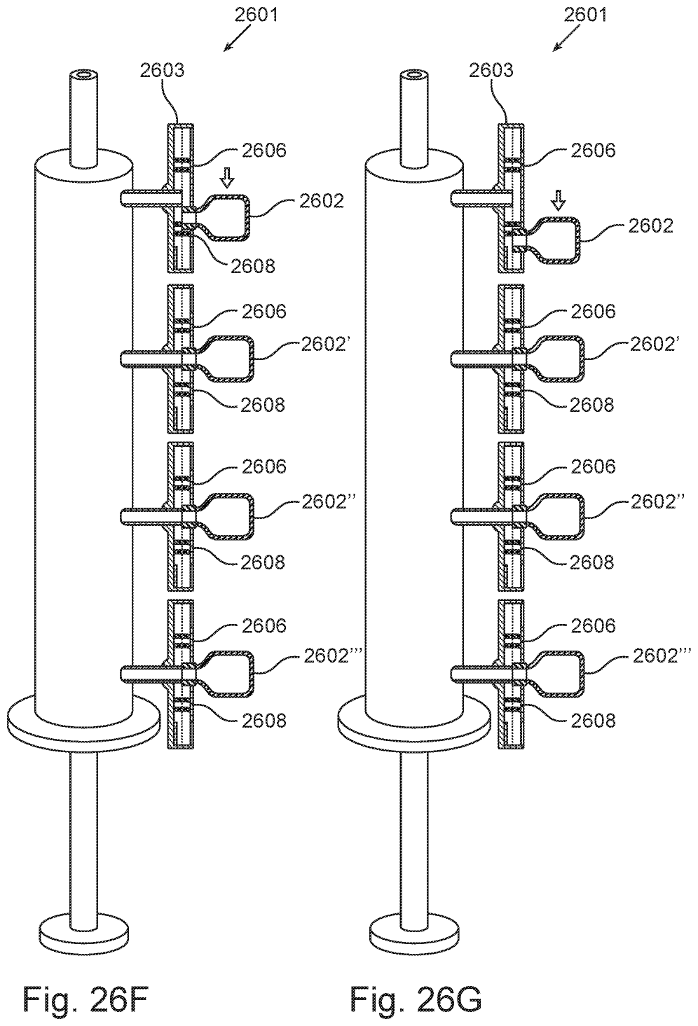

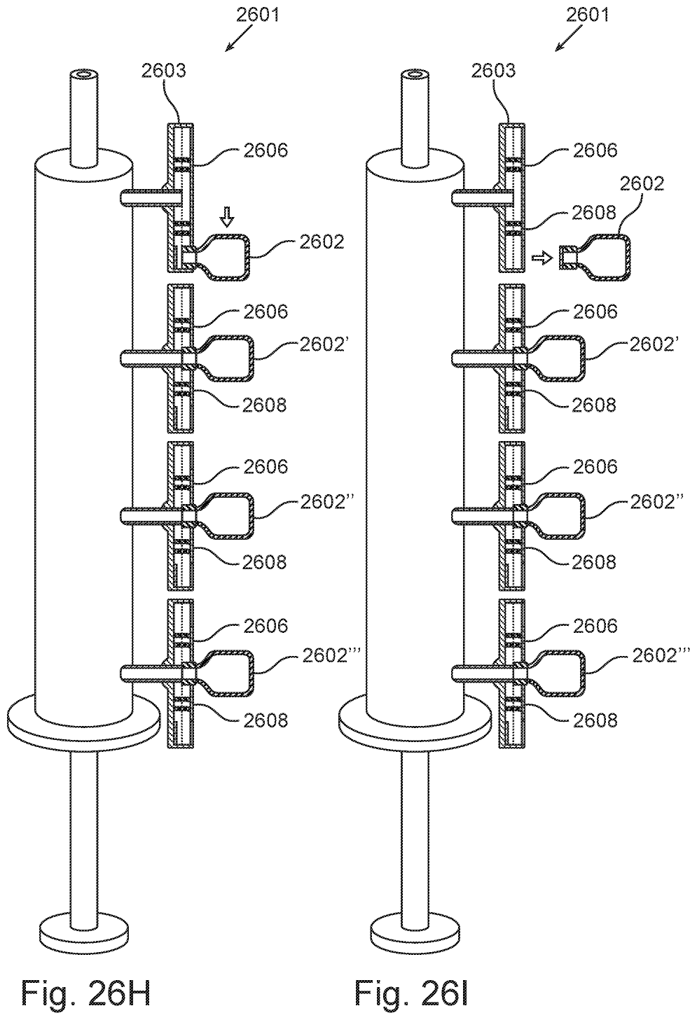

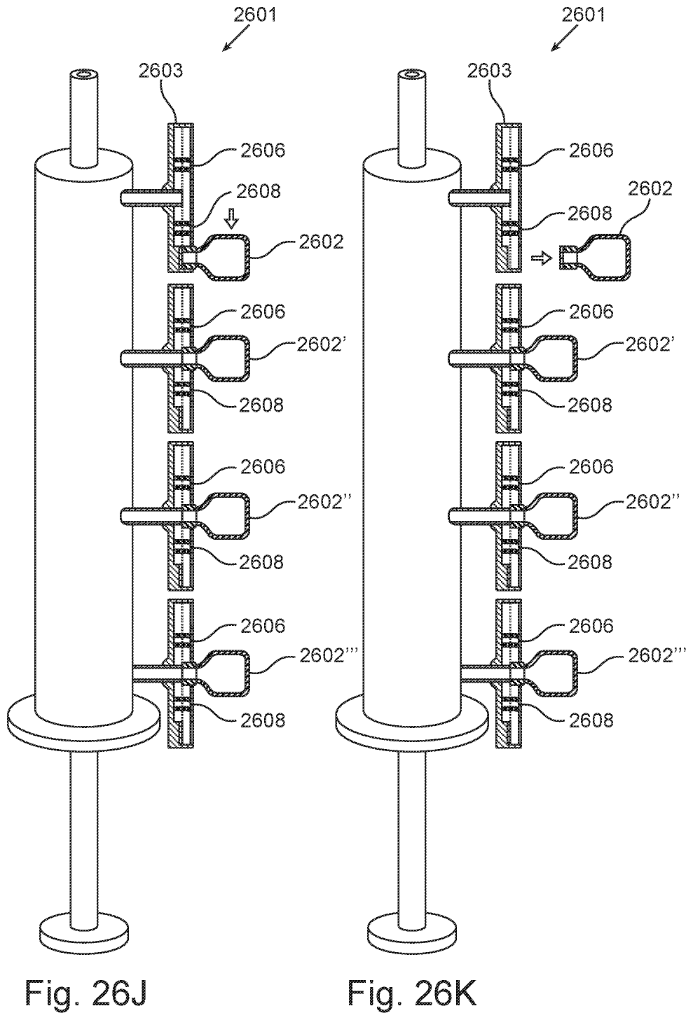

FIGS. 26A-26K are schematic front cut view illustrations presenting a further exemplary system which includes a syringe 2601 having a plurality of entry ports 2603, wherein a plurality of containers 2602 are received and engaged by the plurality of entry ports 2603 to transfer a dose from the plurality of containers 2602 to the syringe 2601, according to some embodiments of the invention.

As shown in FIG. 26A, container 2602 and entry port 2603 are separated and contaminates 2607 are shown on the distal tip of container 2602. In FIG. 26B, container 2602 is engaged with entry port 2603. The container 2602 is able to slide from a first (top) compartment in the entry port 2603 to a second (middle) compartment in the entry port 2603 as shown in FIGS. 26C-26D. The contaminants 2607 are not able to enter the second compartment as a double wiping member 2606 is provided that removes the contaminants from the surface of container 2602.

FIG. 26E shows the transfer of dose from the container 2602 through the entry port 2603 into the syringe 2601 through which is a contaminant-free fluid passageway in the second compartment.

After the dose is transferred, FIGS. 26F-26I shows the container 2602 sliding to a third (bottom) compartment. A double wiping member 2608 is used to decontaminate the distal tip of container 2602 prior to passing into the third compartment.

In certain embodiments, the third compartment has a resealing element, such that upon and/or after entering the third compartment, the distal end of the container 2602 mates with the resealing element. Afterwards, the container 2602 is removed from the entry port 2603 as shown in FIGS. 2J-26K. The first double wiping member 2606 and the second double wiping member 2608 are characterized in the double wipers are spaced apart from each other.

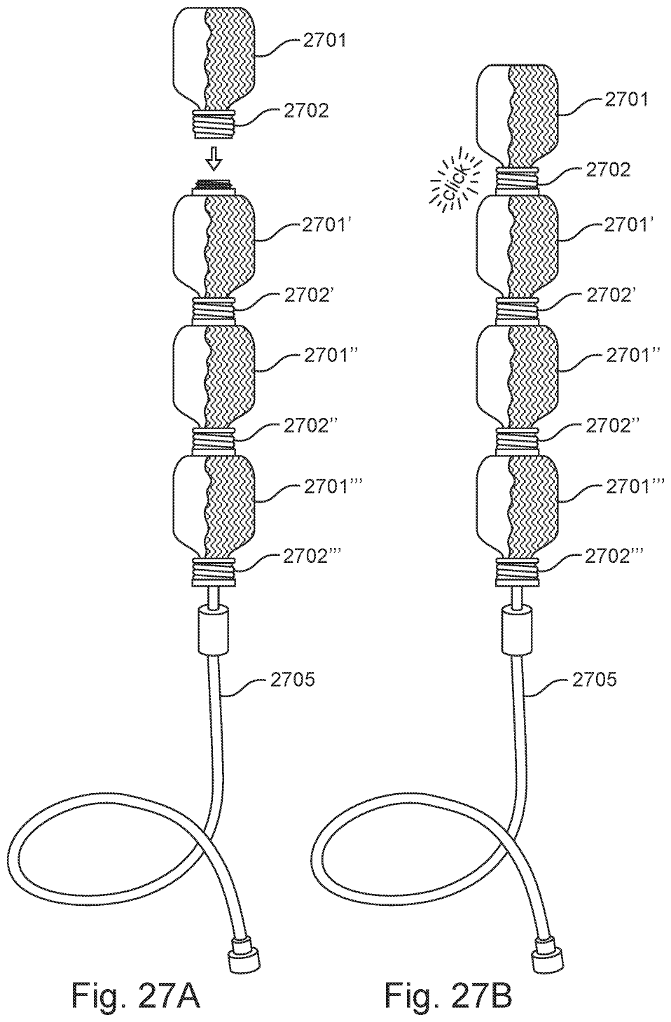

FIGS. 27A-27B are schematic front cut view illustrations presenting a further exemplary system which includes a modular dosing system of a plurality of containers 2701, whereby the containers 2701 are configured to be connected to one another, according to some embodiments of the invention.

As shown in FIG. 27A-27B, a container 2701 is shown having thread 2702. A second container 2701′ is shown having an upper thread and a bottom thread 2702′. The thread 2702 of the first container 2701 mates with the upper thread of the second container 2701′ in order to place the container 2701 and 2701′ in fluid communication with one another. Additional containers 2701″ and 2701′″ are mated together in a similar series configuration terminating in IV line 2705.

FIG. 27B shows that when container 2701 is mated with container 2701′, a “click” or any other sound is provided to know when the containers are engaged and/or hermetically sealed with one another. When the plurality of containers 2701 are in fluidic communication with one another a force of gravity pulls the contents of the plurality of containers down into the infusion line. The containers 2701 may house a beneficial substance and/or a medicament in nonstandard amounts, standard amounts and combinations thereof. Contents of the first container 2701 flow down through the second container 2701′, flow down through the third container 2701″ and flow down through the fourth container 2701′″ into an infusion line 2705. In this embodiment, the second and third containers house a beneficial substance as well as provide a fluidic passageway for the flow of contents of container 2701 to flow through container 2701′ and 2701″ into container 2701′″. Optionally, the infusion line 2705 may not be present. Engagement between containers 2701 may be airtight and/or hermetic.

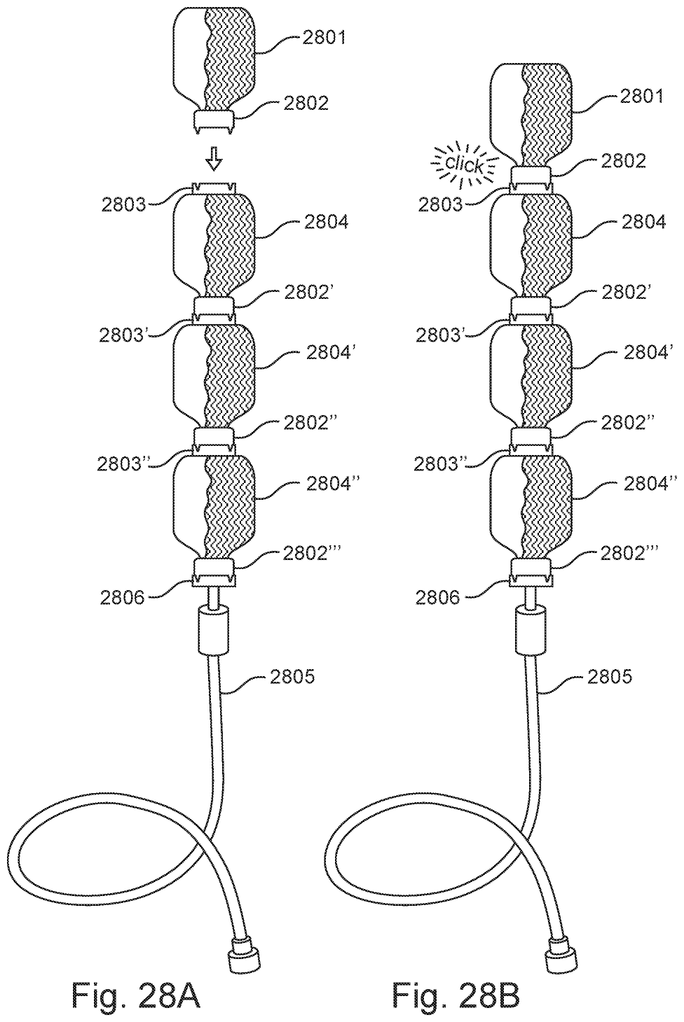

FIGS. 28A-28B are schematic front cut view illustrations presenting a further exemplary system which includes a modular dosing system of a plurality of containers 2801, 2804, 2804′, and 2804″, whereby the containers 2801, 2804, 2804′ and 2804″ are configured to be connected to one another, according to some embodiments of the invention. In certain embodiments, the system of FIG. 28A-28B is a modular system providing for the customization of a final amount of a beneficial substance provided to a patient.

As shown in FIG. 28, a first container 2801 is shown having ratchet teeth 2802. A second container 2804 is shown having an upper ratchet tooth 2803 and a bottom ratchet tooth 2802′. The ratchet teeth 2802 of the first container 2801 mates with the upper ratchet teeth 2803 of the second container 2804 in order to place the container 2801 and 2804 in fluid communication with one another. Additional containers 2804′ and 2804″ are mated together in a similar series configuration terminating in IV line 2805.

FIG. 28B shows that when container 2801 is mated with container 2804, a “click” sound is provided to alert a user when the containers are engaged and/or hermetically sealed with one another. In certain embodiments, other sounds may be produced to alert a user when the containers are engaged.

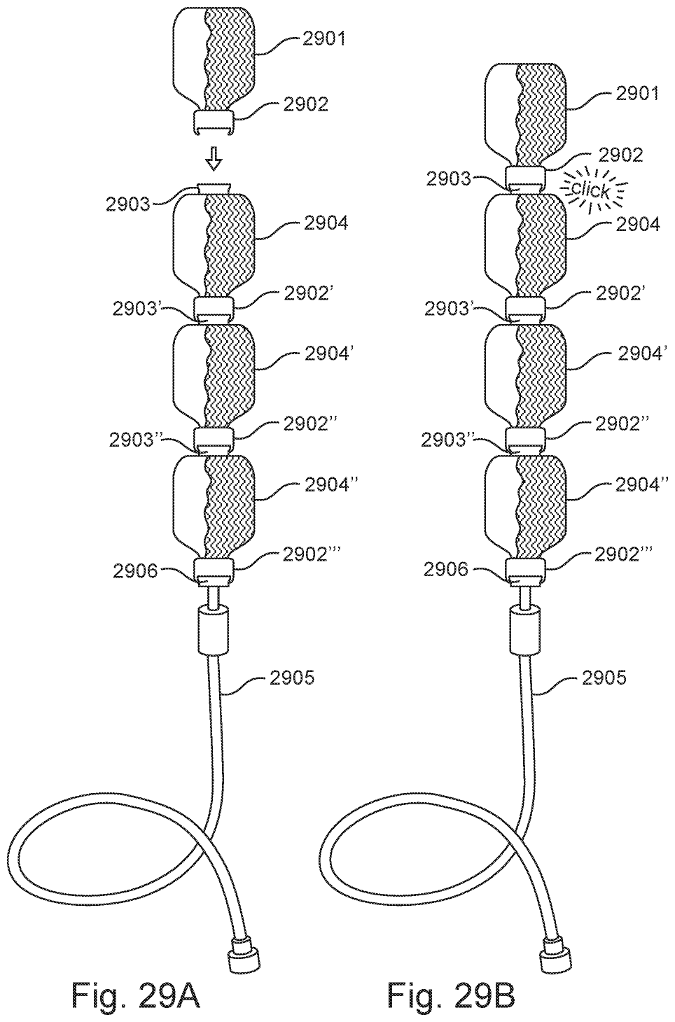

FIGS. 29A-29B are schematic front cut view illustrations presenting a further exemplary system which includes a modular dosing system of a plurality of containers 2901, 2904, 2904′, and 2904″ whereby the containers 2901, 2904, 2904′, and 2904″ are configured to be connected to one another, according to some embodiments of the invention.

As shown in FIG. 29, a container 2901 is shown having ratchet teeth 2902. A second container 2904 is shown having a retention member 2903 and a ratchet tooth 2902′. The ratchet teeth 2902 of the first container 2901 mates with the retention member 2903 of the second container 2904 in order to place the container 2901 and 2904 in fluid communication with one another. Additional containers 2904′ and 2904″ are mated together in a similar series configuration, optionally, terminating in IV line 2905.

FIG. 29B shows that when container 2901 is mated with container 2904, a “click” sound is provided to know when the containers are engaged and/or hermetically sealed with one another.

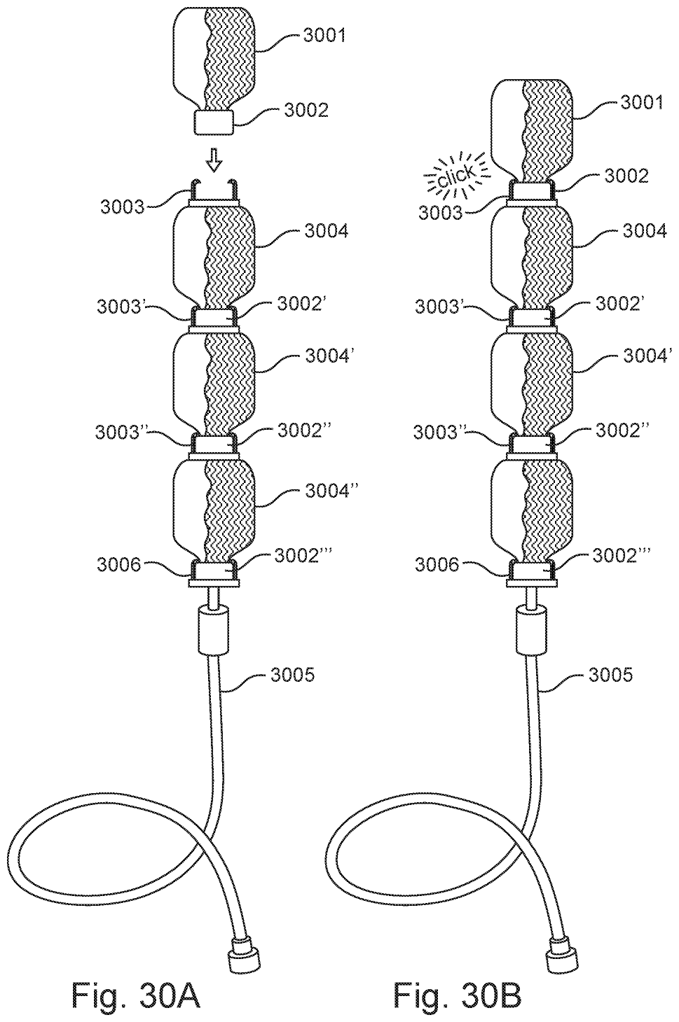

FIGS. 30A-30B are schematic front cut view illustrations presenting a further exemplary system which includes a modular dosing system of a plurality of containers 3001, 3004, whereby the containers 3001, 3004 are configured to be connected to one another, according to some embodiments of the invention.

As shown in FIG. 30A, a container 3001 is shown having a cap 3002. A second container 3004 is shown having a clasping member 3003 and a cap 3002′. The cap 3002 of the first container 3001 mates with the clasping member 3003 of the second container 3004 in order to place the container 3001 and 3004 in fluid communication with one another. Additional containers 3004′ and 3004″ are mated together in a similar series configuration terminating in IV line 3005.

FIG. 30B shows that when container 3001 is mated with container 3004, a “click” sound is provided to know when the containers are engaged and/or hermetically sealed with one another.

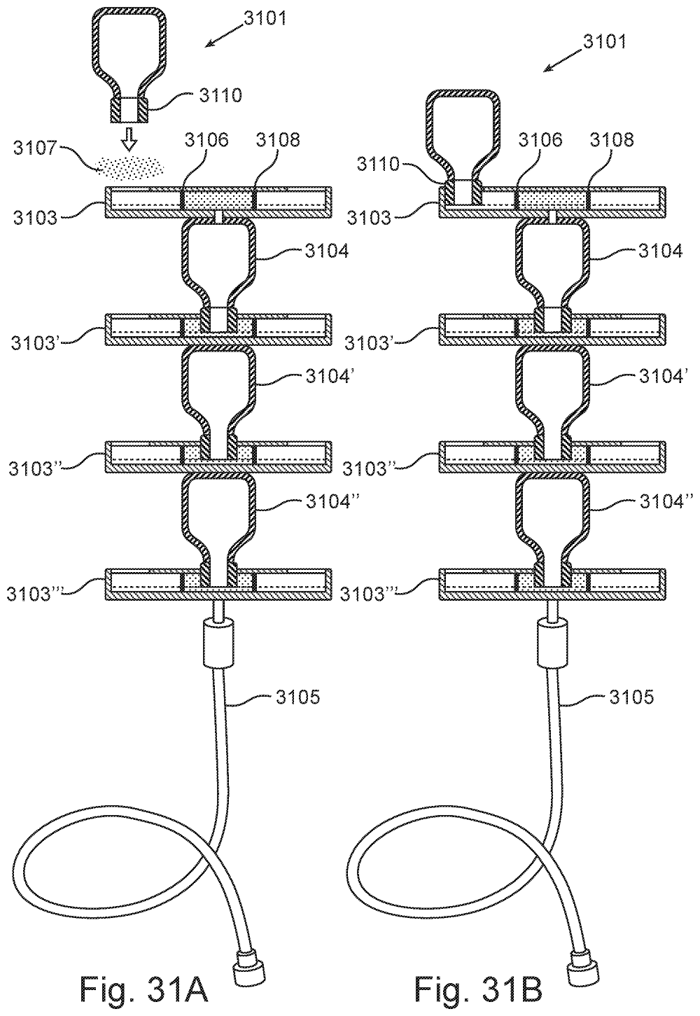

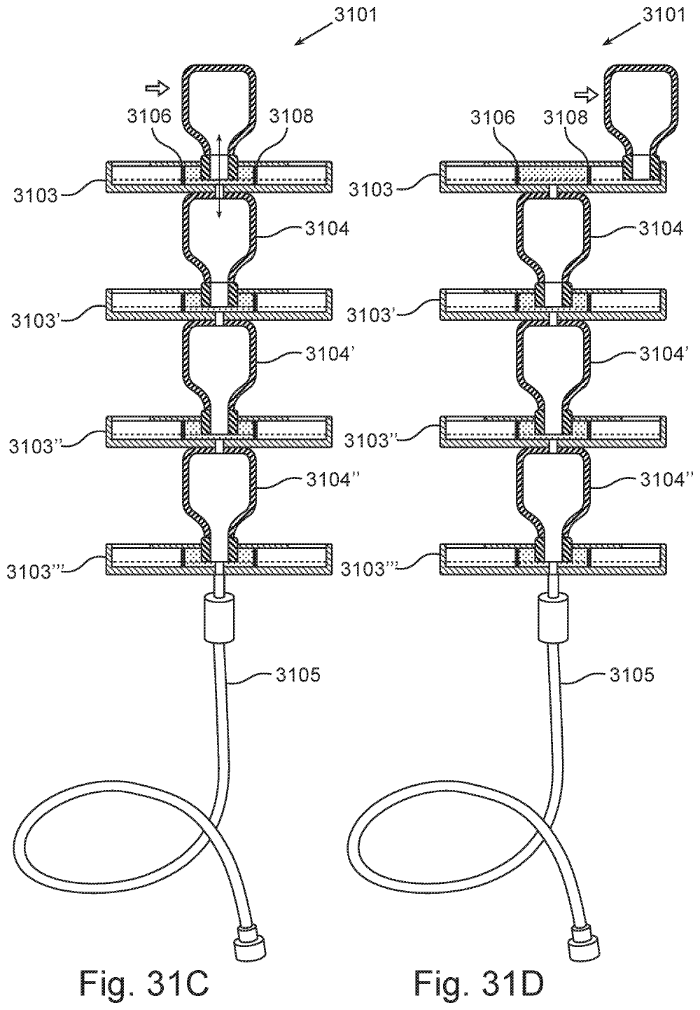

FIGS. 31A-31D are schematic front cut view illustrations presenting a further exemplary system 3101 which includes a modular dosing system of a plurality of containers 3101, 3104, whereby the containers 3101, 3104 are configured to be connected to one another, according to some embodiments of the invention.

As shown in FIG. 31A, container 3101 and entry port 3103 are separated and contaminants 3107 are shown on the distal tip of container 3101, which has a cap member 3110 with an opening. In one or more embodiments, the opening of the cap member 3110 may be sealed. In FIG. 31B, container 3101 is engaged with entry port 3103 of container 3104. The container 3101 is able to slide from a first compartment in the entry port 3103 to a second compartment in the entry port 3103 as shown in FIGS. 31B-31C. The contaminants 3107 are not able to enter the second compartment as a wiping member 3106 is provided that removes (wipes off) the contaminants from the surface of container 3102. Wiping member 3106 may be made of a rubber or any other elastomeric material.

FIG. 31C shows the transfer of dose from the container 3101 through the entry port 3103 into another container 3104 through which is a contaminant-free fluid passageway in the second compartment.

After the dose is transferred, FIG. 31D shows the container 3102 sliding to a third compartment. A wiping member 3108 is used to decontaminate the distal tip of container 3101 prior to passing into the third compartment.

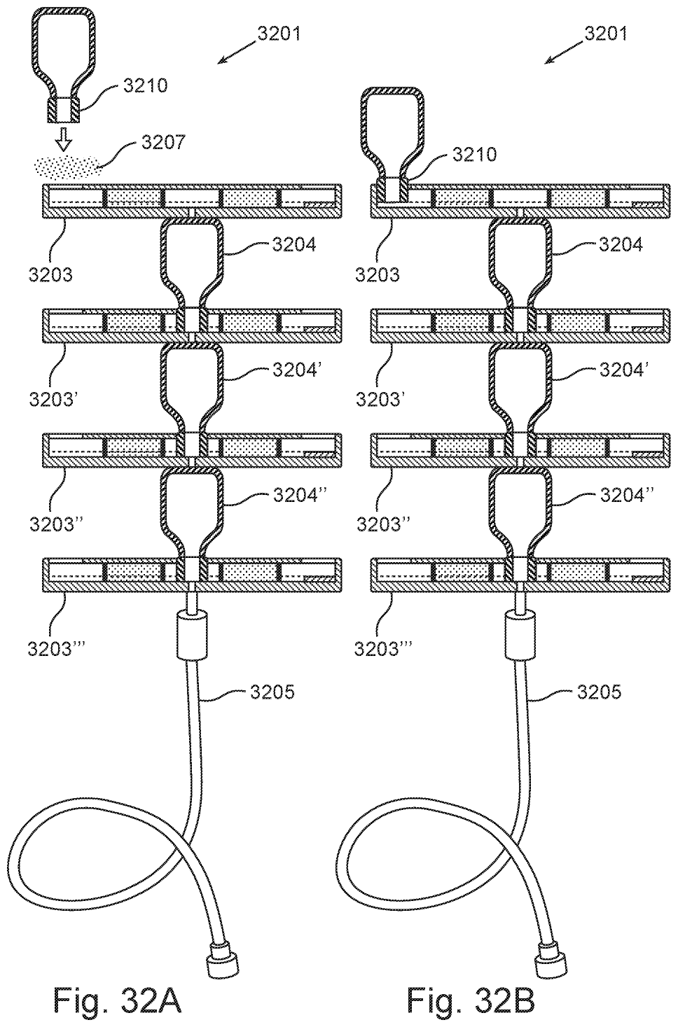

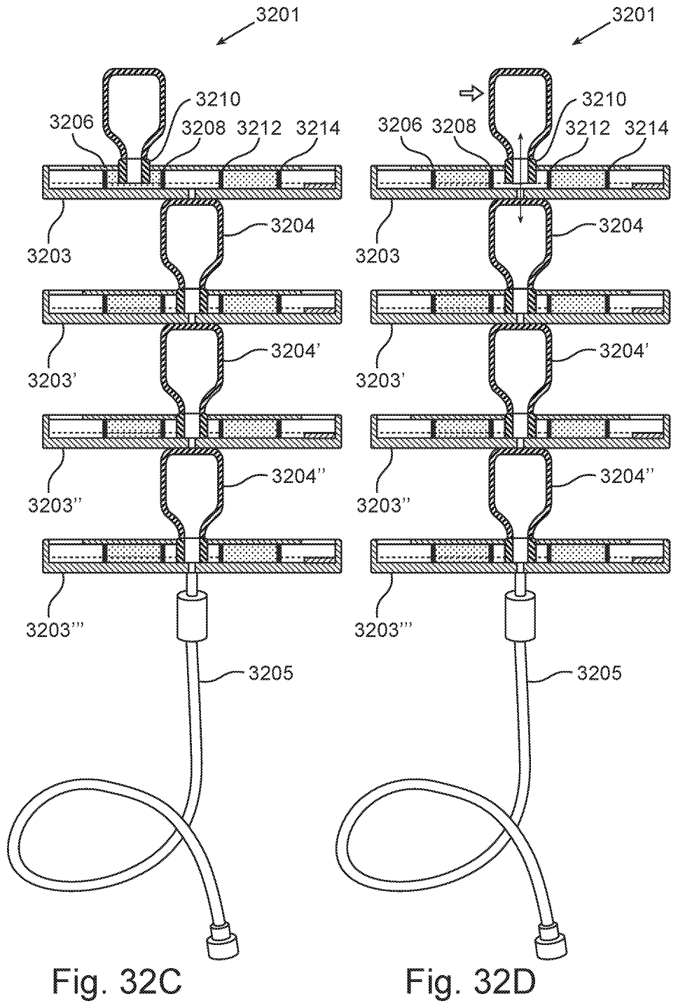

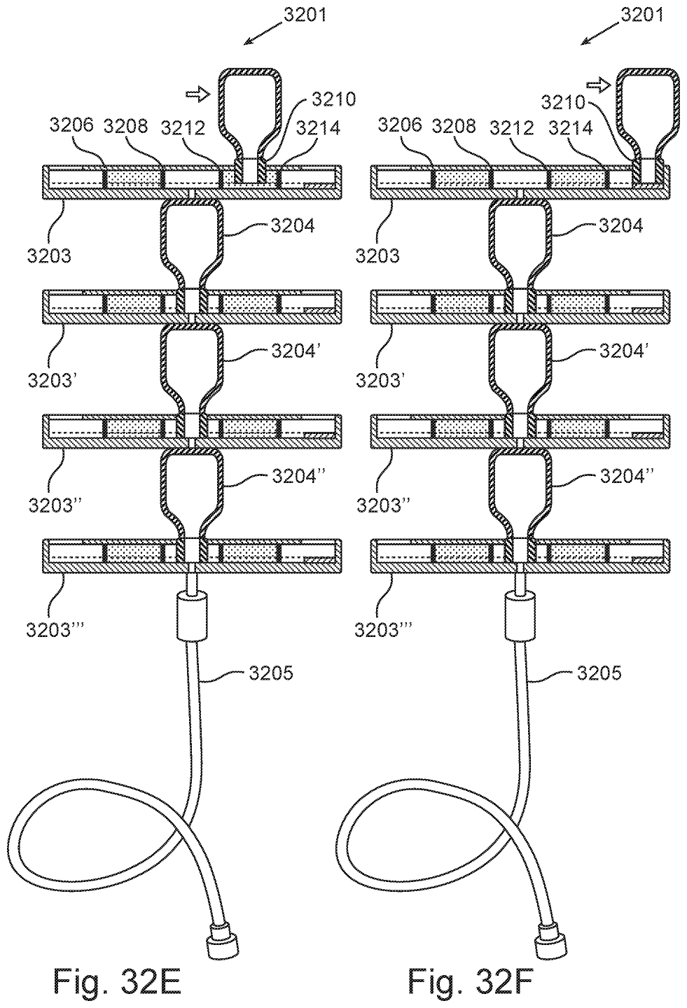

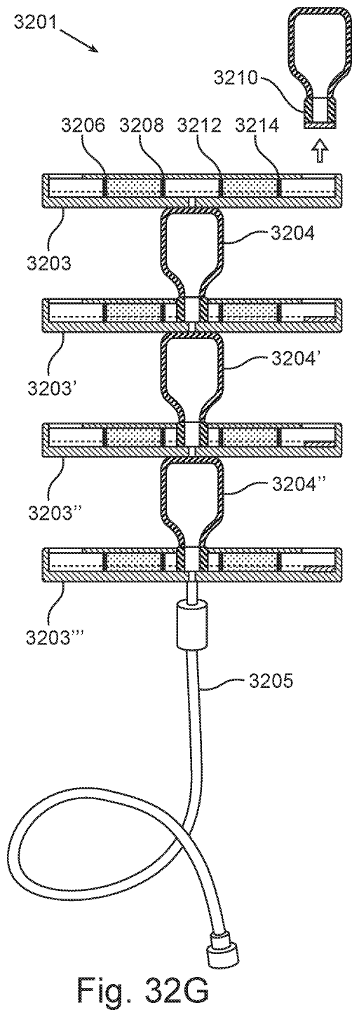

FIGS. 32A-32G are schematic front cut view illustrations presenting a further exemplary system which includes a modular dosing system of a plurality of containers 3201, 3204, whereby the containers 3201, 3204 are configured to be connected to one another, according to some embodiments of the invention.

As shown in FIG. 32A, container 3201 and entry port 3203 are separated and contaminates 3207 are shown on the distal tip of container 3201, which has a cap member 3210 with an opening, wherein the opening may be sealed or covered. In FIG. 32B, container 3301 is engaged with entry port 3203. The container 3101 is able to slide from a first compartment in the entry port 3203 to a second compartment in the entry port 3203 and as shown in FIGS. 32B-32C. The contaminants 3207 are not able to enter the second compartment as a wiping member 3206 is provided that removes the contaminants from the surface of container 3201. The container 3201 then slides from second compartment to third compartment after passing wiping member 3208. The second compartment of entry port 3203 may house a sterilizing or disinfecting substance. Optionally, the second compartment of entry port 3203 may house a sponge-like or absorptive material that wipes off the surface of container 3201. Optionally, the second compartment of entry port 3203 may have a pressure that is greater than or less than the first compartment of entry port 3203.

FIG. 32D shows the transfer of dose from the container 3201 through the entry port 3203 into another container 3204 through which is a contaminant-free fluid passageway in the third (middle) compartment.

After the dose is transferred, FIG. 32E-32F shows the container 3201 sliding from the third compartment to a fourth and fifth compartment. Wiping members 3212 and 3214 are used to decontaminate the distal tip of container 3201 prior to or at about the time and/or at the time of passing into the fourth and fifth compartments, respectively. The fourth compartment of entry port 3203 may house a sterilizing or disinfecting substance. Optionally, the fourth compartment of entry port 3203 may have a pressure that is greater than or less than an adjacent compartment of entry port 3203.

FIG. 32G, shows the container 3201 being removed from the entry port 3203 whereby a resealing element located in the fifth compartment allows the container 3202 to be resealed and removed.

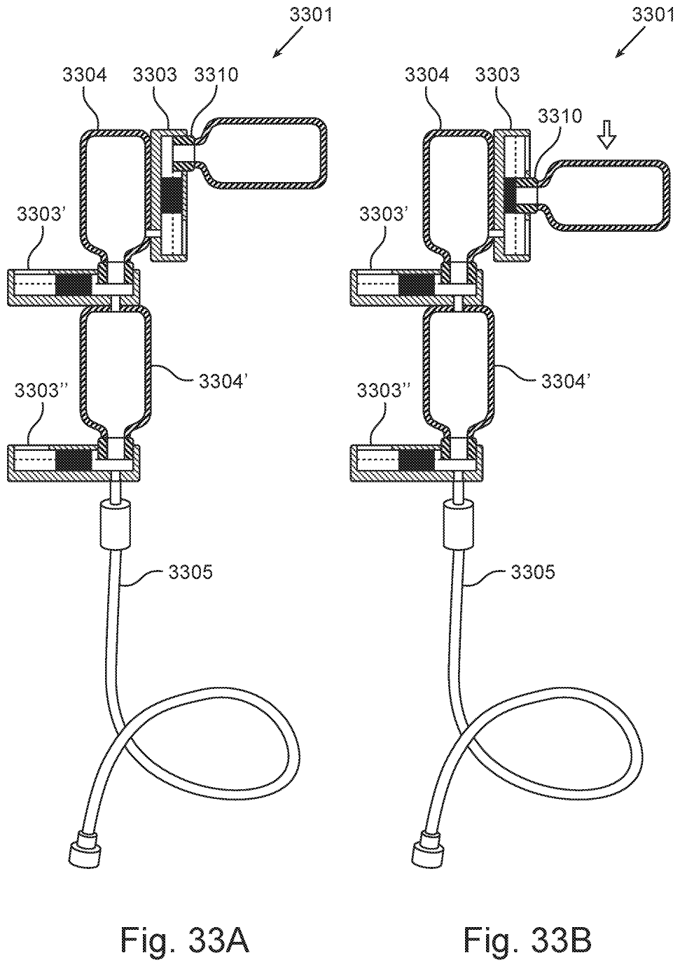

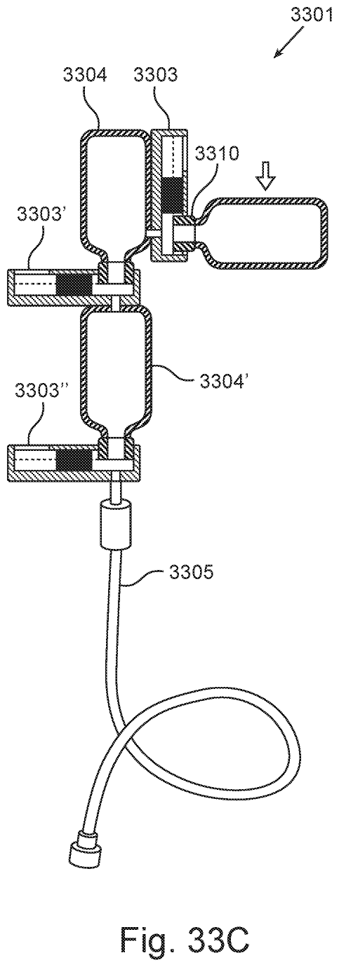

FIGS. 33A-33C are schematic front cut view illustrations presenting a further exemplary system which includes a modular dosing system of a plurality of containers 3302, 3304, whereby the containers 3302, 3304 are configured to be connected to one another, according to some embodiments of the invention.

As shown in FIG. 33A, container 3310 and entry port 3303 are engaged. Additional containers 3304 and 3304′ are also shown connected to the entry port 3303, 3303′ and 3303″ so as to form a modular system 3301, which may be connected to IV line 3305.

In FIG. 33B, container 3310 is engaged with entry port 3303. The container 3310 is able to slide from a first compartment in the entry port 3303 to a second (middle) compartment in the entry port 3303 as shown in FIGS. 33B. The contaminants are not able to enter the second compartment as a wiping member is disposed between the first and second compartments that removes the contaminants from the surface of container 3310. In one or more embodiments, the wiping member is at least as wide as an opening of container 3310.

FIG. 33C shows the transfer of dose from the container 3310 through the entry port 3303 into another container 3304 through which is a contaminant-free fluid passageway in the third compartment of entry port 3303. The same operation of mechanism applies for container 3304 and container 3304′ to decontaminate the surfaces of these containers.

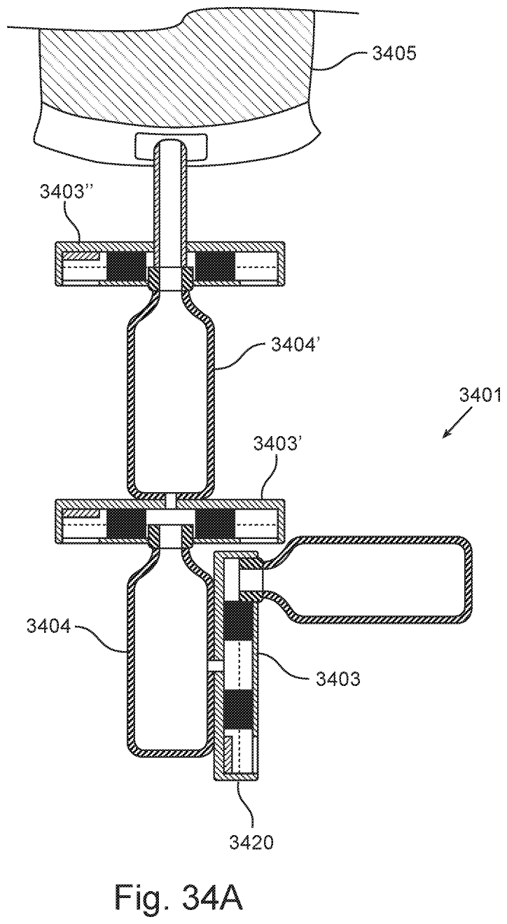

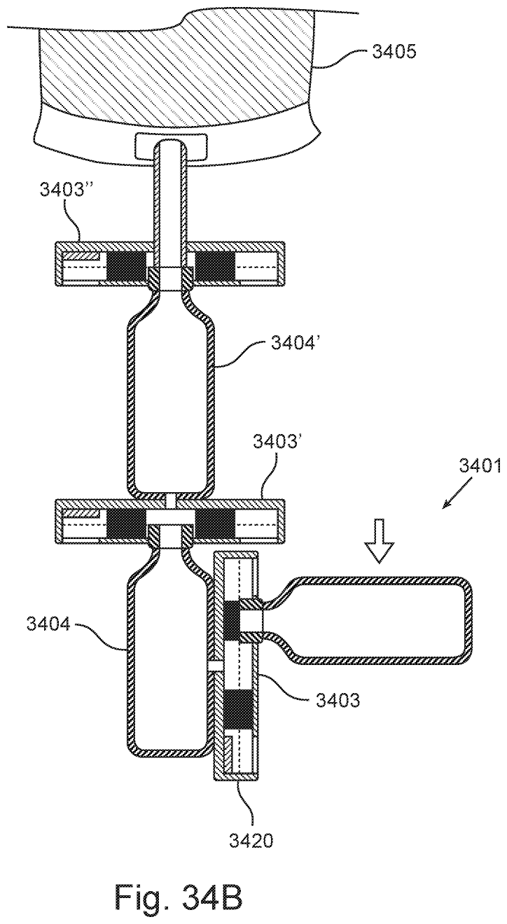

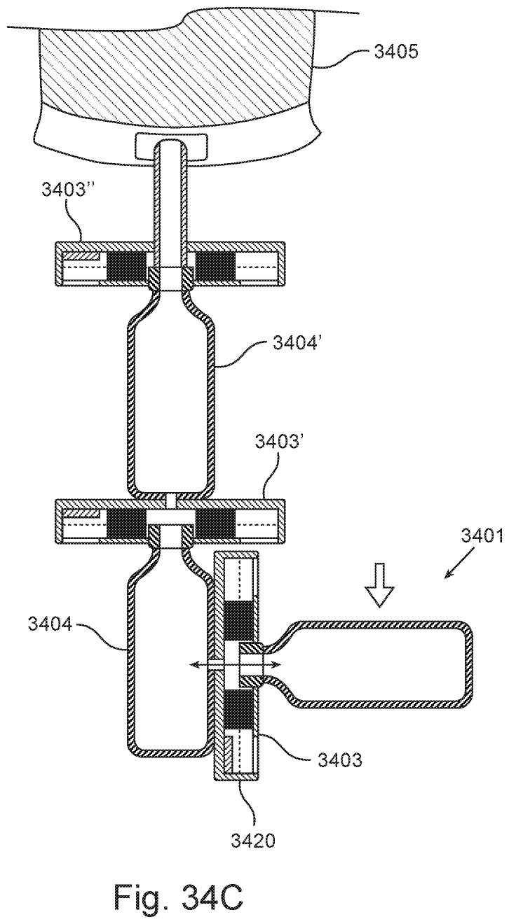

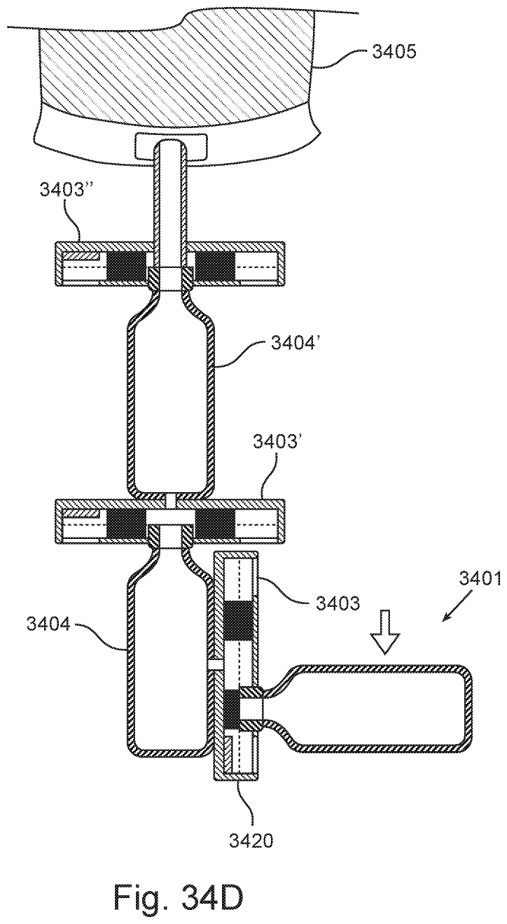

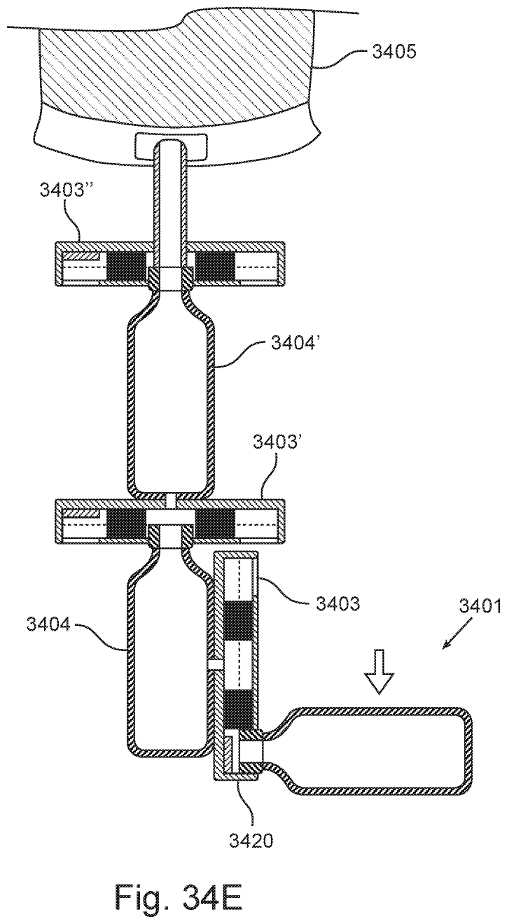

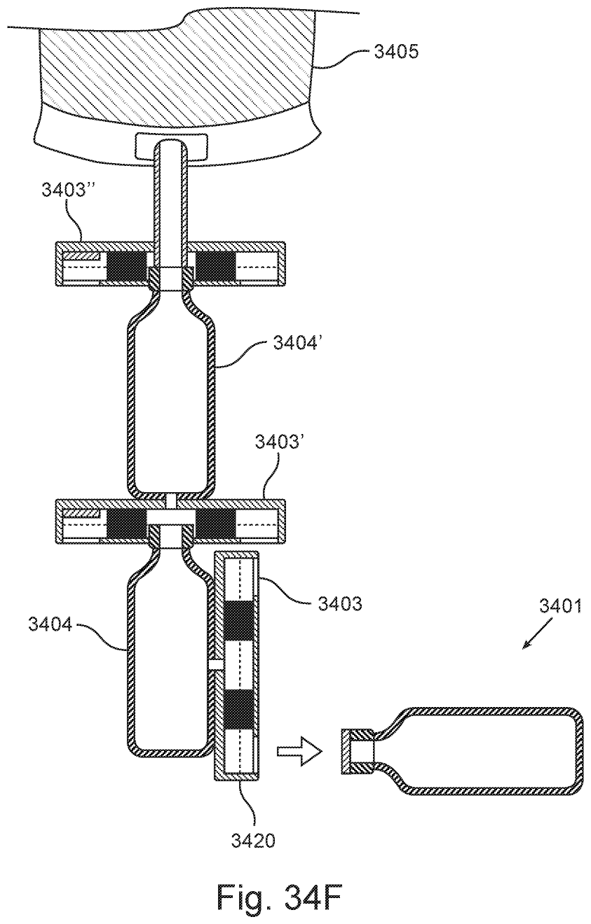

FIGS. 34A-34F are schematic front cut view illustrations presenting a further exemplary system which includes a modular dosing system of a plurality of containers 3401, 3404 connected to an IV bag 3405, whereby the containers 3404 are configured to be connected to one another, according to some embodiments of the invention.

As shown in FIG. 34A, container 3401 and entry port 3403 are engaged. The container 3401 is able to slide from a first compartment in the entry port 3403 to a second compartment in the entry port 3403 as shown in FIGS. 34B-34C. The contaminants are not able to enter the second compartment as a wiping member (black/dark rectangle) disposed between first and second compartment is provided that removes (wipes off) the contaminants from the surface of container 3402.

FIG. 34C shows the transfer of dose from the container 3401 through the entry port 3403 into another container 3404 through which is a contaminant-free fluid passageway in the second compartment.

After the dose is transferred, FIGS. 34D-E shows the container 3401 sliding to a fourth compartment. A wiping member (black/dark rectangle) disposed between the third and the fifth compartment is used to decontaminate the distal tip/end of container 3401 prior to passing into the fifth compartment. The width of the wiping member is at least as wide as an opening or aperture of container 3401.

FIG. 34F, shows the container 3401 being detached/removed from the entry port 3403 whereby a resealing element located in the fifth compartment reseals an opening or aperture of container 3401 and allows container 3401 to be detached/removed from entry port 3403.

The same operation of mechanism applies for container 3404 and container 3404′ to decontaminate the surfaces of these containers. Optionally, a fourth, a fifth, a sixth or more containers may be used in this modular assembly.

It is important to note that for all modular dosing systems disclosed in this invention, any vessels, containers, and/or decontamination devices/systems may have piercing members, actuators and/or frangible/rupturable seals/covers that provide for a fluidic passageway and/or a plurality of fluidic passageways to be established between the vessels, containers, and/or decontamination devices. In certain embodiments, the piercing members may be needles. In certain embodiments, the needles may be hollowed needles.

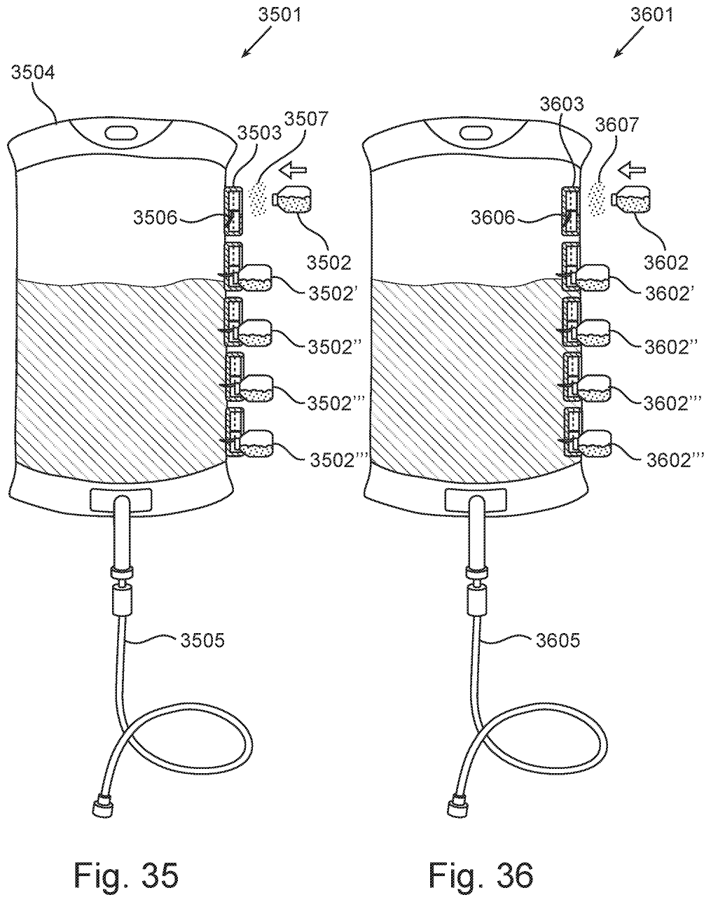

FIG. 35 is a schematic front cut view illustration presenting a further exemplary system 3501 which includes an IV bag 3504 having a plurality of entry ports 3503 and an exit port 3505, wherein a plurality of containers 3502 are received and engaged by the plurality of entry ports 3503 to transfer a dose from the plurality of containers 3502 to the IV bag 3504, according to some embodiments of the invention. It must be noted, that for any of the systems and/or devices disclosed in this invention the bags are used arbitrarily. Any vessel, device and/or container may replace the bag.

FIG. 35 shows the entry ports 3503 surface mounted onto the bag 3504 and includes an entry port 3503 having a piercing member 3506. In one or more embodiments, the entry ports 3503 abut a wall of the bag 3504. In one or more embodiments, the entry ports 3503 share a wall with the bag 3504. In one or more embodiments, the entry ports 3503 are surface mounted to a side wall of the bag 3504. In one or more embodiments, the entry ports 3503 may be located on a top wall of the bag (not shown), on a bottom wall of the bag (not shown), on a side wall of the bag and combinations thereof. In one or more embodiments, the entry ports 3503 are decontamination devices. The bag 3504 is used arbitrarily an may be any medical vessel, container and/or device. In one or more embodiments, entry ports 3503 abutting a wall of the bag may be decontamination devices. In one or more embodiments, entry ports 3503 surface mounted to a wall of a bag may be decontamination devices.

FIG. 36 is a schematic front cut view illustration presenting a further exemplary system 3601 which includes an IV bag having a plurality of entry ports 3603 and an exit port 3605, wherein a plurality of containers 3602 are received and engaged by the plurality of entry ports 3603 to transfer a dose from the plurality of containers 3602 to the IV bag 3604, according to some embodiments of the invention.

FIG. 36 shows the entry ports 3603 flush mounted within the bag and includes an entry port 3603 having a piercing member 3606. In one or more embodiments, at least a portion of the entry ports 3603 may be flush mounted within the bag. In one or more embodiments, the entire entry port may be flush mounted within the bag. In one or more embodiments, the entry ports abutting a wall of the bag. In one or more embodiments, entry ports 3603 flush mounted to the bag may be decontamination devices.

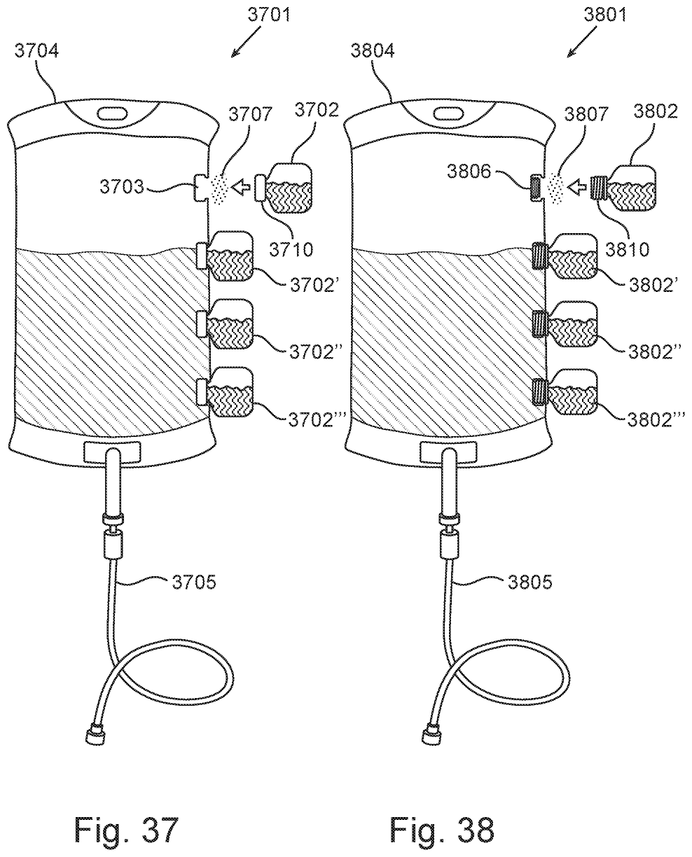

FIG. 37 is a schematic front cut view illustration presenting a further exemplary system 3701 which includes a IV bag 3704 having a plurality of entry ports 3703 and an exit port 3705, wherein a plurality of containers 3702 are received and engaged by the plurality of entry ports 3703 to transfer a dose from the plurality of containers 3702 to the IV bag 3704, according to some embodiments of the invention.

FIG. 37 shows the entry port 3703 abutting the bag 3704 whereby the container 3702 is pressed onto the bag 3704 when the container and the bag are engaged to one another. In one or more embodiments, the entry ports 3703 are flush mounted to the bag. In one or more embodiments, the containers 3702 abut a wall of the bag 3704 when the containers 3702 are engaged to the bag 3704 thus providing a firm and secure engagement between containers 3702 and bag 3704.

FIG. 38 is a schematic front cut view illustration presenting a further exemplary system 3801 which includes an IV bag 3804 having a plurality of entry ports 3803 and an exit port 3805, wherein a plurality of containers 3802 are received and engaged by the plurality of entry ports 3803 to transfer a dose from the plurality of containers 3802 to the IV bag 3804, according to some embodiments of the invention.

FIG. 38 shows the plurality of containers 3802 having threads 3810 and the bag 3804 having a corresponding thread 3806 disposed on and/or within entry ports 3803. Contaminants 3807 are pressed between threads 3810 and 3806 and fluid can pass through a passageway between the thread members. In one or more embodiments, the threads 3806 and 3810 may be a luer. In one or more embodiments, the threads 3806 and 3810 may be luer-lock. In one or more embodiments, the threads 3806 and 3810 may be a smart-site. In one or more embodiments threads 3806 and/or threads 3810 may have a locking feature/member. In one or more embodiments, the locking feature/member may provide for a permanent locking of threads 3806 and 3810. In one or more embodiments, the permanent locking may be an irreversible locking.

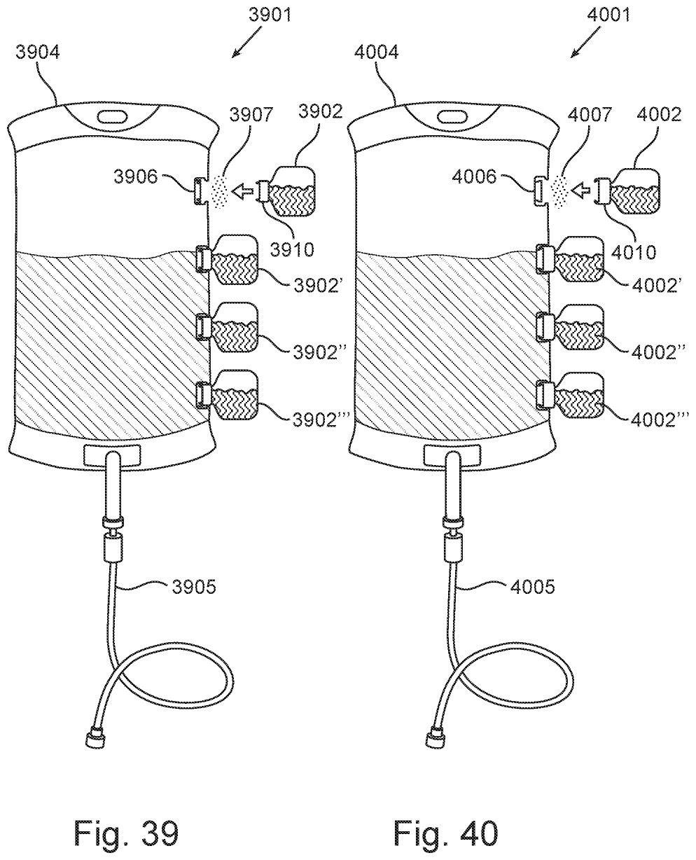

FIG. 39 is a schematic front cut view illustration presenting a further exemplary system 3901 which includes an IV bag 3904 having a plurality of entry ports 3903 and an exit port 3905, wherein a plurality of containers 3902 are received and engaged by the plurality of entry ports 3903 to transfer a dose from the plurality of containers 3902 to the IV bag 3904, according to some embodiments of the invention.

FIG. 39 shows the plurality of containers 3902 having ratchet teeth 3910 and the bag 3904 having a corresponding female member 3906 engaged by ratchet teeth 3910. Contaminants 3907 are pressed between ratchet teeth 3910 and female member 3906 and fluid can pass through a passageway between these members.

FIG. 40 is a schematic front cut view illustration presenting a further exemplary system 4001 which includes an IV bag 4004 having a plurality of entry ports and an exit port 4005, wherein a plurality of containers 4002 are received and engaged by the plurality of entry ports 4003 to transfer a dose from the plurality of containers 4002 to the IV bag 4004, according to some embodiments of the invention.

FIG. 40 shows the plurality of containers 4002 having ratchet teeth 4010 and the bag 4004 having a corresponding female member 4006 disposed on or within the entry ports engaged by ratchet teeth 4010. Contaminants 4007 are pressed between ratchet teeth 4010 and female member 4006 and fluid can pass through a passageway between these members. The female members 4006 are flush mounted to the bag. Optionally, a plurality of the female members abut a wall of the bag.

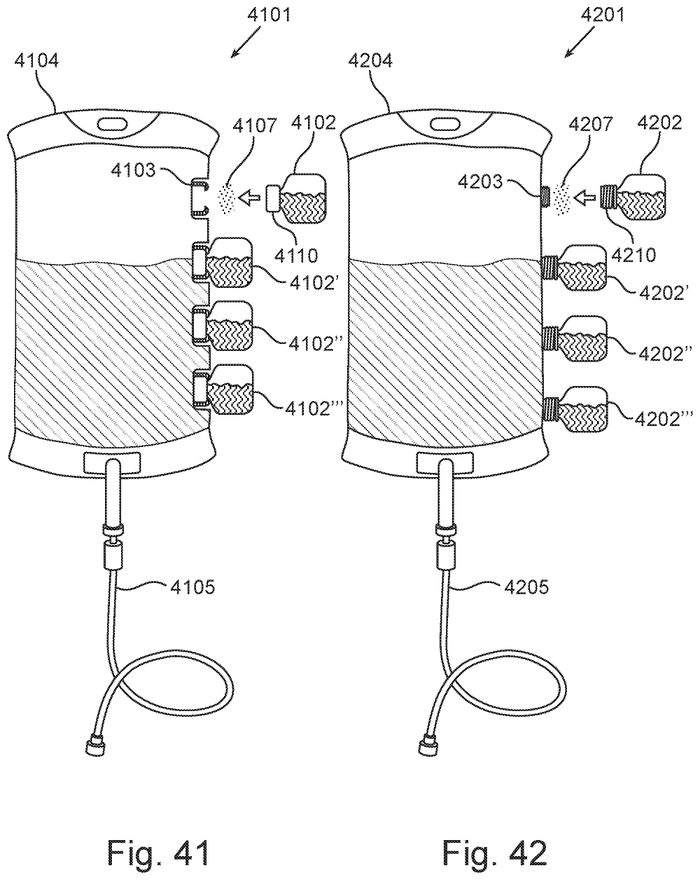

FIG. 41 is a schematic front cut view illustration presenting a further exemplary system 4101 which includes an IV bag 4104 having a plurality of entry ports 4103 and an exit port 4105, wherein a plurality of containers 4102 are received and engaged by the plurality of entry ports 4103 to transfer a dose from the plurality of containers 4102 to the IV bag 4104, according to some embodiments of the invention.

FIG. 41 shows the plurality of containers 4102 having a cap 4110 and the bag 4104 having a clasping member 4103 that engages cap 4110. Contaminants 4107 are pressed between cap 4110 and clasping member 4103 and fluid can pass through a passageway between these members. The clasping member 4103 is flush mounted to the bag 4104. Optionally, the clasping member 4103 abuts a wall of the bag. In one or more embodiments, the bag 4104 has a plurality of piercing members (not shown) configured to pierce a surface of at least cap 4110 to establish a fluidic communication between containers 4102 and bag 4104. In one or more embodiments, containers 4102 have piercing members configured to pierce a surface/cap 4110 of containers 4102 at about the time or after engagement with bag 4104. In one or more embodiments, both bag 4104 and containers 4102 have piercing member configured to pierce at least one surface of bag 4104 and container 4102 to establish a fluidic passageway between bag 4104 and containers 4102. In one or more embodiments, the piercing members are disposed within bag 4104. In one or more embodiments, the piercing members are disposed within containers 4102. In one or more embodiments, the piercing members are disposed within container 4102 and bag 4104.

FIG. 42 is a schematic front cut view illustration presenting a further exemplary system 4201 which comprises an IV bag 4204 having a plurality of threads 4203 and an exit port 4205, wherein a plurality of containers 4202 are received and engaged by the plurality of threads 4203 to transfer a dose from the plurality of containers 4202 to the IV bag 4204, according to some embodiments of the invention.

FIG. 42 shows the plurality of containers 4202 having a thread 4210 and the bag 4204 having a plurality of threads 4203 that engages thread 4210. Contaminants 4207 are pressed between thread 4210 and thread 4203 and fluid can pass through a passageway between these members. The thread 4203 is flush mounted to the bag 4204. Optionally, the threads 4203 abut the bag. Optionally, the threads 4203 abut a wall of the bag. Optionally, the threads 4203 abut a side wall of the bag 4204 as shown.

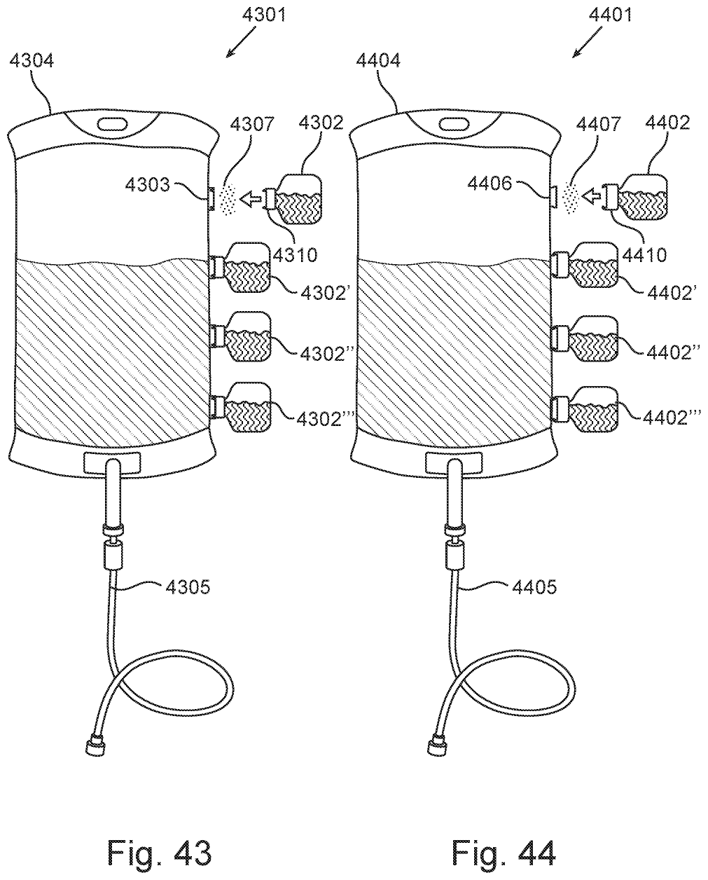

FIG. 43 is a schematic front cut view illustration presenting a further exemplary system 4301 which includes an IV bag 4304 having a plurality of female members 4303 and an exit port 4305, wherein a plurality of containers 4302 are received and engaged by the plurality of female members 4303 to transfer a dose from the plurality of containers 4302 to the IV bag 4304, according to some embodiments of the invention.

FIG. 43 shows the plurality of containers 4302 having a ratchet tooth 4310 and the bag 4304 having a plurality of female members/retention members 4303 that engage ratchet teeth 4310. Contaminants 4307 are pressed between ratchet teeth 4310 and female/retention members 4303 and fluid can pass through a passageway between these members. The female/retention members 4303 are surface mounted to the bag 4304. Optionally, the female members 4303 abut a wall of the bag as shown providing a firm and secure coupling of containers 4302 to bag 4304.

FIG. 44 is a schematic front cut view illustration presenting a further exemplary system 4401 which includes an IV bag 4404 having a plurality of entry ports and an exit port 4405, wherein a plurality of containers 4402 are received and engaged by the plurality of entry ports to transfer a dose from the plurality of containers 4402 to the IV bag 4404, according to some embodiments of the invention.

FIG. 44 shows the plurality of containers 4402 having a ratchet tooth 4410 and the bag 4404 having a plurality of entry ports (male members) 4406 that engage ratchet teeth 4410. Contaminants 4407 are pressed between ratchet teeth 4410 and entry ports (male members) 4406 and fluid can pass through a passageway between these members. The entry ports (male members) 4406 are surface mounted to the bag 4404. Optionally, the entry ports (male members) 4406 abut a wall of the bag 4404.

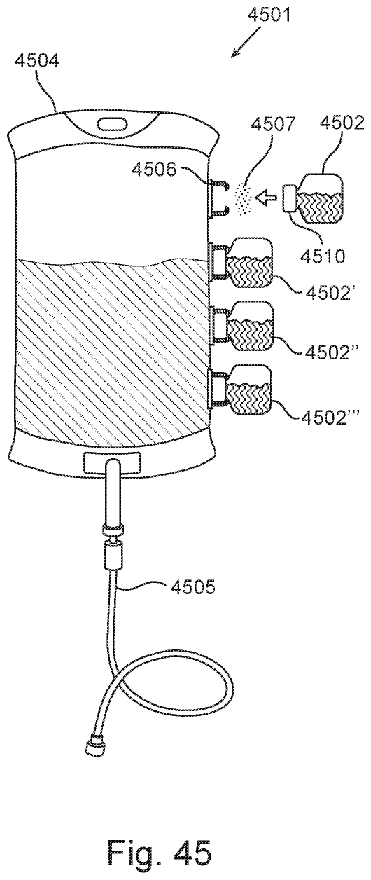

FIG. 45 is a schematic front cut view illustration presenting a further exemplary system 4501 which includes an IV bag 4504 having a plurality of entry ports and an exit port 4505, wherein a plurality of containers 4502 are received and engaged by the plurality of entry ports to transfer a dose from the plurality of containers 4502 to the IV bag 4504, according to some embodiments of the invention.

FIG. 45 shows the plurality of containers 4502 having a cap 4510 and the bag 4504 having a plurality of entry ports with clasping members 4506 that engage caps 4510. Clasping members 4506 may be made of a rigid plastic and/or metal alloy. Contaminants 4507 are pressed between cap 4510 and entry ports with clasping members 4506 and fluid can pass through a passageway between these members. The entry ports with clasping members 4506 are flush mounted to the bag 4504. The clasping members 4506 may abut a wall of the bag.

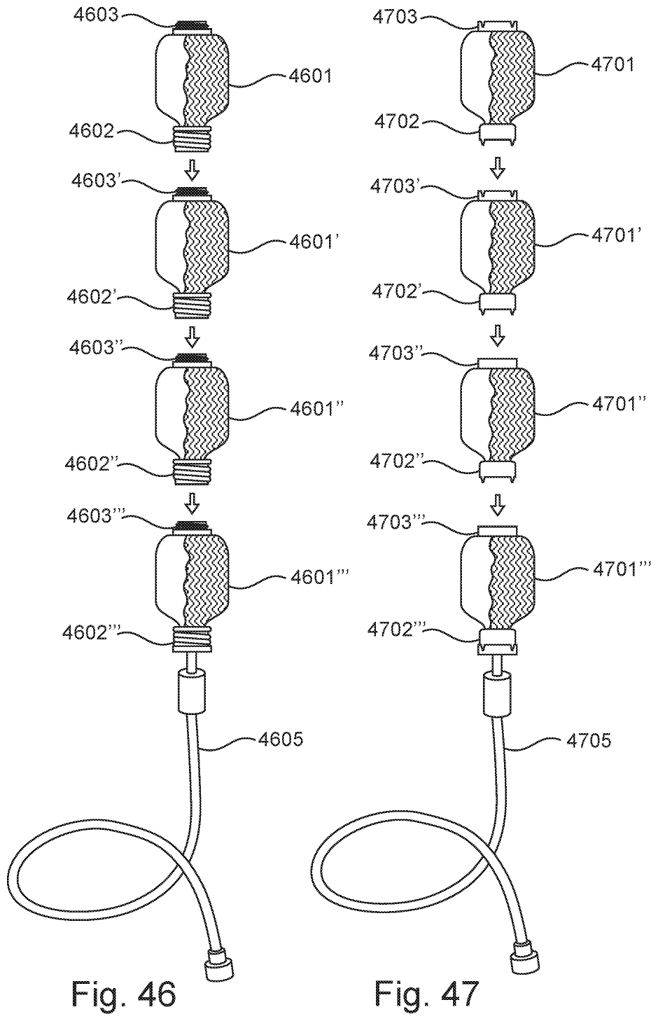

FIG. 46 is a schematic front cut view illustration presenting a further exemplary system which comprises a modular dosing system of a plurality of containers 4601, whereby the containers 4601 are configured to be connected to one another, according to some embodiments of the invention.

As shown in FIG. 46, a container 4601 is shown having lower thread 4602 and upper thread 4603. A second container 4601′ is shown having an upper thread 4603′ and a lower thread 4602′. The lower thread 4602 of the first container 4601 mates with the upper thread 4603′ of the second container 4601′ in order to place the container 4601 and 4601′ in fluid communication with one another. Additional containers 4601″ and 4601′ are mated together in a similar series configuration terminating in IV line 4605. In one or more embodiments, any of containers 4601, optionally a plurality of containers 4601, may have at least one piercing member or a displaceable container surface providing for at least one, optionally a plurality, fluidic passageways between the containers. Any beneficial substance (e.g. medicament) that is contained in containers 4601 flows from the top container 4601 through the middle containers 4601′ and 4601″ and down to the bottom container 4601′″ and into the infusion line 4605 via a force of gravity.

As shown in FIG. 47, a container 4701 is shown having lower ratchet teeth 4702 and upper ratchet teeth 4703. A second container 4701′ is shown having an upper ratchet tooth 4703′ and a lower ratchet teeth 4702′. The lower ratchet teeth 4702 of the first container 4701 mates with the upper ratchet teeth 4703′of the second container 4701′ in order to place the container 4701 and 4701′ in fluid communication with one another. Additional containers 4701″ and 4701′″ are mated together in a similar series configuration terminating in IV line 4705.

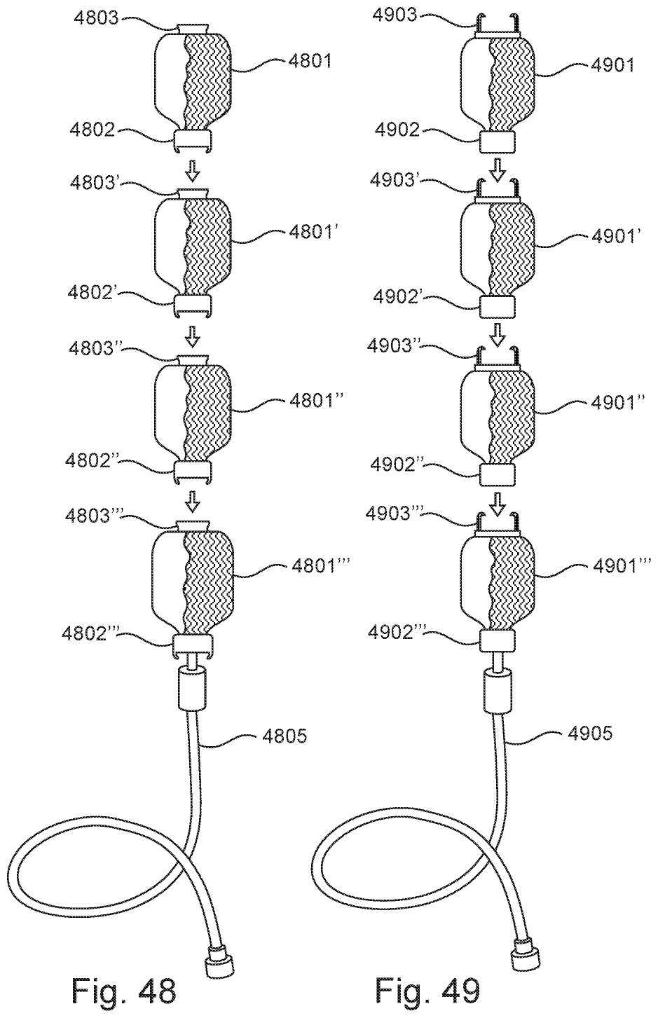

As shown in FIG. 48, a container 4801 is shown having receiving member 4803 and lower ratchet teeth 4802. A second container 4801′ is shown having an receiving member 4803′ and a lower ratchet teeth 4802′. The lower ratchet teeth 4802 of the first container 4801 mates with the receiving member 4803′ of the second container 4801′ in order to place the container 4801 and 4801′ in fluid communication with one another. Additional containers 4801″ and 4801′ are mated together in a similar series configuration terminating in IV line 4805.

As shown in FIG. 49, a container 4901 is shown having clasping member 4903 and cap 4902. A second container 4901′ is shown having a clasping member 4903′ and cap 4902′. The cap 4902 of the first container 4901 mates with the clasping member 4903′ of the second container 4901′ in order to place the container 4901 and 4901′ in fluid communication with one another. Additional containers 4901″ and 4901′ are mated together in a similar series configuration terminating in IV line 4905. It must be noted that for all modular systems the engagement between containers may be airtight or hermetic.

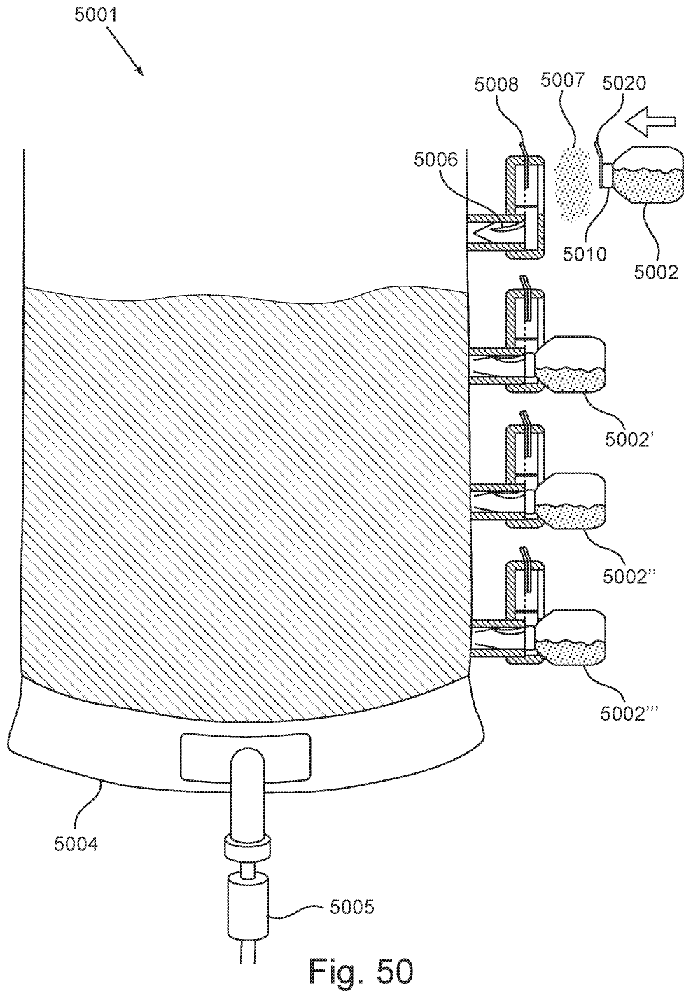

FIG. 50 is a schematic front cut view illustration presenting a further exemplary system 5001 which includes an IV bag 5004 having a plurality of entry ports and an exit port 5005, showing a plurality of containers 5002 able to be received by the plurality of entry ports 5006, according to some embodiments of the invention.

FIG. 50 shows the plurality of containers 5002 having a cap 5010 and the bag 5004 having an entry port 5006 that engages cap 5010. Contaminants 5007 are pressed between entry port 5006 and cap 5010. Optionally, cap 5010 and container 5002 once engaged with entry port 5006 slides from a first position to a second position. The cap has an decontamination interface 5020 and the entry port has a decontamination interface 5008 which mate with one another and are configured to slide externally as the cap 5010 is displaced from a first position to a second position.

In the second position, the container 5002 is in fluid communication with the bag 5004 through entry port 5006. In certain embodiments, a piercing member is used to pierce the cap 5010. The piercing member may be disposed within the port of bag 5004 or within a chamber of bag 5004.

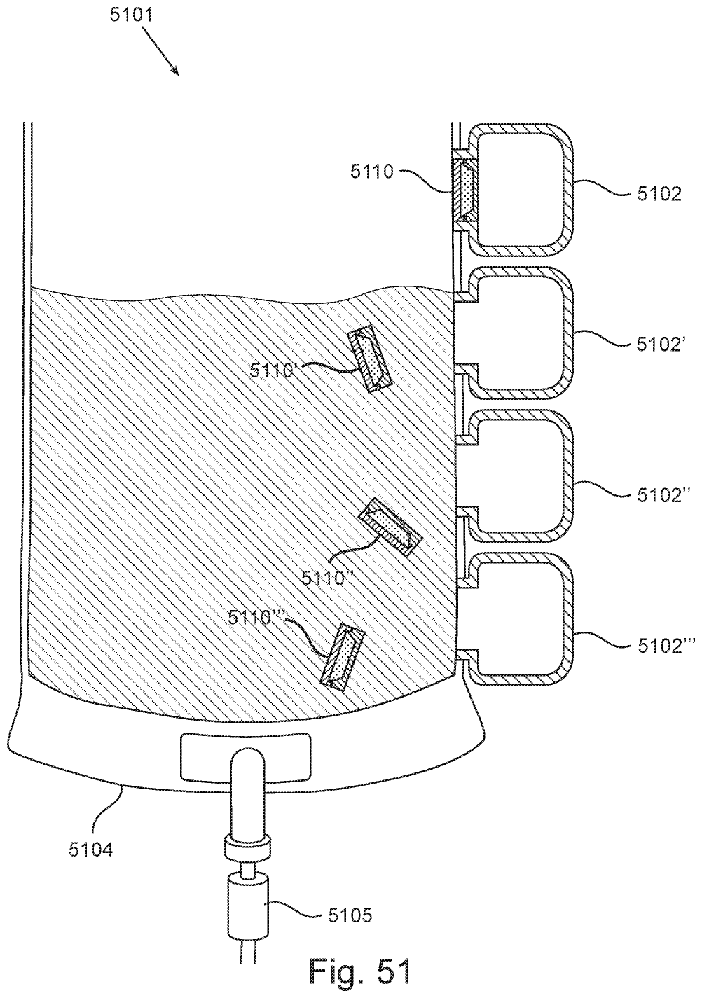

FIG. 51 is a schematic front cut view illustration presenting a further exemplary system 5101 which includes an IV bag 5104 having a plurality of entry ports and an exit port 5105, showing a plurality of containers 5002 able to be received by the plurality of entry ports 5103, according to some embodiments of the invention.

FIG. 51 shows the plurality of containers 5102 having a cap that mates with a plurality of entry ports 5110 of the bag. Contaminants are pressed between entry ports of the bag 5110 and the caps. The cap and container 5102 once engaged with entry port 5110 displace internally into the bag 5104. Contaminants 5107 are housed within or between the interface between the entry port cap 5110 and the cap of container 5102.

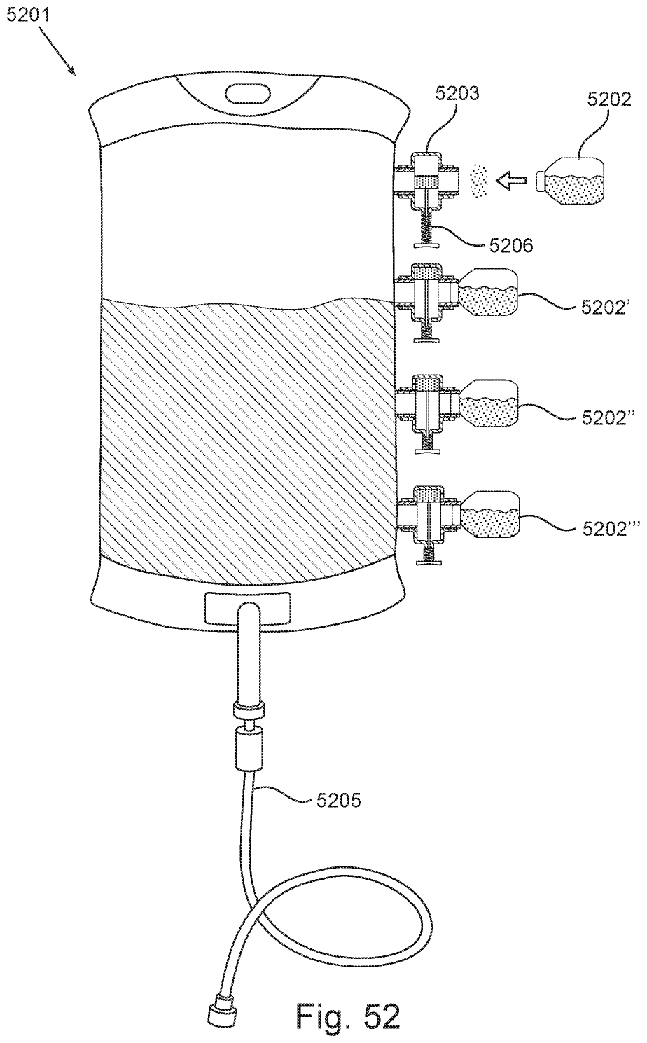

FIG. 52 is a schematic front cut view illustration presenting a further exemplary system which includes an IV bag 5201 having a plurality of entry ports 5203 and an exit port 5205, showing a plurality of containers 5202 able to be received by the plurality of entry ports 5203, according to some embodiments of the invention.

FIG. 52 shows the entry ports 5203 having a wiping member configured to move across the housing to decontaminate a surface of the plurality of containers 5202. In one or more embodiments, the entry ports are decontamination devices. In one or more embodiments, the wiping members are disposed within the entry ports 5203 of bag 5201.

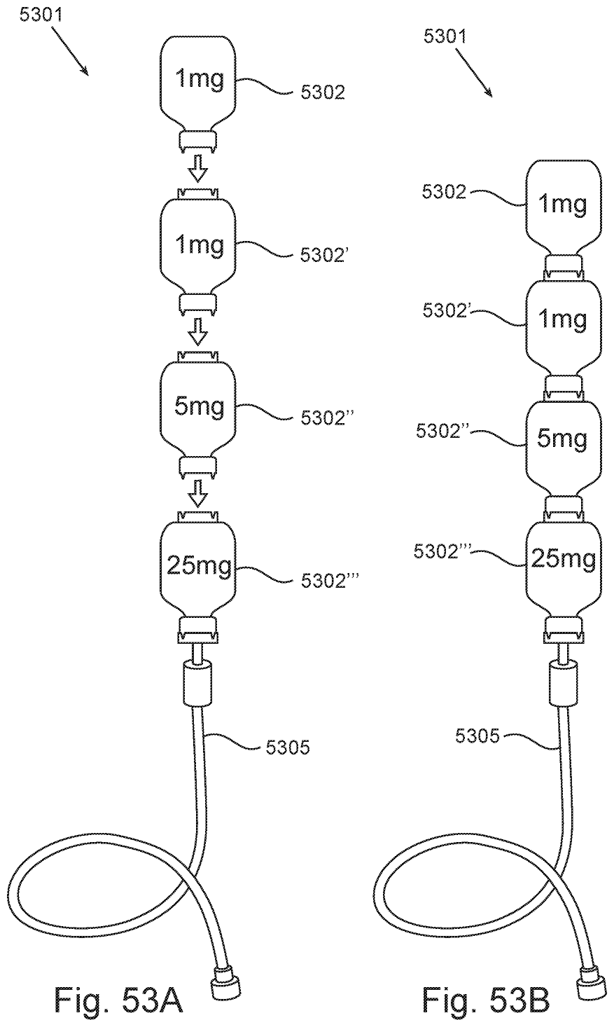

FIGS. 53A-53B is a schematic front cut view illustration presenting a further exemplary system which includes a modular dosing system of a plurality of containers 5302 showing amounts of a beneficial substance housed in the containers 5302, whereby the containers 5302 are configured to be connected to one another, according to some embodiments of the invention. In one or more embodiments, a plurality of the containers 5302 are in a fluidic communication each other at about the time and/or after engagement of the plurality of the containers.

In the above referenced figures and descriptions, the plurality of containers and/or ports and components incorporate by reference the teachings of U.S. Application Ser. Nos. 16/100,594; 16/100,712; 16/100,840; 16/100,964.

As shown in FIG. 53A, a container 5302 is shown having ratchet teeth. A second container 5302′ is shown having an upper ratchet teeth and a bottom ratchet teeth. The ratchet teeth of the first container 5302 mates with the upper ratchet teeth of the second container 5302′ in order to place the containers in fluid communication, and optionally, in an airtight engagement with one another. The containers can have different amounts of the same or a different beneficial substance, such as 1 mg, 5 mg, 25 mg or other amounts, so that a user may assemble and/or prepare a customized final amount of a beneficial substance to a patient or animal. FIG. 53A shows the modular system 5301 in an open configuration, while FIG. 53B shows the modular system 5301 in a connected configuration. In one or more embodiments, upon engagement of the plurality of containers 5302 the containers 5302 are in a fluidic communication with each other and the beneficial substance and/or drug housed in the containers is pulled down into the infusion line via a force of gravity. In one or more embodiments, at least one of the containers 5302 houses a non-standard amount of a beneficial substance and/or drug. In one or more embodiments, a plurality of the containers 5302 houses a non-standard amount of a beneficial substance and/or a drug. Packaging non-standard amounts of a beneficial substance and/or a drug in commercially prepackaged containers 5302 allows for the assembly of a customized and/or individualized amount of a beneficial substance and/or a drug without the need to manually measure and manipulate the beneficial substance. In one or more embodiments, at least one of the containers 5302 houses a drug in an amount less than about 5% of a Table 1 Column A or Table 2 Column A amount. In one or more embodiments, at least one of the containers 5302 houses a drug in an amount less than about 10% of a Table 1 Column A or Table 2 Column A amount. In one or more embodiments, at least one of the containers 5302 houses a drug in an amount less than about 20% of a Table 1 Column A or Table 2 Column A amount. In one or more embodiments, at least one of the containers 5302 houses a drug in an amount less than about 30% of a Table 1 Column A or Table 2 Column A amount. In one or more embodiments, at least one of the containers 5302 houses a drug in an amount less than about 40% of a Table 1 Column A or Table 2 Column A amount. In one or more embodiments, at least one of the containers 5302 houses a drug in an amount less than about 50% of a Table 1 Column A or Table 2 Column A amount. In one or more embodiments, at least one of the containers 5302 houses a drug in an amount less than about 60% of a Table 1 Column A or Table 2 Column A amount. In one or more embodiments, a plurality of the containers 5302 house a non-standard amount of a drug listed in Table 1 or Table 2.

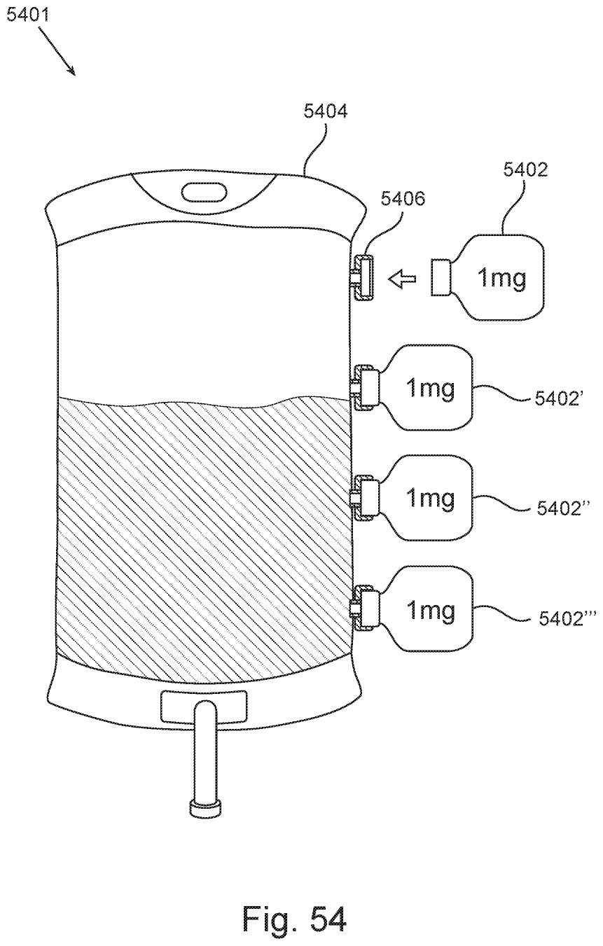

FIG. 54 is a schematic front cut view illustration presenting a further exemplary system 5401 which includes an IV bag 5404 having a plurality of entry ports 5406, wherein a plurality of containers 5402 are received and engaged by the plurality of entry ports 5406 to transfer a dose from the plurality of containers 5402 to the IV bag 5404, according to some embodiments of the invention. The containers 5402 can have different dosing regiments, such as 1 mg, 5 mg, 25 mg or other dosing regiments, so that a user can create non-standard or customized dosing amounts to administer to patients.

In one or more embodiments, the IV bag 5404 may be any vessel or container. In one or more embodiments, the container may be a bottle. In one or more embodiments, the vessel may be a syringe, a manifold or a connector with a plurality of entry ports.

In one or more embodiments, the bottle may have a negative pressure compared to ambient air and/or atmospheric pressure.

In one or more embodiments, at least one of the containers 5402 houses a non-standard amount of a beneficial substance and/or drug. In one or more embodiments, a plurality of the containers 5402 houses a non-standard amount of a beneficial substance and/or a drug. Packaging non-standard amounts of a beneficial substance and/or a drug in commercially prepackaged containers 5402 allows for the assembly of a customized and/or individualized amount of a beneficial substance and/or a drug without the need to manually measure and manipulate the beneficial substance. In one or more embodiments, at least one of the containers 5402 houses a drug in an amount less than about 5% of a Table 1 Column A or Table 2 Column A amount. In one or more embodiments, at least one of the containers 5402 houses a drug in an amount less than about 10% of a Table 1 Column A or Table 2 Column A amount. In one or more embodiments, at least one of the containers 5402 houses a drug in an amount less than about 20% of a Table 1 Column A or Table 2 Column A amount. In one or more embodiments, at least one of the containers 5402 houses a drug in an amount less than about 30% of a Table 1 Column A or Table 2 Column A amount. In one or more embodiments, at least one of the containers 5402 houses a drug in an amount less than about 40% of a Table 1 Column A or Table 2 Column A amount. In one or more embodiments, at least one of the containers 5402 houses a drug in an amount less than about 50% of a Table 1 Column A or Table 2 Column A amount. In one or more embodiments, at least one of the containers 5402 houses a drug in an amount less than about 60% of a Table 1 Column A or Table 2 Column A amount. In one or more embodiments, a plurality of the containers 5402 house a non-standard amount of a drug listed in Table 1 or Table 2. In one or more embodiments, the drug may be a beneficial substance. In one or more embodiments, the beneficial substance may be a nutritional substance. In one or more embodiments, the beneficial substance may be a diagnostic substance. In one or more embodiments, the containers 5402 may be commercially packaged containers. In one or more embodiments, the commercially packaged containers may be commercially prepackaged containers. In one or more embodiments, the containers may have tamper evident and/or tamper resistant seals/caps. In one or more embodiments, the commercially prepackaged containers are packaged by a pharmaceutical manufacturer and/or packager.

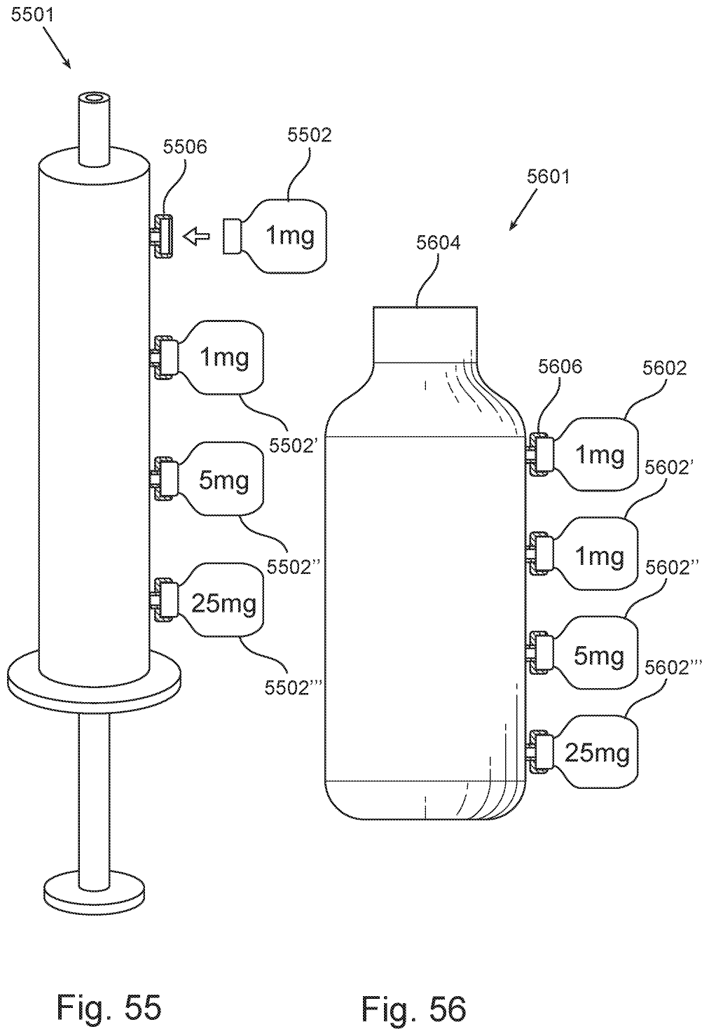

FIG. 55 is a schematic front cut view illustration presenting a further exemplary system which includes a syringe 5501 having a plurality of entry ports 5506, wherein a plurality of containers 5502 are received and engaged by the plurality of entry ports 5506 to transfer a dose from the plurality of containers 5502 to the syringe 5501, according to some embodiments of the invention. The containers 5502 can have different amounts of drugs, such as 1 mg, 5 mg, 25 mg or other amounts, so that a user can create non-standard and/or customized dosing amounts to administer to patients. In one or more embodiments, at least one of the containers 5502 houses a non-standard amount of a beneficial substance and/or drug. In one or more embodiments, a plurality of the containers 5502 houses a non-standard amount of a beneficial substance and/or a drug. Packaging non-standard amounts of a beneficial substance and/or a drug in commercially prepackaged containers 5502 allow for the assembly of a customized and/or individualized amount of a beneficial substance and/or a drug without the need to manually measure and manipulate the beneficial substance. In one or more embodiments, at least one of the containers 5502 houses a drug in an amount less than about 5% of a Table 1 Column A or Table 2 Column A amount. In one or more embodiments, at least one of the containers 5502 houses a drug in an amount less than about 10% of a Table 1 Column A or Table 2 Column A amount. In one or more embodiments, at least one of the containers 5502 houses a drug in an amount less than about 20% of a Table 1 Column A or Table 2 Column A amount. In one or more embodiments, at least one of the containers 5502 houses a drug in an amount less than about 30% of a Table 1 Column A or Table 2 Column A amount. In one or more embodiments, at least one of the containers 5502 houses a drug in an amount less than about 40% of a Table 1 Column A or Table 2 Column A amount. In one or more embodiments, at least one of the containers 5502 houses a drug in an amount less than about 50% of a Table 1 Column A or Table 2 Column A amount. In one or more embodiments, at least one of the containers 5502 houses a drug in an amount less than about 60% of a Table 1 Column A or Table 2 Column A amount. In one or more embodiments, a plurality of the containers 5502 house a non-standard amount of a drug listed in Table 1 or Table 2. In one or more embodiments, the drug may be a beneficial substance. In one or more embodiments, the beneficial substance may be a nutritional substance. In one or more embodiments, the beneficial substance may be a diagnostic substance. In one or more embodiments, the containers 5502 may be commercially packaged containers. In one or more embodiments, the commercially packaged containers may be commercially prepackaged containers. In one or more embodiments, the containers may have tamper evident and/or tamper resistant seals/caps. In one or more embodiments, the commercially prepackaged containers are packaged by a pharmaceutical manufacturer and/or packager.

FIG. 56 is a schematic front cut view illustration presenting a further exemplary system 5601 which includes a bottle 5604 having a plurality of entry ports 5606, wherein a plurality of containers 5602 are received and engaged by the plurality of entry ports 5606 to transfer a dose from the plurality of containers 5602 to the bottle 5604, according to some embodiments of the invention. The containers 5602 can have different amounts of drugs, such as 1 mg, 5 mg, 25 mg or other non-standard amounts, so that a user can create non-standard and/or customized/individualized dosing amounts to administer to patients.

In one or more embodiments, at least one of the containers 5402 houses a non-standard amount of a beneficial substance and/or drug. In one or more embodiments, a plurality of the containers 5602 houses a non-standard amount of a beneficial substance and/or a drug. Packaging non-standard amounts of a beneficial substance and/or a drug in commercially prepackaged containers 5602 allows for the assembly of a customized and/or individualized amount of a beneficial substance and/or a drug without the need to manually measure and manipulate the beneficial substance. In one or more embodiments, at least one of the containers 5602 houses a drug in an amount less than about 5% of a Table 1 Column A or Table 2 Column A amount. In one or more embodiments, at least one of the containers 5602 houses a drug in an amount less than about 10% of a Table 1 Column A or Table 2 Column A amount. In one or more embodiments, at least one of the containers 5602 houses a drug in an amount less than about 20% of a Table 1 Column A or Table 2 Column A amount. In one or more embodiments, at least one of the containers 5602 houses a drug in an amount less than about 30% of a Table 1 Column A or Table 2 Column A amount. In one or more embodiments, at least one of the containers 5602 houses a drug in an amount less than about 40% of a Table 1 Column A or Table 2 Column A amount. In one or more embodiments, at least one of the containers 5602 houses a drug in an amount less than about 50% of a Table 1 Column A or Table 2 Column A amount. In one or more embodiments, at least one of the containers 5602 houses a drug in an amount less than about 60% of a Table 1 Column A or Table 2 Column A amount. In one or more embodiments, a plurality of the containers 5602 house a non-standard amount of a drug listed in Table 1 or Table 2. In one or more embodiments, the drug may be a beneficial substance. In one or more embodiments, the beneficial substance may be a nutritional substance. In one or more embodiments, the beneficial substance may be a diagnostic substance. In one or more embodiments, the containers 5602 may be commercially packaged containers. In one or more embodiments, the commercially packaged containers may be commercially prepackaged containers. In one or more embodiments, the containers may have tamper evident and/or tamper resistant seals/caps. In one or more embodiments, the commercially prepackaged containers are packaged by a pharmaceutical manufacturer and/or packager. In one or more embodiments, the bottle 5604 may be any vessel, container, or medical device. In one or more embodiments, the bottle 5604 may be a bag. In one or more embodiments, the bottle 5604 may be a container with a flexible wall. In one or more embodiments, the bottle 5604 may be a container with a rigid wall.

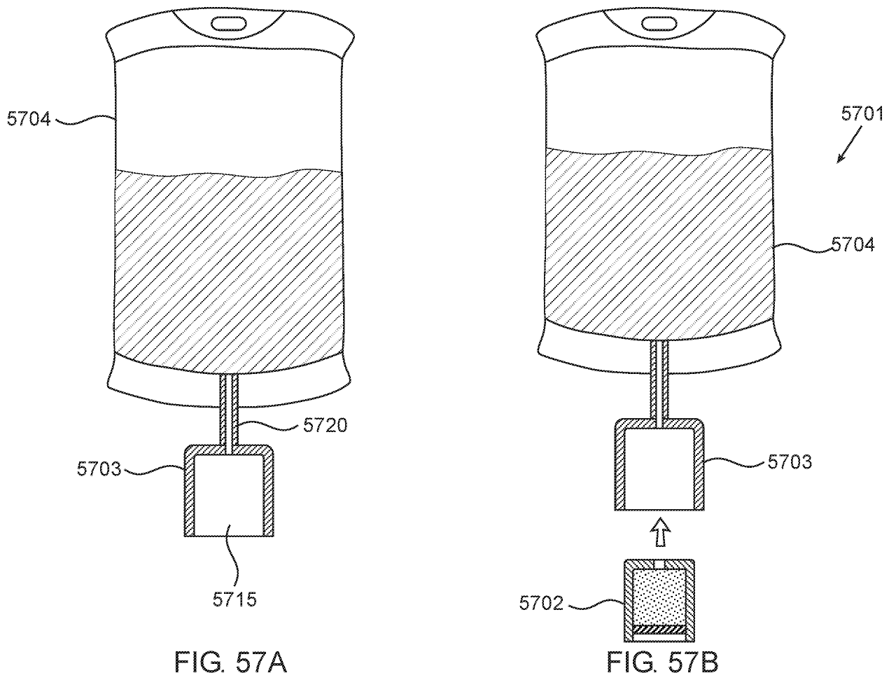

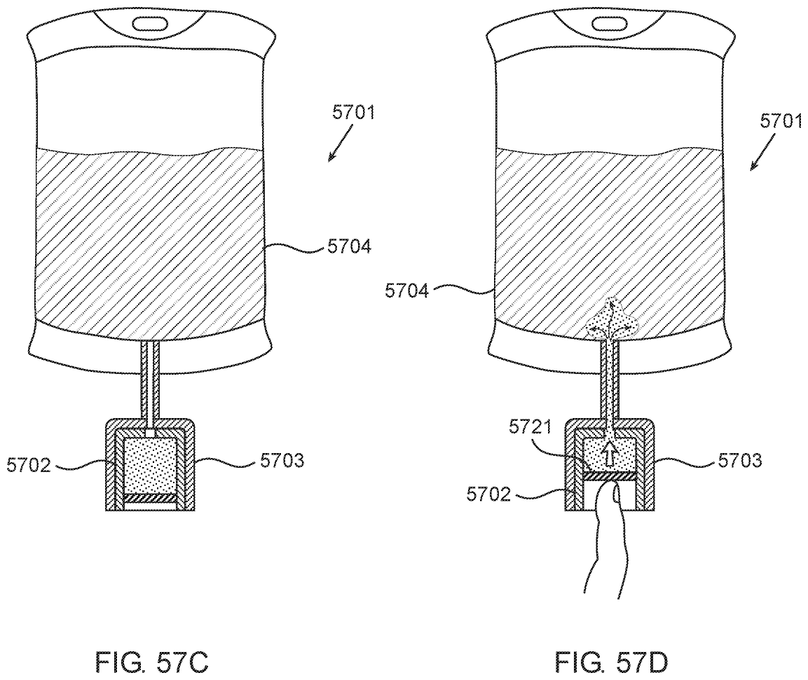

FIGS. 57A-57D are schematic front cut view illustrations presenting yet another exemplary system 5701 having an IV bag 5704 with an entry port 5703. Entry port 5703 is fluidly connected to IV bag 5704 via a conduit 5720. Entry port 5703 includes a peripheral wall enclosing a cavity 5715 configured in size and/or shape and/or volume to engulf/accommodate container 5702. Container 5702 can be received by and engaged with entry port 5703 to transfer a dose from the container 5702 to the IV bag 5704, according to some embodiments of the invention.

FIG. 57A illustrates IV bag 5704 which has an entry port 5703 configured to accommodate container 5702. FIG. 57B illustrates system 5701, wherein IV bag 5704 and container 5702 are separated. In FIG. 57C, the cartridge 5702 is engaged with port 5703. The port 5703 is able to engulf entirely and thereby protect cartridge 5702 from damages that may be caused to by accidental hit or fall that may occur during medicament preparation and/or transport. Port 5703 may be referred to in one or more embodiments as a protective port. Port 5703 in one or more embodiments may abut (not shown) container/bag 5704. In one or more embodiments, port 5703 may abut a wall (not shown) of container/bag 5704. In FIG. 57D, a user is shown to transfer the beneficial substance from container 5702 by pushing plunger 5721 towards bag 5704 thereby allowing the fluid transfer into bag 5704. Entry port 5703 may engulf the entire length, width, and/or volume of the container 5702 or may at least partially engulf the length, width, and/or volume of the container 5702. The entry port 5703 thus protects the container 5702 and prevents accidental spillage of a beneficial substance from container 5702. For example, in a scenario of fall of bag 5704, any substance contained within the container 5702 (e.g., a toxic chemotherapeutic substance) won't spill due to protection of container 5702 from damages or breakage by the protective peripheral walls of the port 5703 which may be made of a rubber, elastomeric, plastic, and/or metal material. Port 5703 may have circumferential protective peripheral walls that surround container 5702. Container 5702 is shown as a container having a plunger 5721, however container 5702 may in one or more embodiments, be a vial, a syringe, etc.

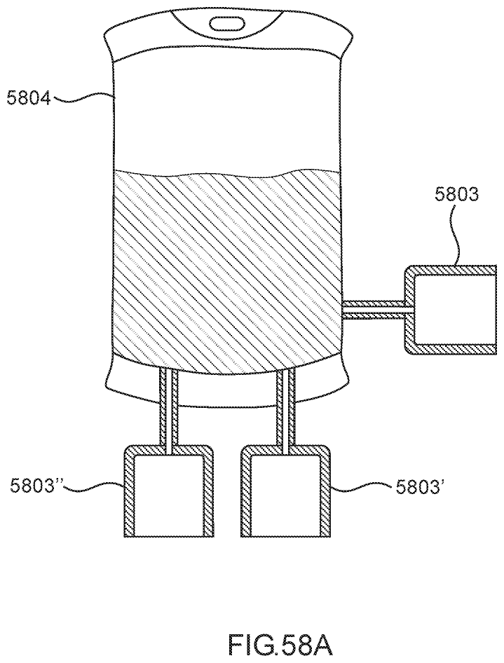

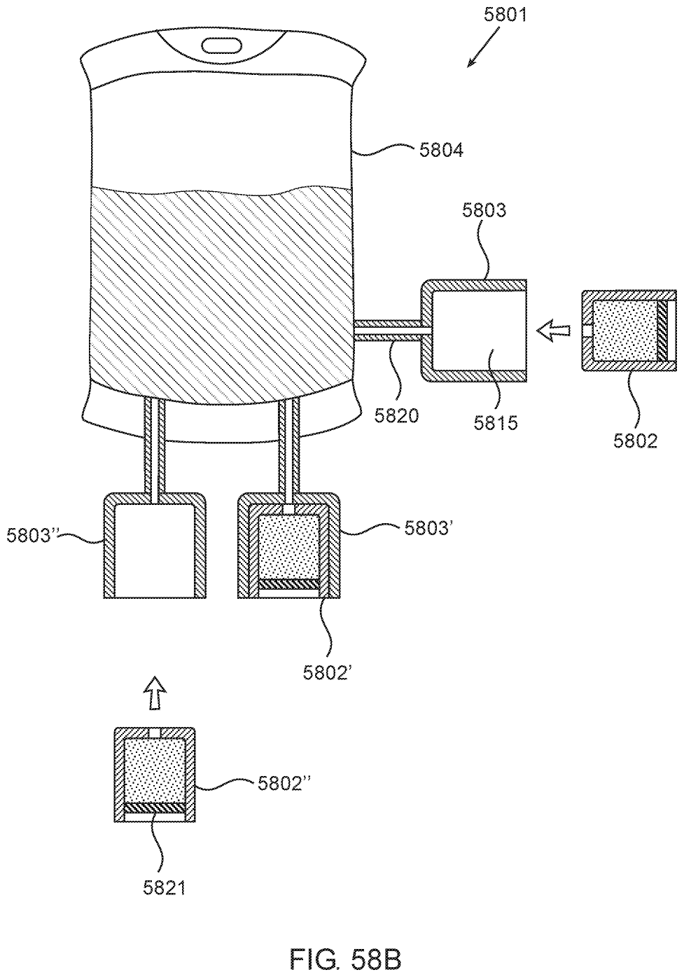

FIGS. 58A-58B are schematic front cut view illustrations presenting yet another exemplary system 5801 having an IV bag 5804 with a plurality of entry ports 5803 connected to IV bag 5804 via conduits 5820. Entry ports 5803 include a peripheral wall enclosing a cavity 5815 configured in size and/or shape and/or volume to engulf/accommodate containers 5802 to thereby transfer a dose from the containers 5802 to the IV bag 5804, according to some embodiments of the invention. Conduits 5820 are shown connecting the bag 5804 to the entry ports 5803, however in one or more embodiments entry ports 5803 may abut bag 5804, may abut a wall of bag 5804, may be flush mounted to bag 5804, and/or may be surface mounted to bag 5804. Bag 5804 is used arbitrarily and may be a bottle, a syringe, or any type of container. In one or more embodiments, entry ports 5803 may have a piercing member (not shown). In one or more embodiments, entry ports 5803 may have piercing member(s) (not shown) disposed in peripheral wall enclosing cavity 5815, may have piercing member(s) (not shown) disposed within peripheral wall enclosing cavity 5815, may have a piercing member (not shown) disposed on a wall of peripheral wall enclosing cavity 5815, may have a piercing member (not shown) disposed in/within/on conduits 5820, may have a piercing member(s) (not shown) disposed in/within/on container/bag 5804, and combinations thereof. The piercing member (not shown) may be a needle. The needle may be a hollowed needle. The piercing member(s) may be configured to piercing through a surface of at least one of the bag/container 5804, a wall of the bag/container 5804, a wall of port 5803, and through a surface of container 5802.

FIG. 58A illustrates IV bag 5804 with a plurality of entry ports 5803 configured for accommodating therein a medical vessel (i.e., containers/cartridge 5802) and allowing a fluid transfer between the containers 5802 and the IV bag 5804. FIG. 58B illustrates system 5801 which further includes containers 5802 that can be engaged with and received by entry ports 5803. The Containers 5802 have plungers 5821 which are configured to be pushed by a user to expel any contents contained within containers 5802 out of the containers.

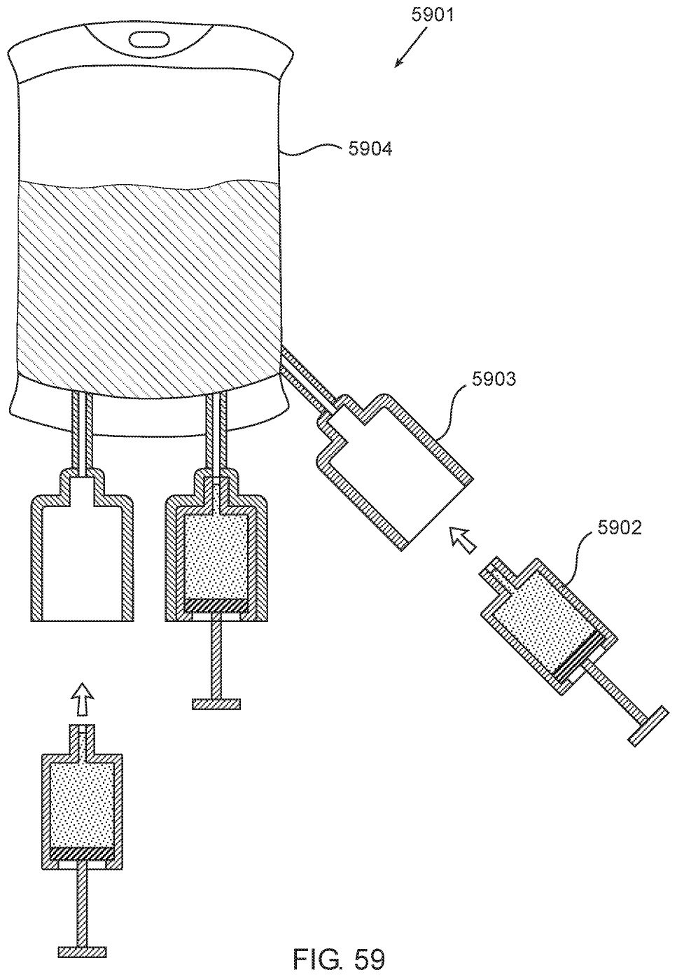

FIG. 59 is a schematic front cut view illustration presenting yet another exemplary system 5901 that includes a plurality of entry ports 5903 having peripheral walls enclosing cavities that can accommodate containers is the form of syringes 5902. Peripheral wall enclosing cavities of the entry ports 5903 are characterized in that they surround/engulf the body/barrel of the syringe thus protecting the syringe body/barrel from accidental cracks/breaks if bag 5904 falls along with syringes 5902 to the ground or sustains a hit. Ports 5903 are configured to be of sufficient strength and/or durability to absorb impact from a fall to the ground or from any other source and to prevent breakage/cracking of ports 5903 and optionally syringes 5902. Ports 5903 are configured to circumferentially surround syringe 5902, optionally syringe barrel 5902, to protect syringe 5902 from breakage/cracking upon impact. Ports 5903 are protective ports.

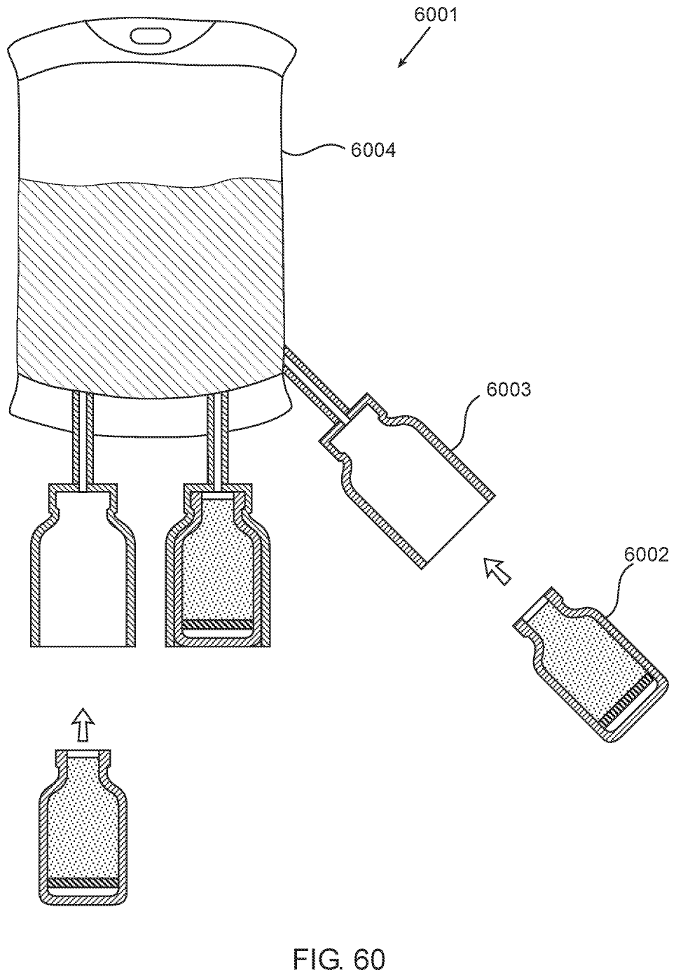

FIG. 60 is a schematic front cut view illustration presenting yet another exemplary system 6001 that includes a plurality of entry ports 6003 having peripheral walls enclosing cavities that can accommodate containers is the form of bottles 6002. In one or more embodiments, the bottles may have a plunger. In one or more embodiments, the bottles do not have plungers (not shown). In one or more embodiments, the bottles may be vials. Peripheral wall enclosing cavities of the entry ports 6003 are characterized in that they entirely or partially or substantially surround the bottles 6002 thus protecting the bottles from breaking/cracking.

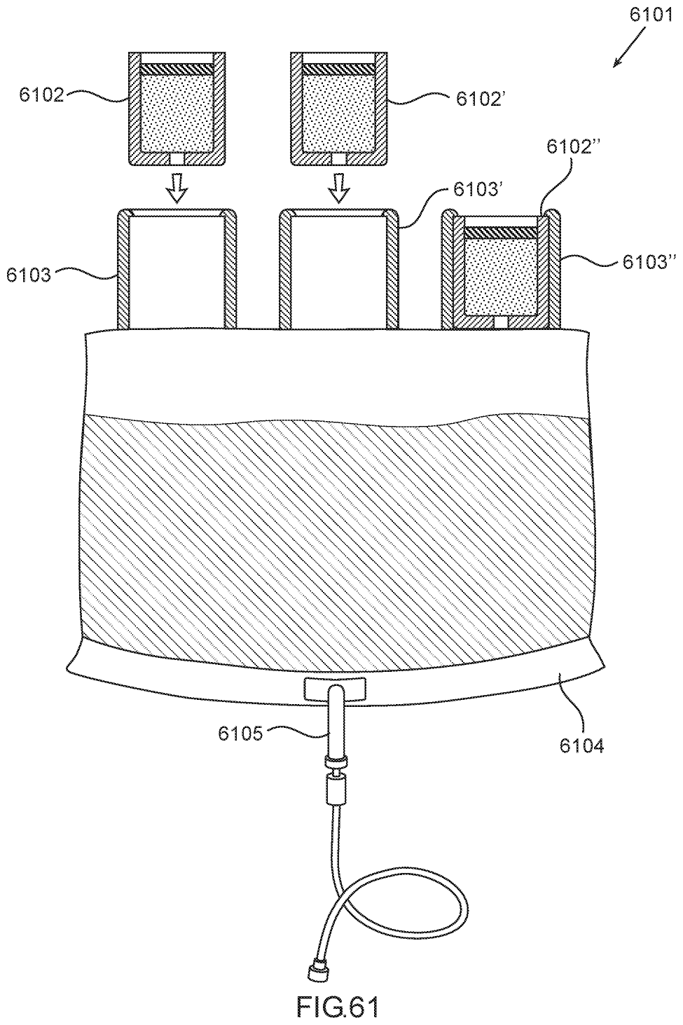

FIG. 61 is a schematic front cut view illustration presenting yet another exemplary system 6101 which includes an IV bag 6104 having a plurality of entry ports 6103 and an exit port 6105, wherein a plurality of containers 6102 are received and engaged by the plurality of entry ports 6103 to thereby transfer a dose from the plurality of containers to the IV bag, according to some embodiments of the invention. Entry ports 6103 are connected directly to a wall of IV bag 6104. As shown, entry ports 6103 abut a wall of IV bag 6104. As shown, entry ports 6103 are surface mounted to bag 6104. In certain embodiments, entry ports 6103 are absent of a conduit to connect the ports to bag 6104. Entry ports 6103 may include a circumferential protrusion 6122 vertically extending from proximal ends of the walls for securing the connection between containers 6102 and entry ports 6103. Circumferential protrusion 6122 is able to hold the containers 6102 within the entry ports 6103 and prevent dispatchment thereof.

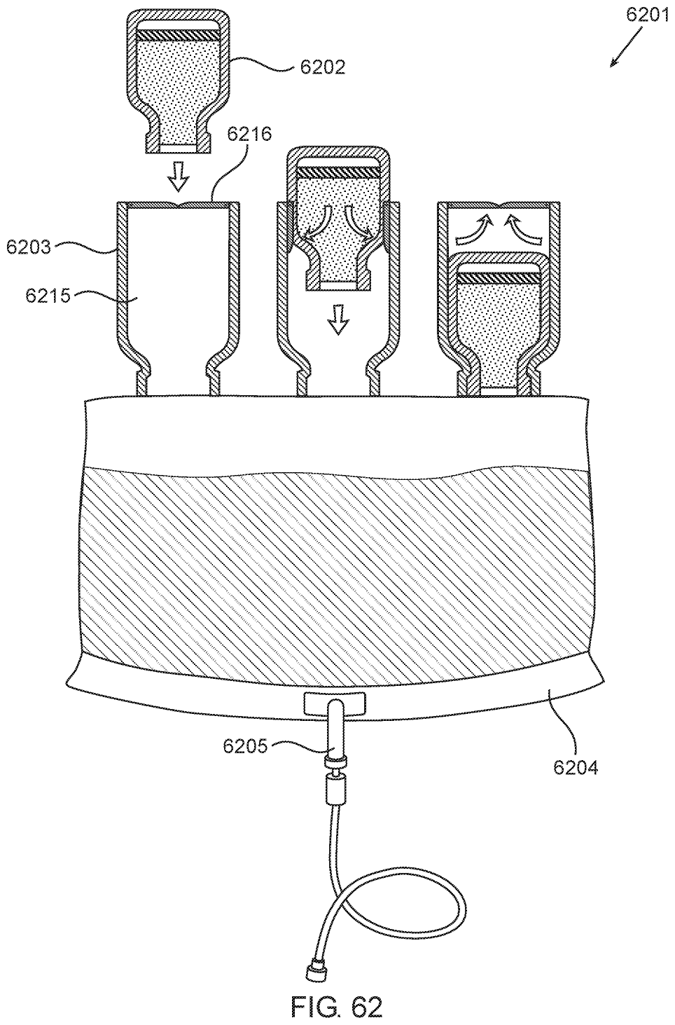

FIG. 62 is a schematic front cut view illustration presenting yet another exemplary system 6201 which includes an IV bag 6204 (optionally a bottle) having a plurality of entry ports 6203 and an exit port 6205. Entry ports 6203 are connected directly to IV bag 6204 and configured to accommodate and engulf bottles 6202. Entry ports 6203 include a port closure mechanism in the form of dual flaps 6216 connected to circumferential wall of the entry ports 6203 via hinges and configured to open and close ports 6203. The flaps 6216 can be opened to allow the entry of bottles 6202 into cavities 6215. The flaps 6216 can be closed following the engagement of bottles 6202 with entry ports 6203. The flaps 6216 can be closed at about the time and/or following entry of bottles 6202 into peripheral wall enclosing cavity 6215 of port 6203. The flaps 6216 may open inwardly into the cavities 6215. Optionally, the flaps may open outwardly (not shown) to allow bottles 6202 into cavities 6215 of ports 6203. When bottle 6202 is positioned inside cavity 6215 of port 6203 as shown in far right port 6203 the bottle 6202 is entirely engulfed by (entirely disposed inside) the peripheral wall enclosing cavity 6215 of port 6203 and therefore bottle 6202 is protected from breaking/cracking in case of a fall to the ground. Additionally, when bottle 6202 is completely inside peripheral wall enclosing cavity 6215 of port 6206 any leakage of fluids and/or vapors (contained in bottle 6202) that may escape the fluidic communication between bottle 6202 and bag 6204 is contained within the peripheral wall enclosing cavity 6215 of port 6203 thus preventing escape of the fluids and/or vapors to the environment and thus prevention of exposure of personnel/users to the fluids/vapors which is of particular importance if a toxic/teratogenic substance is contained within bottle 6202 such as a chemotherapeutic agent. In one or more embodiments, flaps 6216 are configured to hermetically seal the peripheral wall enclosing cavity 6215 of port 6203. In one or more embodiments, flaps 6216 are configured to hermetically seal the peripheral wall enclosing cavity 6215 of port 6203 when bottle 6202 is disposed inside the peripheral wall enclosing cavity 6215. Flaps 6216 may be made of a rubber material, an elastomeric material, a plastic material, a metal material, and combinations thereof. In one or more embodiments, the flaps 6216 are transparent allowing a user to visually see any labels (not shown) that may be on container(s) 6202. In one or more embodiments, the flaps 6216 are transparent allowing a user to scan any barcodes (not shown) and/or similar labeling that may be present on container(s) 6202. In one or more embodiments, the flaps 6216 may be translucent. In one or more embodiments, the flaps 6216 may be opaque. In one or more embodiments, port 6203 may be made of a material that is transparent, translucent, opaque, and combinations thereof. In one or more embodiments, port 6203 may be made of a glass or see-through plastic material thus allowing a user to visually see and/or scan any labels/barcodes that may be present on container(s) 6202 when container(s) 6202 are disposed inside port 6203.

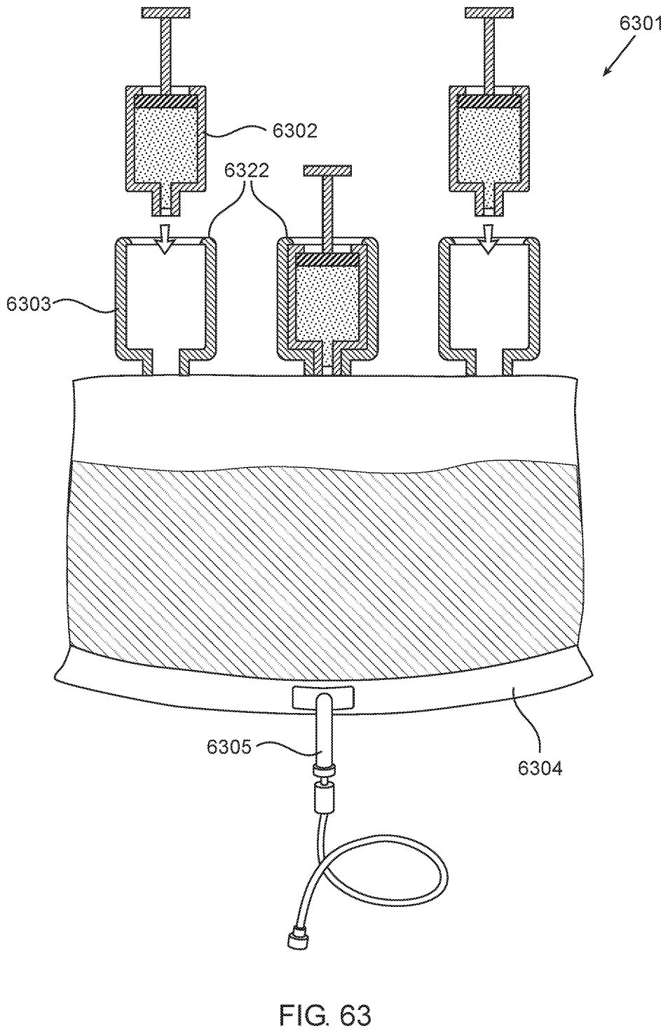

FIG. 63 is a schematic front cut view illustration presenting yet another exemplary system 6301 which includes an IV bag 6304 having a plurality of entry ports 6303 and an exit port 6305. Entry ports 6303 configured for accommodating and engulfing syringes 6302. The entry ports 6303 include a peripheral protrusion 6322 for securing the connection between the syringes 6302 and entry ports 6303. Protrusions 6322 is configured to allow entry of the syringes 6302 into the entry ports 6303. Protrusions 6300 are configured to prevent syringes from exiting ports 6303 once syringes are disposed inside of ports 6303. In one or more embodiments, protrusions 6322 are characterized in that they allow entry of syringes 6302 into entry ports 6303 and the protrusions 6300 prevent exit of syringes 6302 from entry ports 6303. Protrusions 6322 may be made of a rigid material, a rubber material, a plastic material, an elastomeric material, a metal alloy, and combinations thereof. Protrusions 6322, in one or more embodiments, may retract to allow syringes 6302 to enter entry ports 6303. Entry ports 6303 are configured in size and/or shape and/or volume to allow the entire body/barrel of the syringes 6302 to be disposed inside the peripheral wall enclosing cavities of the entry ports 6303 as shown in the middle port 6303. There may be an aperture/hole in the flaps/opening that allows the rod of the syringe handle to positioned through the aperture thus allowing a user to push the handle downward to expel any contents contained inside the syringe 6302 out of the syringe 6302 into the bag 6304. The aperture may be lined with a rubber, elastomeric, or other substance. The aperture may be circumferentially lined with a rubber, elastomeric, or other substance that provides a hermetic/airtight seal between the aperture of the flaps and the rod of the syringe thus providing a hermetically sealed port 6303 in which the barrel of the syringe is disposed inside port 6303.

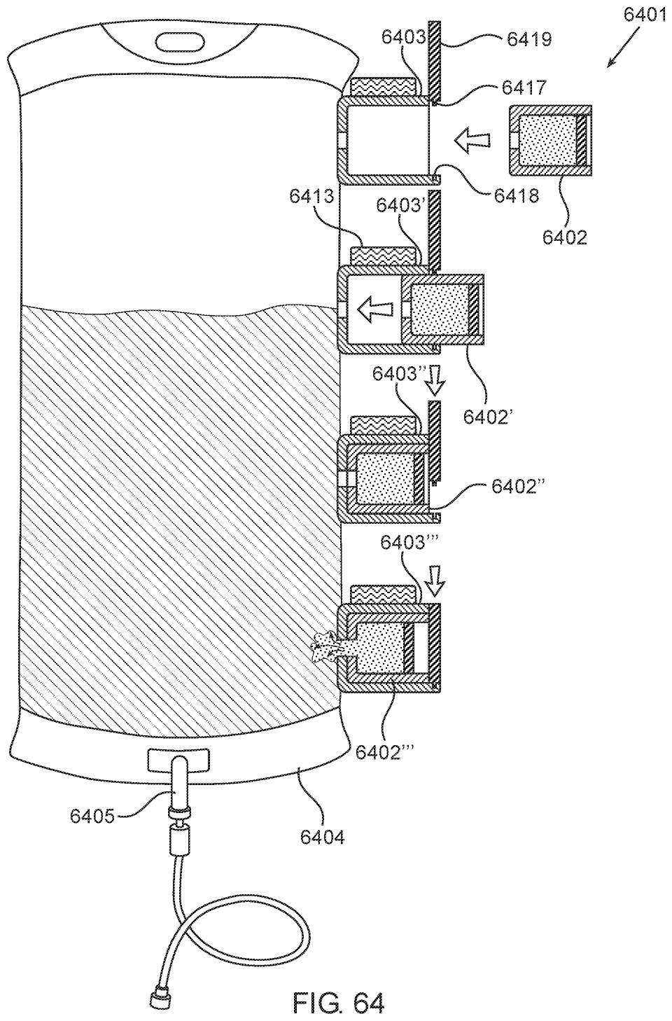

FIG. 64 is a schematic front cut view illustration presenting yet another exemplary system 6401 which includes an IV bag 6404 having a plurality of entry ports 6403 and an exit port 6405. Entry ports 6403 configured for accommodating therein containers 6402. Containers 6402 having plungers configured to move and expel contents of containers 6402 out of containers 6402. Entry ports 6403 further include a negative air pressure compartment 6413 for exerting a lower pressure within the entry ports 6403 as compared to the environmental and/or ambient air pressure. Such negative pressure in the ports 6403 draws containers 6402 into the entry ports 6403 and stabilizes the connection between the containers 6402 and the entry ports 6403. Additionally, the negative air pressure compartment(s) withdraw any fluid and/or vapor leaks from within port 6403 that may be produced during the establishment of a fluidic communication between containers 6402 and bag 6404. Additionally, the negative air pressure compartment(s) withdraw any fluid and/or vapor leaks from within the port 6403 that may be produced during the transfer of a medicament or other beneficial substance from the containers 6402 and bag 6404. A closure mechanism in the form of covers 6419 may, according to certain embodiments, be further incorporated to entry ports 6403 for closing the entry ports 6403 and further providing protected structure to containers 6402. The covers 6419 are configured to provide a hermetic/airtight seal of ports 6403, thus when containers 6402 are disposed inside ports 6403 the containers 6402 are hermetically sealed within ports 6403 which prevents the leakage of fluids or vapors out of ports 6403 into the environment. This prevents accidental exposure of healthcare personnel/users to potentially toxic substances such as chemotherapeutics that may be contained inside containers 6402. The covers 6419 may be transparent to allow a user to read labelling on the containers 6402 when the containers 6402 are disposed inside the ports 6403. Optionally, or alternately, covers 6419 may be translucent or opaque. The covers 6419 may include a lock mechanism in the form of pin 6417 that mates and can engage with slot 6418, for securing the connection between the covers 6419 and the peripheral walls of entry ports 6403. The covers 6419, according to certain embodiments, may include a sliding mechanism (not shown) for sliding along an aperture of the entry ports 6403 to thereby close the entry ports 6403. Other forms of lock mechanisms are contemplated such as latches, lock-and-key, twist-on locks, snap-on locks, etc. The importance of covers 6419 hermetically sealing containers 6402 inside ports 6403 is that during fluidic communication between containers 6402 and bag 6404 as shown in the bottom port 6403 of FIG. 64 (where the contents of container 6402′″ are expelled out of container 6402′″ into bag 6404), the contents of container 6402′″ may escape/leak into the space (not shown) between the exterior walls of container 6402′ and the interior walls of port 6403, the covers contain any such leaks of fluids/vapors within ports 6403 thus preventing escape of the fluids/vapors into the surrounding environment which protects the user from being exposed to the leaked fluids/vapors. The hermetically sealed ports 6403 contain any leaks of fluids, vapors, and the alike within/inside the ports 6403. Covers 6419 may be made of a rigid material, an elastomeric material, a metal alloy, a glass material, and combinations thereof. Bag 6404 may in one or more embodiments be a bottle. Containers 6402 may be vials, cartridges, etc. Bag 6404 is shown having four ports 6403, however any number of ports 6403 may be present/disposed on bag 6404 such as one port, two ports, three ports, four ports (as shown), five ports, and six or more ports.

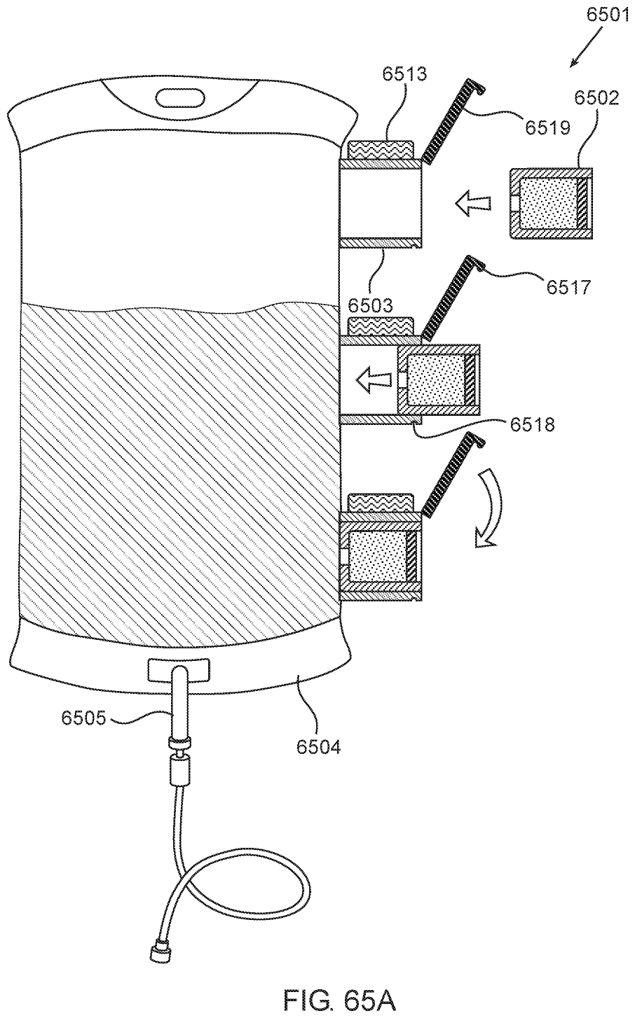

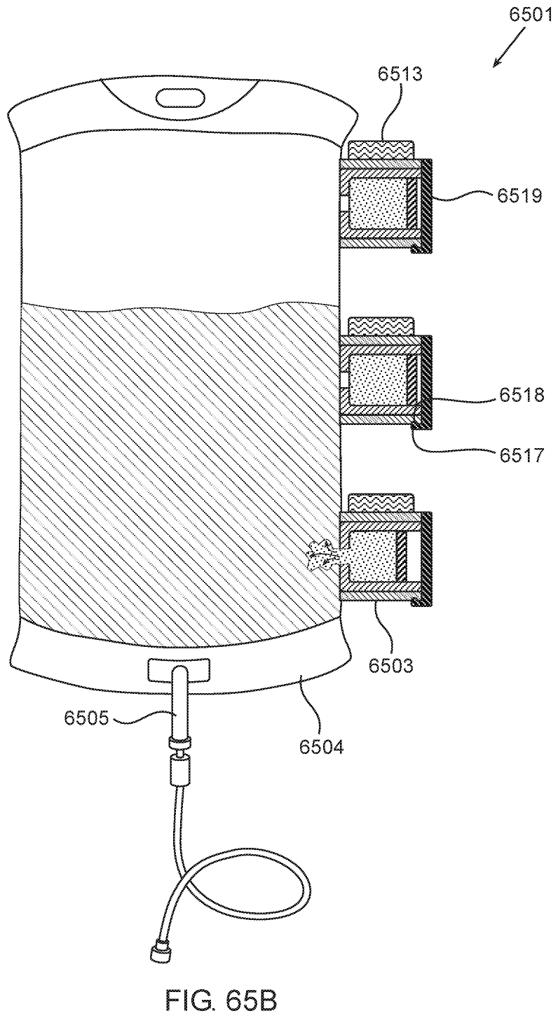

FIGS. 65A-65B are schematic front cut view illustrations presenting yet another exemplary system 6501 which includes an IV bag 6504 having a plurality of entry ports 6503 and an exit port 6505. Entry ports 6503 configured for accommodating therein containers 6502 and allow a fluid transfer between IV bag 6504 and containers 6502. Entry ports 6503 may, according to certain embodiments, further include a negative air pressure compartment 6513 for exerting a lower pressure within the entry ports 6503 as compared to the environmental and/or ambient air pressure and/or air pressure at sea level and thereby draw and maintain containers 6502 within entry ports 6503 and withdraw any vapor and/or fluid leaks from within ports 6503 when containers 6502 are disposed inside ports 6503. A closure mechanism in the form of covers 6519 may, according to certain embodiments, be further incorporated to entry ports 6503 for closing the ports 6503. The covers 6519 may include a fastener lock mechanism in the form of latch 6517 that can mate and engage slot 6518, for securing the connection between the covers 6519 and the ports 6503. The covers 6519, according to certain embodiments, may include a hinge mechanism for pivotally closing an aperture of the entry ports 6503 to thereby close the ports 6503. In certain embodiments, covers 6519 may be attached to ports 6503 via a flexible plastic which allow covers 6519 to move between an open and closed position. Ports 6503 are shown surface mounted to bag 6504, however ports 6503 may be flush mounted to bag 6504. Bag 6504 is used arbitrarily and may be a bottle or any other type of container. In one or more embodiments, container 6504 is shown having ports 6503 configured to completely engulf a plurality of containers 6502. Bag 6504 is shown having a plurality of ports 6503 and a plurality of negative pressure compartments 6513. The negative pressure compartments 6513 may be made of a rigid material such as a rigid plastic, a metal alloy, a glass material, and combinations thereof. The negative pressure compartments may have a vacuum inside the negative pressure compartments 6513.

FIG. 65A shows containers 6502 in various steps of engagement with entry ports 6503. FIG. 65B illustrates the system 6501 when all entry ports accommodate containers 6502 and the covers 6519 securely cover the entry ports 6503. A fluid passageway between IV bag 6504 and containers 6502 can be formed and any fluid and/or vapor leaks that may be produced during the transfer of medicaments/beneficial substances from within containers 6502 to bag 6504 are entrapped within ports 6503 thus preventing exposure of a user to any contents held within containers 6502 or bag 6504. The covers 6519 are configured to hermetically seal containers 6502 within/inside ports 6503. Fluidic communication between containers 6502 and bag 6504 may be mediated via piercing by a piercing member (not shown) of a surface of at least one of bag 6504 and container 6502. Optionally, or alternately, fluidic communication between containers 6502 and bag 6504 may be mediated via opening of valve(s) (not shown) of at least one of bag 6504 and containers 6502. Bag 6604 may in certain embodiments have at least one piercing member configured to pierce through a surface of container(s) 6603. Bag 6604 may in certain embodiments have at least one valve configured to open at about the time and/or after engagement of container(s) 6602 to bag 6604. Optionally, or alternately, container(s) 6602 may have valve(s) (not shown) configured to open at about the time and/or after engagement of container(s) 6602 to ports 6603. Port(s) 6603, in certain embodiments may further comprise piercing member(s) disposed in and/or on and/or within ports 6603. In certain embodiments, port(s) 6603 may further comprise piercing member(s) disposed through a wall of ports 6603. The piercing member(s) (not shown) may be needle(s). The needle(s) (not shown) may be hollowed needles. In one or more embodiments, the piercing members (not shown) are configured to pierce through a surface of container(s) 6602 to establish a fluidic communication between bag 6604 and container(s) 6602. In one or more embodiments, the piercing members (not shown) are configured to pierce through a surface of bag 6604 and container(s) 6602 to establish a fluidic communication between bag 6604 and container(s) 6602.

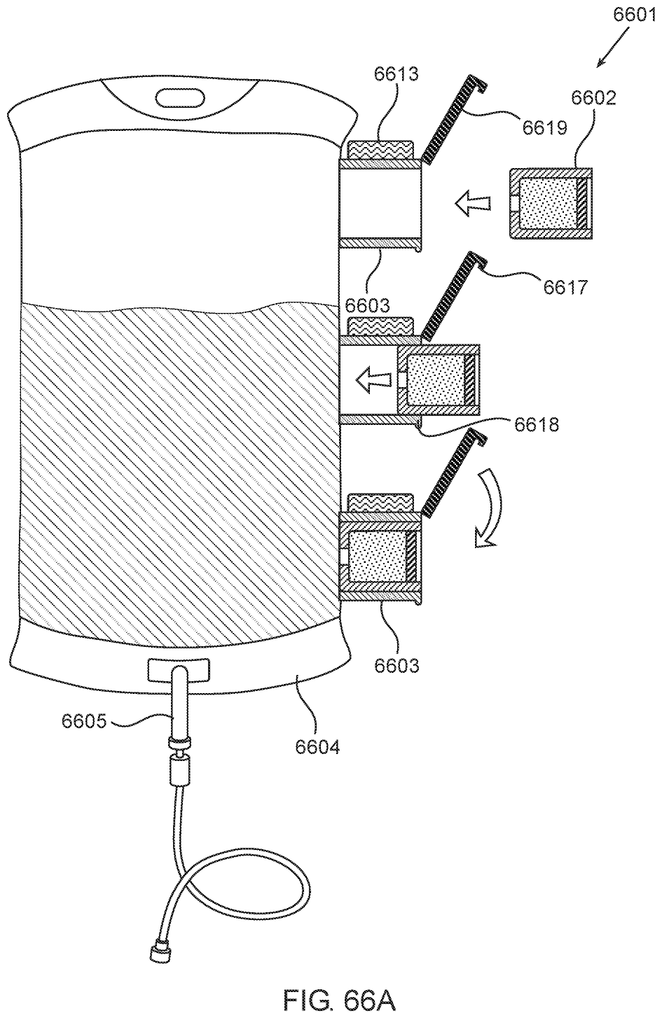

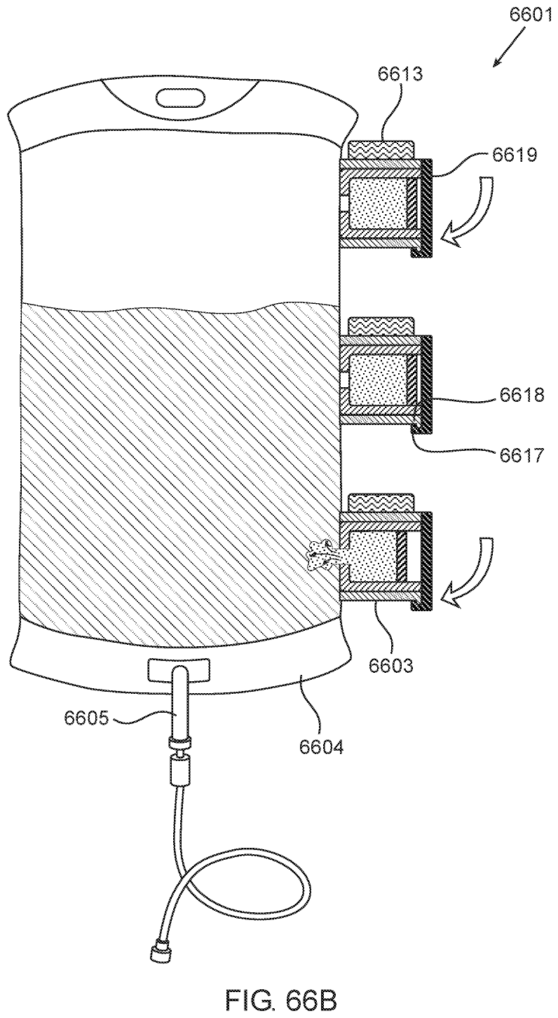

FIGS. 66A-66B are schematic front cut view illustrations presenting yet another exemplary system 6601 which includes an IV bag 6604 having a plurality of entry ports 6603 configured for accommodating therein containers 6602 and an exit port 6605. A closure mechanism in the form of covers 6619 may, according to certain embodiments, be further incorporated to entry ports 6603 for closing the ports 6603. The covers 6619 may include a snap on lock mechanism in the form of latch 6617 and protrusion 6618 for securing the connection between the covers 6619 and the entry ports 6603. The covers 6619, according to certain embodiments, may include a hinge mechanism for pivotally closing an aperture of the entry ports 6603 to thereby close the ports 6603.

FIG. 66A shows containers 6602 in various steps of engagement with entry ports 6603. FIG. 66B illustrates the system 6601 when all entry ports accommodate containers 6602 and the covers 6619 securely cover the entry ports 6603. A fluid passageway between IV bag 6604 and containers 6602 can be formed.

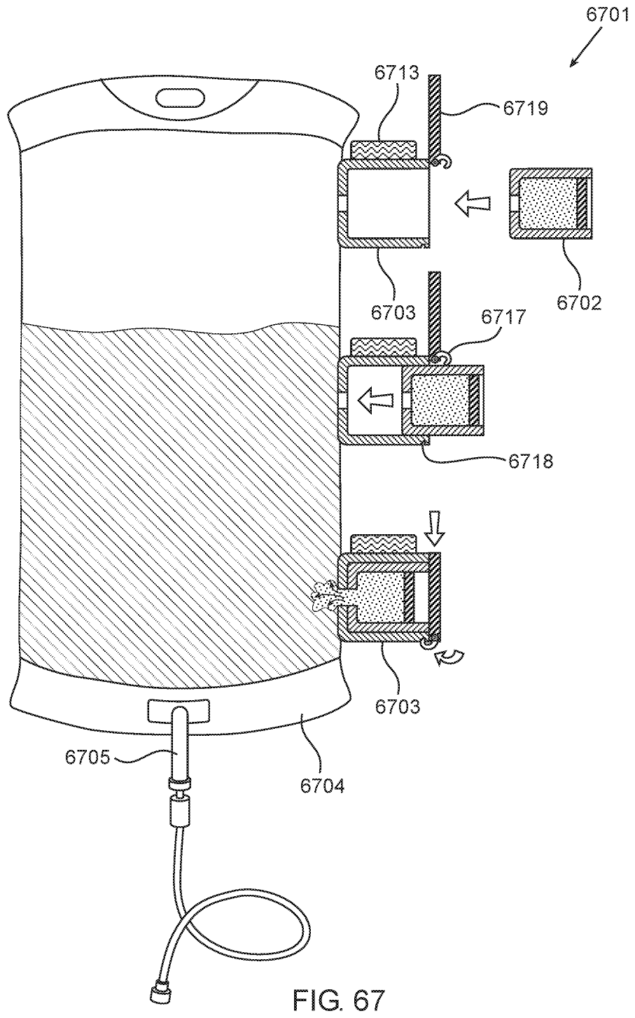

FIGS. 67 is a schematic front cut view illustration presenting yet another exemplary system 6701 which includes an IV bag 6704 having a plurality of entry ports 6703 configured for accommodating therein containers 6702 and an exit port 6705. A port closure mechanism in the form of covers 6719 may, according to certain embodiments, be further incorporated to entry ports 6703 for closing the ports 6703. The covers 6719 may include a lock mechanism in the including hook 6717 that locks into slots 6718 for securing the connection between the covers 6719 and the entry ports 6703. The covers 6719, according to certain embodiments, may include a hinge mechanism for pivotally closing an aperture of the ports 6703 to thereby close the ports 6703. Covers 6719 are configured to hermetically seal ports 6703 thus containing any fluid/vapor leaks within ports 6703. Covers 6719 may be lined with a rubber and/or elastomeric material. Covers may be circumferentially lined with a rubber and/or elastomeric material which aids in the establishment of a hermetic seal between the cover 6719 and peripheral walls of ports 6703. Cover may be made of a rubber or elastomeric material. Bag 6704 may in one or more embodiments be a bottle or any type of container. Bag 6704 is shown having a plurality of protective ports 6703 with a plurality of covers and a plurality of negative pressure compartments 6713.

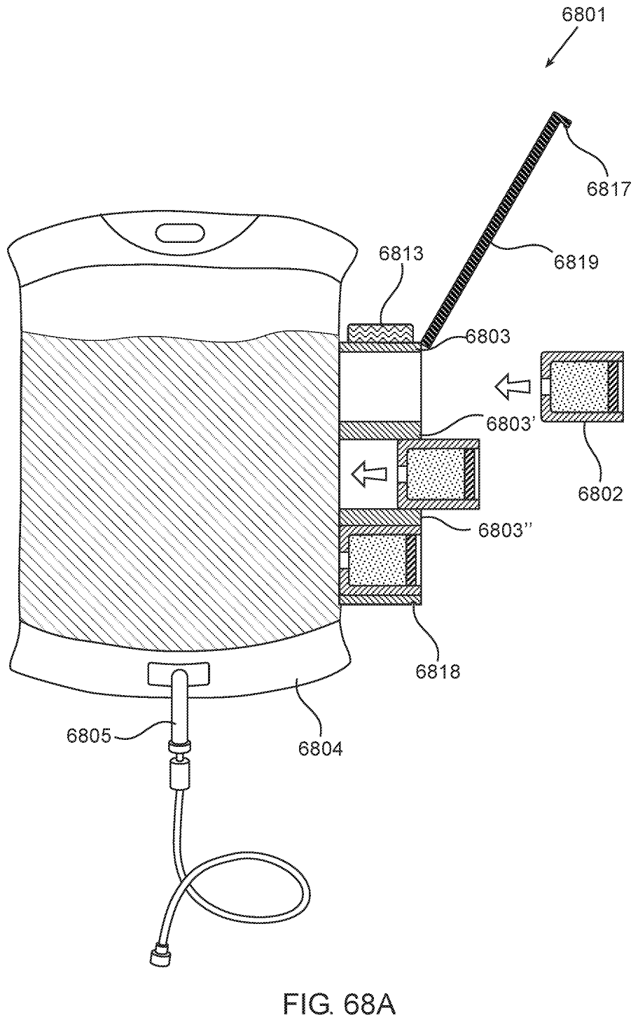

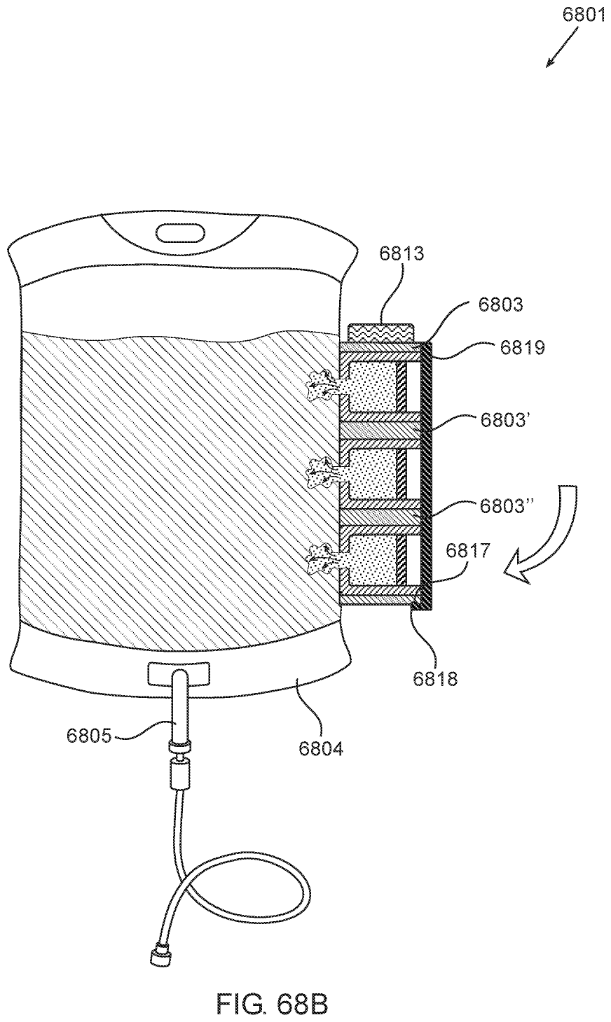

FIGS. 68A-68B are schematic front cut view illustrations presenting yet another exemplary system 6801 which includes an IV bag 6804 having a plurality of entry ports 6803 configured for accommodating therein containers 6802 and an exit port 6805. Entry ports 6803 are attached to each other forming a unitary multiple port structure. One or more negative air pressure compartments 6813 may be incorporated to the entry port structure 6803 to attract and hold containers 6802 within the ports 6803. In one or more embodiments, at least one negative air pressure compartment 6813 may be incorporated to the unitary multiple port structure. A singular cover 6819 may be hingedly attached to a top port 6803 in order to cover the ports following their connection with containers 6802. The cover 6819 may include a cover lock mechanism in the form of latch 6817 that can mate slot 6818. The singular cover 6819 may be configured to seal a plurality of containers 6802 inside the unitary multiple port structure.

FIG. 68A illustrates the system 6801 and various steps of insertion of containers 6802 into entry port structure 6803. The unitary multiple entry port structure 6803 of FIG. 68A as shown has walls 6803′ and 6803″ disposed inside the unitary multiple port structure that separate the containers 6802 from each other when the containers are disposed inside the unitary multiple port structure. However, in one or more embodiments, the unitary multiple port structure may not have the walls 6803′ and 6803″. In one or more embodiments, the unitary multiple port structure 6803 may have a retention member/fastener (not shown) configured to engage, optionally securely engage, containers 6802 inside unitary multiple port structure 6803. The retention member/fastener (not shown) may in one or more embodiments be a latch, a lock, a protrusion, etc. FIG. 68B illustrates the system 6801 when all entry ports accommodate containers 6802 and the cover 6819 securely covers the ports 6803. In one or more embodiments, it is contemplated that cover 6819 is not present and containers 6802 snuggly and/or fixedly fit into entry port structure (unitary multiple entry port structure) 6803. In accordance with this embodiment, the friction between the inner walls of unitary multiple entry port structure 6803 and exterior walls of containers 6802 when containers enter and are located inside unitary multiple entry port structure 6803 provides sufficient force to hermetically seal containers 6802 inside unitary multiple entry port structure 6803 and any vapor/fluid leaks that may be produced as a result of the fluidic communication between container 6804 and the plurality of the containers 6802 is contained between container 6804 and containers 6802 and thus not allowed to escape into the environment.

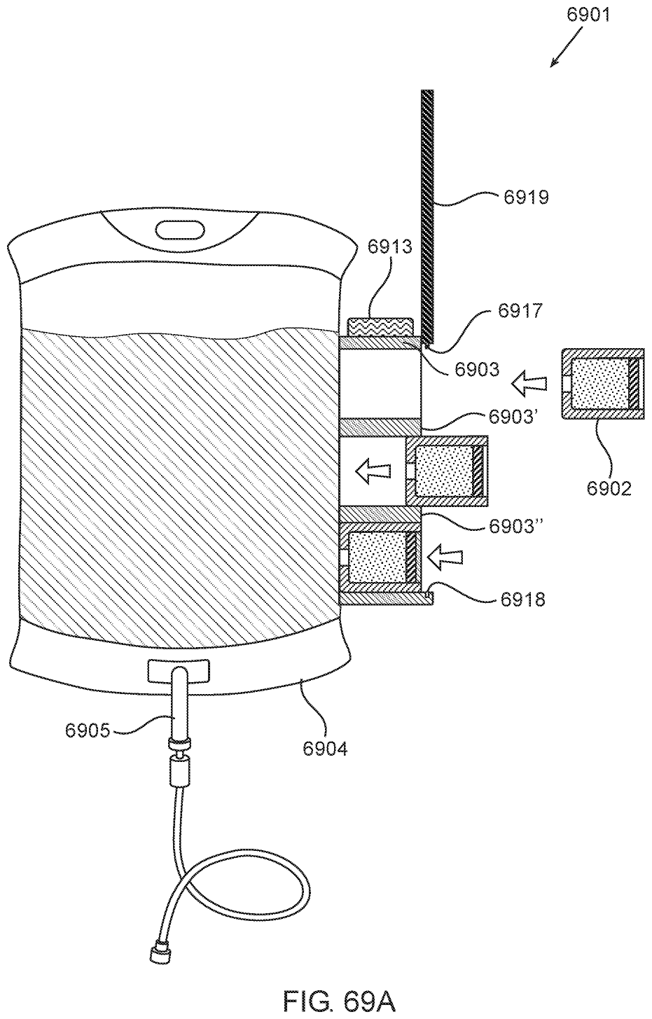

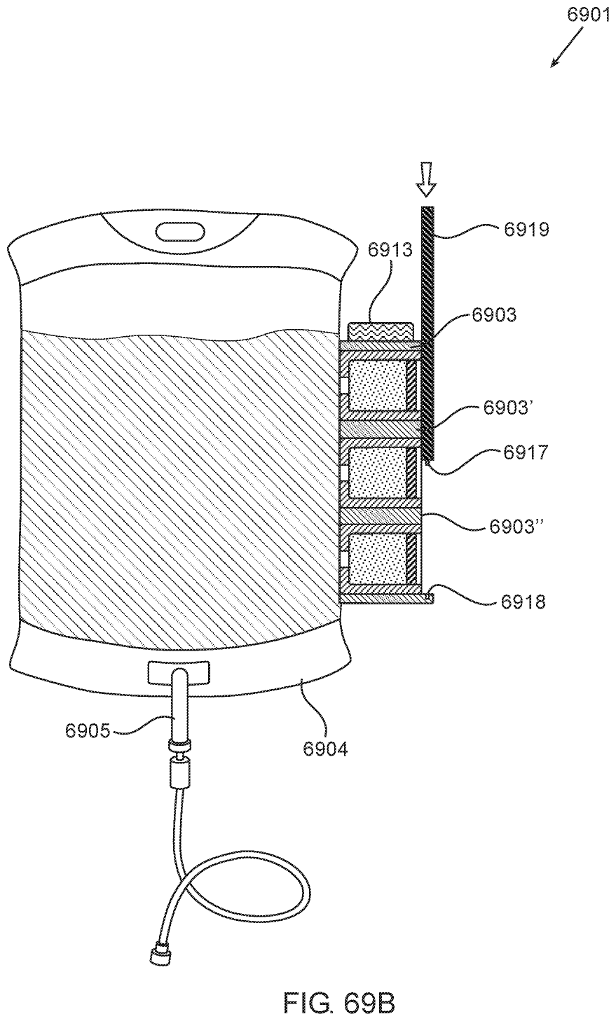

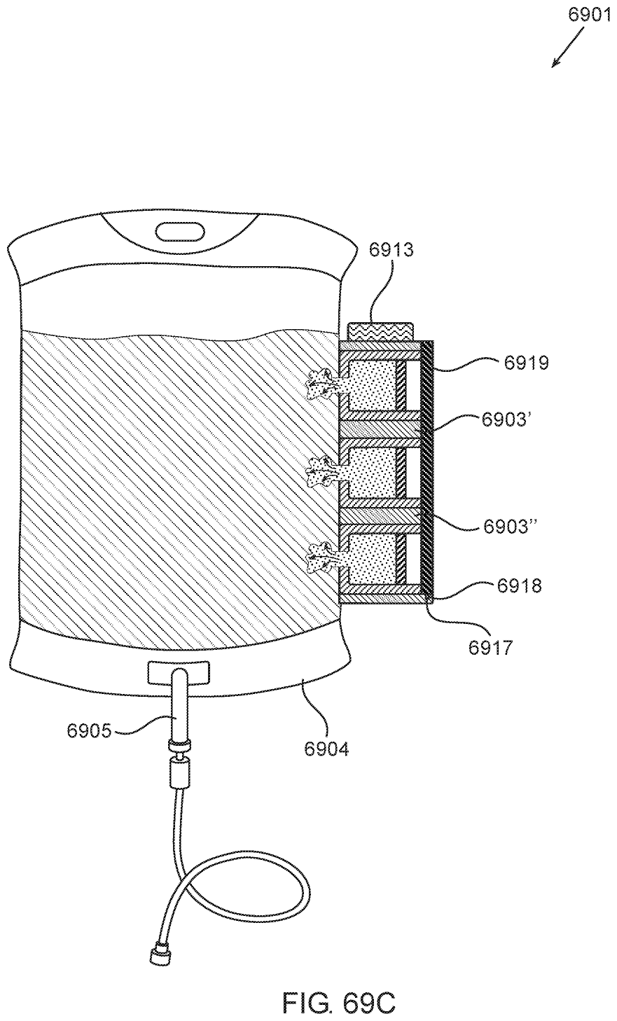

FIGS. 69A-69C are schematic front cut view illustrations presenting yet another exemplary system 6901 which includes an IV bag 6904 having a plurality of entry ports 6903 configured for accommodating therein containers 6902, and an exit port 6905. Entry ports 6903 are attached to each other forming a unitary multiple port structure. One or more negative pressure compartments 6913 may be incorporated to the ports 6903 to attract and hold containers 6902 within the entry ports 6903. A singular cover 6919 may be attached to a top port 6903 in order to cover the ports following their connection with containers 6902. The cover 6919 may include a cover lock mechanism in the form of pin 6917 and slot 6918. The cover 6919 may include a sliding mechanism (not shown) to allow the cover 6919 to slide down from top bottom, or vice versa, and thereby cover the entry port structure 6903. In one or more embodiments, the sliding mechanism (not shown) may be a rail mechanism (not shown). Containers 6902 are shown having a plunger configured to move within containers 6902 to expel any contents contained within containers 6902 into bag 6904. Bag 6904 may in one or more embodiments be a bottle or any other type of container.

FIG. 69A illustrates the system 6901 and various steps of insertion of containers 6902 into entry ports 6903. Entry ports 6903 may be circular, square, rectangular, or any other shape. Entry ports 6903 are configured in size and shape to allow containers 6902 to enter into ports 6903. Containers 6902 are configured in size and/or shape and/or volume to enter entry ports 6903 and/or unitary multiple port structure 6903, 6903′, 6903″. FIG. 69B illustrates the system 6901 when all ports accommodate containers 6902 and the cover 6919 is sliding along the port structure to close the structure 6903. FIG. 69C illustrates the system 6901 when all ports accommodate containers 6902 and the cover 6919 securely covers the ports 6903. FIG. 69C shows a plurality of containers 6902 hermetically sealed inside port 6903. FIG. 69C shows a plurality of containers 6902 hermetically sealed inside the unitary multiple port structure 6903, 6903′, 6903″. A fluid transfer from containers 6902 to IV bag 6904 is then established. The fluid transfer from containers 6902 to IV bag 6904 may be established via a piercing member(s) (not shown) piercing through a surface of at least of bag 6904 and containers 6902. Optionally, fluid transfer from containers 6902 to IV bag 6904 may be established via opening of at least one valve(s) (not shown) of bag 6904 and/or containers 6902. In one or more embodiments, interior walls of entry ports 6903 may have a rail mechanism (not shown) which is configured to accommodate sliding of containers 6902 into the entry ports 6903. The rail mechanism may aid in the entry of containers 6902 into entry ports 6903.

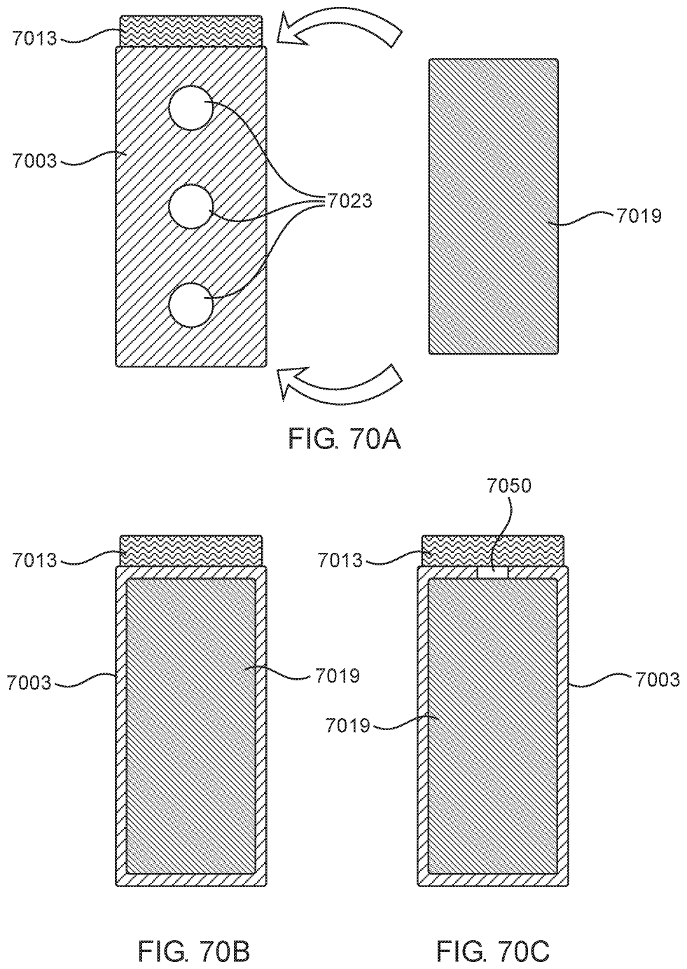

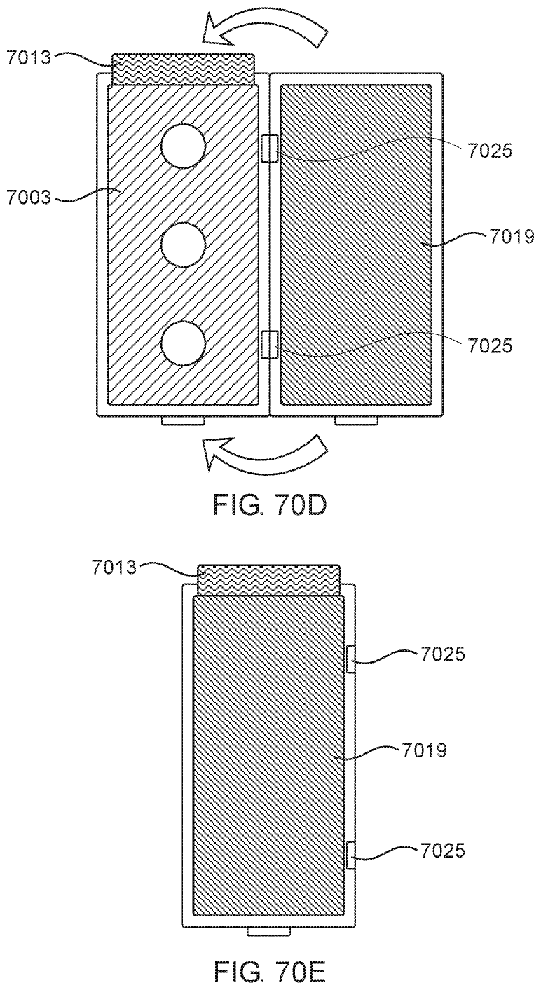

FIGS. 70A-70E are front view illustrations demonstrating a unitary port structure 7003 with three apertures 7023 for receiving three containers and a negative pressure compartment 7013 for allowing a lower pressure in the port structure 7003 compared to ambient air pressure outside the entry port 7003. The cover 7019 is shown detached from the port structure 7003. The cover 7019, when covering the entry port 7003, is shown in FIG. 70B. As shown in in FIG. 70C, an opening 7050 between the negative pressure compartment 7013 and the entry port 7003, may be provided to allow a negative air pressure within the cavities of the port structure 7003 compared to ambient air pressure. As illustrated in FIGS. 70D and 70E, the cover 7019 may be connected to port structure 7003 via one or more hinges 7025. FIG. 70D shows the cover 7019 when in an open position and FIG. 70E shows the cover 7019 when in a closed position. In one or more embodiments, openings between an IV bag and containers are covered by a rubber layer (not shown) to allow an airtight sealed fluid passageway.

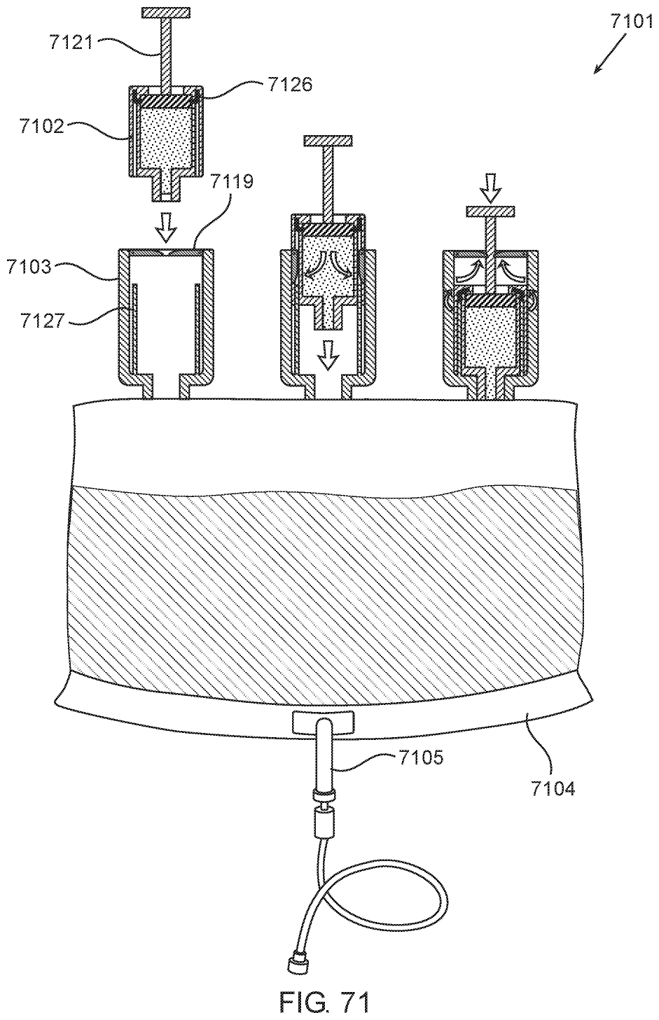

FIG. 71 is a schematic front cut view illustration presenting yet another exemplary system 7101 which includes an IV bag 7104 having a plurality of entry ports 7103 configured for accommodating therein syringes 7102 and allowing a fluid transfer from syringes 7102 to IV bag 7104. A closure mechanism in the form of flaps 7119 may, according to certain embodiments, be further incorporated to entry ports 7103 for closing the ports 7103. Syringes 7102 include a plunger 7121 with a plunger lock mechanism in the form of stoppers 7126 attached to the plunger 7121and are able to prevent premature movement thereof. A plunger unlock mechanism in the form of rods 7127 allow to release plungers 7121 when the rods enter channels 7128 within the walls of the syringes 7102. Rods 7127 are shown disposed inside ports 7103. In one or more embodiments, rods 7127 enter channels within the walls of the syringes 7102 as shown in the middle and right ports 7103. Rods 7127 engage stoppers 7126 thus unlocking plunger 7121 as shown in the right-most (right) port 7103. Unlocking of plunger 7121 allows plunger 7121 to be pushed downward towards bag 7104 to expel contents contained inside syringe 7102 into bag 7104. Cover in the form of flaps 7119 is shown sealing the syringe 7102 barrel inside port 7103, thus any vapors/fluids that may leak from within the syringe 7102 or bag 7104 will be contained inside port 7103. Bag 7104 may be a bottle or any other type of container.

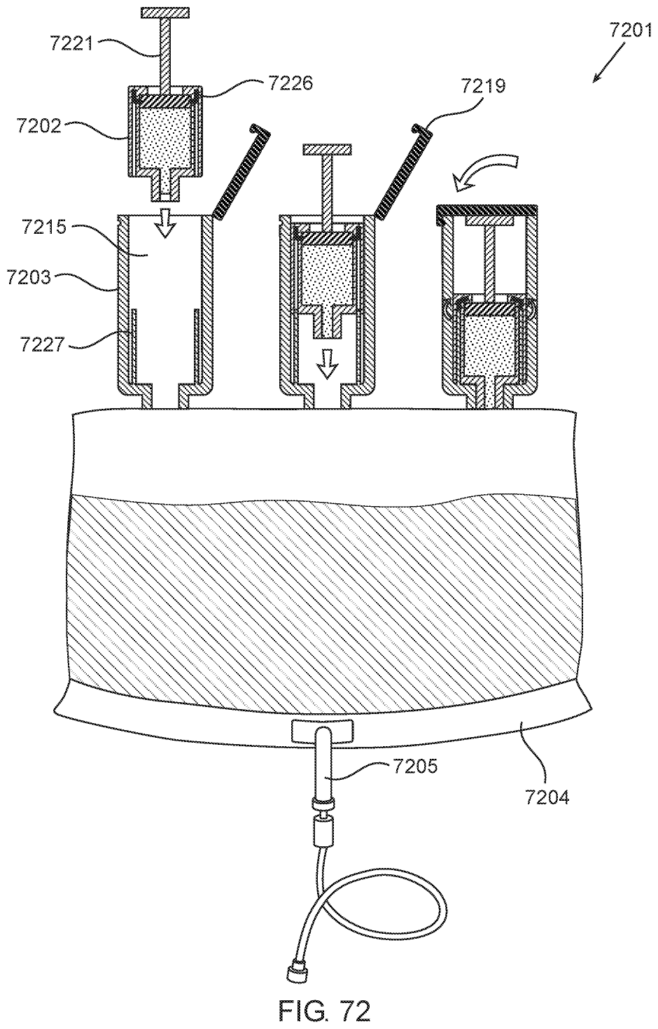

FIG. 72 is a schematic front cut view illustration presenting yet another exemplary system 7201 which includes an IV bag 7204 having a plurality of entry ports 7203 configured for accommodating therein syringes 7202 and allowing a fluid transfer from syringes 7202 to IV bag 7204. A closure mechanism in the form of entry port covers 7219 may, according to certain embodiments, be further incorporated to the walls of entry ports 7203 for closing the ports 7203. Syringes 7202 include plungers 7221 which after closing the covers 7219 via a dedicated hinge are maintained entirely inside the cavities 7215 of the entry ports. Interior walls of ports 7203 that face the cavities 7215 may be lined with a disinfecting/sterilizing substance such as alcohol, isopropyl alcohol, 70% isopropyl alcohol, etc. Rods 7227 disposed inside cavities 7215 are configured to enter channels in syringe 7202 walls to engage stopper 7226. Rods 7227 are configured to displace stoppers 7226 of syringes 7202 to unlock the plungers 7221 thus allowing plungers 7221 to be pressed/moved to expel any contents contained in syringes 7202.

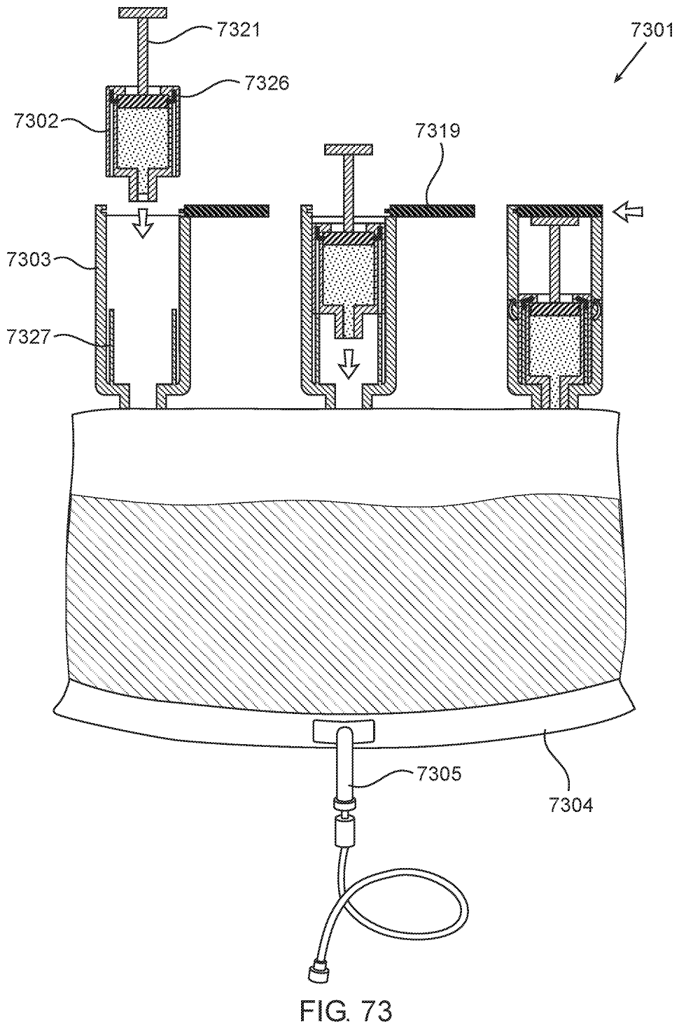

FIG. 73 is a schematic front cut view illustration presenting yet another exemplary system 7301 which includes an IV bag 7304 having a plurality of entry ports 7303 configured for accommodating therein syringes 7302 and allowing a fluid transfer from syringes 7302 to IV bag 7304. A closure mechanism in the form of entry port covers 7319 may, according to certain embodiments, be further incorporated to ports 7303 for closing the ports 7303. The covers 7319 may include a sliding mechanism (not shown) for slidably covering the entry ports 7303. Covers 7319 after closure of entry ports 7303 may in certain embodiments be configured to move along vertical side walls of ports 7303 along a rail mechanism (not shown) to push the plunger 7321 downwards towards bag 7304.

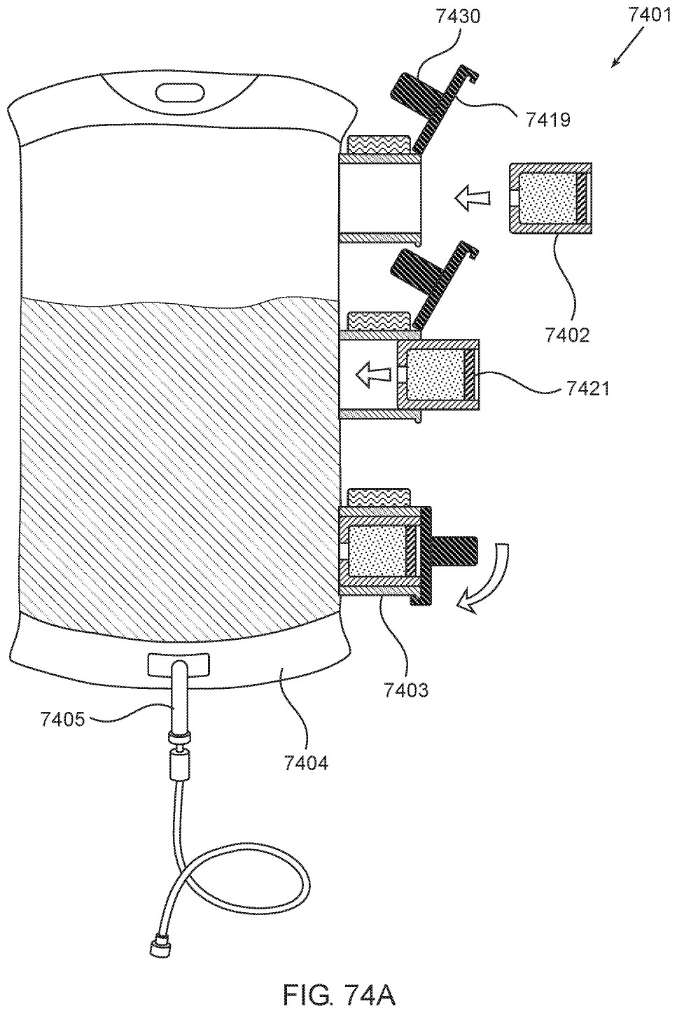

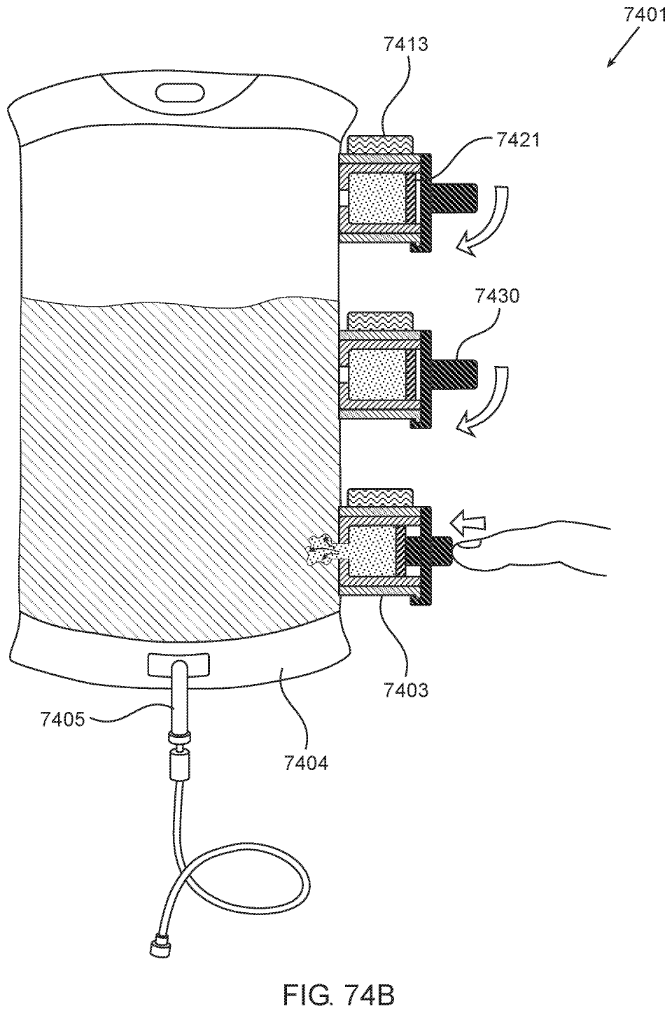

FIGS. 74A-74B are schematic front cut view illustrations presenting yet another exemplary system 7401 which includes an IV bag 7404 having a plurality of entry ports 7403 configured for accommodating therein containers 7402 and allowing a fluid transfer from containers 7402 to IV bag 7404. A port closure mechanism in the form of entry port covers 7419 may, according to certain embodiments, be further incorporated to entry ports 7403 for closing the ports 7403. The covers 7419 may, according to certain embodiments, include a mechanism for fluid transfer in the form of push buttons 7430 which can be pushed by a user to move plungers 7421 and thereby allow the fluid transfer from the containers 7402 to bag 7404.

FIG. 74A illustrate various steps of inserting containers 7402 into entry ports 7403. The cover 7419 can be securely closed to cover entry ports 7403. FIG. 74B illustrates the accommodation of containers 7402 within the entry ports 7403. A user may then push buttons 7430 to thereby move plunger 7421 of containers 7402 and exert the fluid flow from the containers 7402 to the bag 7404. Buttons 7430 are configured to move through covers 7419. In one or more embodiments, buttons 7430 are configured to move through covers 7419 to actuate the expulsion of contents of containers 7402 into bag 7404. In one or more embodiments, buttons 7430 are configured to move through covers 7419 while maintaining a hermetic seal od ports 7403. Buttons 7430 may be circumferentially covered by a rubber, optionally elastomeric, substance that maintains a hermetic seal of ports 7403 which the button is being pushed towards IV bag 7404. Buttons 7430 serve as an actuator to expel contents of containers 7402 from into IV bag 7404. IV bag 7404 may in one or more embodiments be a bottle.

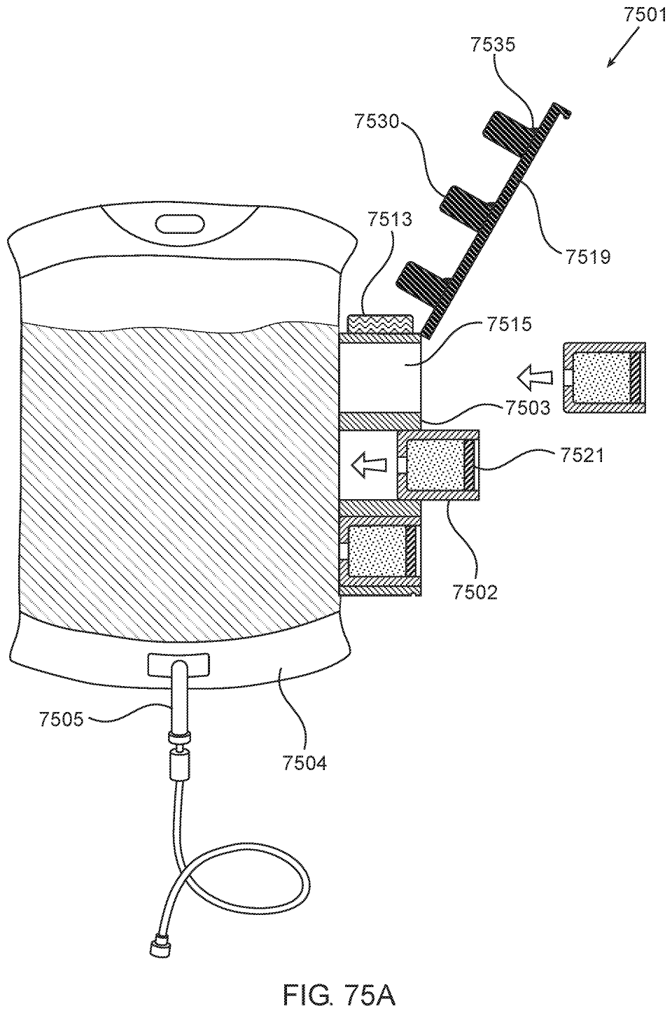

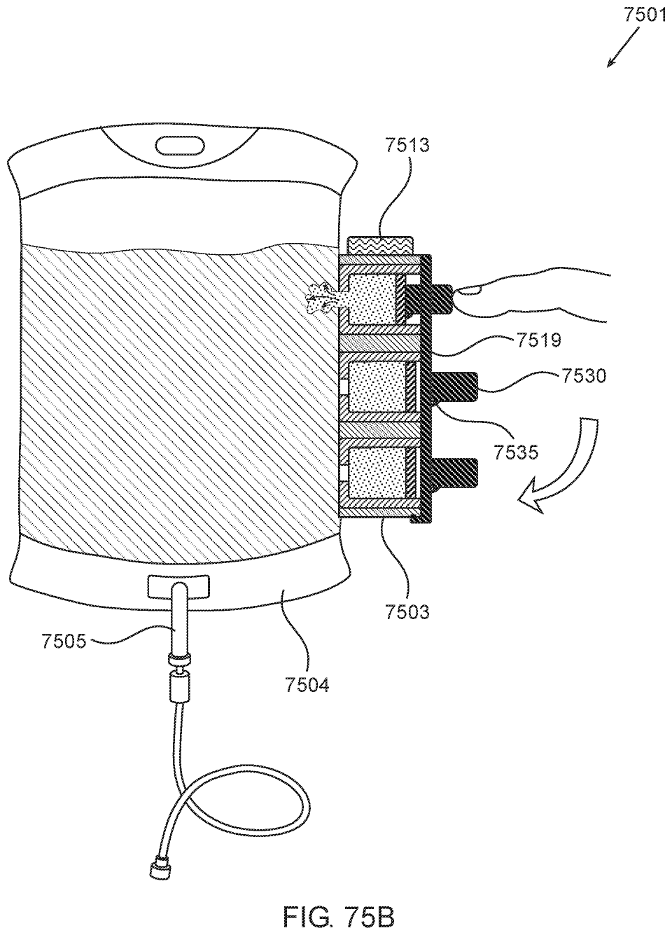

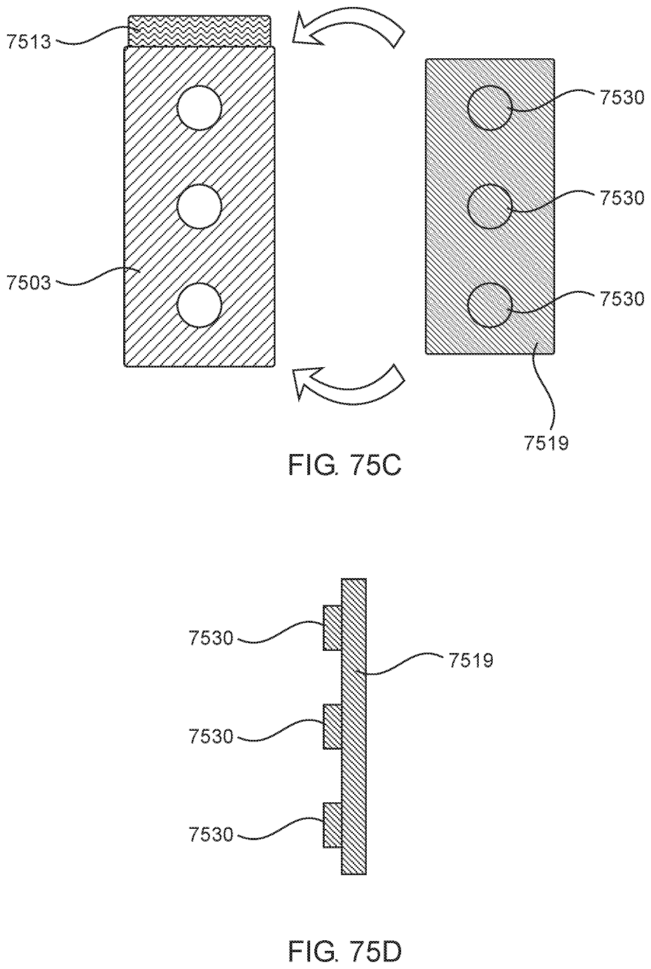

FIGS. 75A-75B are schematic front cut view illustrations presenting yet another exemplary system 7501 which includes an IV bag 7504 having a unitary multiple entry port structure 7503 with a plurality of entry ports apertures 7515 configured for receiving containers 7502 and allowing a fluid transfer from containers 7502 to IV bag 7504. FIGS. 75C is a schematic front view illustration and FIG. 75D is a schematic side view illustration of the unitary port structure 7503. A closure mechanism in the form of port unitary cover 7519 may, according to certain embodiments, be further incorporated to entry port structure 7503 for closing the entry ports. The cover 7519 may, according to certain embodiments, include buttons 7530 which can push plungers 7521 to thereby allow the fluid transfer from the containers 7502 to IV bag 7504. Buttons 7530 are configured to move through port unitary cover 7519 to push plungers 7521 towards IV bag 7504 when containers 7502 are disposed inside entry port apertures 7515. Buttons lock mechanism in the form of stoppers 7535 can also be incorporated to prevent premature actuation of the buttons 7530. Button lock mechanisms 7535 may be configured to lock buttons 7530 thus preventing buttons 7530 movement when port unitary cover 7519 is in an open position as shown in FIG. 75A. At about the time and/or after closure of port unitary cover 7519 as shown in FIG. 75B button lock mechanisms 7535 are unlocked thus allowing buttons 7530 to move and push plungers 7521 of containers 7502. Unlocking of button lock mechanisms 7535 may include retraction (not shown) of button lock mechanisms 7535 into the buttons 7530 and/or retraction (not shown) of button lock mechanisms 7535 into port unitary cover 7519. Buttons 7530 and/or port unitary cover 7519 may have a dent disposed on/within the buttons 7530 and/or port unitary cover 7519 which is configured to allow/accommodate entry of button lock mechanisms 7535. The port unitary cover 7519 is configured to enclose a plurality of entry port apertures 7515 of the unitary port structure 7503. In one or more embodiments, the port unitary cover 7519 is configured to seal a plurality of containers 7502 inside the entry port apertures 7515. In one or more embodiments, the port unitary cover 7519 is configured to seal a plurality of containers 7502 inside a plurality of entry port apertures 7515 of the unitary port structure 7503. In one or more embodiments, the unitary port structure 7503 is the same as a unitary multiple port structure. In one or more embodiments, the unitary port structure 7503 is the same as a unitary multiple entry port structure. FIG. 75A shows the port unitary cover having a plurality of buttons 7530. In one or more embodiments, buttons 7530 may further comprise spring mechanisms (not shown) disposed within the buttons 7530, inside the buttons 7530, or elsewhere on port unitary cover 7519. The spring mechanisms (not shown) may be configured, in one or more embodiments, to hold/keep the buttons 7530 in an extended state as shown in FIG. 75A until about the time and/or at the time of actuation/pushing/movement of the buttons as shown in the top button 7530 of FIG. 75B. Buttons 7530, optionally or alternately port unitary cover 7516, may further comprise button(s) locking mechanism(s) (not shown) that are configured to hold/maintain the buttons 7530 in place when/after the buttons have been pushed into entry port apertures 7515 towards IV bag 7504. The button(s) locking mechanism(s) are intended to prevent the buttons 7530 from retracting back to the initial extended state as shown in FIG. 75A. Port unitary cover 7519 is characterized in that it hermetically seals a plurality of containers 7502 inside entry port apertures 7515. Any vapor/fluid leaks that may be produced by the fluidic communication between containers 7502 and IV bag 7504 are thus contained inside/within unitary multiple entry port structure 7503.

FIG. 75A illustrate various steps of inserting containers 7502 into port 7503. The cover 7519 can be securely closed to cover the entry port structure 7503. FIG. 75B illustrates the accommodation of containers 7502 within the ports 7503. A user may then push button(s) 7530 to thereby push plunger 7521 of containers 7502 and exert the fluid flow from the containers 7502 to the bag 7504. FIG. 75C is a front view illustration of unitary port 7503 which includes negative air pressure compartment 7513 and a cover 7519 with press buttons 7530. FIG. 75D is a side view illustration of the unitary port 7503 which includes push buttons 7530. Bag 7504 is used arbitrarily and may in one or more embodiments be a bottle and/or any other container. System 7501 shows container 7504 having a unitary multiple entry port structure 7503 configured to completely engulf a plurality of containers 7502 inside the unitary multiple entry port structure 7503. In one or more embodiments, container 7504 is shown having a unitary multiple entry port structure 7503 configured to allow a plurality of containers 7502 to be hermetically sealed inside the unitary multiple entry port structure 7503. Unitary multiple entry port structure 7503 is a three-dimensional structure configured to allow entry of a plurality of containers 7502 into the unitary multiple entry port structure 7503.

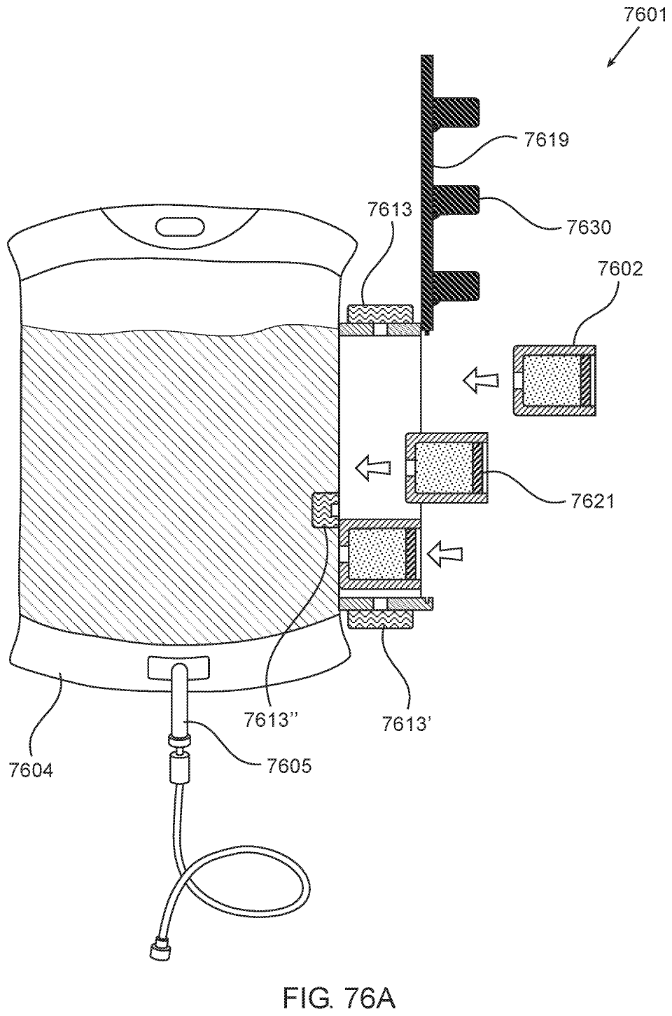

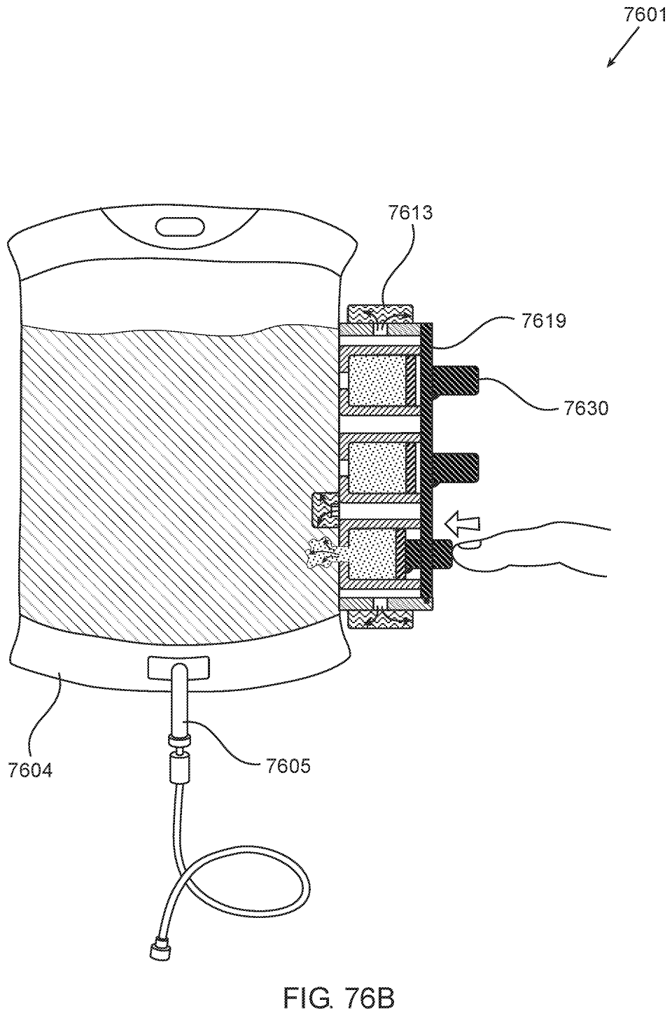

FIGS. 76A-76B are schematic front cut view illustrations presenting yet another exemplary system 7601 which includes an IV bag 7604 having a unitary entry port structure 7603 configured for accommodating therein containers 7602 and allowing a fluid transfer from containers 7602 to IV bag 7604. A closure mechanism in the form of port unitary cover 7619 may, according to certain embodiments, be further incorporated to unitary entry port 7603 for closing the port 7603. The cover 7619 slidably covers port structure 7603. The cover 7619 includes buttons 7630 for pushing plungers 7621 to thereby allow the fluid transfer from the containers 7602 to bag 7604. A plurality of negative air pressure compartments 7613 are incorporated to system 7601. Negative air pressure compartments 7613 and 7613′ disposed outside of IV bag 7604 and connected to entry port structure 7603 whilst negative air pressure compartment 7613″ disposed within IV bag 7604 and connected to entry port structure 7603. The negative air pressure compartments 7613 maintain a pressure in entry port 7603 that is less than ambient air pressure, thereby attracting containers 7602 and maintaining same within entry port structure 7603.

FIG. 76A illustrate various steps of inserting containers 7602 into port 7603. The cover 7619 can be securely closed to cover ports 7603. FIG. 76B illustrates the accommodation of containers 7602 within the ports 7603. A user may push buttons 7630 to thereby push plungers 7621 of containers 7602 and exert the fluid flow from the containers 7602 to the bag 7604 as shown in bottom container and button of FIG. 76B.

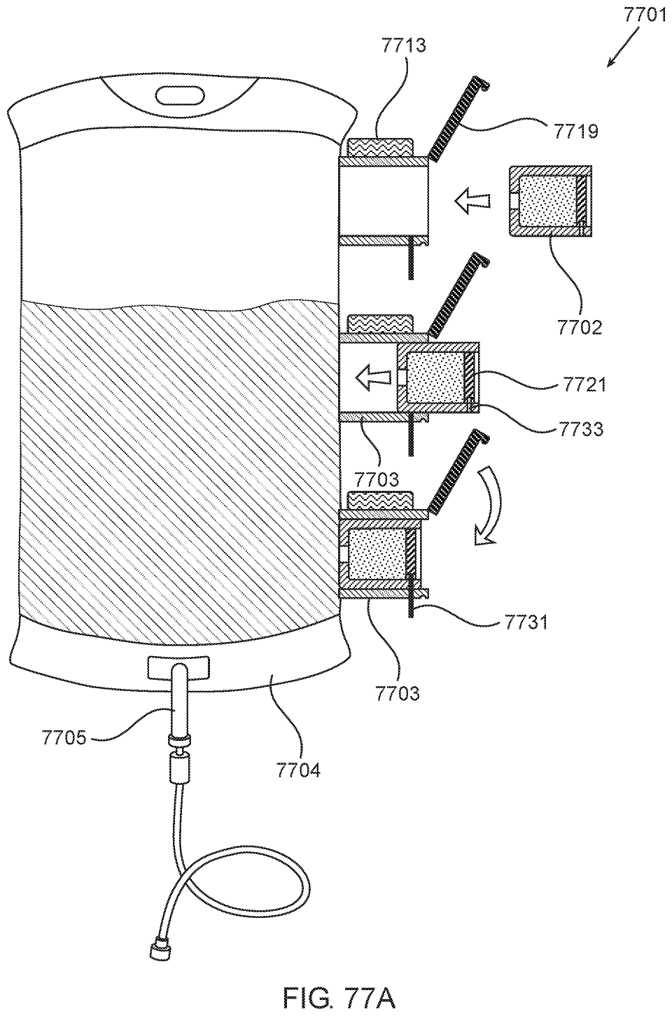

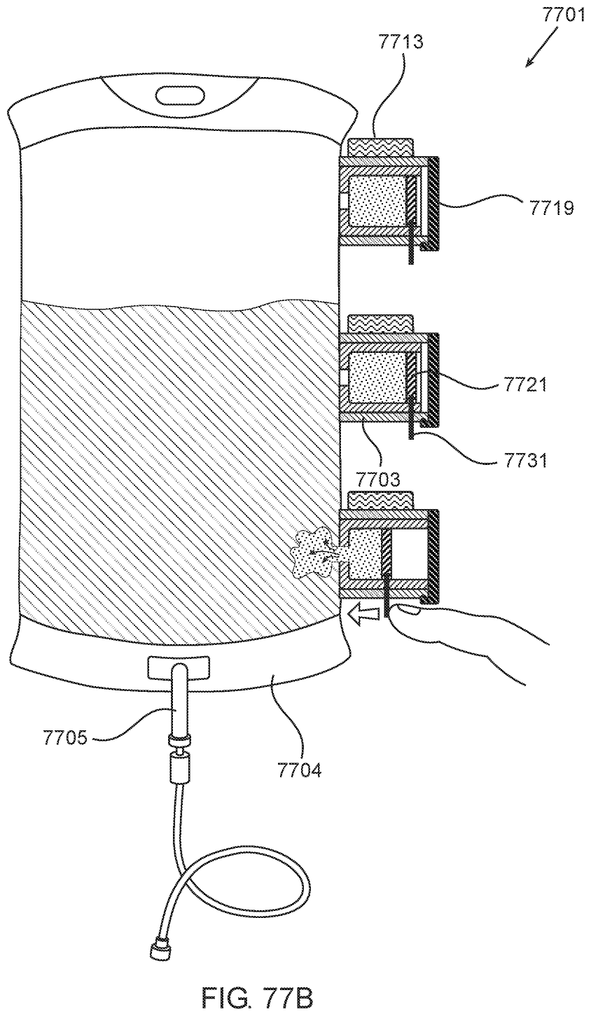

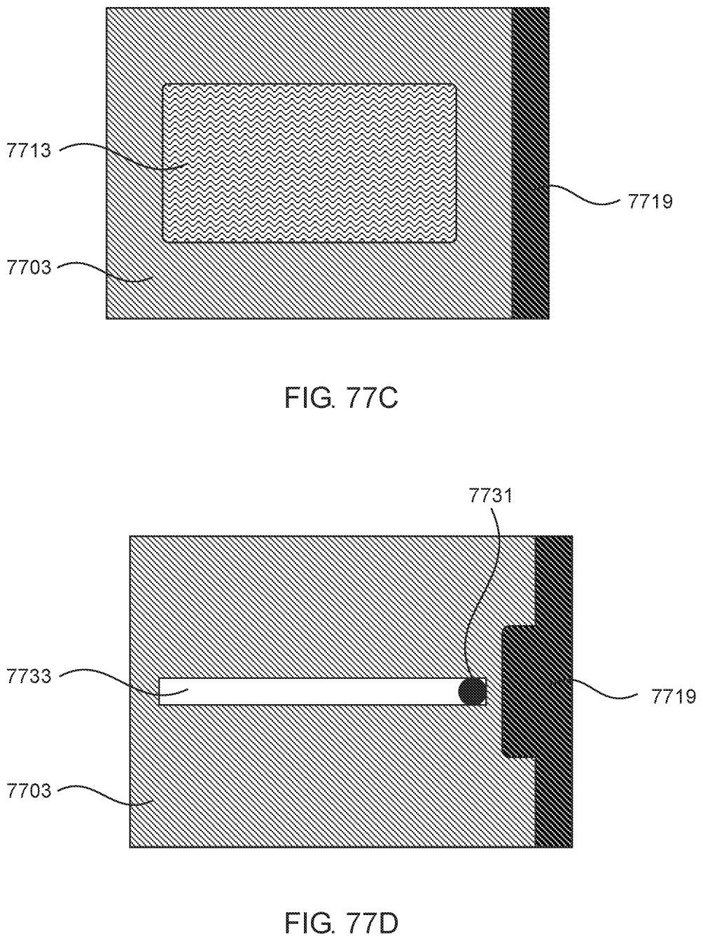

FIGS. 77A-77D are schematic front cut view illustrations presenting yet another exemplary system 7701 which includes an IV bag 7704 having a plurality of entry ports 7703 configured for accommodating therein containers 7702 and allowing a fluid transfer from containers 7702 to IV bag 7704. A closure mechanism in the form of plurality of entry port covers 7719 may, according to certain embodiments, be further incorporated to entry ports 7703 for closing the ports 7703. The entry ports 7703 may, according to certain embodiments, include a mechanism for fluid transfer in the form of levers 7731 which extend through a wall of the entry ports 7703 and which can engage plungers 7721 upon entry of containers 7702 into entry ports 7703. The plungers 7721 include a channel 7733 which is sized and shaped to be receives by levers 7731 and thereby allow movement and the fluid transfer from the containers 7702 to IV bag 7704 when a user pushes the levers 7731 forward towards IV bag 7704. Entry port covers 7719 are configured to hermetically seal entry ports 7703 when entry port covers 7719 are in a closed position as shown in FIG. 77B.

FIG. 77A illustrate various steps of inserting containers 7702 into ports 7703. The covers 7719 can be securely closed to cover entry ports 7703. FIG. 77B illustrates the accommodation of containers 7702 within the ports 7703. Levers 7731 enter channels 7733 and a user may then push levers 7731 towards bag 7704 to thereby push plungers 7721 of containers 7702 and exert the fluid flow from the containers 7702 to the bag 7704. Levers 7731 engage/couple with plungers 7721 through a wall of containers 7702. FIG. 77C is a top view of port 7703 illustrating the peripheral wall of ports 7703, the negative air pressure compartment 7713 and the port cover 7719. FIG. 77D is a bottom view of port 7703 illustrating lever 7731 and cover 7719.

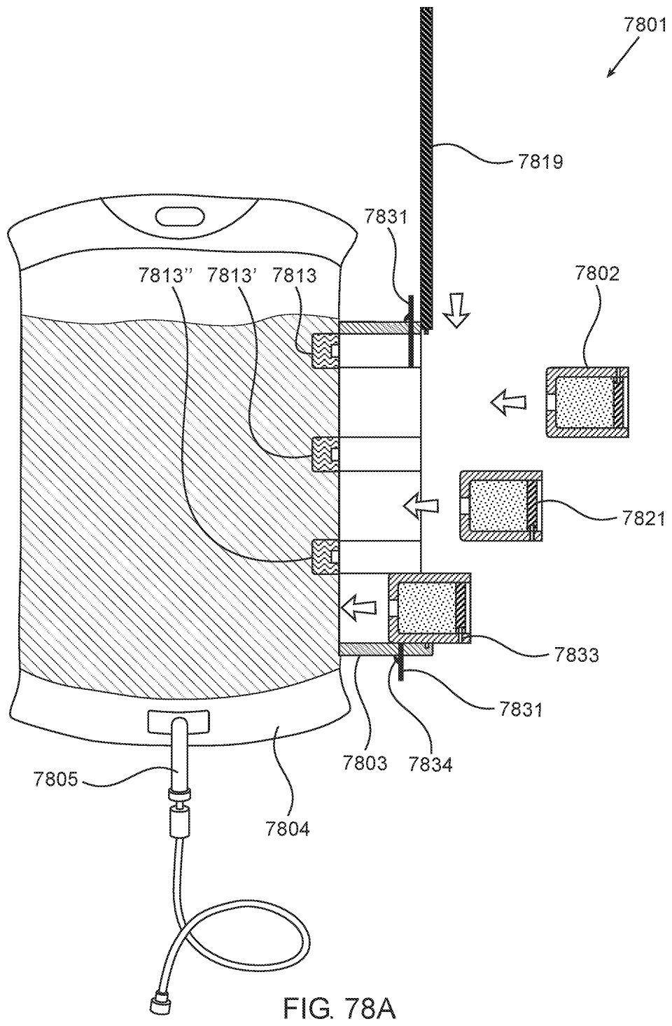

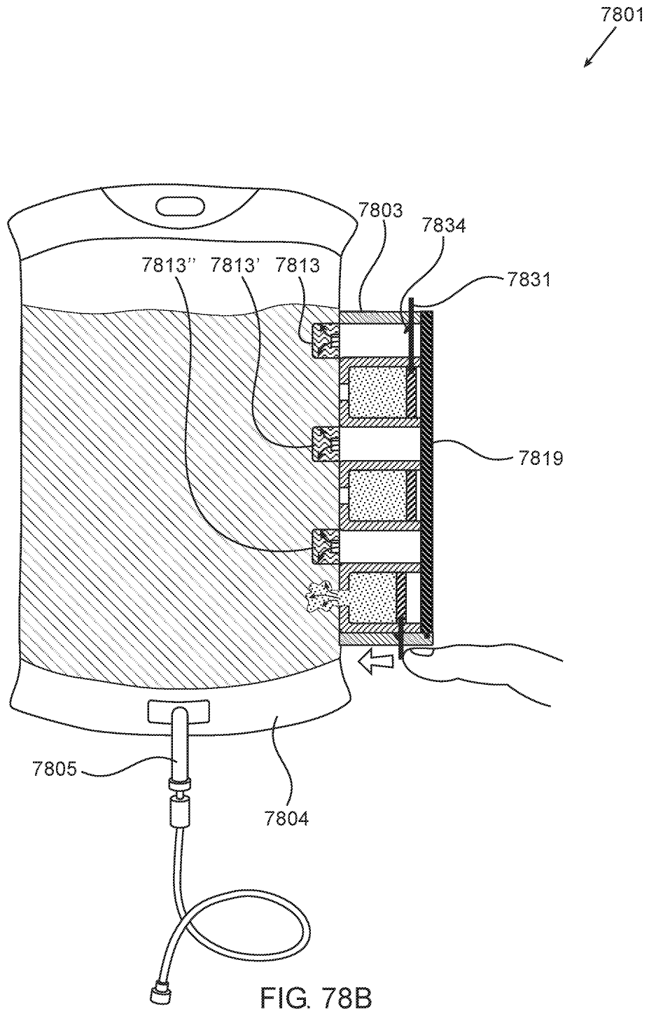

FIGS. 78A-78B are schematic front cut view illustrations presenting yet another exemplary system 7801 which includes an IV bag 7804 having a unitary multiple entry port structure 7803 for accommodating therein a plurality of containers 7802 and allowing a fluid transfer from the plurality of containers 7802 to IV bag 7804. An entry port closure mechanism in the form of port unitary cover 7819 may, according to certain embodiments, be further incorporated to port structure 7803, optionally bag 7504, for closing the port structure 7803. One or more negative air pressure compartments 7813 are disposed within and/or on bag 7804 to exert a lower air pressure inside unitary multiple entry port structure 7803 compared to ambient air pressure. The system 7801 may, according to certain embodiments, include a mechanism for allowing a fluid transfer in the form of levers 7831 which can engage plungers 7821 via dedicated channels 7833. A lever lock mechanism, optionally in the form of a retractable pin 7834 is further incorporated to levers 7831, optionally unitary multiple entry port structure 7803, to prevent premature movement of levers 7831 and allow the movement thereof upon the engagement of containers 7802 with entry port structure 7803.

FIG. 78A illustrates various steps of inserting containers 7802 into port 7803. The cover 7819 can be securely closed to cover ports 7803. The cover 7819 is configured to hermetically seal containers 7802 inside port structure 7803. FIG. 78B illustrates the accommodation of containers 7802 within the ports 7803. A user may then push lever 7831 to thereby push plunger 7821 of containers 7802 and exert the fluid flow from the containers 7802 to the bag 7804. Unitary multiple entry port structure 7803 may further comprise at least one, optionally a plurality, of piercing members (not shown) configured to pierce through a surface of containers 7802 thus establishing a fluidic communication between containers 7802 and bag 7804. The piercing members (not shown) may be disposed inside, within, and/or on unitary multiple entry port structure 7803. In one or more embodiments, piercing members (not shown) may be disposed within and/or on bag 7804, optionally or alternately within/on containers 7802. The piercing members (not shown) may be needles. The needles may be hollowed needles. In one or more embodiments, the unitary multiple entry port structure may further comprise at least one and/or a plurality of frangible seals that are configured to rupture/break at about the time and/or at the time of movement of the plunger 7821 of containers 7802 towards bag 7804. Contents of containers 7802 apply press forces to the frangible seal(s) (not shown) of the unitary multiple entry port structure thus breaking the seals and allowing a fluidic communication between containers 7802 and bag 7804. Bag 7804 is used arbitrarily and may be any container, such as but not limited to a bottle. The cover 7819 may slide downward from top to bottom as shown by downward pointing arrow in FIG. 78A to seal unitary multiple entry port structure 7803. The cover 7819 may slide along a rail mechanism (not shown). The rail mechanism (not shown) may be disposed along at least a portion, optionally along a length and/or width of the unitary multiple entry port structure 7803. The rail mechanism (not shown) may be made of a plastic material, a metal material, and combinations thereof. The unitary multiple entry port structure 7803 may be transparent, translucent, opaque, and combinations thereof. Levers 7834 may be in one or more embodiments made of a plastic material, a metal allow, a glass material, and combinations thereof.

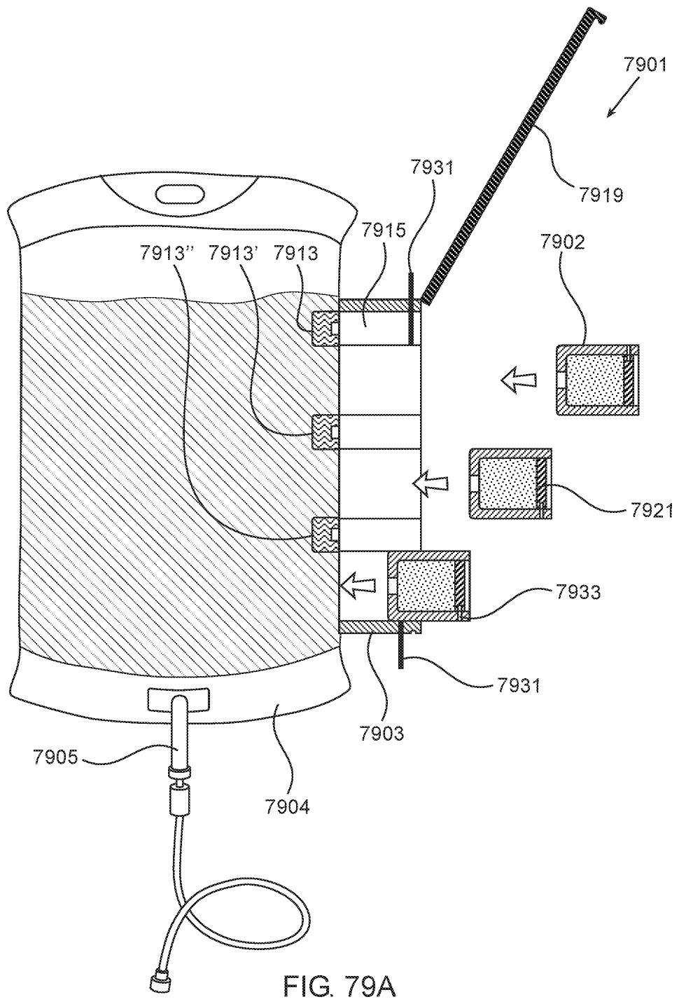

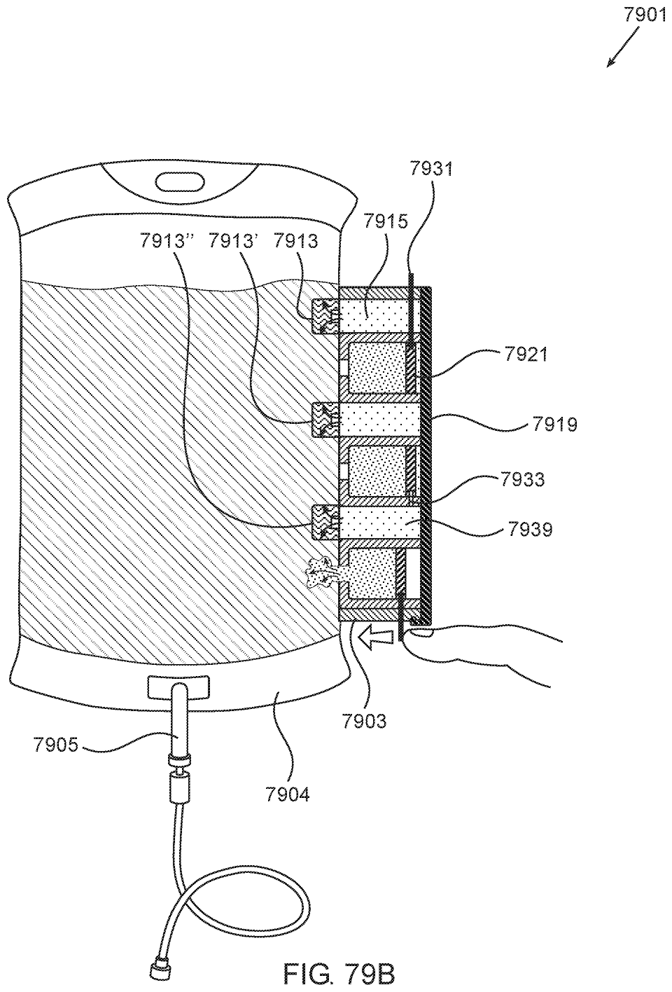

FIGS. 79A-79B are schematic front cut view illustrations presenting yet another exemplary system 7901 which includes an IV bag 7904 having a unitary port structure 7903 for accommodating therein containers 7902 and allowing a fluid transfer from containers 7902 to IV bag 7904. A port closure mechanism in the form of port unitary cover 7919 may, according to certain embodiments, be further incorporated to port structure 7903, or bag 4904, for closing the port structure 7903. FIG. 79A illustrates various steps of inserting containers 7902 into port 7903. The cover 7919 can be securely closed to cover ports 7903. FIG. 79B illustrates the accommodation of containers 7902 within the entry port 7903. A negative air pressure is exerted in cavity 7915 of entry port structure 7903 by negative air pressure compartments 7913 which suck air particles 7939 from the cavity 7915 into the air pressure compartments 7913 to thereby contribute to stabilizing the connection between the containers 7902 and the entry port structure 7903. Air particles 7939 may also in one or more embodiments represent vapors/fluid that has leaked from containers 7902 and/or bag 7904 into cavity 7915. The vapor/fluid 7939 leak may be produced from the fluidic communication between containers 7902 and bag 7904. The vapors/fluids 7939 are contained inside/within unitary port structure 7903 because the cover 7919 hermetically seals containers 7902 inside unitary port structure 7903. The negative air pressure compartments 7913, 7913′, and 7913″ withdraw (suck out) the vapor/fluid 7939 from within the unitary port structure 7903 into the negative air pressure compartments 7913, 7913′, and 7913″. Additionally, the negative air pressure compartments prevent build-up of pressure within the unitary port structure if vapor/fluid leaks are present inside unitary port structure 7903. The system 7901 further includes a mechanism for allowing a fluid transfer in the form of levers 7931 which can engage plungers 7921 once containers 7902 are received by entry port 7903. FIG. 79B shows the containers 7902 disposed in port 7903. A user may then push/move lever 7931 to thereby push plunger 7921 of containers 7902 and exert the fluid flow from the containers 7902 to the IV bag 7904 as shown with bottom (bottom-most) container 7902 of FIG. 79B. In one or more embodiments, the interior walls of unitary multiple entry port structure 7903 that face (come in contact) with the exterior sides of containers 7902 may be lined with an engagement mechanism (not shown) such as a thread (not shown), the thread (not shown) configured to engage/couple with a complimentary thread (not shown) disposed on the exterior sides of containers 7902. The threads (not shown) provide a secure and snug engagement of containers 7902 to the interior of unitary multiple entry port structure 7903. In one or more embodiments, the unitary multiple entry port structure 7903 comprises a plurality of entry ports connected to each other, the plurality of the entry ports configured to allow entry of a plurality of containers into the plurality of the entry ports.

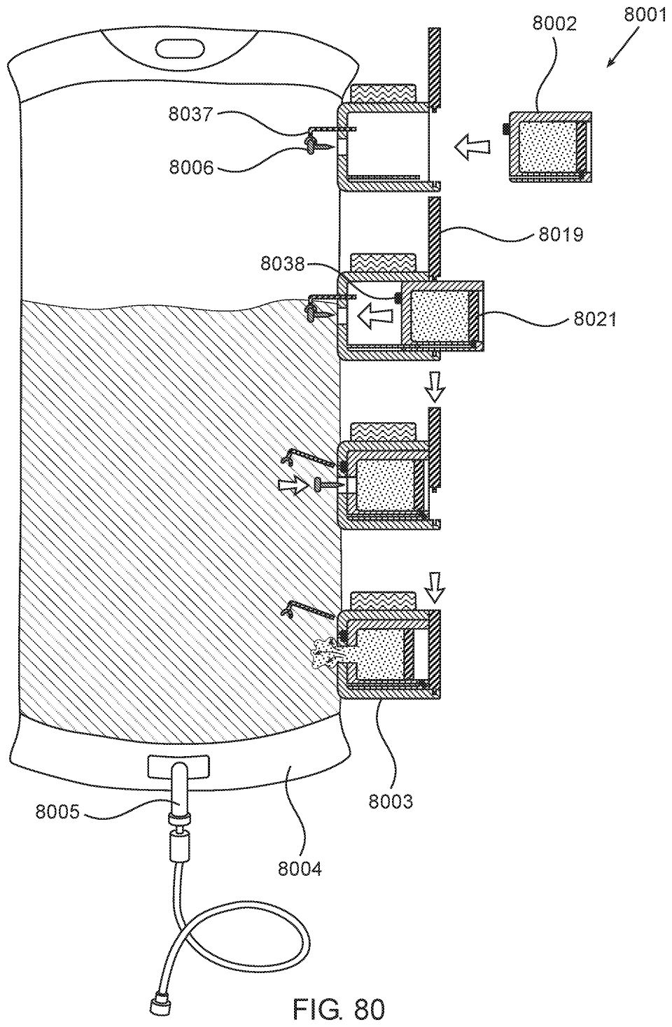

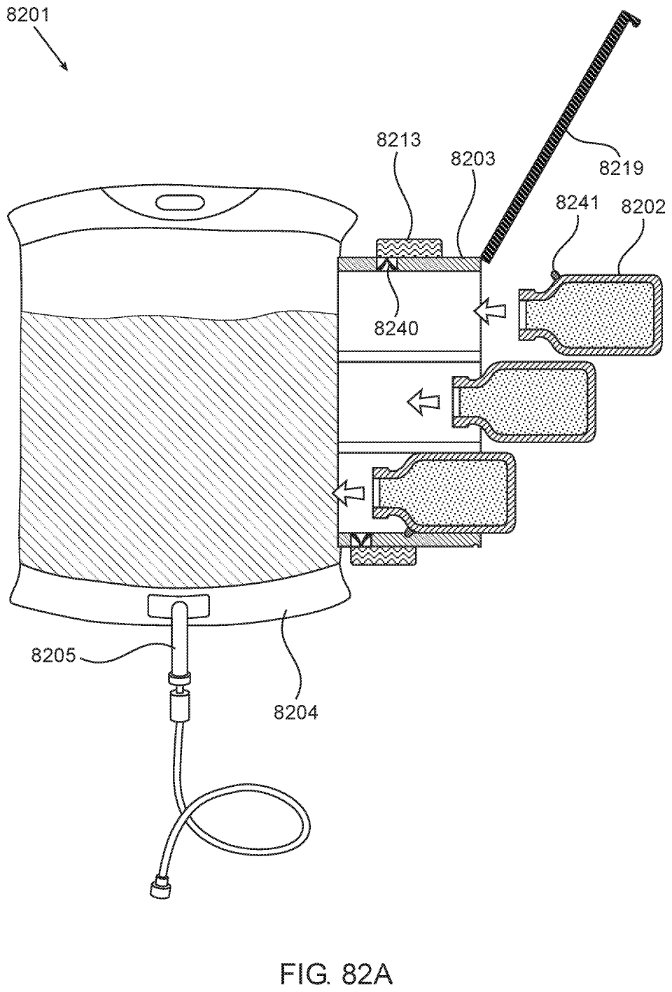

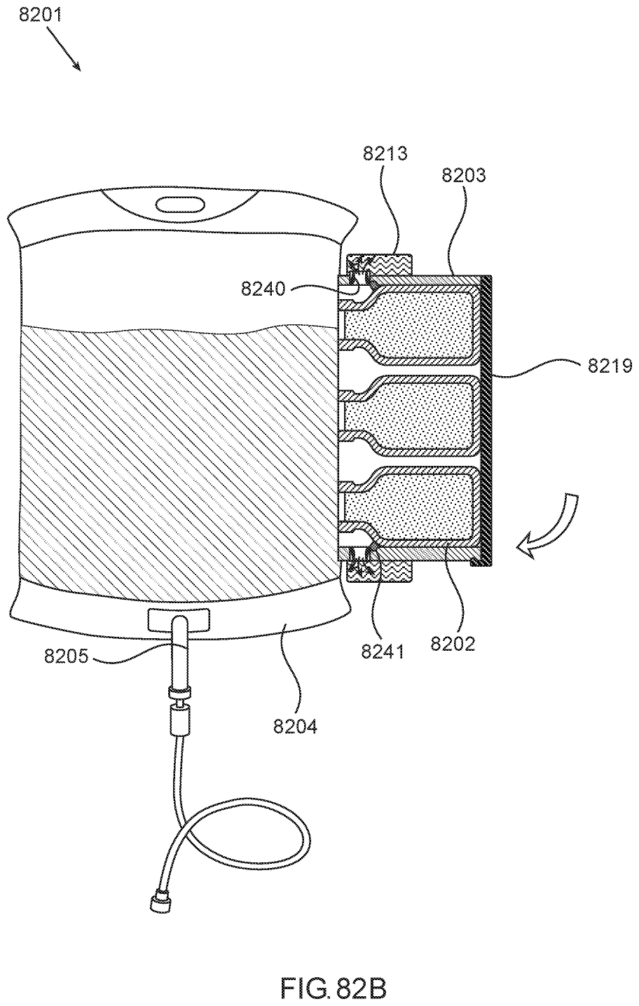

FIG. 80 is a schematic front cut view illustration presenting yet another exemplary system 8001 which includes an IV bag 8004 having a plurality of entry ports 8003 configured for accommodating therein containers 8002 and allowing a fluid transfer between containers 8002 and IV bag 8004. A closure mechanism in the form of slidable port covers 8019 are incorporated to ports 8003 for closing the ports 8003. In certain embodiments, a piercing member 8006 is provided in IV bag 8004, such that once containers 8002 reside within ports 8003, the piercing member 8006 pierces a cap or seal or surface of the containers 8002 and allows the dose transfer from the containers to bag 8004. Piercing member 8006 includes a piercing member lock mechanism 8037 which connects piercing member 8006 to a wall of the entry ports 8003 and prevents the premature actuation of piercing member 8006. In certain embodiments, a piercing member unlock mechanism 8038 is further provided to unlock piercing member lock mechanism 8037 and allow the movement of piercing member 8006 such to pierce through a cap or surface of the containers 8002. In one or more embodiments, piercing member 8006 pierces through a surface of bag 8004 and container 8002. In one or more embodiments, piercing member 8006 pierces through a surface of port 8003 and container 8002. In one or more embodiments, piercing member 8006 pierces through a surface of bag 8004, port 8003, and container 8002. In one or more embodiments, the piercing member is a needle. In one or more embodiments, the needle is a hollowed needle. In one or more embodiments, the bag 8004 may be a bottle or any other container. It is important to note that this specification incorporates in its entirety the teachings of U.S. non-provisional utility patent Ser. No. 16/504,286 filed on Jul. 7, 2019. Any of the teachings/contents of patent Ser. No. 16/504,286 may be incorporated into any of the systems, containers, device, and methods disclosed in herein. In one example, the unitary multiple entry port structure of FIGS. 82A-82B may incorporate any of the systems, containers, devices, and methods disclosed in U.S. patent Ser. No. 16/504,286.

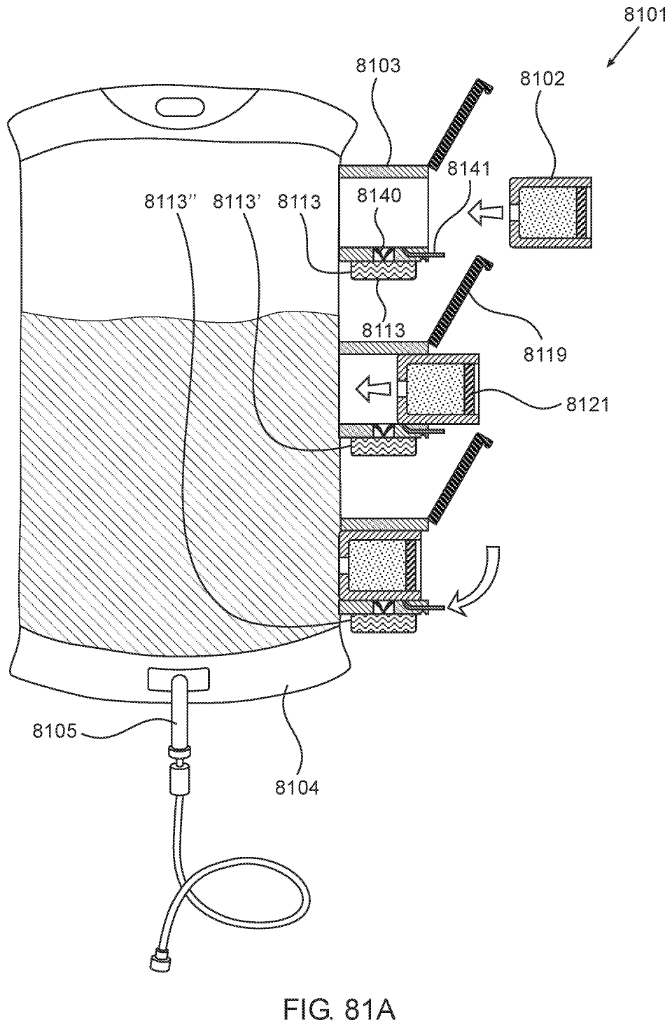

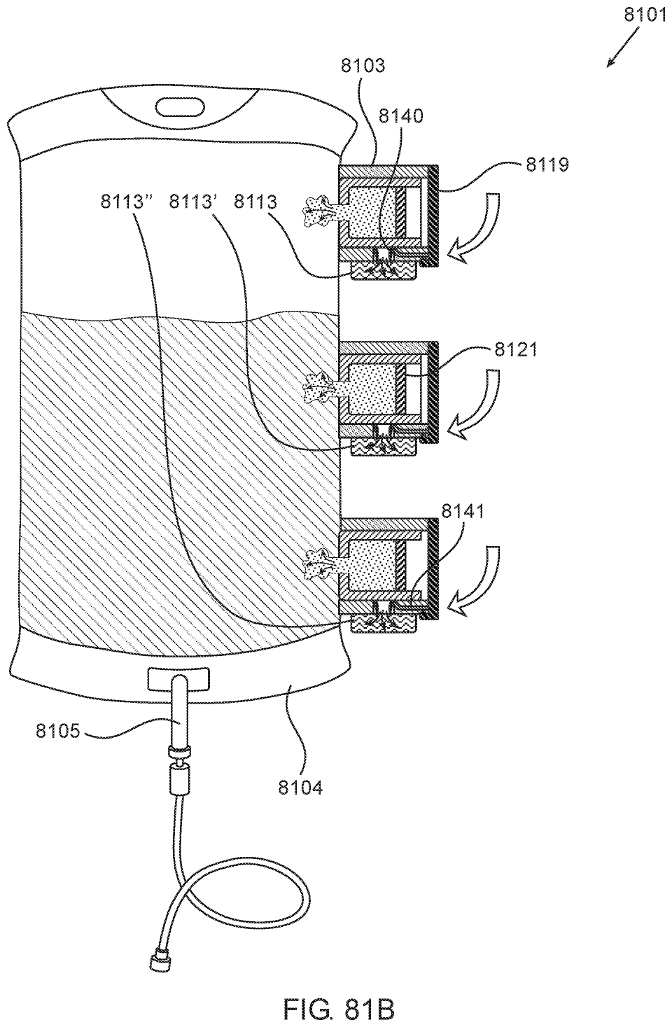

FIGS. 81A-81B are schematic front cut view illustrations presenting yet another exemplary system 8101 which includes an IV bag 8104 having a plurality of entry ports 8103 configured for accommodating therein containers 8102 and allowing a fluid transfer therebetween. A closure mechanism in the form of entry port covers 8119 are incorporated to entry ports 8103 for closing the ports 8103. Negative air pressure compartments 8113 are coupled to ports 8103 to induce an air pressure lower in ports 8103 compared to the ambient air pressure. The air pressure differential between any of the negative air pressure compartments compared to ambient air pressure may in one or more embodiments be between −0.001 (negative 0.001) inches water column and −0.4 (negative 0.4) inches water column. In certain embodiments, a valve 8140 is provided within aperture 8023 to maintain close the aperture 8023 prior to an engagement between containers 8102 and entry ports 8103. In certain embodiments, a valve unlock mechanism in the form of rod 8141 resided within a wall of ports 8103 to open the valve 8140. The valve 8140 may in one or more embodiments by disposed on a surface of entry ports 8103, on an interior or exterior surface of entry ports 8103, inside/within entry ports 8103, through a wall of entry port(s) 8103, and combinations thereof. The rod 8141 may be actuated by the entry of container 8102 into entry port 8103 to open valve 8140. Optionally, or alternately, rods 8141 may be actuated to open valves 8140 by the closure of covers 8113 as shown in FIG. 81B.

FIG. 81A illustrate various steps of inserting containers 8102 into entry ports 8103. The covers 8119 can be securely closed to cover ports 8103. In one or more embodiments, covers 8119 are configured to hermetically seal ports 8103. In one or more embodiments, covers 8119 are configured to hermetically seal containers 8102 inside ports 8103. FIG. 81B illustrates the accommodation of containers 8102 within the entry ports 8103. Valve unlock mechanism 8141 is configured such that once containers 8102 reside within entry ports 8103, the valve unlock mechanism 8141 opens valve 8140 to thereby allow air within the entry ports to be sucked into negative air pressure compartment(s) 8113 to exert a lower pressure within the cavities of entry ports 8103, thus allowing to maintain the containers 8102 within entry ports 8103 and suck out/withdraw any leaks contained inside entry ports 8103 from entry ports 8103 into negative air pressure compartment(s) 8113.

FIGS. 82A-82B are schematic front cut view illustrations presenting yet another exemplary system 8201 which includes an IV bag 8204 having a unitary multiple entry port structure 8203 configured for accommodating therein containers 8202 and allowing a fluid transfer between containers 8202 and IV bag 8204. A closure mechanism in the form of port cover 8219 is incorporated to entry port structure 8203 for closing the structure 8203. Optionally, or alternately, port cover 8219 may be attached to IV bag 8204 and may be configured to cover the unitary multiple entry port structure 8203. Negative air pressure compartments 8213 are coupled to ports 8203 to induce an air pressure lower in ports 8203 as compared to the ambient air pressure. In certain embodiments, a valve 8240 is provided within, optionally on/over (not shown) apertures of the ports 8203. In certain embodiments, a valve unlock mechanism 8241 is attached to a wall of containers 8202.

FIG. 82A illustrates various steps of inserting containers 8202 into entry ports 8203. FIG. 82B illustrates the accommodation of containers 8202 within the unitary multiple entry port structure 8203. Valve unlock mechanisms in the form of protruding pins 8241 are configured such that once containers 8202 reside within ports 8203, the valve unlock mechanisms 8241 open valves 8240 to thereby allow the air located inside port structure 8203 to be sucked into the negative pressure compartment 8213 to exert a lower pressure within the cavities of ports 8203.

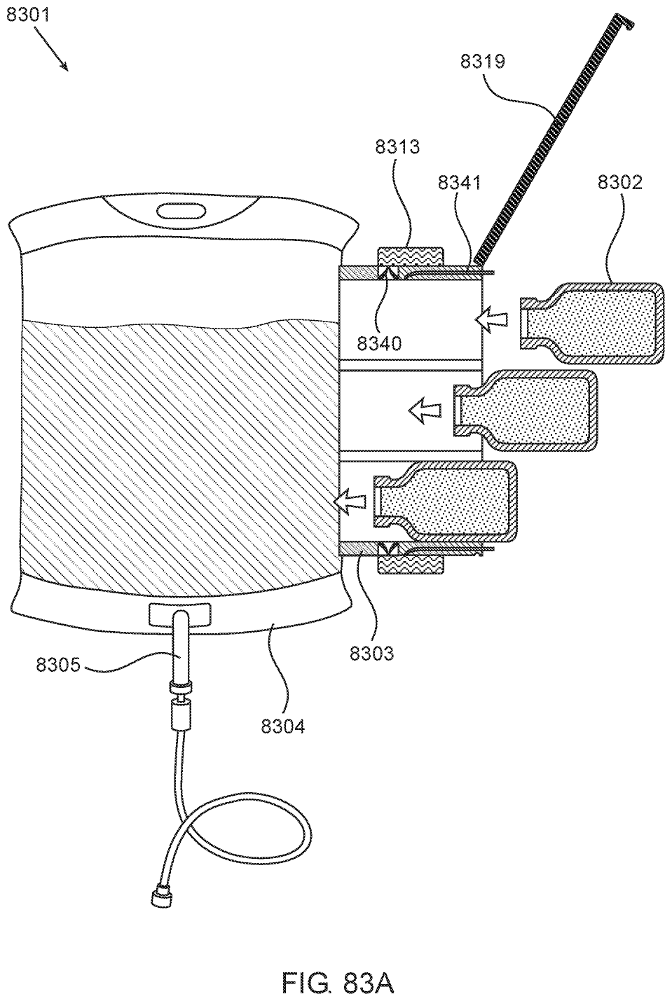

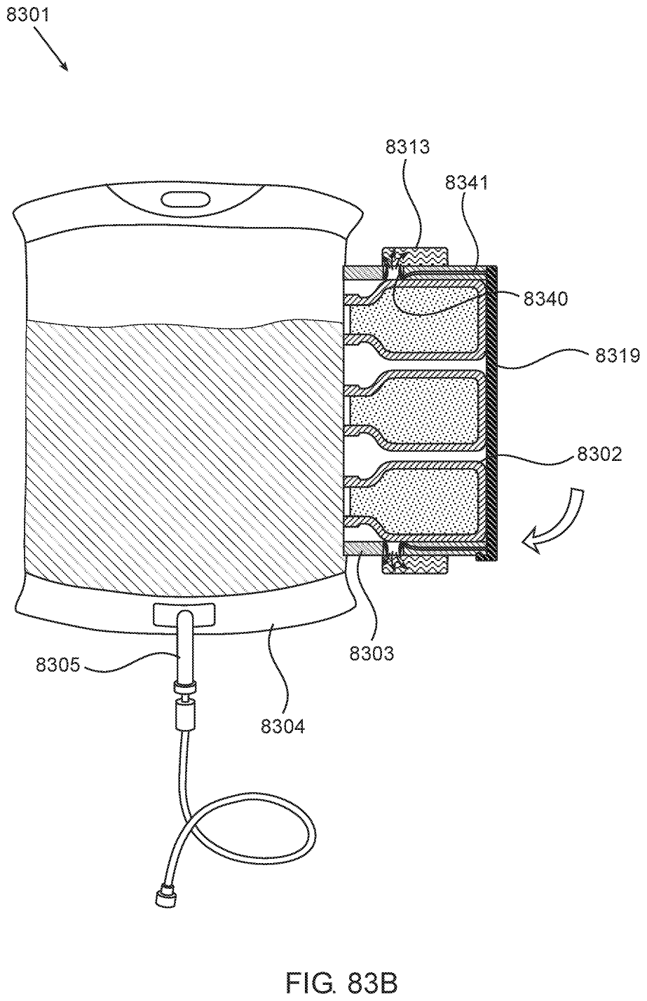

FIGS. 83A-83B are schematic front cut view illustrations presenting yet another exemplary system 8301 which includes an IV bag 8304 having a unitary multiple entry port structure 8303 configured for accommodating therein a plurality of containers 8302 and allowing a fluid transfer between the containers 8302 and IV bag 8304. A valve 8340 and an unlock mechanism thereof 8341 are further provided to control the air pressure in the port structure 8303. The valve unlock mechanism 8341 extends through a wall of entry port structure 8303 and outwardly protrudes therefrom such that upon closure of entry port structure 8303 by cover 8319, the valve unlock mechanism moves internally within the wall and opens valve 8340. The valve unlock mechanism 8341 is configured to open valve 8340 at about the time and/or after closure/sealing of unitary multiple entry port structure 8303 by cover 8319.

FIG. 83A illustrates various steps of inserting containers 8302 into port structure 8303. Containers 8302 may be bottles, vials, cartridges, syringe, etc. FIG. 83B illustrates the accommodation of containers 8302 within the ports 8303. Valve unlock mechanism 8341 is configured such that once containers 8302 reside within ports 8303 and cover 8319 is closed, the valve unlock mechanism 8341 moves to opens valve 8340 to thereby allow the air to be sucked from within unitary multiple entry port structure 8303 into negative pressure compartment(s) 8313 to exert a lower pressure within the cavities of entry ports 8303 than ambient air pressure or air pressure at sea level. Valves 8340 may in one or more embodiments be one-way valves configured to allow movement of air, vapors, leaks, and/or fluids from within unitary multiple entry port structure 8303 into negative air pressure compartment(s) 8313 while preventing backflow of any contents from within the negative air pressure compartments 8313 into the interior of unitary multiple entry port structure 8303.

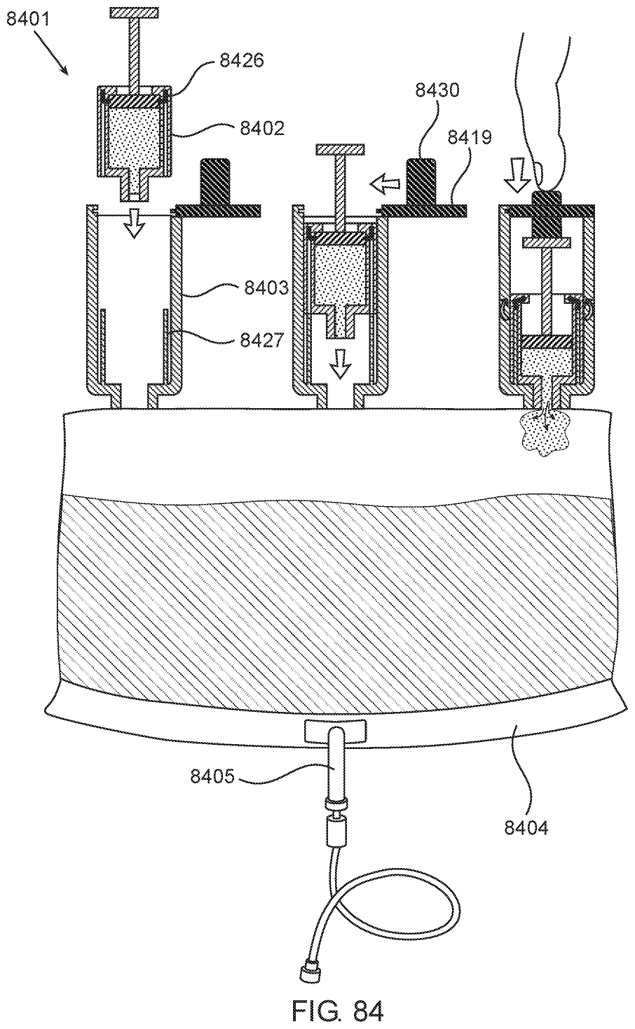

FIG. 84 is a schematic front cut view illustration presenting yet another exemplary system 8401 which includes an IV bag 8404 having a plurality of entry ports 8403 configured for accommodating therein containers 8402 and allowing a fluid transfer between the containers 8402 and IV bag 8404. The syringes 8402 in system 8401 include a plunger lock mechanism 8426 which can be unlocked by plunger unlock mechanism containing rods 8427 upon entry of syringes 8402 into entry ports 8403. Covers 8419 with moveable buttons 8430 are further provided to push plunger and expel a dose from the syringes 8402 once unlocked by unlock mechanism 8427. Entry ports 8403 are configured in size and/or shape and/or volume to completely engulf syringe 8402 inside the entry port 8403. Cover 8419 is configured to hermetically/airtight seal the syringe (including syringe barrel and plunger) inside the entry port 8403. Therefore, any leaks such as vapors/fluids that may be produced between the fluidic communication between syringe 8402 and bag 8404 are entrapped inside entry port 8403. Button 8430 is configured to move through a wall of cover 8419. In one or more embodiments, button 8430 is configured to move through cover 8419. In one or more embodiments, button 8430 is configured to be pushed through cover 8419 while the cover maintains a hermetic/airtight seal of entry port 8403. The button(s) 8430 may be made of a rubber material. In one or more embodiments, the aperture in cover 8419 through which the button 8430 is positioned is lined with a rubber and/or elastomeric substance that maintains the hermetic seal of the entry port when covered by the cover 8419. It must be noted that any bag and/or IV bag in this specification may be a bottle and/or any other type of container. It is important to note that the herein patent specification incorporates in it's entirely the teaching of U.S. non-provisional utility patent application Ser. Nos. 16/423,120 and 16/423,122 entitled MEDICAL VESSELS WITH DYNAMIC FLUID TRANSFER LOCK MECHANISM and any of the systems, containers, devices, and methods disclosed in the patent applications Ser. Nos. 16/423,120 and 16/423,122 may be incorporated into any of the systems, containers, device, and methods of herein specification. In one example, any of the ports (including but not limited to unitary multiple entry port structure) of FIGS. 84-89B may incorporate any of the systems, containers, device, and methods of U.S. patent applications Ser. Nos. 16/423,120 and 16/423,122.

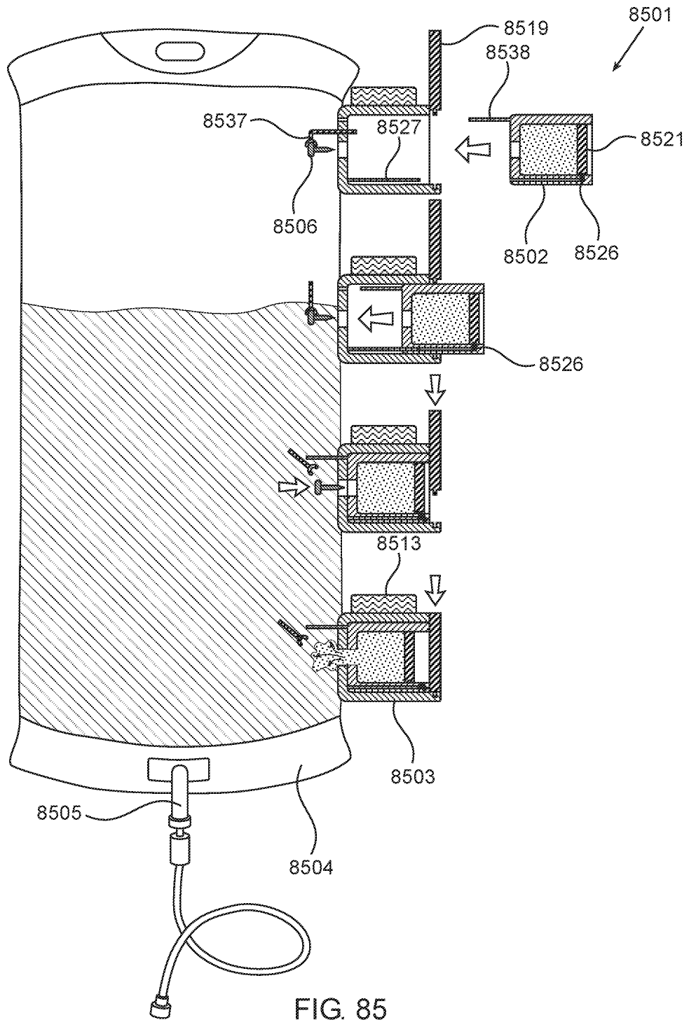

FIG. 85 is a schematic front cut view illustration presenting yet another exemplary system 8501 which includes an IV bag 8504 having a plurality of entry ports 8503 configured for accommodating therein containers 8502 and allowing a fluid transfer therebetween the containers 8502 and IV bag 8504. A piercing member 8506 coupled to a wall of entry ports 8503 is further provided to pierce through a cover/surface of the containers 8502. Piercing member unlock mechanism in the form of rods 8538 extending outwardly from a front surface of the containers 8502 push/displace piercing member lock mechanism 8537 upon entry of containers 8502 into entry ports 8503. In turn, the piercing member 8506 is released and can pierce a cap or surface of containers 8502 thus establishing a fluidic communication between containers 8502 and IV bag 8504. Entry ports 8503 are also shown having rods 8527 configured to enter channels of containers 8502 to engage/couple and unlock plunger locking mechanisms 8526 when containers 8502 enter entry ports 8503. Upon unlocking of plunger locking mechanisms 8526 the plungers are free to move and expel contents contained inside containers 8502 into IV bag 8504. Entry ports 8503 are configured in size and shape to fully encapsulate containers 8502 thus protecting containers 8502 from breaking and/or cracking if IV bag 8504 and containers 8502 fall to the ground or encounter impact. Additionally, covers 8519 are configured to hermetically seal containers 8502 inside entry ports 8503 thus providing a fully contained IV bag-Containers system which prevents leakage of any substance contained in either bag 8504 and/or containers 8503 from contacting the environment. The covers 8519 are configured to hermetically seal the containers 8502 inside the entry ports 8503.

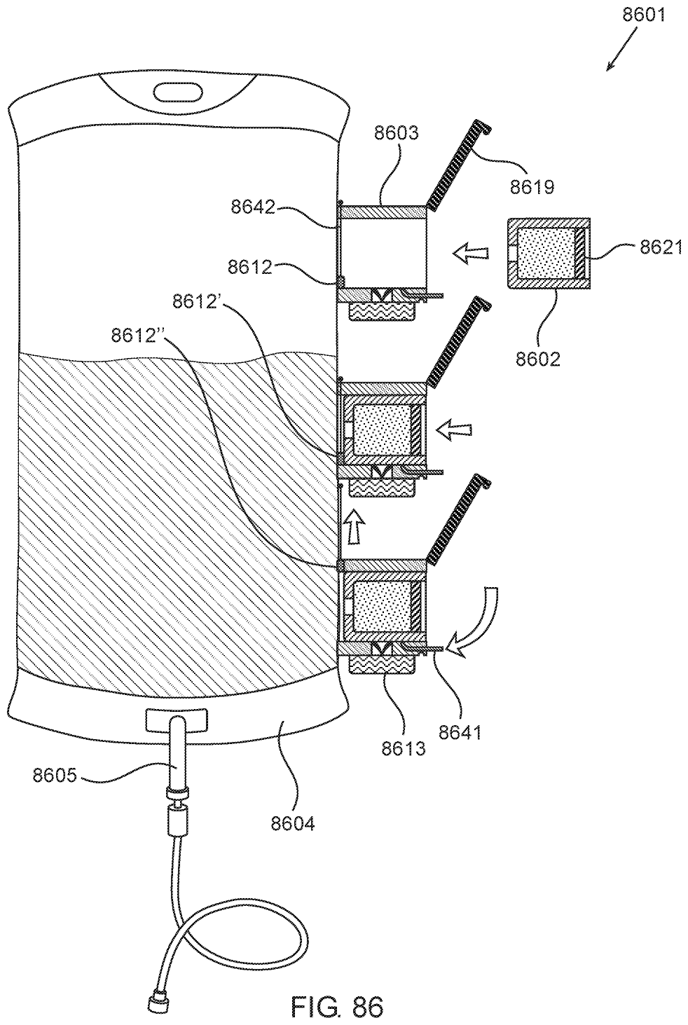

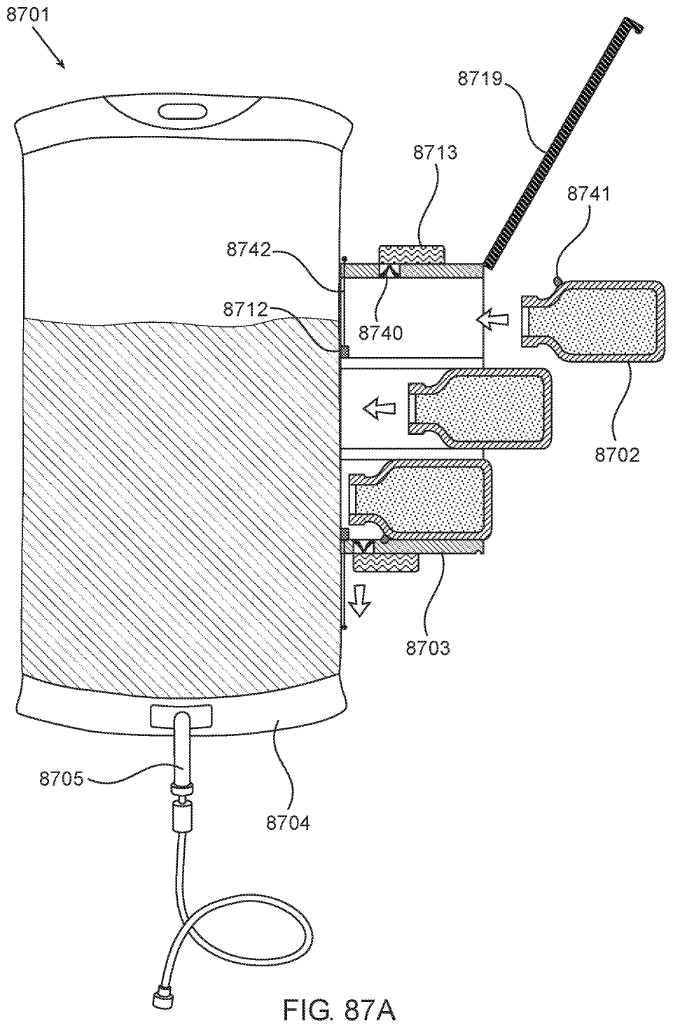

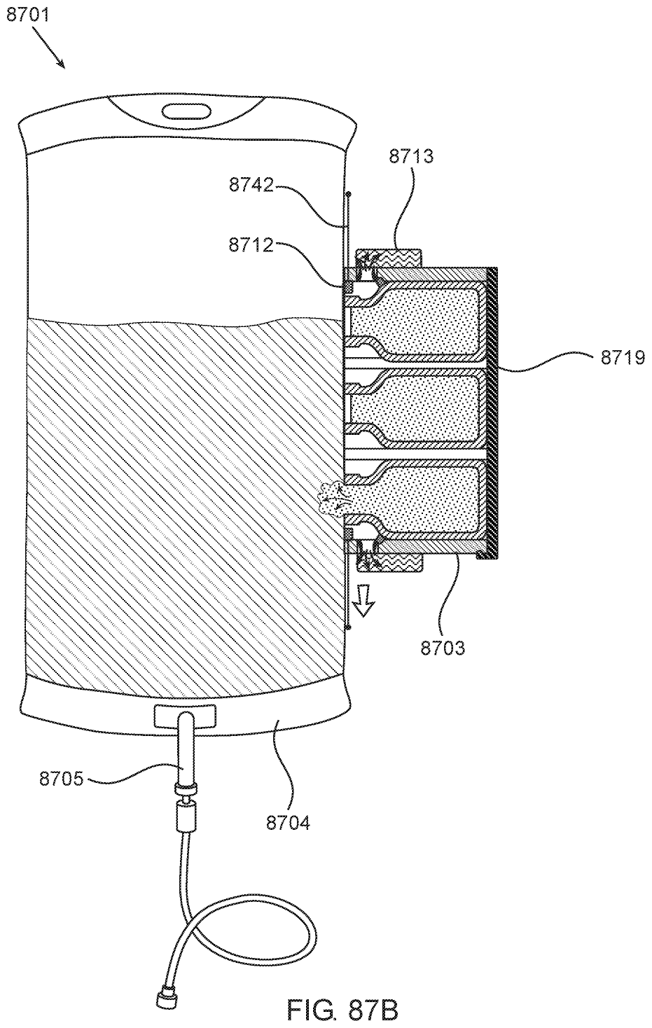

FIG. 86 is a schematic front cut view illustration presenting yet another exemplary system 8601 which includes an IV bag 8604 having a plurality of entry ports 8603 configured for accommodating therein containers 8602 and allowing a fluid transfer between containers 8602 and IV bag 8604. A wiping member 8612 connected to wiping member actuator 8642 is used to decontaminate the distal tip/end of containers 8602 prior to transferring a dose from containers 8602 into bag 8604. In certain embodiments, the wiping member actuator 8642 is manipulated externally by a user to wipe off the surfaces of containers 8602. In alternative embodiments, the entry of containers 8602 within entry ports 8603 automatically exert movement of wiping member across the entry ports 8603. FIGS. 87A-87B are schematic front cut view illustrations presenting yet another exemplary system 8701 which includes an IV bag 8704 having a unitary multiple port structure 8703 configured for accommodating therein a plurality of containers 8702 and allowing a fluid transfer between containers 8702 and IV bag 8704. A wiping member 8712 connected to wiping member actuator 8742 is used to decontaminate the distal tip/end (port) of containers 8702 prior to transferring a dose from containers 8702 into IV bag 8704. The unitary multiple port structure may have at least one, optionally a plurality, of wiping members 8712 and/or actuators 8742.

FIG. 87A illustrate various steps of inserting containers 8702 into unitary multiple entry port structure 8703. The wiping members 8712 disposed at a first end of an entry port 8703. FIG. 87B illustrates the accommodation of bottles/vials 8702 within the entry ports 8703. Valve unlock mechanism 8741 is configured such that once containers 8702 reside within the port structure 8703 and cover 8719 is closed, the valve unlock mechanism 8741 moves to opens valve 8740 to thereby allow the air and any leaked vapors/fluids from IV bag 8704 and/or bottles/vials 8702 to be sucked into negative pressure compartment 8713 to exert a lower pressure within the cavities of unitary multiple entry port structure 8703. This allows to draw the containers and maintain same within the ports and further allow the transfer of any leakage of vapors and/or fluids from the fluidic communication between IV bag 8704 and bottles/vials 8702 from within unitary multiple entry port structure 8703 into negative pressure compartment(s) 8713. The wiping member(s) 8712 may be disposed inside and/or on an inner surface of unitary multiple entry port structure 8703. Wiping member(s) may be manually actuated to move from the one end position to a second opposing end position within the port to thereby remove contaminates from a surface of the plurality of containers/bottles/vials 8702. It is important to note that herein specification incorporates in it's entirety the teachings of U.S. non-provisional patent applications Ser. No. 16/100,840 entitled SYSTEMS, DEVICES AND METHODS FOR DECONTAMINATING SURFACES OF PHARMACUETICAL VESSELS AND PHARMACEUTICAL ADMINISTRATION DEVICES and application Ser. No. 16/100,964 entitled DECONTAMINATION DEVICE FOR PHARMACEUTICAL VESSELS and application Ser. No. 16/199,909 entitled DECONTAMINATINO DEVICE FOR PHARMACEUTICAL VESSELS HAVING SAFETY MECHANISMS and application Ser. No. 16/274,717 entitled SYSTEMS AND METHODS FOR DECONTAMINATED ENGAGEMENT OF VESSELS USING A DISPLACEABLE PLATE. Any of the systems, containers, devices, and methods disclosed in herein specification may incorporate any of the teachings disclosed in the mentioned patent applications. In one example, the port structure 8703 (also referred to as the unitary multiple entry port structure) may incorporate any of the teachings disclosed in the patent applications mentioned in this paragraph.

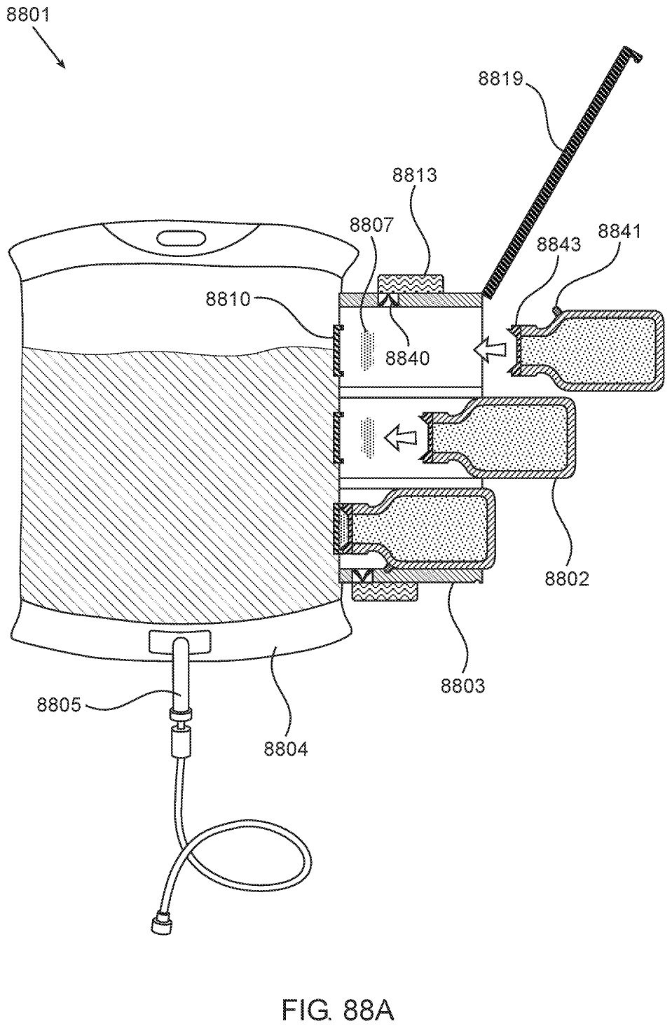

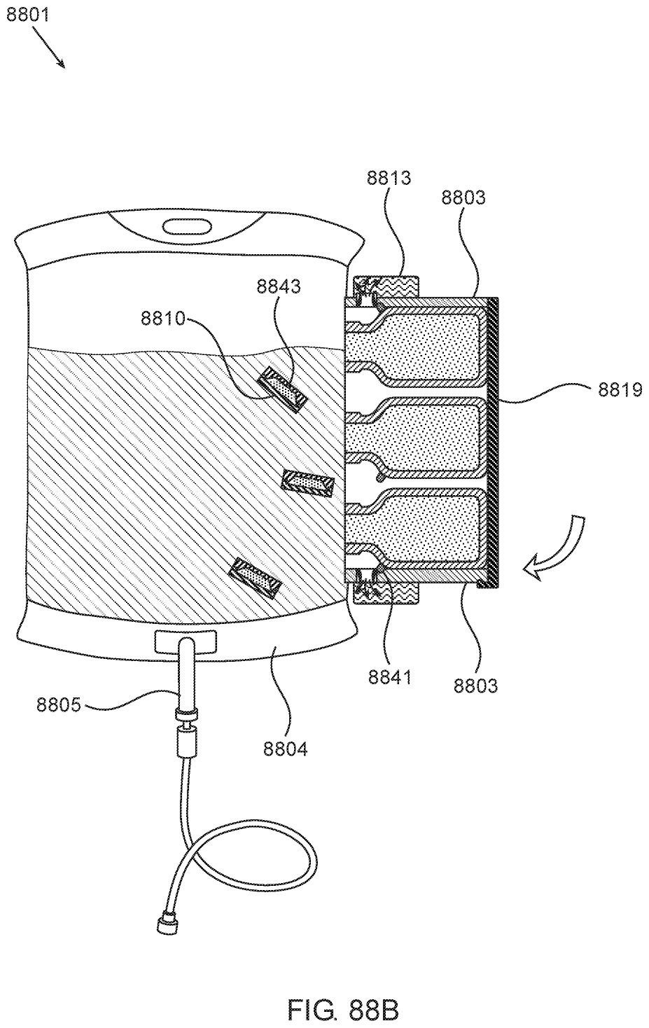

FIGS. 88A-88B are schematic front cut view illustrations presenting a further exemplary system 8801 which includes an IV bag 8804 having a unitary multiple entry port structure configured to receive a plurality of containers 8802, according to some embodiments of the invention. Containers 8802 having decontamination cap members 8843 which cover apertures thereof. Entry ports have decontamination cap members 8810 which cover apertures thereof. Cap members 8843 and cap members 8810 can mate with one another and are configured to displace internally at about the time of and/or after engagement between the containers 8802 and entry ports 8803. Contaminants 8807 such as ambient air particles are pressed between cap member 8810 of the IV bag and cap member 8843 of the containers and are housed within or between the interface between the entry port cap 8810 and the caps 8843 of containers 8802. Entry ports 8803 may in one or more embodiments represent a unitary multiple entry port structure 8803 configured to hermetically seal containers 8802 inside the unitary multiple entry port structure 8803 after cover 8819 is in a closed position as shown in FIG. 88B. Any leaks produced by the fluidic communication between IV bag 8804 and containers 8802 are contained within the unitary multiple entry port structure 8803 and may be withdrawn/sucked out into negative pressure compartment(s) 8813.

FIG. 88A illustrates various steps of inserting containers 8802 into entry ports 8803. Contaminants 8807 are pressed between cap member 8810 and cap member 8843. Optionally, valve 8840 is opened by the valve unlock mechanism 8841. FIG. 88B illustrates the internal displacement of cap member 8843 and cap member 8810 into bag 8804 establishing contaminant-free fluid passageways between the bag and containers. It is important to note that herein specification incorporates in it's entirety the teachings of U.S. non-provisional utility patent application Ser. No. 16/100,712 entitled DEVICES AND SYSTEMS WITH AN INTERNAL DISPLACEMENT MECHANISM FOR CONTAMINANT-FREE ENGAGEMENT OF MEDICAL VESSELS AND DEVICES. The internal displacement decontamination systems, containers, devices, and methods as shown in FIGS. 88A-88B may incorporate any of the teachings of utility patent application Ser. No. 16/100,712. In one or more embodiments, any of the systems, containers, devices, and methods in herein specification may incorporate any of the teaching of application Ser. No. 16/100,712.

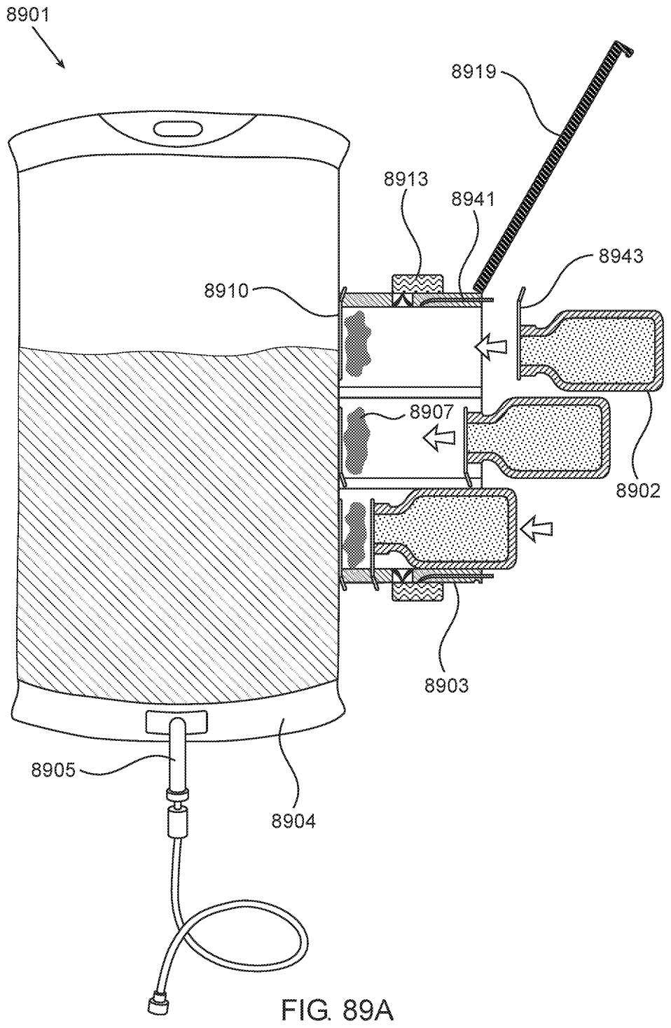

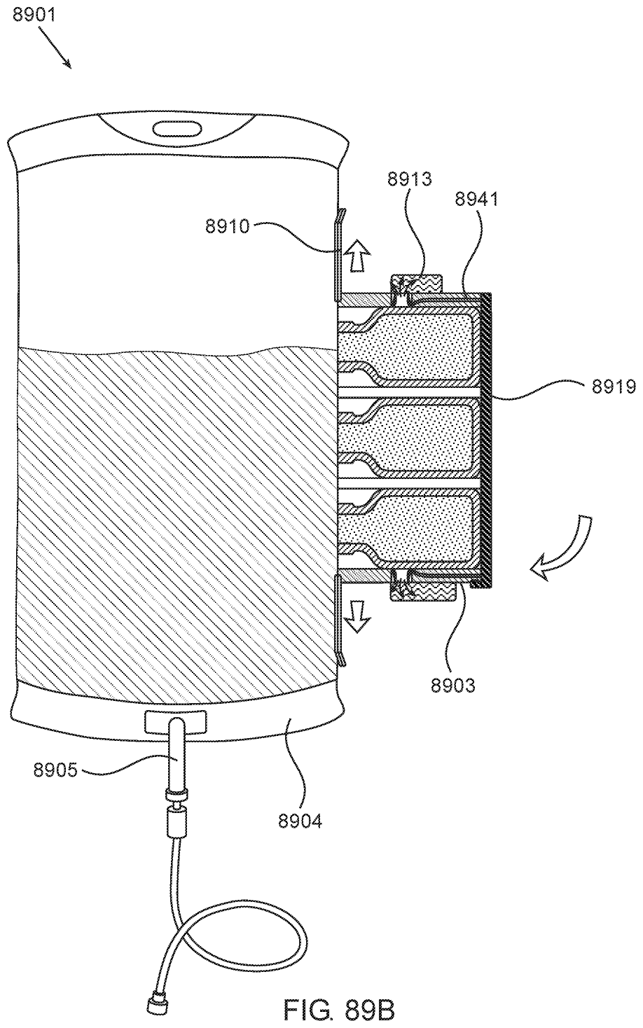

FIGS. 89A-89B are schematic front cut view illustrations presenting a further exemplary system 8901 which includes an IV bag 8904 having a unitary multiple entry port structure 8903, an exit port 8905, and a plurality of containers 8902 configured to be received by the unitary multiple entry port structure 8903, according to some embodiments of the invention. The containers have a decontamination interface 8943 and the entry port structure has decontamination interfaces 8910 covering apertures of the structure 8903. The decontamination interfaces 8910 mate with decontamination interfaces 8943 and are configured to slide externally as the decontamination interfaces engage with each other. Sliding externally may mean in one or more embodiments sliding externally to the unitary multiple entry port structure 8903 and/or sliding externally to apertures of the unitary multiple entry port structure 8903 that the decontamination interfaces 8940 cover. It is important to note that herein specification incorporates in it's entirety the teaching of U.S. non-provisional utility patent application Ser. No. 16/100,594 entitled DEVICES AND SYSTEMS WITH AN EXTERNAL DISPLACEMENT MECHANISM FOR CONTAMINANT-FREE ENGAGEMENT OF PHARMACUETICAL VESSELS AND PHARMACEUTICAL ADMINISTRATION DEVICE and any of the systems, containers, devices and methods disclosed in patent application Ser. No. 16/100,594 may be incorporated into any of the systems, containers, devices, and methods disclosed in herein specification. In one example the systems, containers, device, and methods of patent application Ser. No. 16/100,594 may be incorporated into the unitary multiple entry port structure 8903.

FIG. 89A illustrates various steps of inserting containers 8902 into unitary multiple entry port structure 8903. Contaminants 8907 such as but not limited to ambient air particles are confined between decontamination interfaces 8910 and decontamination interfaces 8943. FIG. 89B illustrates the external displacement of decontamination interfaces 8910 and decontamination interfaces 8943, establishing contaminates-free fluid passageway between the bag and containers. Apertures (not shown) may be present in a wall(s) of the unitary multiple entry port structure 8903, optionally or alternately between IV bag 5904 and unitary multiple entry port structure 8903, the apertures (not shown) configured to allow displacement of interfaces 8910 and 8943 through the apertures (not shown).

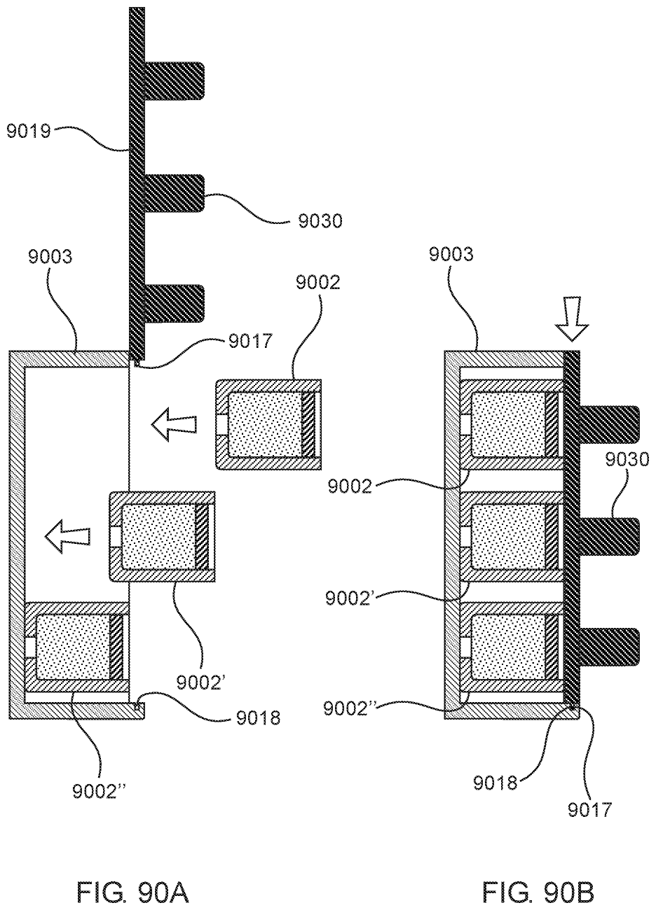

FIGS. 90A-90B are schematic side cut view illustrations presenting a unitary multiple entry port structure 9003 with peripheral walls and a cover 9019 enclosing cavities configured to accommodate containers 9002, according to some embodiments of the invention.

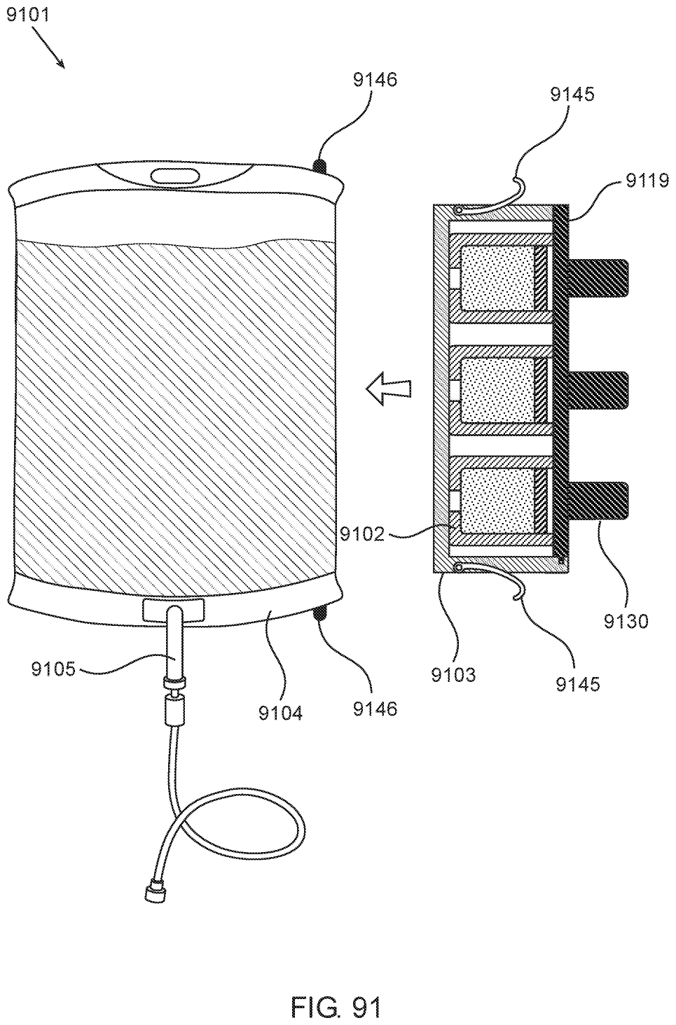

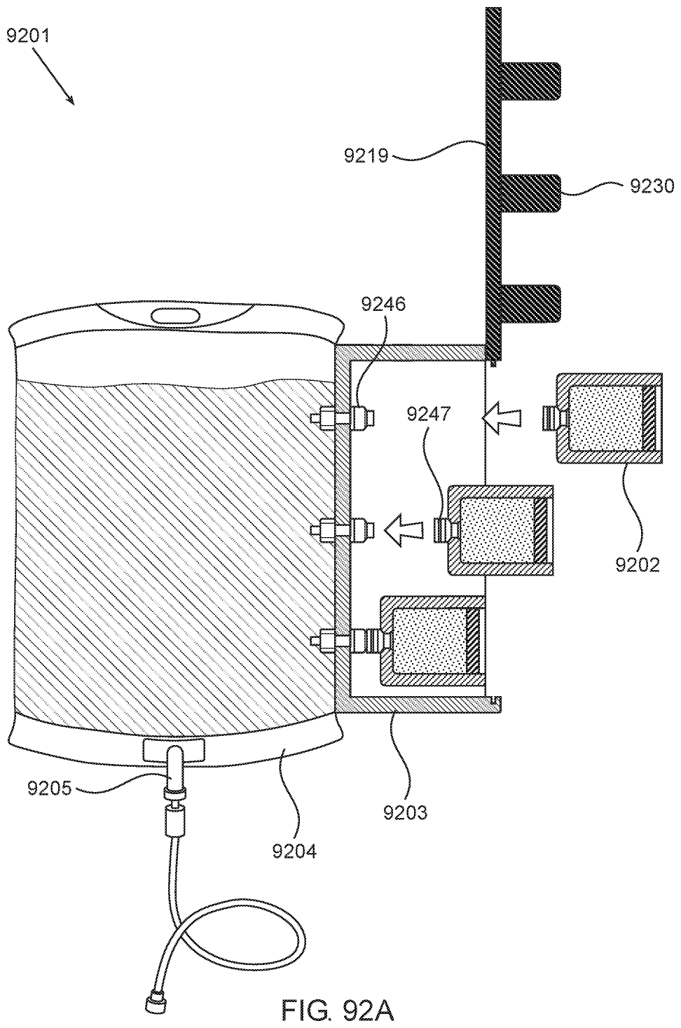

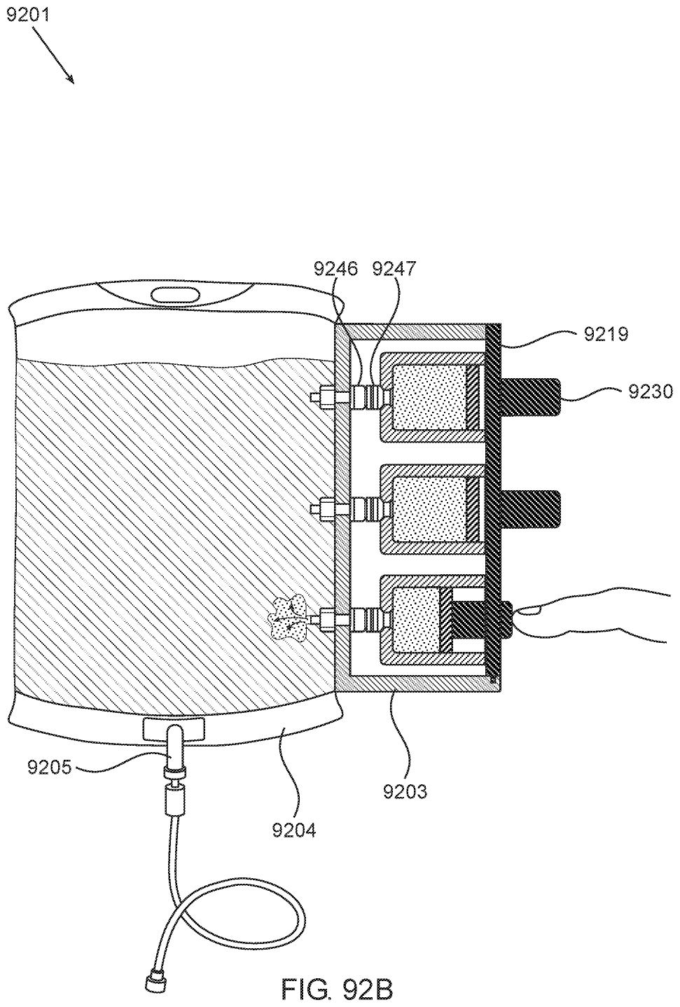

FIG. 90A illustrate the unitary multiple entry port structure 9003 and containers 9002 which are being received by the unitary multiple entry port structure 9003. Each of the containers 9002 enter and reside within a dedicated entry port within the unitary multiple entry port structure 9003. The cover 9019 slidable closes the entry port structure 9003 and can securely lock the structure via a cover lock mechanism having a pin 9017 that mate slot 9018 (FIG. 90B). Buttons 9030 are configured to move thorough cover 9019 to actuate movement of a plunger of containers 9002 to expel contents contained inside containers 9002. The unitary multiple entry port structure 9003 shown in FIGS. 90A-90B may be in one or more embodiments a connector and/or manifold having a cover 9019 configured to seal at least one container inside the connector and/or manifold. The connector 9003 and/or manifold 9003 may in one or more embodiments hermetically seal at least one container inside the connector and/or manifold. The unitary multiple entry port structure 9003 shown in FIGS. 90A-90B may be in one or more embodiments a connector and/or manifold having a cover 9019 configured to seal a plurality of containers inside the connector and/or manifold. The unitary multiple entry port structure 9003 shown in FIGS. 90A-90B may be in one or more embodiments a connector and/or manifold having a cover 9019 configured to hermetically/airtight seal a plurality of containers inside the connector and/or manifold. The unitary multiple entry port structure 9003 shown in FIGS. 90A-90B may be in one or more embodiments a connector and/or manifold having a cover 9019 configured to seal a plurality of containers inside the connector and/or manifold and further comprising at least one button 9030 to actuate movement of a plunger of the containers disposed inside the connector and/or manifold. The unitary multiple entry port structure 9003 shown in FIGS. 90A-90B may in one or more embodiments be a connector/manifold having a cover 9019 configured to hermetically seal a plurality of containers inside the connector/manifold and further comprising a plurality of buttons 9030 configured to at least partially move through the cover 9019 to actuate the movement of a plurality of plungers of containers 9002. The connectors/manifold 9003 is very useful in the medicinal setting since it allows a pharmacy/pharmacists and/or other pharmaceutical distributor to assemble a customized amount of an injectable medicament by placing an appropriate number of vials/containers 9002 containing a customized final dosage amount of a medicament into the connector/manifold and then sealing the connector/manifold with the cover 9019. Containers/vials containing a final dosage amount of a beneficial substance/medicament are now disposed inside the connector/manifold thus preventing a patient or other person from removing the containers 9002 from the connector/manifold 9003. The connector/manifold 9003 housing the plurality of containers 9002 may now be delivered/mailed/distributed to an end user for attachment to an IV bag as shown in FIGS. 91, 92A, and 92B. The containers 9002 are locked, optionally permanently locked, inside connector/manifold 9003 by a locking mechanism 9017 and fastener 9018 as shown in FIG. 90B thus preventing removal of containers 9002 from connector/manifold 9003.

FIG. 90B is a schematic front cut view illustration showing a plurality of containers 9002, 9002′, and 9002″ disposed inside the connector/manifold and the cover 9030 is in a closed position and locked, preferably permanently locked. The cover 9030 may in one or more embodiments, hermetically/airtight seal containers 9002, 9002′, and 9002″ inside the connector/manifold 9003. The connector/manifold 9003 loaded with the plurality of containers 9002 provides a compact and portable presentation of a customized dosage amount of an injectable beneficial substance which is safe and easy to distribute via mail or within a hospital/clinic from a pharmacy/pharmacist to an end user such as a nurse or patient. The customized dosage amount is provided by assembling a plurality of containers 9002 and placing them inside the connector/manifold 9003 by a pharmacist, closing the connector/manifold with the cover 9019, and locking the cover in place via engagement/coupling of locking member 9017 and fastener 9018. The connector/manifold cover may hermetically seal the containers 9002 inside the connector/manifold. After the connector/manifold 9003 is loaded with a plurality of the containers 9002 then a user may attached the connector/manifold 9003 to a container such as an IV bag (not shown), a bottle (not shown), or any other type of container or device.

FIG. 91 is a schematic front cut view illustration presenting a further exemplary system which includes an IV bag 9104 and a unitary multiple entry port structure 9103 with peripheral wall(s). In certain embodiments, the unitary multiple entry port structure 9103 is provided as a separate element configured to engage an IV bag via an engagement mechanism. The engagement mechanism here hook 9145 and pin 9146 is configured to connect the unitary multiple entry port structure 9103 to the IV bag 9104. Various types of engagement mechanisms are applicable and are contemplated such as a thread, ratchet teeth, snaps, adhesive, and any of the alike. The unitary multiple entry port structure 9103 with peripheral wall(s) is shown with a plurality of containers/vials disposed inside the unitary multiple entry port structure 9103 with peripheral wall(s). Attachment of the unitary multiple entry port structure 9103 with peripheral wall(s) to IV bag 9104 occurs after a plurality of containers have been loaded/disposed inside the unitary multiple entry port structure 9103 with peripheral wall(s). In one or more embodiments, attachment of the unitary multiple entry port structure 9103 to IV bag 9104 occurs after a plurality of containers have been loaded/disposed inside the unitary multiple entry port structure 9103. In one or more embodiments, a plurality of containers are loaded/assembled inside unitary multiple entry port structure 9103, a cover 9119 closes and hermetically seals the plurality of the containers inside the unitary multiple entry port structure 9103, and then container 9104 is attached and/or engaged and/or coupled to the unitary multiple entry port structure 9103. In one or more embodiments, the unitary multiple entry port structure 9103 of FIG. 91 further comprising at least one button(s) 9130. In one or more embodiments, the unitary multiple entry port structure 9103 of FIG. 91 further comprising a plurality of buttons 9130. In one or more embodiments, the buttons 9130 are configured to move, optionally at least partially move, through cover 9119 to actuate/move plungers of containers 9102 to actuate expulsion of any contents contained inside containers 9102 out of containers 9102. In one or more embodiments, a decontamination device (not shown) may be disposed on an exterior surface of unitary multiple entry port structure 9103 and/or on an exterior surface of container 9104 so that when container 9104 engages/couples with unitary multiple entry port structure 9103 the engagement/coupling at the location of the fluid passageways (not shown) of container 9104 and unitary multiple entry port structure 9103 is decontaminated.

FIGS. 92A-92B are schematic front cut view illustrations presenting a further exemplary system which includes an IV bag 9204 having a unitary multiple entry ports structure 9203 with peripheral walls and a cover 9219 enclosing cavities configured to accommodate containers 9202. According to certain embodiments, the containers 9202 include snap on engagement mechanism 9247 configured to connect the IV bag 9204 via a complementary engagement mechanism 9246. The engagement mechanism 9246 and 9247 extend through apertures (not shown) and allow the fluid flow from the containers 9202 to IV bag 9204. In certain embodiments, the engagement mechanisms include a lock and an unlock mechanism to prevent premature connection/opening of the apertures. Various types of engagement mechanisms are applicable and are contemplated such as a thread, ratchet teeth, snaps, adhesives, and any of the alike. In one or more embodiments, the snap on mechanisms 9246 and 9247 may couple via a push motion of containers 9202 in relation to engagement mechanism 9246, a push motion of engagement mechanism 9247 in relation engagement mechanism 9246, a twist motion of engagement mechanism 9247 in relation to engagement mechanism 9246 (or vice versa), a push and twist motion of engagement mechanism(s) 9247 in relations to engagement mechanisms 9246, twist and push motion of engagement mechanism(s) 9247 in relation to engagement mechanism(s) 9246, and combinations thereof. In one or more embodiments, at least one of engagement mechanisms 9246 and 9247 are a smart-site engagement mechanism. In one or more embodiments, The smart-site engagement mechanism(s) 9246 and/or 9247 may have a locking mechanism which provides a secure and permanent connection between engagement mechanism(s) 9246 and 9247 and prevents detachment of containers 9202 from unitary multiple entry ports structure 9203. In one or more embodiments, engagement mechanism 9247 and/or 9246 may be a valve configured to open/establish a fluidic passageway between containers 9202 and IV bag 9204 at about the time and/or after engagement/coupling of engagement mechanisms 9246 and 9247. FIG. 92B shows containers 9202 completely disposed inside unitary multiple entry ports structure 9203, cover 9219 in a closed position and hermetically sealing containers 9202 inside unitary multiple entry ports structure, engagement mechanisms 9246 and 9247 mated/coupled to each other, and bottom button 9230 pushed through cover 9219 towards IV bag 9204 by a user's finger which moves a plunger of container 9202 towards IV bag 9204 thus expelling contents of container 9202 into bag 9204. In one or more embodiments, a valve (not shown) may be disposed within, inside, and/or over the fluidic passageway between containers 9202 and IV bag 9204. The valve (not shown) may be a one-way valve which allows fluid to move from within containers 9202 into IV bag 9204 while preventing backflow of fluid from IV bag 9204 to containers 9202. The valve(s) (not shown) may be located on the multiple entry ports structure 9203, on an interior surface of the multiple entry ports structure 9203, in a wall of the multiple entry ports structure 9203, through a wall of the multiple entry ports structure 9203 on an interior surface of the multiple entry ports structure 9203, on an exterior surface of the multiple entry ports structure 9203, on the containers 9202, on the IV bag 9204, any combination thereof. The unitary multiple entry port structure 9203 is shown in FIGS. 92A-92B surface mounted to container 9204. The unitary multiple entry port structure 9203 is shown in FIGS. 92A-92B abutting container 9204. However, in certain embodiments, unitary multiple entry port structure may be flush mounted (not shown) to container 9204. In one or more embodiments, container 9204 may be referred to as a first container and containers 9202 may be referred to as a plurality of containers. In one or more embodiments, buttons 9230 and/or cover 9219 may further comprise spring mechanisms (not shown) configured to mediate the movement of the buttons 9230. In one or more embodiments, buttons 9230 may be replaced with other actuators/actuating mechanisms that will move through the cover 9216, optionally or alternately through a surface of the cover 9216. Unitary multiple entry port structure 9203 is shown having a single cavity inside the unitary multiple entry port structure 9203, the single cavity configured to allow entry of a plurality of the containers 9202. FIG. 92B shows the plurality of the containers 9202 located inside the unitary multiple entry port structure, the plurality of the containers 9202 are fully engulfed (fully disposed) inside the unitary multiple entry port structure 9203 when the cover 9219 is in a closed position as is shown in FIG. 92B. When the plurality of the containers 9202 are fully engulfed inside the unitary multiple entry port structure 9203 and when the cover 9219 is in a closed position the plurality of the containers are isolated within the unitary multiple entry port structure 9203 and the plurality of the containers 9202 are not exposed to the environment. Any breakage, fluid leaks, vapor, leaks, and the alike are contained inside the unitary multiple entry port structure thus protecting the environment and a user from exposure to the contents contained within the plurality of the containers 9202. Unitary multiple entry port structure may in one or more embodiments be made of a rigid material, a rigid plastic material, a metal alloy, and combinations thereof. In one or more embodiments, it is contemplated that the cover 9219 has a single actuator that is configured to move the plurality of the plungers of the plurality of the containers 9202 when the single actuator is actuated. In one or more embodiments, it is contemplated that the cover 9219 has a single button that is configured to move the plurality of the plungers of the plurality of the containers 9202 when the single button is pushed.

It should be appreciated that for simplicity and clarity of illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

Each of the following terms: ‘includes’, ‘including’, ‘has’, ‘having’, ‘comprises’, and ‘comprising’, and, their linguistic, as used herein, means ‘including, but not limited to’, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof. Each of these terms is considered equivalent in meaning to the phrase ‘consisting essentially of’.

Each of the phrases ‘consisting of’ and ‘consists of’, as used herein, means ‘including and limited to’.

The term ‘method’, as used herein, refers to steps, procedures, manners, means, or/and techniques, for accomplishing a given task including, but not limited to, those steps, procedures, manners, means, or/and techniques, either known to, or readily developed from known steps, procedures, manners, means, or/and techniques, by practitioners in the relevant field(s) of the disclosed invention.

Throughout this disclosure, a numerical value of a parameter, feature, characteristic, object, or dimension, may be stated or described in terms of a numerical range format. Such a numerical range format, as used herein, illustrates implementation of some exemplary embodiments of the invention, and does not inflexibly limit the scope of the exemplary embodiments of the invention. Accordingly, a stated or described numerical range also refers to, and encompasses, all possible sub-ranges and individual numerical values (where a numerical value may be expressed as a whole, integral, or fractional number) within that stated or described numerical range. For example, a stated or described numerical range ‘from 1 to 6’ also refers to, and encompasses, all possible sub-ranges, such as ‘from 1 to 3’, ‘from 1 to 4’, ‘from 1 to 5’, ‘from 2 to 4’, ‘from 2 to 6’, ‘from 3 to 6’, etc., and individual numerical values, such as ‘1’, ‘1.3’, ‘2’, ‘2.8’, ‘3’, ‘3.5’, ‘4’, ‘4.6’, ‘5’, ‘5.2’, and ‘6’, within the stated or described numerical range of ‘from 1 to 6’. This applies regardless of the numerical breadth, extent, or size, of the stated or described numerical range.

Moreover, for stating or describing a numerical range, the phrase ‘in a range of between about a first numerical value and about a second numerical value’, is considered equivalent to, and meaning the same as, the phrase ‘in a range of from about a first numerical value to about a second numerical value’, and, thus, the two equivalently meaning phrases may be used interchangeably.

The term ‘about’, is some embodiments, refers to ±30% of the stated numerical value. In further embodiments, the term refers to ±20% of the stated numerical value. In yet further embodiments, the term refers to ±10% of the stated numerical value.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system for intermixing beneficial substances, comprising:
a first container having a unitary multiple entry port structure, the unitary multiple entry port structure configured to receive a plurality of containers and fully engulf thereof, the unitary multiple port structure further comprising a cover configured to seal the plurality of the containers inside the unitary multiple entry port structure, thereby providing a protective entry port structure; and
a plurality of containers containing a beneficial substance, the plurality of the containers configured to enter inside the unitary multiple entry port structure,
wherein upon entry of the plurality of the containers inside the unitary multiple entry port structure, the plurality of the containers are completely enclosed inside the unitary multiple entry port structure thus providing for leak-free establishment of fluidic communication between the first container and the plurality of the containers.

2. The system of claim 1, wherein the cover is configured to hermetically seal the unitary multiple entry port structure.

3. The system of claim 1, wherein the port unitary cover is configured to hermetically seal the plurality of the containers inside the unitary multiple entry port structure when the port unitary cover is in a closed position.

4. The system of claim 1, wherein the cover further comprising at least one button configured to move through the cover.

5. The system of claim 1, wherein the cover further comprising a plurality of buttons configured to move through the cover to actuate movement of a plurality of plungers of the plurality of the containers when the plurality of the containers are disposed inside the unitary multiple entry port structure.

6. The system of claim 1, wherein the plurality of the containers having a plunger.

7. The system of claim 1, wherein the unitary multiple entry port structure further comprising at least one lever disposed through the unitary multiple entry port structure, the at least one lever configured to engage at least one plunger of the plurality of the containers and to move at least one plunger of the plurality of the containers.

8. The system of claim 1, wherein at least one of the first container and the unitary multiple entry port structure further comprising at least one negative pressure compartment.

9. The system of claim 8, wherein the unitary multiple entry port structure has at least one conduit connecting the at least one negative pressure compartment with the interior of the unitary multiple entry port structure.

10. The system of claim 9, wherein the unitary multiple entry port structure further comprising a valve disposed inside and/or covering the conduit.

11. The system of claim 1, wherein the unitary multiple entry port structure includes a peripheral wall enclosing cavity configured to receive the plurality of the containers and engulf thereof, thereby providing a protective entry port structure.

12. The system of claim 1, wherein the unitary multiple entry port structure includes at least one conduit fluidly connecting the first container to the plurality of the containers.

13. The system of claim 1, wherein the first container is a bag or a bottle.

14. The system of claim 1, wherein the plurality of the containers are selected from a group consisting of a bottle, a syringe, and a container with a plunger.

15. The system of claim 9, wherein the at least one negative pressure compartments having a lower pressure than ambient air pressure.

16. The system of claim 1, wherein the cover includes a cover closure mechanism for locking the cover to the unitary multiple entry port structure.

17. The system of claim 16, wherein the cover closure mechanism is selected from a group consisting of flaps, pin-slot, latch-slot, latch protrusion, and hook-slot.

18. The system of claim 1, wherein the unitary multiple entry port structure further comprising at least one decontamination device.

19. The system of claim 18, wherein the decontamination device comprises a wiping member disposed inside the unitary multiple entry port structure, the wiping member configured to move within the unitary multiple entry port structure to wipe of a surface of at least one of the plurality of the containers.

20. The system of claim 1, wherein the unitary multiple entry port structure further comprises a plurality of cap members configured to couple with a plurality of cap members of the plurality of the containers, wherein after coupling the plurality of the cap members of the unitary multiple entry port structure with the plurality of the cap members of the plurality of the containers the coupled cap members entraps contaminants between the coupled cap members and displace internally into the first container providing a contaminant-free engagement of the plurality of the containers to the first container.

21. The system of claim 1, wherein the unitary multiple entry port structure further comprises a plurality of decontamination interfaces and the plurality of the containers further comprise a plurality of decontamination interfaces, wherein upon engagement of the plurality of the decontamination interfaces of the unitary multiple entry port structure with the plurality of the decontamination interfaces of the plurality of the containers the engaged decontamination interfaces displace external to the unitary multiple entry port structure through an aperture in the unitary multiple entry port structure.

22. The system of claim 1, wherein the unitary multiple entry port structure is surface mounted to the first container.

23. The system of claim 1, wherein the unitary multiple entry port structure abuts the first container.

24. The system of claim 1, wherein the unitary multiple entry port structure is flush mounted to the first container.

25. The system of claim 1, wherein the first container further comprising a peripheral wall enclosing a cavity configured to receive at least one of the plurality of the containers and engulf thereof, thereby providing a protective entry port structure.

26. The system of claim 1, wherein when the cover is in a closed position the plurality of the containers are completely enclosed inside the unitary multiple entry port structure and any vapor and/or fluid leaks produced from the fluidic communication between the first container and the plurality of the containers is contained inside the unitary multiple entry port structure.

27. The system of claim 1, wherein the cover are flaps.

28. The system of claim 1, wherein the unitary multiple entry port structure further comprises a plurality of piercing members configured to pierce through a surface of at least one of the first container and the plurality of the containers.

29. The system of claim 1, wherein the unitary multiple entry port structure further comprising a rail mechanism configured to allow the cover to move along the rail mechanism to seal the plurality of the containers inside the unitary multiple entry port structure.

30. The system of claim 1, wherein the unitary multiple entry port structure further comprising a hinge mechanism configured to allow the cover to move from an open position to a closed position.

31. The system of claim 1, wherein the unitary multiple entry port structure further comprising a plurality of plunger unlock mechanisms in the form of rods and the plurality of the containers further comprising plunger lock mechanisms configured to be unlocked by the rods, wherein upon engagement of the rods to the plunger lock mechanisms the plunger lock mechanisms are unlocked thus allowing the plungers of the plurality of the containers to move.

32. The system of claim 4, wherein the unitary multiple entry port structure further comprising at least one button lock mechanism configured to maintain the plurality of the buttons in an extended position until about the time and/or after the cover is in a closed position at which time the at least one button lock mechanism is unlocked thus allowing movement of buttons through the cover.

33. The system of claim 1, wherein the unitary multiple entry port structure further comprising a piercing member lock mechanism configured to lock piercing members and wherein the plurality of the containers further comprising piercing member unlock mechanisms configured to unlock the piercing members at about the time or after entry of the plurality of the containers inside the unitary multiple entry port structure.

34. The system of claim 10, wherein the unitary multiple entry port structure further comprising a valve unlock mechanism, the valve unlock mechanism configured to open the valve, the valve unlock mechanism configured to be actuated by closure of the cover.

35. The system of claim 7, wherein the unitary multiple entry port structure further comprising at least one lever lock mechanism in the form of a retractable pin, the retractable pin configure to prevent the lever from moving until after the plurality of the containers have been placed inside the unitary multiple entry port structure and after the cover is in a closed position sealing the plurality of the containers inside the unitary multiple entry port structure.

36. The system of claim 1, wherein the unitary multiple entry port structure comprises a plurality of entry ports configured to allow entry of a plurality of containers inside the plurality of the entry ports, the plurality of the entry ports connected to each other.

37. The system of claim 1, wherein the cover is configured to hermetically seal a plurality of ports of the unitary multiple entry port structure.

38. The system of claim 1, wherein the unitary multiple entry port structure has a plurality of conduits configured to connect the first container to the plurality of the containers when the plurality of the containers are coupled to the unitary multiple entry port structure.

39. The system of claim 1, wherein the unitary multiple entry port structure integrally attached to the first container.

40. The system of claim 1, wherein the unitary multiple entry port structure forms a unitary structure with the first container.
